(19) United States
(12) Patent Application Publication
(10) Pub. No.: US 2015/0095882 A1
(43) Pub. Date: Apr. 2, 2015

(54) METHOD FOR THE UTILIZATION OF ENVIRONMENT MEDIA IN A COMPUTING SYSTEM

(71) Applicant: Blackspace Inc., Concord, MA (US)

(72) Inventors: Denny Jaeger, Lafayette, CA (US); David Surovell, San Carlos, CA (US)

(21) Appl. No.: 14/479,240

(22) Filed: Sep. 5, 2014

Related U.S. Application Data
(60) Provisional application No. 61/874,908, filed on Sep. 6, 2013.
(60) Provisional application No. 61/874,901, filed on Sep. 6, 2013.
(60) Provisional application No. 61/954,575, filed on Mar. 17, 2014.

(51) Int. Cl. G06F 9/44

(52) U.S. Cl. CPC G06F 8/34
USPC 717/109

(57) ABSTRACT

Methods for utilizing environment media in a computing system use environment media objects to create, modify and/or share any content. The environment media objects that have a relationship to at least one other object can communicate with each other to perform at least one purpose or task.

### CROSS REFERENCE TO RELATED APPLICATIONS

This application is entitled to the benefit of U.S. Provisional Patent Application Ser. No. 61/874,908, filed on Sep. 6, 2013, U.S. Provisional Patent Application Ser. No. 61/874,901, filed on Sep. 6, 2013, and U.S. Provisional Patent Application Ser. No. 61/954,575, filed on Mar. 17, 2014, which are all incorporated herein by reference.

### BACKGROUND

Today a staggering level of content is being created by a globally connected society. A popular method of creating user-generated-content is by combining one piece of content with another. One problem that has emerged for the end-user is the increasing number of file formats and the difficulty in playing, viewing, editing, combining and managing content of differing formats, which are not easily compatible. Further, the world of computing remains largely programmer-centric and the end-user must still work in ways dictated by the companies that create and design computer hardware and software.

### SUMMARY

Methods for utilizing environment media in a computing system use environment media objects to create, modify and/or share any content. The environment media objects that have a relationship to at least one other object can communicate with each other to perform at least one purpose or task.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram depicting a computer system capable of carrying out the operations of the present invention.

FIG. 2 serves two purposes:

(1) In a first discussion, FIG. 2 illustrates problems within and between two windows-based programs, a word document and a graphics layout document.

(2) In a second discussion, FIG. 2 is used to illustrate solutions to the problems raised in said first discussion by redefining the example of FIG. 2 and presenting the contents of said two windows-based programs as one object-based or definition-based environment, e.g., an Environment Media.

FIG. 3A shows the insertion of two paragraph text objects into the object-based text document, presented in said second discussion of FIG. 2.

FIGS. 3B and 3C show the results of inserting two paragraph text objects into said object-based text document.

FIG. 4 forms the foundation for a detailed discussion of maintain relationships between objects in and object-based environment, called “Environment 1.”

FIG. 5A presents an Environment Media Object Environment, A-1, which is comprised of at least three objects, (1) fader track, 30, (2) fader cap, 31, and (3) function, 32, which have one or more relationships to each other.

FIG. 5B this is an illustration of the use of fader cap, 31, to program a graphic that is not part of Environment Media, A-1.

FIG. 5C shows vertical gray rectangle being assigned to a pointer object by the drawing of a directional indicator.

FIG. 5D shows a pointer object after its assigned-to object (the object assigned to said pointer object) has been hidden.

FIG. 5E shows the assignment for a pointer object. Said assignment is a semi-transparent vertical gray rectangle.

FIG. 5F shows a pointer object outputted adjacent to a vertical orientation of LED objects.

FIG. 5G shows a pointer object that has been activated to present its assignment, a vertical gray rectangle that can be used to control the setting for an audio threshold function.

FIG. 6 illustrates a general logic for an object being able to utilize one or more of its characteristics to update another object's characteristics.

FIGS. 7A-7G illustrate the use of Type Two Invisible Objects and the recognition of a context that initiates one or more actions.

FIG. 8 is a flow chart illustrating a method that creates an action object from a recognized context in an Environment Media.

FIGS. 9A and 9C depict a series of steps that are recorded as motion media.

FIG. 9B is an example only of the utilization of an object to crop a segment of a picture.

FIG. 9D is an object equation setting two equivalents for a motion media.

FIG. 10 is an object equation setting two equivalents for a known word: “Picture”, which denotes a generic picture category.

FIG. 11 is an object equation setting an equivalent for a known phrase: “Any Type.”

FIG. 12 is an object equation setting an equivalent for a known phrase: “Just This Type.”

FIG. 13A-13C are examples of an object equation that includes an equivalent for a motion media.

FIG. 13D is an object equation that includes an equivalent for a motion media and includes a modification made with an equivalent for a known phrase.

FIG. 14 illustrates the assignment of an Environment Media equation to an object.

FIG. 15 illustrates the use of an Environment Media equation as an element in another Environment Media equation.

FIG. 16A shows the elements of an equivalent and said equivalent being assigned to an entry in an Environment Media equation.

FIG. 16B shows the result of the assignment illustrated in FIG. 16A.

FIGS. 17A-17C illustrate an Environment Media equation used to create an equivalent for the known word “Password”.

FIG. 18A-18C show a series of objects which are impinged in a sequential order by an object which is moved along a path and the result of the impingement.

FIGS. 19A-19D show visual reconfigurations of a password.

FIGS. 20A-20D illustrate the encryption of a password Environment Media with a password Environment Media.

FIG. 21 shows the duplication of a password entry.

FIG. 22A shows an expanded Environment Media password.

FIG. 22B illustrates the activation of an object to show its assignment.

FIG. 22C depicts a composite assignment object which has been modified with new characters.

FIG. 22D shows an object in one location communicating its updated assignment to an object in another location.

FIG. 23A depicts an object being selected with a gesture.

FIG. 23B shows the communication of a modified characteristic between two objects in an Environment Media.

FIG. 24A shows a newly outputted environment password.

FIG. 24B depicts an Environment Media password being assigned to an object.

FIG. 25A depicts the modification of characters assigned to an object.

FIG. 25B depicts an object being encrypted by a password equivalent.

FIG. 25C depicts the assignment of object 141A modified with new characters.

FIG. 25D shows the assignment of object 141, composite object 137D, being hidden

FIG. 26 is a flow chart that illustrates a method of a second object updating a first object of which said second object is a duplicate.

FIG. 27 illustrates a motion media utilized to cause a dynamic updating of the assignment to an object.

FIG. 28 illustrates a motion media equivalent being outputted to impinge an object in an Environment Media password.

FIG. 29 depicts the modification of invisible time interval objects.

FIG. 30 illustrates an Environment Media equation.

FIG. 31 illustrates the assignment of an object equation to a gesture object.

FIG. 32 is a flowchart illustrating the automatic creation of an Environment Media in a computing system.

FIG. 33 illustrates various elements of a motion media.

FIG. 34 illustrates the result of the impingement of smaller picture, 13, with larger picture, 1, as shown in FIG. 2.

FIG. 35 is a flowchart illustrating the analysis of a motion media and the creation of a programming object.

FIG. 36 is a flowchart that illustrates the calling forth of a programming action from a Type One Programming Action object and applying said programming action to an object via an impingement.

FIG. 37 illustrates the assignment of a gesture in a path to equal a programming action.

FIG. 38 is a flow chart showing the steps in impinging an object with a PAO 1 where the path of the impingement includes a recognized gesture.

FIG. 39 is a flow chart illustrating a method of creating a Type Two Programming Action Object (“PAO 2”).

FIG. 40 is flow chart illustrating an iterative process to determine a task.

FIG. 41 is a flowchart describing the use of relationship analysis to derive a Type Two Programming Action Object from a motion media.

FIGS. 42A to 42I comprise an example illustrating user inputs and changes resulting from said user inputs, recorded as a new motion media

FIG. 43 is a flow chart that illustrates a method of assigning a Type Two Programming Action Object to an object.

FIG. 44 is a flow chart that illustrates the applying of valid PAO 2 model elements to an environment.

FIGS. 45A-45F illustrate one method of programming one PAO Item with another PAO Item.

FIGS. 46A-46E are an example of the creation of a motion media that can be used to derive an alternate model element for a PAO Item.

FIG. 47 illustrates a method of determining which changes recorded as a motion media are needed to support a specific task.

FIG. 48A depicts an Environment Media that contains a set of controls that are being used to program rotation for an object.

FIG. 48B shows a change of value for a Y axis setting.

FIG. 48C illustrates a 360 degree rotated position of an object.

FIG. 49 depicts the creation of an equivalent for Environment Media.

FIGS. 50A and 50B illustrate an alternate method of creating an equivalent for an Environment Media.

FIG. 51A depicts the manipulation of an equivalent to a 180 degree rotation.

FIG. 51B depicts a 180 degree rotation of an equivalent as the result of the rotation of an Environment Media.

FIG. 52 depicts the assignment of an invisible PAO2 to a gesture shape.

FIG. 53 is a flow chart illustrating the interrogation of an Environment Media with an interrogating operator.

FIG. 54 is a flow chart that illustrates the creation of an Environment Media from physical analog object information that performs a task.

FIG. 55 illustrates the use of an environment media 13, to modify video frame, 14.

FIG. 56 illustrates another approach for producing a transparent environment media.

FIG. 57 illustrates the automatic creation of an environment media resulting in said environment automatically matching the size and shape of the user input.

FIG. 58 illustrates verbal inputs to a synced environment.

FIG. 59 illustrates the creation of an environment media that is the size and shape of an input to a video frame.

FIG. 60A illustrates a verbal input presented to an environment media to apply a modification to multiple frames of a video.

FIG. 60B illustrates four categories of change depicted as timelines

FIG. 61 depicts a designated area on a video frame.

FIG. 62 depicts a hand gesture used to select a portion of a video frame image.

FIG. 63 an environment media is moved up and down five times in a gesture to send said environment media in an email.

FIG. 64 is flow chart illustrating the process of automatically creating an environment media in sync to a video and/or a video frame

FIG. 65 is a flow chart illustrating the matching of multiple video frames with objects in an environment media.

FIG. 66 illustrates the presenting of an analog object to an environment media object to instruct said environment media object.

FIG. 67 depicts a digital fader object drawn in an environment media fader and used to instruct a software object.

FIG. 68 defines a secondary relationship.

FIG. 69 illustrates primary and secondary relationships between three objects.

FIG. 70 is a flowchart illustrating the method of automatically saving and managing change for an object in an environment operated by the software of this invention.

FIG. 71 is a flowchart wherein software recognizes a user action as a definition for a software process.

FIG. 72 illustrates the creation of a verbal marker in an environment.

FIG. 73 is a flowchart that illustrates the use of a verbal marker.

FIG. 74A depicts a series of markers presented in an environment media.

FIG. 74B depicts a process call graphical stitching.

FIG. 74C depicts a composite object comprised of each “stitched” marker being presented by the software.

FIG. 74E depicts a method of determining the exact location of an insertion in an edit region.

FIG. 75 is a flow chart illustrating the utilization of a motion media to program an environment media to recreate a task in a software environment.

FIG. 76 is a flow chart illustrating the analysis of a first state of a motion media to create an environment media.

FIG. 77 depicts an environment media comprised of a pixel-based composite object.

FIG. 78A an environment media receives an input that causes environment media to present a composite object in real time.

FIG. 78B depicts an environment media stopped at a point in time.

FIG. 78C depicts an object being presented to a composite object in an environment media.

FIG. 78D depicts a gesture being applied to a composite object.

FIG. 79 is a flowchart describing a method of acquiring data, saving it as an EM visualization, and performing one or more analyses on said acquired data FIG. 80A illustrates the use of an environment media to modify an existing content.

FIG. 80B is a flowchart that follows from the flowchart of FIG. 80A.

FIG. 81 a user draws on a bear image to define a series of designated areas.

FIG. 82 is a diagram of the structure of an Environment Media and the relationships and functions of the objects comprising an environment media.

FIG. 83 is a flowchart illustrating the process of a motion media discovering a collection of objects that share a common task.

FIG. 84 is a continuation from Step 640 in the flowchart of FIG. 84. FIG. 84's flowchart illustrates the creation of a daughter environment media.

FIG. 85 is a flowchart illustrating an example of a service being employed to determine a boundary for a recognized area.

FIG. 86 is a flowchart illustrating a method whereby the data of one user, “Client A,” is sent to another user “Client B” to program the objects that comprise Client B's environment media.

FIG. 87 is a flowchart illustrating the receipt of said motion object by Client B from Client

A and the subsequent programming of objects in an environment media of Client B.

FIG. 88 is a flow chart illustrating one possible set of communication operations.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

### Definition of Terms

Assigned-to object: An object to which one or more other objects have been assigned. Assigned-to objects can contain environments, motion media, invisible software objects, Environment Media equations, and any other content. Assigned to objects can include real world physical objects. An object “rug” can be assigned to an object “dining room.” A “lamp” can be assigned to a “furnace temperature setting.”

Change—The term change is often used to refer to a change in any state of an environment, or in the state of one or more objects, or to any characteristic of any object. The term change is frequently used in relation to motion media. A motion media records inputs and other change causing phenomenon and the results of said inputs and other change causing phenomenon, which generally cause change in the states of an environment or in one or more objects receiving said inputs. The term “change” can be singular or plural, often meaning: “changes.”

Computing system—The term computing system as used in this disclosure includes any one or more digital computers, that can include any device, data, object, and/or environment that is accessible via any network, communication protocol or the equivalent. A computing system also includes any one or more analog objects in the physical analog world that can be recognized by any digital processor system or that have any relationship with any digital processor or digital processor system. A computing system can include or be comprised of a connected array of processors that are embedded in physical analog objects.

Dynamic characteristics—Characteristics that can be changed over time.

EM Elements—include an environment media and the objects that comprise an environment media. The objects that comprise an environment media are sometimes referred to as “EM Objects.” The term “EM Elements” can also be used to include a server-side computer, or its equivalent, to which EM objects communicate with.

Functionality—This term pertains to any action, function, operation, trait, behavior, process, procedure, performance, transaction, bringing about, calling forth, activation or the equivalent. Among other things, this term is associated with a description of “visualizations”, including “visualization actions,” in this disclosure. See the definition of “visualization” and “visualization action” below.

Input—The word input as used in this disclosure includes inputs presented or otherwise existing in the digital world and in the physical analog world. Digital inputs include any signal that is activated, outputted to an environment or to an object or to any item that can receive data, or called forth or presented by any means, including: typing, touch, mouse, pen, sound, voice, context, assignment, relationship, time, motion, position, configuration, and more. Inputs can also be from the physical analog world as anything recognized by a digital system. Such inputs include, but are not limited to: body movements (e.g., eye movements, hand movements, body language), temperature (e.g., room temperature, body temperature, any environment temperature), physical objects that are presented or moved in some fashion (e.g., showing a picture to a camera based computer recognition system), location (e.g., GPS signals), proximity (e.g., one object impinging another in a physical space) and the like. An input can be produced by many means, including: user input (a person interacts with an environment to cause something to happen), software input (software analysis of characteristics, relationships and other data produces some result), context (the existence of one or more objects produces a recognized response), time (events occur based upon the passage of time), configuration (presets determine one or more inputs).

Locale—any object and/or data in one any device, location, infrastructure, or its equivalent. An Environment Media can consist of objects in many locales. Thus an Environment Media can include objects existing on a mobile device and other objects existing on an intranet server and other objects existing on a cloud server and so on. All of the above mentioned objects could comprise a single Environment Media, and said objects can have one or more relationships and communicate with each other, regardless of their location. Further, locales can be objects. Accordingly, locales that belong to an Environment Media can communicate with each other and maintain relationships. Said locales can be within, or on, or be associated with any device at any location, and/or exist between multiple locations. In a digital world said locations would include: the internet, web sites, cloud servers, ISP servers, storage devices, intranets and the like. In a physical analog world said locations would include: physical rooms, cities, countries, a shirt pocket and any other physical structure, entity, object or its equivalent. Said locales can be within, or on or be associated with multiple devices (e.g., networked storage devices and personal devices, like smart phones, pads, PCs, laptops in the digital world, and, embedded processors in physical appliances, clothes, skin, and in any other physical analog object. A single EM can contain locales that exist as a location or in any location that is digitally accessible. All locales that have one or more relationships to each other and that support any part of the same task or any part of a similar task could be part of a single Environment Media.

Motion Media—an object, software definition, image primitive, or any equivalent, that includes any one or more of the following: movement, dynamic behavior, characteristic, any real time or non-real time action, function, operation, input, result of an input, the conditions of objects, the state of tools, relationships between objects, and anything else that can exist or occur in or be associated with objects, and/or software definitions, and/or image primitives and any equivalent in a computing system. Motion media can also include, but are not limited to: video, animations, slide shows, any sequential, non-sequential or random play back of media, graphics and other data, for any computer environment. A motion media saves, presents, analyzes and communicates change in any state, characteristic, and/or relationship of any object or its equivalent. Motion media recorded change can include, but is not limited to: states of any environment or object, characteristics of any object, video, animations, slide shows, any sequential, non-sequential or random play back of media, graphics and other data, and relationships between any objects that comprise an environment media, relationships between said objects and the environment that they comprise, relationships between environment media and the like, for any computer environment. For the purposes of programming an object, the definition of a motion media would include at least one of the following: an environment, one or more objects in or comprising an environment, one or more changes to an environment, one or more changes to said one or more objects in an environment, the relationship(s) between said one or more objects in an environment, one or more changes to one or more relationship(s) between said one or more objects in an environment, the relationship(s) between one or more environments, one or more changes to one or more relationship(s) between said one or more environments, the point in time when each change starts, the point in time when said each change ends, the total length of time that elapses during each change, the point in time when the motion media starts a record process, the point in time when the motion media recording ends, the total length in time of the motion media. Motion media can be saved to memory, any device, to the cloud, server or any other suitable storage medium. As further defined herein, a motion media can be an object, which is paired with another object for the purpose of saving and managing change to the object to which said motion media is paired.

Object—An object includes any visible or invisible definition, image primitive, function, action, operation, status, process, procedure, relationship, data, location, locale, motion media, environment, equation, device, collection, line, video, website, document, sound, graphic, text or anything that can exist or be presented, operated, associated with and/or interfaced with in a digital computing environment, and/or that can be presented, operated, associated with and/or interfaced with in a physical analog environment. The term “object” as used in this disclosure can be a software object, software definition, image primitive, or any equivalent. “Objects” are not limited to objects created using object-oriented language. It can exist in any computer environment, including a multi-threaded computer environment. An object includes any visible or invisible function, action, operation, status, process, procedure, relationship, data, location, locale, motion media, environment, equation, device, collection, line, video, website, document, sound, graphic, text or anything that can exist or be presented, operated, associated with and/or interfaced with in a digital computing environment, and/or that can be presented, operated, associated with and/or interfaced with in a physical analog environment. The objects of this invention are not limited to digital display technologies, including flat panel or projected displays, holograms and other visual presentation technologies, but also include physical objects in the physical analog world. Said physical analog objects may include an embedded digital processor, like Micro-Electro-Mechanical-Systems (“MEMS”) with or without an associated microprocessor or its equivalent. Physical analog objects can be anything in a real life environment, including but not limited to: appliances, machinery, lights, clothing, furniture, part of any building, the human body, any part of an animal or plant, or any other object that exists in real life. Objects of this invention also include things that may not be visible in a physical analog world or digital world. These “invisible” objects include, but are not limited to: time, distance, order, functionality, relationship, comparison, perception, prediction, occurrence, preference, control and more. Further, objects can include feelings and emotions, like hope, promise, anger, joy, freedom, anxiety and patience, which may or may not be presented in some physical manner, such as via facial expressions, eye movements, hand movements, body language, sound, temperature, color and more.

Object Characteristics—also referred to herein as “characteristic,” or “characteristics.” The characteristic of an object includes, but is not limited to:
i. An object's properties, definition, behaviors, function, operation action or the like.
ii. Any relationship between any two or more objects; between any two or more characteristics of one object; between at least one object and at least one action; between at least one non-Environment Media and at least one Environment Media.
iii. The way or means that an object is affected by context.
iv. The manner in which an object responds to or is affected by a user input.
v. The manner in which an object responds to or is affected by software input, either pre-programmed or programmed on-the-fly, e.g., dynamically programmed

Open Object—An object that has generic characteristics, which may include: size, transparency, the ability to communicate, the ability to respond to input, the ability to analyze data, ability to maintain a relationship, the ability to create a relationship, ability to recognize a layer, and the like.

Physical Analog World—This is not the digital domain. The physical analog world is not constructed of 1's and 0's, but of organic and non-organic non-digital structures. The physical analog world is our everyday world filled with physical objects, like chairs, clothes, cars, houses, tables, rain, snow, and the like. The physical analog world is also referred to herein as “real life,” “physical analog environment,” “physical world,” and “physical analog environment.”

Programming Action—any condition, function, operation, behavior, capacity, relationship, term, state, status, being, action, form, sequence, model, model element, context, or anything that can be applied to, used to modify, be referenced by, appended to, made to produce any cause or effect, establish a relationship, cause a reaction, response or any equivalent of anything in this list, for any one or more objects.

Programming Action Object—one or more objects, and/or one or more definitions and/or an environment, which can be an Environment Media generally derived from a motion media that can be used to program an object, one or more definitions, environment or any equivalent. Sometimes referred to herein as an “action object.”

Purpose—the term purpose is interchangeable with the term “task.”

Sharing instruction—This is also referred to as a “sharing input” or “sharing output.” A sharing instruction is data that contains as part of its characteristics a command for the data that comprises a sharing instruction to be shared with other objects, which can include other environments, devices, actions, concepts, context or anything that can exist as an object in an object-based environment. If multiple objects are capable of communicating to each other, a single sharing instruction can be automatically communicated between said objects. In addition, a sharing instruction can be modified by any input, context, function, action, association, assignment, or the like, to set any rule governing the sharing of data within, related to, or otherwise associated with said sharing instruction. As an example, a sharing instruction could be modified to share its data only in the presence of a certain context or according to a specified period of time or caused to wait to receive an external input from any source, e.g., from a user or automated software process, before sharing its data. Further a sharing instruction could be modified to only share its data with a certain type of object with certain characteristics.

To Program—To cause or create or bring forth, or the equivalent, any change or modification to any characteristic of any object, including any environment.

VDACC—An object that manages other objects on a global drawing canvas, permitting, in part, websites to exist as annotatable objects in a computer environment. Regarding VDACC objects and IVDACC objects, see “Intuitive Graphic User Interface with Universal Tools,” Pub. No.: US 2005/0034083, Pub. Date: Feb. 10, 2005, incorporated herein by reference.

Visualization—A method of recording and analyzing image data resulting in the programming of EM objects by a user's operation of any program or app operated on any device running on any operating system, or as a cloud service, or any equivalent.

Known Visualization—A visualization whose “visualization action” is known to the software operating visualizations.

Visualization Action—One or more operations, functions, processes, procedures, methods or the equivalent, that are called forth, enacted or otherwise carried out by a known visualization. The software of this invention permits environments to exist as content, objects, and/or as definitions, or any equivalent, in a multi-threaded computer environment or in or via any other suitable digital environment. Said media, objects and definitions are also referred to herein as “objects” or “object”. An environment defined by said “objects” is referred to as an Environment Media, “EM.” An EM can be defined by any number of objects that have a relationship to at least one other object and support at least one purpose or task. So in one sense, an Environment Media exists as a result of relationships between objects that communicate with each other for some purpose. An important feature of the software of this invention is that relationships between objects are not limited to a single device, operating system, server, website, ISP, cloud infrastructure or the like. An Environment Media can contain and manage one or more objects, which can include one or more other Environment Media, which can directly communicate with each other between any one or more locations, or communicate across any network between any one or more locations. Environment Media can be referred to, managed, updated, copied, modified, programmed or operated or associated with, via any network with or without an application server. Environment Media are defined according to relationships that can exist anywhere in the digital domain and in the physical analog world. Further, said relationships support real time and non-real time unidirectional and/or bi-directional communication between any object at any location via any communication means. An Environment Media, defined by the relationships of the objects that comprise it, is a dynamic collection of context aware objects and/or definitions that can freely communicate with each other. Unlike environments that are defined by programming software to implement windows protocols, server protocols, software applications, or the like, EM are defined by relationships. A valuable feature of EM is their ability to become self-aware based upon the relationships between and associated with their content. Further, unlike typical software environments which require software programming for their creation and management, EM can be created, shared and maintained by non-programming computer users, e.g., consumers, as well as programmers. Environment Media can be defined, modified, copied and operated by user input. Further, a user can work in any physical analog and/or digital environment to perform a task that can be used to create an object tool or the equivalent that can be used to program an Environment Media or one or more objects or definitions or the equivalent (hereinafter referred to as “objects”) comprising an Environment Media. As used herein, an “equivalent” can be any user-generated or computer-generated text, drawing, image, gesture, verbalization or an equivalent that equals any functionality or operation that the software of the invention can deliver, call forth, operate or otherwise execute in a computer system.

In one embodiment of the invention an Environment Media is defined by objects that have one or more relationships to one or more other objects and where said objects are part of a definable purpose, operation, task, collection, design, function, action, state or the like (“task” or “purpose”).

In another embodiment of this invention the software of this invention can derive a task from an analysis of the characteristics, states and relationships of one or more objects to create an Environment Media

In another embodiment of the invention an Environment Media includes composite relationships, which can be used as a data model to program Environment Media or other objects, or used to organize data and relationships, or used as a locale.

In another embodiment of the invention, Programming Action Objects can define an Environment Media in whole or in part. As an alternate, one or more Programming Action Objects can be automatically recalled upon the activation of an Environment Media such that said Programming Action Objects program said Environment Media.

In another embodiment of the invention a device and its constituent parts, which support a task, can define an Environment Media. Accordingly, any object comprising said device can be operated in any location as part of said Environment Media. Further any object of said device can be duplicated or recreated and operated in any location as part of said Environment Media.

In another embodiment of the invention, an Environment Media can act as an object equation, which is used to program objects and environments, including Environment Media.

An exemplary method in accordance with the invention is executed by software that can be installed and running in a computing system, and/or operated on the cloud, or via any network, or in a virtual machine, at any one or more locations. The method is sometimes referred to herein as “the software” or “software.” The method is sometimes described herein with respect to software referred to as “Blackspace.” However, the invention is not limited to Blackspace software or to a Blackspace environment. Blackspace software presents one universal drawing surface that is shared by all graphic objects. Each of these objects can have a relationship to any of all the other objects. There are no barriers between any of the objects that are created for or that exist on this canvas. Users can create objects with various functionalities without delineating sections of screen space.

Environment Media

An Environment Media can be a much larger consideration than a window or a program or what's visible on a computer display or even connected via a network. An Environment Media can be defined by any number of objects, definitions, data, devices, constructs, states, actions, functions, operations and the like, that have a relationship to at least one other object that comprise an Environment Media (“environment elements”), and where said environment elements support the accomplishing of at least one task or purpose. Environment elements could exist in, on and/or across multiple devices, across multiple networks, across multiple operating systems, across multiple layers, dimensions and between the digital domain and the physical analog world. An Environment Media is comprised of elements related to one or more tasks. Said collection of elements can co-communicate with each other and/or affect each other in some way, e.g., by acting as a context, being part of an assignment, a characteristic, by being connected via some protocol, relationship, dynamic operation, scenario, methodology, order, design or any equivalent.

Environment elements can exist in any location, be governed by any operating system, and/or exist on any device. It is one or more relationships that together support a common task that bind said environment elements together as a single Environment Media. There are many ways to establish relationships between objects and/or definitions or the equivalent that comprise an Environment Media. A partial list includes: (1) user inputs, (2) context, (3) software, (4) time, (5) predictive behavior.

The relationships that bind objects together as an Environment Media are not mere links to data on a server to the cloud via a network, e.g., HTML links, as found in a website. Said relationships between objects in an Environment Media operate uni-directionally and/or bi-directionally and create awareness between objects and their Environment Media. Thus any one or more objects in any location (cloud server, local storage, web page, via a network server, via a processor embedded in a physical analog object in a physical world location) can communicate information to and receive information from other objects in the same Environment Media. Communication can be based on context, automatic software analysis, user-initiated software analysis, time, arrow or line or object transaction logic, an object's polling of data and many other factors. Said information includes change, which can be the result of any input, context, time, model element, protocol, scenario or any other occurrence that is possible in a computing system.

Environment Media can be applied to any function, operation, protocol, thought process, condition, action, characteristic or the equivalent. A key idea is that an Environment Media enables objects existing in any location, controlled by any context, or as part of any operation, structure, data or the like, to freely communicate with each other. Further, said objects can update, program, modify, address, clarify, control each other or engage in any other type of interaction, with or without user input.

Multiple Types of Relationships

Relationships are a key element in the software of this invention. There many possible types of relationships. Two types of general types of relationships are discussed below:
Objects that communicate either uni-directionally or bi-directionally. This includes any object (plus any duplicated or recreated version of said any object) that communicates to or from or to and from any object in any location. Said any object can be visible or invisible and can have any number of assignments. If said any objects exist in an Environment Media, said communication supports the accomplishing of more or more tasks, including: updates, instruction, control, producing or causing any action, causing any association, creating or modifying any context, producing a sequence of events, creating or modifying any object, analyzing any data, action, function, operation, or any equivalent of any entry in this list.
Data that has been modeled. Models are more generalized actions derived from one or more events of change. Models can be objects and thus can have relationships to an Environment Media, other objects, and to other models.

Benefits of an Environment Media (“EM”)

There are many benefits of an Environment Media. Some are listed below.
1. Auto Sequencing—the communication of sequencing information from one or more objects to one or more other objects, in any location, performing any function and/or operation, for a defined purpose.
2. Modeling—the analysis and utilization of modeling, e.g., model elements, as objects in an environment.
   Ease-of-use of models—Model elements can be derived from motion media and can be used to program environments or objects.
   Visual representation of models and model elements
      Enables easy assignment of models
      Enables easy management of models
      Enables modification of models with other model, e.g., impinge a first model visualization with a second model to program said first model.
3. Presentation of history and historic data as recorded in a motion media—easy fast and efficient management of historical data by managing motion media objects and PAOs and model elements and tasks and task categories. Note: task categories can be objects and can be used for searching, collating, organization and the equivalent.
4. Clean, reliable, efficient and fast management of data in environments—each data in an Environment Media is related in some way to at least one other data Relationships between data establish communication paths which support faster operations in an Environment Media. This includes VDACCs' (Visual Design and Control Canvas) management of data Data includes objects, devices, operations, relationships, patterns of use, history, locales (explained later in this document), PAOs (see: “Method for the Utilization of Motion Media as a Programming Tool”) and the equivalent. VDACCs are objects that manage data in an Environment Media, VDACCs can maintain one or more relationships between other VDACC objects and other data, including any object, graphic, recognized object, line, picture, video, motion media and the like.
5. VDACC management of Environment Media includes managing the following:
   Relationships between data, VDACCs, environments, locales, operations, functions, actions, time, sequential data, motion media, history, objects, and the equivalent.
   Objects and their characteristics
   Communicate between data, objects and any other content of any environment, locale or the like.
   Location of any content of any environment.
   Dynamic allocation of resources.
   Updating of objects in any environment, locale or the equivalent.
   Direct communication between all data, including direct sending and receiving of information to and from addresses if all data
   Motion media.
   Models and model elements.
   Categories.
   Any Task or purpose.
   Decisions regarding alternate or modification model elements in Programming Action Objects, both PAO 1 and PAO 2.
6. The ability to program and maintain multiple processors (including embedded processors in the physical analog world or as part of an integrated digital system and the equivalent, which could include the utilization of MEMS). Examples of multiple processors in a location site include:
   In a home kitchen—this could include processors in various appliances, including refrigerators, ovens, microwaves, mixers, toasters, and non-appliances, like knives, counter tops, faucets, and the like.
   In a living room or family room in a home or other environment—this could include all furniture, wall hangings, lamps, carpets, other floor fixtures, walls, floors, railing, windows, wall covering, pictures and anything else that could exist in such an environment.
   Factory Assembly Lines—this could include any part of any piece of assembly line machinery, plus, any part of any product being created along an assembly line, plus any part of any assembly line worker's work site, or any piece of clothing for any worker and the like.
   Robotics—any part of any robot or their physical environment.
   Collaboration—maintaining communication between processors, devices, and all computing systems; further including organizing data, archiving history, analyzing data, constructing software motion media and the utilization of data derived from motion media, and the equivalent, used for any type of collaboration, both real time and non-real time.
7. Replacing email attachments, and eventually email, with shared environments.

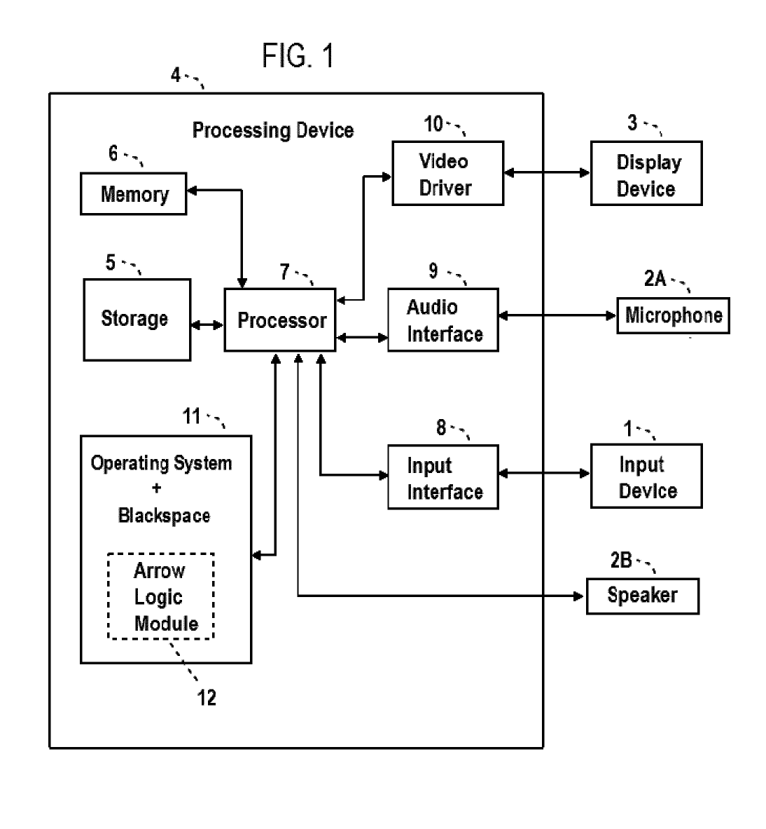

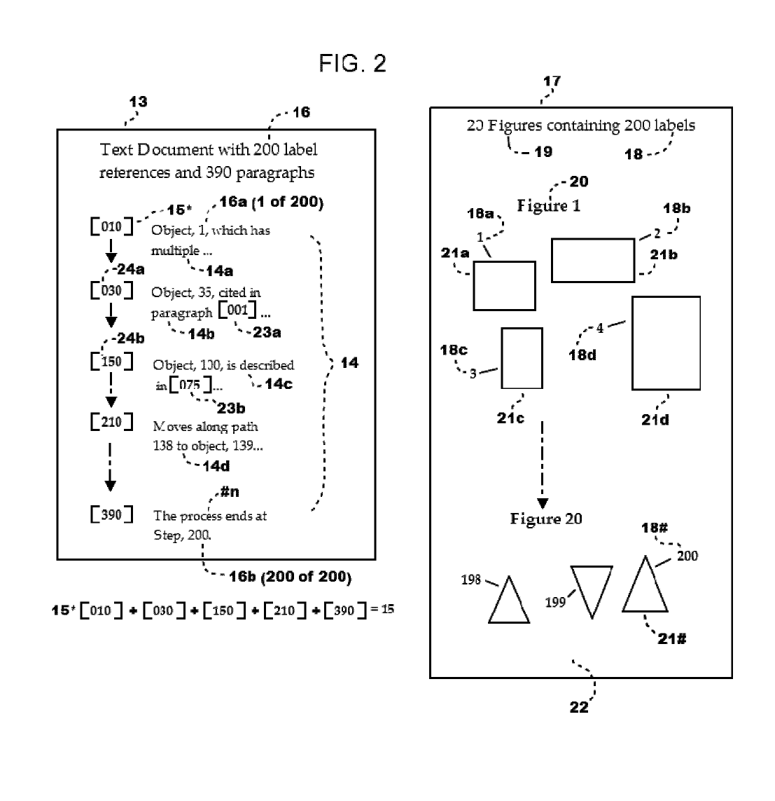

Referring to FIG. 1, the computer system for providing the computer environment in which the invention operates includes an input device 1, a microphone 2, a display device 3 and a processing device 4. Although these devices are shown as separate devices, two or more of these devices may be integrated together. The input device 1 allows a user to input commands into the system to, for example, draw and manipulate one or more arrows. In an embodiment, the input device 1 includes a computer keyboard and a computer mouse. However, the input device 1 may be any type of electronic input device, such as buttons, dials, levers and/or switches, camera, motion sensing device input and the like on the processing device 4. Alternatively, the input device 1 may be part of the display device 3 as a touch-sensitive display that allows a user to input commands using a finger, a stylus or devices. The microphone 2 is used to input voice commands into the computer system. The display device 3 may be any type of a display device, such as those commonly found in personal computer systems, e.g., CRT monitors or LCD monitors.

The processing device 4 of the computer system includes a disk drive 5, memory 6, a processor 7, an input interface 8, an audio interface, 9, and a video driver, 10. The processing device 4 further includes a Blackspace User Interface System (UIS) 11, which includes an arrow logic module, 12. The Blackspace UIS provides the computer operating environment in which arrow logics are used. The arrow logic module 12 performs operations associated with arrow logic as described herein. In an embodiment, the arrow logic module 12 is implemented as software. However, the arrow logic module 12 may be implemented in any combination of hardware, firmware and/or software.

The disk drive 5, the memory 6, the processor 7, the input interface 8, the audio interface 9 and the video driver 10 are components that are commonly found in personal computers. The disk drive 5 provides a means to input data and to install programs into the system from an external computer readable storage medium. As an example, the disk drive 5 may a CD drive to read data contained therein. The memory 6 is a storage medium to store various data utilized by the computer system. The memory may be a hard disk drive, read-only memory (ROM) or other forms of memory. The processor 7 may be any type of digital signal processor that can run the Blackspace software 11, including the arrow logic module 12. The input interface 8 provides an interface between the processor 7 and the input device 1. The audio interface 9 provides an interface between the processor 7 and the microphone 2 so that use can input audio or vocal commands. The video driver 10 drives the display device 3. In order to simplify the figure, additional components that are commonly found in a processing device of a personal computer system are not shown or described.

Referring to FIG. 2, a user has created a text document, 14, in a first program, 13, and has also created 20 figures, 19, in a second program 17. Further said 20 figures, 19, in said second program, 17, have 200 labels, 18, which are referenced in said text document, 14, in said first program 13. Said first program, 13, is a windows-based word software program that contains a text document, 14, which contains 200 numbers, 16, which reference said 200 labels, 18, used in said 20 figures, 19. Note: the “1” label reference number, 16a, of text document, 14, equals “1 of 200” and the 200^{th} referenced number, 16b, equals “200 of 200”. Document, 14, contains a description of each figure in layout, 22. Said document, 14, includes a discussion of each of said 200 labels, 18, such that a reader can better understand said figures, 19. Thus, said 200 label references, 16, refer to 200 labels, 18, presented in 20 figures, 19, in layout, 22, in said second program, 17. Said second program, 17, is a windows-based graphic layout software program. Said 200 labels, 18, presented in said 20 figures, 19, in said layout, 22, in said second program, 17, are not “aware” of the 200 label reference numbers, 16, in said text document, 14, in said first program, 13. As is typical with separate programs (or applications) the contents of said separate programs do not generally communicate with each other. Said contents are controlled by the program which was used to create them.

Thus it should be noted that there is no communication between the 200 label references, 16, in said text document, 13, and the 200 labels, 18, in said layout, 22. Further, there is no communication between the bracketed paragraph numbers, 15, in text document, 14, and the references to said bracketed paragraph numbers, 23a and 23b, found in various paragraphs of text in document, 14. Note: examples of bracketed paragraph numbers are presented in FIG. 2 as [010], [030], [150], [210] and [390], collectively, 15. Note: the labels in said second program, 17, are shown as 1, 18a; 2, 18b; 3, 18c; to 200, 18#.

As previously referred to, each paragraph in said text document, 14, has a number, 15, presented in brackets. Each of the 200 labels in layout, 22, is described in text document, 14. As a part of this process, some paragraph numbers are referenced in various text paragraphs of said text document, 14. For instance, in text document, 14, paragraph [001], 23a, is cited in paragraph [030]. As another example, paragraph [075], 23b, is cited in paragraph [150], 24b, of text document, 14.

A key point here is that there is no communication between the bracketed paragraph numbers, 15, in text document, 14, and the references to said bracketed paragraph numbers, 23a and 23b, found in various paragraphs of text document 14. Nor is there any communication between numbers referenced and described in paragraphs of text document, 14, and number labels in the 20 figures, 19, of layout, 22. In text document, 14, the connections between cited references both between various paragraphs and between text descriptions in document, 14, and corresponding number labels in layout, 22, are created and maintained by the human being, not by software.

In current programs, the user must create and maintain the above described connections (“relationships”) manually. This is true, even though paragraphs can be automatically numbered by a word program. In fact, this automatic numbering becomes part of the problem for a user who is trying to maintain accurate relationships between the following data (1) 200 sequentially ordered label references, 16, in said text document, 14, (2) 200 separate labels, 18, in layout, 22, and (3) paragraph numbers, 15, and, (4) paragraph numbers, e.g., 23a and 23b, cited in paragraphs of said text document, 14.

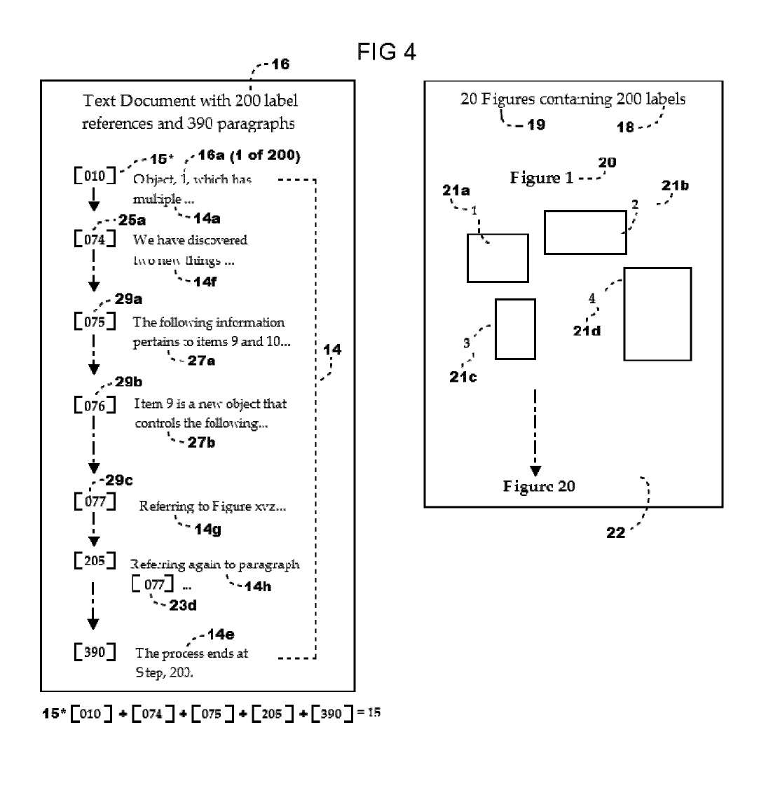

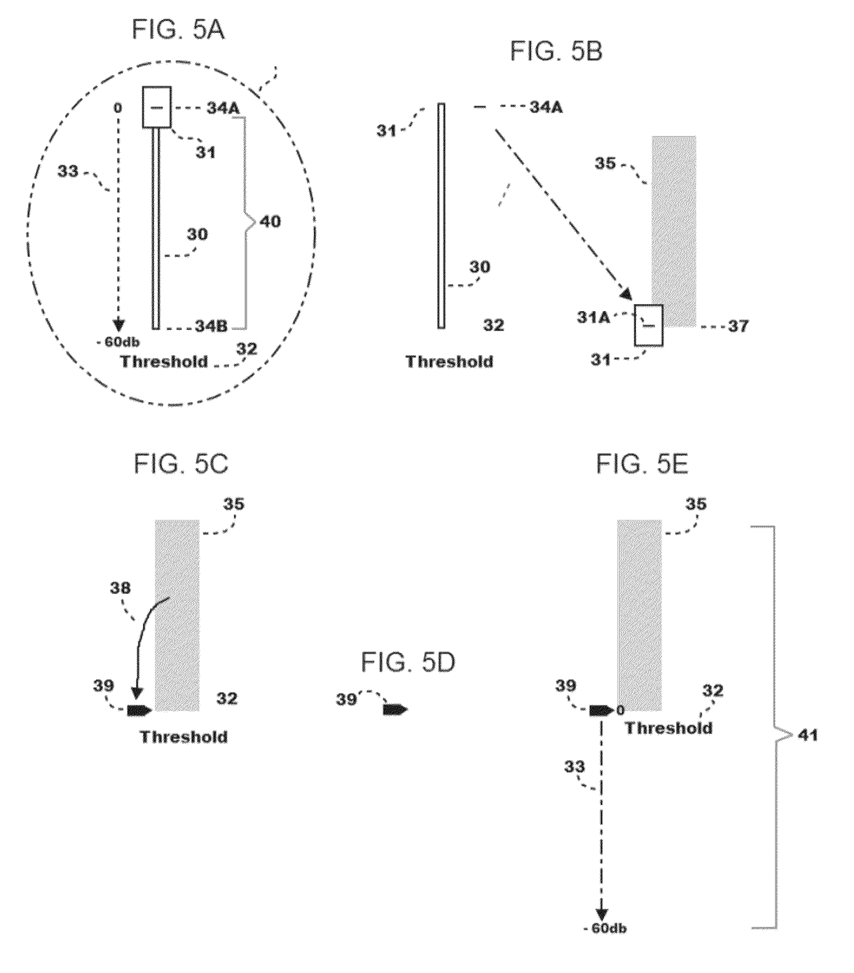

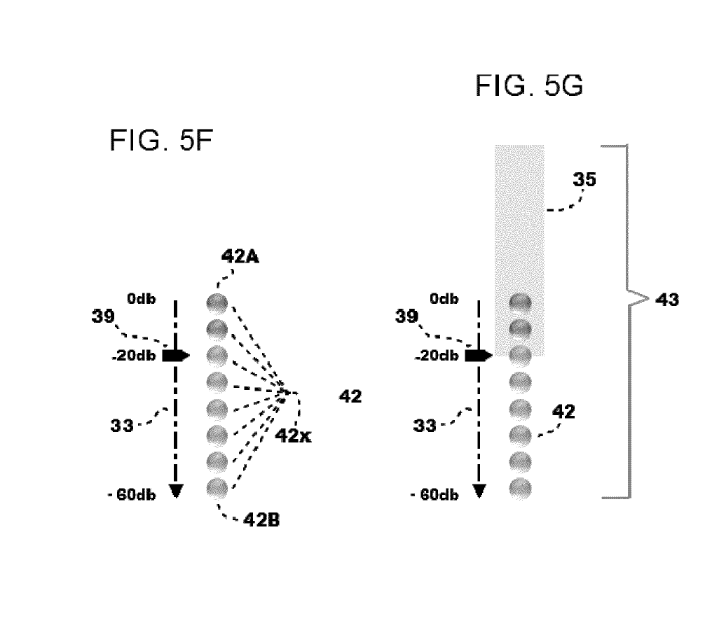

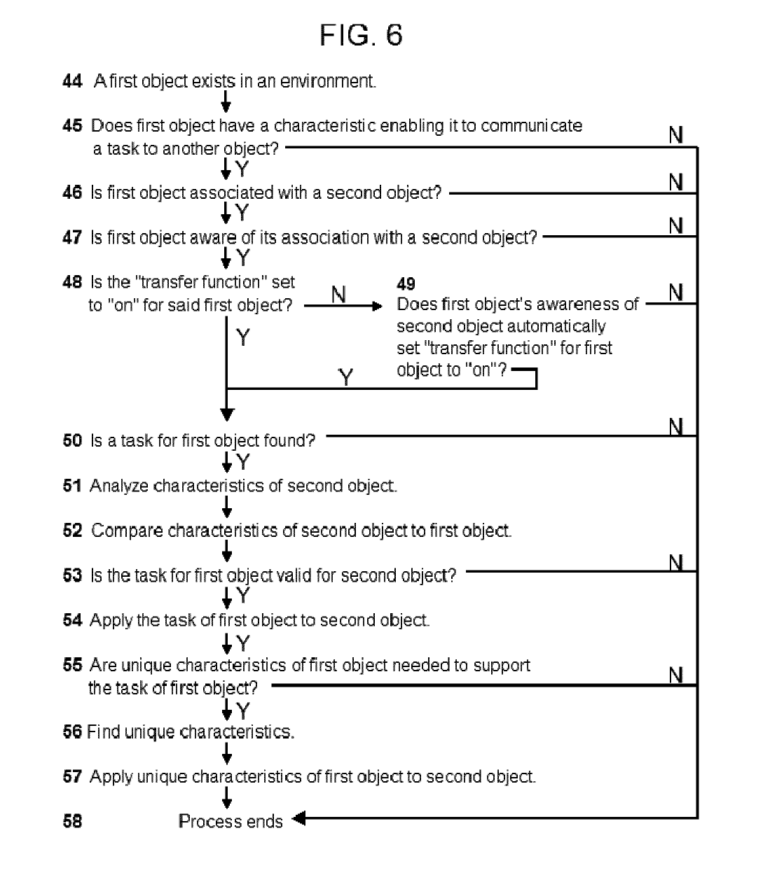

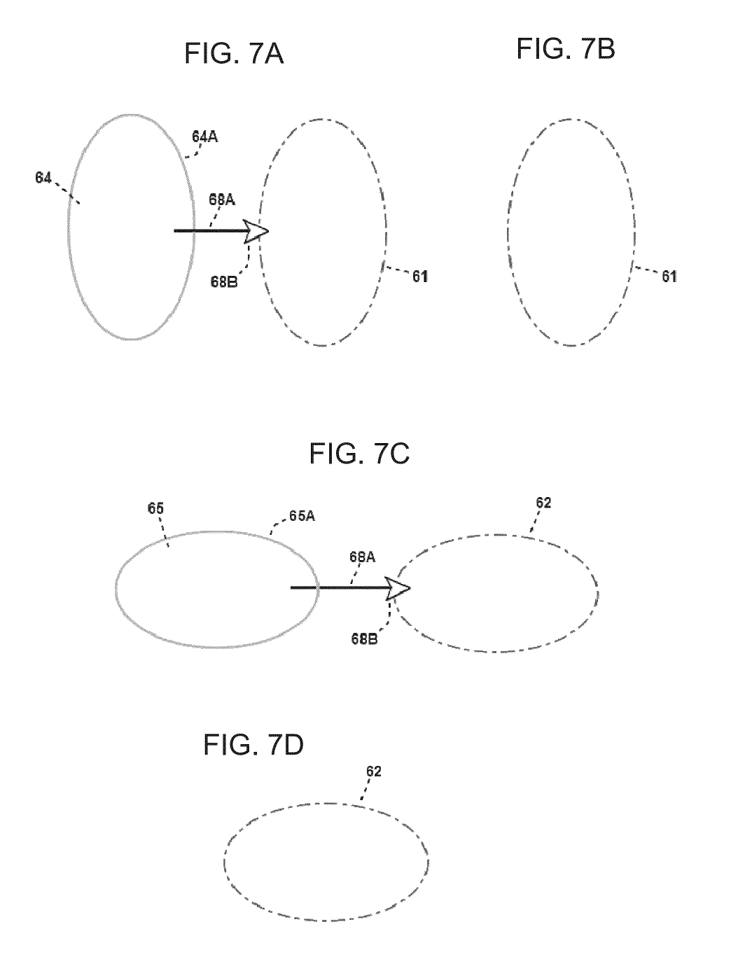

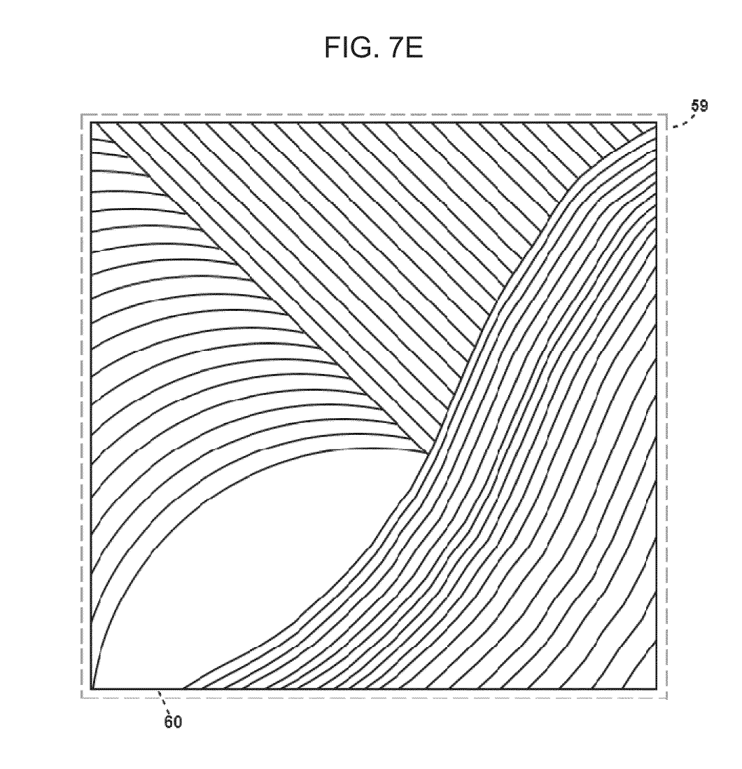

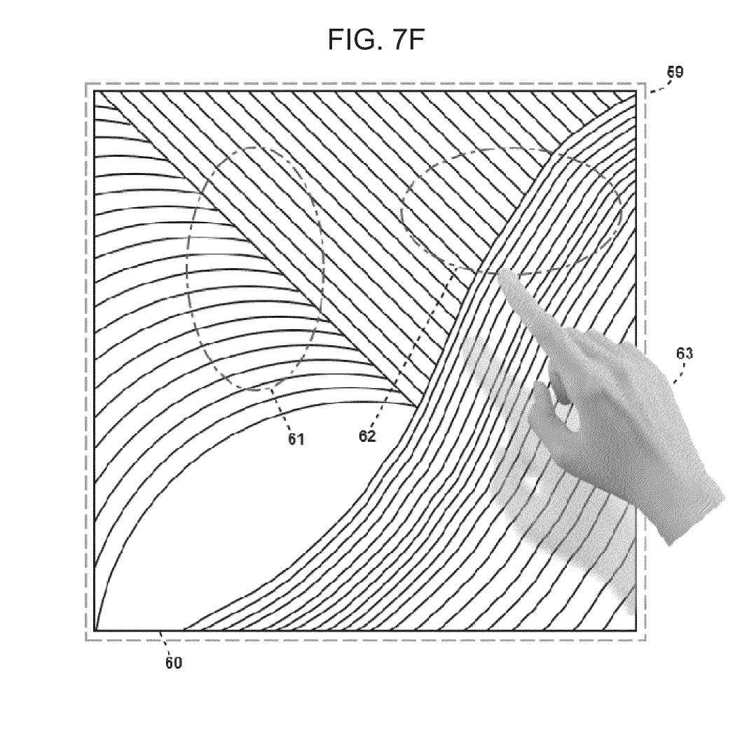

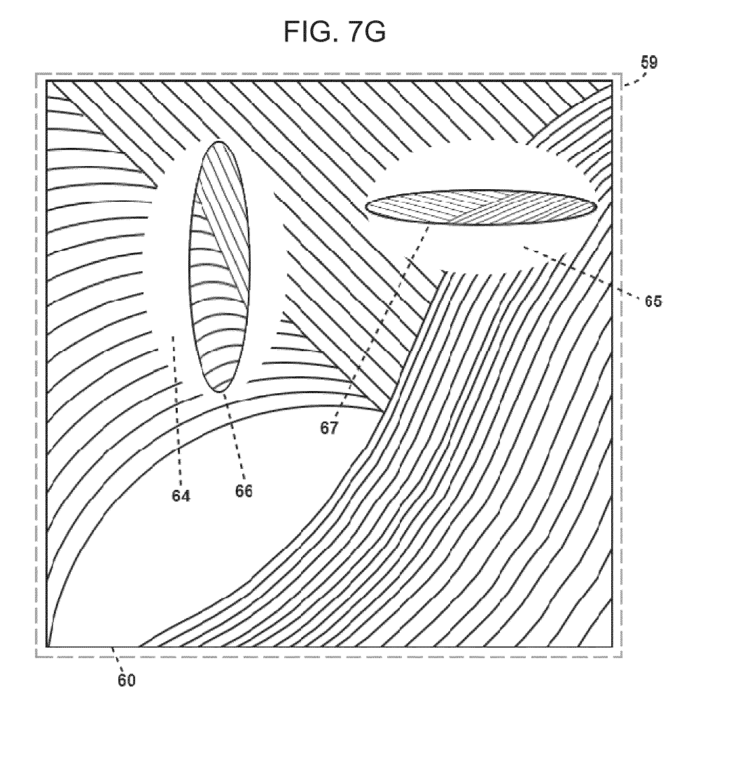

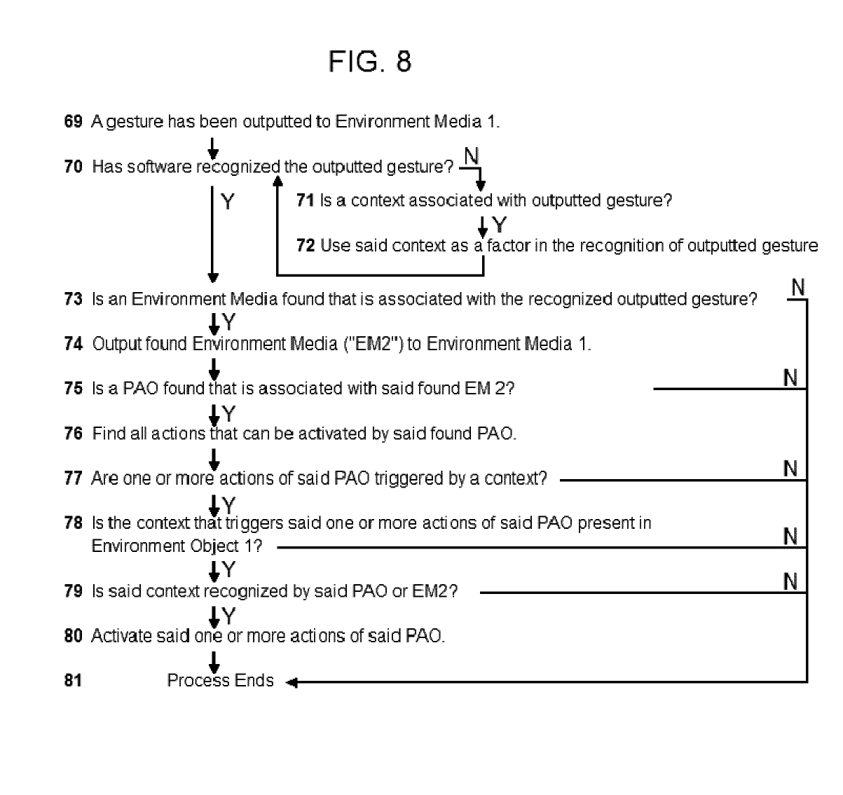

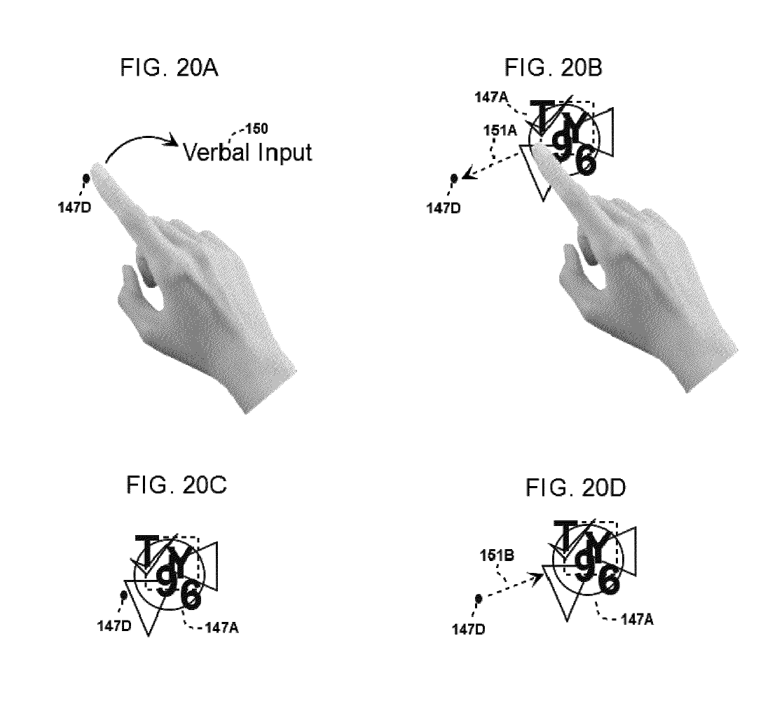

To continue this example, let's say that after completing FIG. 20 in said second program, 17, in said layout, 22, and after describing each of the 200 numbered labels, 18, in said text document, 14, a user discovers that a new figure (we'll call it “inserted figure”) is needed to be created and inserted after existing FIG. 5 and before existing FIG. 6 in said layout document, 14. For the purposes of illustration only, let's further say that each of the 20 figures of layout, 22, has 10 number labels. Let's further say that said “inserted figure” utilizes 10 numbered labels. In this case, the insertion of said “inserted figure” after existing FIG. 5 and before existing FIG. 6 would require the sequencing of the following items to maintain the existing relationships within said document, 14, and between said document, 14, and said layout, 22:
(1) Renumbering sequentially ordered numbers, 16, in said text document, 14, from number 51 to 200.
(2) Renumbering labels from 51 to 200, as presented in existing FIGS. 6 to 20 of layout, 22. Note: existing FIG. 6 of layout, 22, becomes FIG. 7, existing FIG. 7 becomes FIG. 8, etc.
(3) Renumbering each paragraph reference (e.g., 23a and 23b) in the paragraphs of said text document, 14, to each paragraph number, 15, that contains data referencing any figure label above the number 50. Note: “(3)” is necessary because when new text paragraphs are inserted in said text document, 14, the paragraph numbers, 15, (after the inserted text) will auto-sequence, thus the references (i.e., 23a, 23b) to various paragraph numbers, 15, in various paragraphs of document, 14, will no longer be correct.

Relationships Define Environments

In an exemplary embodiment of this invention an Environment Media is defined according to relationships that exist between objects that support at least one common task. Said relationships can exist in any location and can be established by any suitable means, including but not limited to: at least one object characteristic, user input, software programming, preprogrammed software, context, any dynamic action, response, operation, or any equivalent.

Consider the example of the windows-based word program and windows-based layout program illustrated in FIG. 2. The problems exhibited in this example would be solved if everything in document, 14 and layout, 22 were included in a single Environment Media that is defined by the relationships between objects and/or definitions being used to perform one or more tasks or a set of sub-tasks that support one common one or more tasks. In FIG. 2, two programs and their contents are being used to perform tasks. What are the tasks defined by FIG. 2? One task would be creating a series of 20 figures, 19, with 200 sequential number labels, 18, in a layout, 22. Another task would be creating a text document, 14, containing text descriptions, 14a, 14b, 14c, 14d, to #n, of 200 labels, 18, in layout, 22. And still another task would be referencing certain paragraph numbers, 15, in the text descriptions, 14a to #n, of text document, 14. Could all of these tasks be considered one task? Yes, they could all be considered the creation of a patent document with a disclosure and accompanying figures. Or a single task could be defined in a broader sense as the creation of a collection of diagrams with accompanying text descriptions.

In one embodiment of the invention the definition of a task relates to the process of the human being and/or to the machine to the extent that the machine patterns a human thought process. In this embodiment the invention defines an environment based upon the relationships of objects associated with one or more purposes, tasks or the equivalent. Looking at the software logic that permits such an environment to exist, we could start with the contents of an environment. Referring to FIG. 2, and for the purposes of example only, let's consider that document, 14, and layout, 22, are not separate windows-based programs, but instead are comprised of objects, digital definitions or any equivalent and that these objects and the relationships between these objects comprise a single Environment Media, which we'll call “Environment 1.” Note: the following discussion repurposes FIG. 2 and its elements to describe an example of an Environment Media (“EM”). EM are not limited to any type of object or data, or to any method of operation or approach, protocol, action, procedure, organization, structure, input or the equivalent. The discussion of Environment 1 is for illustration only and is not meant in any way to narrow the scope of the software of this invention. FIG. 2 will explored now as an illustration of a single Environment Media, instead of two windows-based programs.

Thus the following is a new discussion of FIG. 2 and its contents from a different perspective, namely, that FIG. 2 illustrates an Environment Media, which shall be referred to as “Environment 1.” In Environment 1 there are many objects or their equivalent, e.g., definitions in a multi-threaded computing environment. Unlike a word processor program, Environment 1 is not a document in the sense of a windows program where text and its operations are defined and controlled by the rules of a word processing program. Environment 1 is comprised of objects or their equivalent that can communicate with each other via any suitable causality, including, but not limited to, any of the following: context, input, (e.g., user input or software input), analysis of object characteristics, time based operations, logics, assignments, patterns of use, and more. Environment 1 includes document, 14, plus, layout, 22, but there are no applications or programs here. What were previously programs 13, and 17, are now a single environment, containing all elements presented in FIG. 2, which are now objects. To summarize this point, in the example of Environment 1 there is no program, 13, or program, 17. Replacing these programs is a single Environment Media, Environment 1, which is comprised of objects that have one or more relationships with one or more other objects comprising Environment 1. Environment 1 represents at least one task, which could include multiple sub-tasks. For the purposes of illustration only, references will still be made to “text document”, 14, (or just “document, 14,”) and “layout”, 22, as this enables us to refer to the existing FIG. 2 and its labels. References will be made to other existing labels in FIG. 2, but they will be discussed as part of a an Environment Media, Environment 1, not as a part of what was originally two separate windows-based programs, 13 and 17.

Paragraph Number Objects in Environment 1.

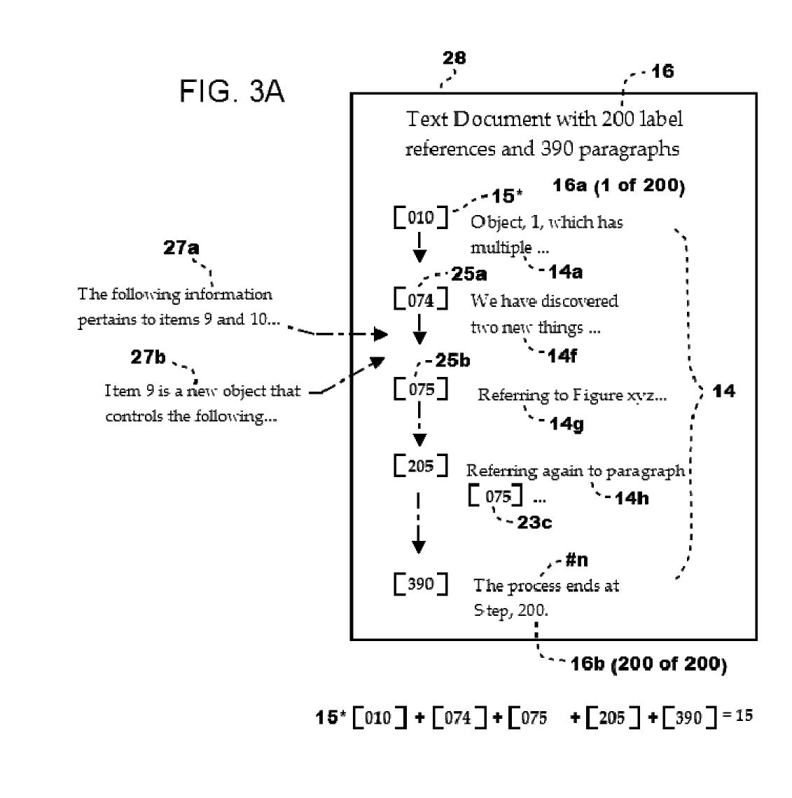

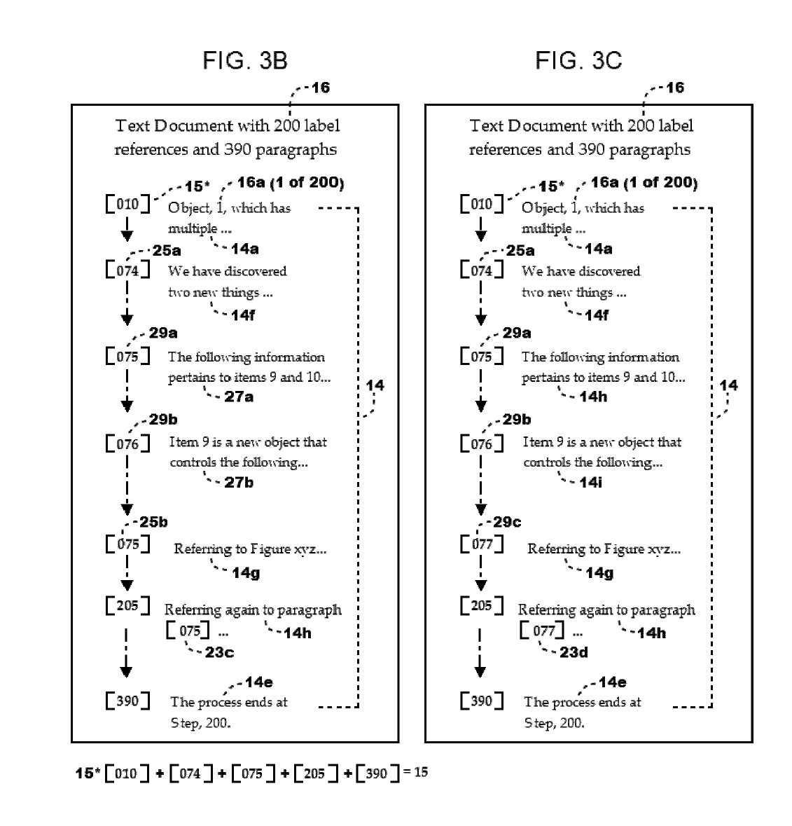

In this new scenario, all elements of document 14 and 17 are converted to objects that could be definitions or any equivalent, and which are communicated via a communication protocol. As such, paragraph numbers [001] to [390], 15, in document, 14, in Environment 1 are now objects. One characteristic of said paragraph number objects, 15, is that they would be presented sequentially, e.g., a new paragraph number object would be created for each new paragraph definition of object that is created, e.g., 27a and 27b of FIG. 3A. Another characteristic of said paragraph number objects would be their ability to communicate sequence information to other objects, including other paragraph number objects, 15. Another characteristic would be the ability for one or more paragraph number objects to communicate auto sequencing to all paragraph number objects, 15. One benefit of this is that if any paragraph number object, 15, was deleted or a new paragraph number object, 15, was inserted, all following paragraph number objects, 15, could be adjusted in their hierarchical order and, if necessary, assigned a new number. This behavior can exist in a word processor as a function of a windows program. But that is part of the problem for a user who tries to maintain accurate relationships between all parts of layout, 22, and document, 14, by manually managing elements of two separate programs that don't talk to each other. Enabling the elements of layout, 22, and of document, 14, to exist as objects in one Environment Media, solves relationship problems that simply cannot be easily maintained between separate windows-based programs.

An object environment defined by the relationships of the objects that comprise it is a dynamic collection of context aware objects that can freely communicate with each other. In Environment 1 each paragraph number object, 15, is capable of communicating with every other paragraph number object, 15. Further, each object comprising said Environment Media “Environment 1” could be the result of a communication protocol. But the communication would not stop there. Each paragraph number object in Environment 1 can be duplicated or recreated and the duplicate or recreated object can communicate to all objects that the original (from which it was duplicated or recreated) can communicate. Duplication can be accomplished by many means. For example, duplicating an object could be via a verbal command: “duplicate.” A user selects an object and says: “duplicate.” Another example would be to touch, hold for a minimum defined time and move off a duplicate copy of any object. An example of recreating an object would be to retype a text object or redraw a graphic object in any location. Another example could be to verbally define a second object that exactly matches the characteristics of a first object.

When objects are duplicated or recreated, the duplicate or recreated version of an original object contains the same characteristics as the original. In the software of this invention, all objects can possess the ability to communicate with and maintain one or more relationships with one or more other objects. In the case of Environment 1, each paragraph number object has the potential ability to not only communicate with other paragraph number objects, but also with any object in Environment 1. What defines the environment of this invention? In one embodiment an Environment Media is defined by objects that have one or more relationships to one or more other objects, where said objects are associated with at least one definable purpose, operation, task, collection, design, function, action, state or the like (“task” or “purpose”). So in one sense, an Environment Media exists as a result of relationships between objects that communicate with each other for some purpose. What if there is no purpose? Whenever possible, The software of this invention can derive a purpose from an analysis of the characteristics, states and relationships of one or more objects. A user is not required to perform this operation, although user input can be considered by the software. A purpose could be as generic as providing a collection of accessible data. Or a purpose could be very complex, such as the designing of an automobile engine.

How does the software of this invention define a task by the analysis of objects and their relationships? Two methods are described herein that enable the software of this invention to determine a task from elements in a motion media. These methods are: (1) Task Model Analysis, and (2) Relationship Analysis. Briefly, a starting and ending state can define a task. Further, changes in states and changes in object characteristics (which include changes in relationships) comprise steps in accomplishing a task, and therefore can be used to define a task, purpose (or its equivalent) by software.

What is the benefit of having an environment defined by relationships? There are many benefits. Some are described below.

User Operations can Define an Environment.

Users can create objects at will and place them at will and operate them at will. In this creation, placement and use, relationships are established between objects. Further, other inputs can establish additional relationships or modify existing relationships. Examples of other inputs could include: assignments (e.g., outputting lines or graphic objects between source and target objects); gesturing to call forth actions, functions, operations, and the like; modifying one or more objects' characteristics; creating one or more new contexts; modifying one or more existing contexts; duplicating any object and moving it to a new location, which could be a different device, server, website or cloud location; accessing data from any website via the internet, an intranet or any other network; and the equivalent.

An important feature of the software of this invention is that relationships between objects are not limited to a single device, operating system, server, website, ISP, cloud infrastructure or the like. Thus an Environment Media (“EM”) is not limited to one device and one location. If a relationship is established between any object, definition, data, and any equivalent in one device, location, infrastructure, or its equivalent, (“locale”) and an object in another “locale”, one Environment Media includes objects in both locales. Thus an EM can have objects existing on one device and other objects existing on another device and other objects existing on an intranet server and other objects existing on a cloud server and other objects existing in the physical analog world, such as in a kitchen or office. All of the above mentioned objects could comprise a single EM, and said objects could have one or more relationships and communicate with each other, regardless of their location.

Another feature of the software of this invention is that locales can be objects. Accordingly, locales that belong to an EM can communicate with each other and maintain relationships. A single EM can contain locales that exist as a location or exist in any location that is accessible in the digital domain or in the physical analog world. Said locales can be within or on any one device at one location, or exist between multiple locations, (e.g., between multiple cloud servers, ISP servers, physical analog world structures, devices, objects and the like), on multiple devices (e.g., on networked storage devices and personal devices, like smart phones, pads, PCs, laptops, or on physical analog devices, like appliances, physical machinery, planes, cars and the like). All locales that have one or more relationships to each other and to any EM object can comprise the same Environment Media.

In consideration of a “locale,” we could argue that a “locale” is not limited in definition to a device or network location, or its equivalent, but additionally, a “locale” could be defined by one or more functions, operations, actions, or relationships that exist in a single location. For example, let's refer again to FIG. 2, as an illustration of the object-based environment, Environment 1. A first locale of Environment 1 could be paragraph number objects, 15, in document, 14. A second locale could be the text objects, 14a, 14b, 14c, 14d, to #n, (also referred to as “paragraph objects”) that comprise the paragraphs of document, 14, and which are numbered by paragraph number objects, 15. A third locale could be referenced paragraph number objects in paragraph objects, e.g., 23a and 23b. A fourth locale could be 200 label objects, 18, in layout, 22. A fifth local could be graphic objects, 21a to 21# in FIGS. 1 to 20 in layout, 22. Note: locales can be of any size and complexity and contain any data or its equivalent.

It should be noted that, any individual character or punctuation (i.e., comma, period or the like) in any of the above cited text objects could be a separate object.

Said first, second, third, fourth and fifth locales have one or more relationships to each other and they have one or more relationships to the objects and data that comprise each locale. The software of this invention maintains said relationships and permits dynamic updating and modification of said relationships via user input, automatic input, programmed input, changes due to context, or the like. Further, the objects in said each locale can freely communicate with the objects in each other locale. This is quite beneficial to a user.

For example, if one or more paragraphs were inserted in said text document, 14, communication between objects in said first and second locale would permit the following automatic processes. First, the auto-sequencing of paragraph number objects. This can be accomplished by any word processor today. Second, the automatic updating of paragraph number objects, e.g., 23a and 23b of FIG. 2 that are referenced in text object paragraphs, e.g. 14b and 14c, of FIG. 2. This cannot be accomplished by any word processor today. Further, communication between locales.

As another example, if a new figure were inserted in layout, 22, communication between all five locales would permit the following: (a) automatic sequential numbering of new labels in said new figure, (b) auto-sequencing causing a renumbering of existing label objects, 18, in layout 22, (c) renumbering of 200 label references, 16, in document, 14, (d) renumbering of paragraph label objects, 15, (e) renumbering of referenced paragraph label objects, e.g., 23a and 23b.

In a key embodiment of the Environment Media of this invention, there are no programs. Instead there is a collection of objects that have relationships to each other for the accomplishment of some purpose or task, and a communication between said objects in said collection. It should be noted that said relationships can be maintained for any period of time—from persistent to very transitory. Further, the relationships themselves and the maintaining of said relationships can be either static or dynamic.

Referring again to FIG. 2 and Environment 1, one or more objects in said first locale can communicate with and/or have one or more relationships with one or more objects in said second locale. Text objects, 14a to #n, of document, 14, are sequentially numbered by paragraph number objects, 15, as to [030] to [150] to [210] to [390]. Each paragraph number object, 15, can have a relationship to each other paragraph number object and to each text object, 14a to #n comprising document, 14.

There are various types of relationships that could exist between paragraph number objects, 15. They include, but are not limited to:
Auto-sequencing: if any paragraph number object, 15, is deleted from the existing group of paragraph number objects, or if any new paragraph number object is inserted into the existing group of paragraph number objects, said paragraph number objects can communicate with each other to maintain a continuity of their sequential numbering. This will result in auto-sequencing.
Auto-updating: if one or more new paragraph objects are inserted in said document, 14, each new paragraph object will be numbered by a paragraph number object whose number is determined by the existing sequential order of paragraph number objects, 15.
Assignment: if an assignment is made to a specific paragraph number object, e.g., [030], the software can determine is said assignment is of a generic nature (e.g., valuable to all paragraph number objects) or is of a specific nature (e.g., valuable to only to said specific paragraph number object). If said assignment is of a generic nature, said specific paragraph number object can communicate said assignment to all other paragraph number objects to permit said assignment to be made to all other paragraph number objects.
Duplication and recreation: if any paragraph number object is duplicated or recreated by any means, the resulting duplicate or recreation will have the same characteristics as the original from which it was duplicated or recreated. For example, each duplicate and recreated paragraph number object would have the ability to communicate to all other paragraph number objects, regardless of their location.

Below are some of the relationships that could exist between paragraph number objects, 15, and paragraph objects, 14a-#n, in document, 14. Said relationships between paragraph number objects, 15, and paragraph objects, 14a-#n, in document, 14, illustrate powerful advantages to a user and/or to an automatic software process.

Auto-updating of a referenced object: Referring now to FIG. 3A, document, 14, of Environment 1. Two new paragraph objects, 27a and 27b, are being inserted into document, 14, directly after paragraph number object [074], 25a. Note: upon insertion, each new paragraph, 27a and 27b, will either exist as an individual object or become part of an existing text object. For purposes of this example the two inserted paragraphs, 27a and 17b, will exist as two individual objects. Given this condition, the following can occur in the Environment Media, Environment 1, upon the insertion of said two new paragraphs, 27a and 27b. Note: there are many possible scenarios. Below is one of them.

Paragraph object numbers communicate to update each other. Referring now to FIG. 3B, in Environment 1 two new paragraph objects, 27a and 27b, have been inserted into document, 14 between original paragraphs [074] and [075] of FIG. 3A. After insertion into document, 14, paragraph objects 27a and 27b, communicate to paragraph number object [074], 25a, in document, 14. Paragraph number object, [074], 25a, communicates with new paragraph objects, 27a and 27b, to cause two new sequential paragraph number objects, [075], 29a, and [076], 29b, to be assigned, respectively to each new inserted paragraph object. Thus, inserted paragraph object, 27a, is assigned the number object [075], 29a, and inserted paragraph 27b, is assigned the number object [076], 29b. Paragraph number [076], 29b, communicates to the original paragraph number [075], 25b, and commands it to change its number to [077], shown in “Figure C” as 29c. Referring again to FIG. 3B, the original paragraph number object [075], 25b, is renumbered as [077] shown in FIG. 3C, 29c. Referring now to FIG. 3C, (further illustrating Environment 1) paragraph number [077], 29c, communicates with the original paragraph number [076], not shown, and commands it to change its number to [078] and so on. As an alternate to this process, the original paragraph number object [075], 25b, (See FIG. 3A) communicates to all existing paragraph number objects above number [075] and commands them to increase their number by two integers. In either case all existing paragraph numbers objects, 15, above the number 74 are automatically increased by two integers. This can be an automatic process or a user could be prompted with some visualization that permits the user to initiate or stop the proposed renumbering of paragraph number objects.

Paragraph number objects communicate to paragraph number references, for example [075], 23c, in paragraph object, 14h, of FIG. 3B. The original paragraph number [075], 25b, in FIG. 3B has been changed to number [077], 29c, in FIG. 3C. Paragraph number object [077], 29c, communicates its two integer increase to its recreated paragraph number object, [075], 23c, shown in FIG. 3B. Referring to FIG. 3C, recreated paragraph number object, 23d, receives the communication from paragraph number object, 29c, and the causes the number for the referenced paragraph number object, 23d, to be changed to [077], 23d as shown in FIG. 3C. According to this method, any paragraph number object that is referenced in any paragraph object, 14a-#n, of document, 14, can be automatically changed to match a change in any paragraph number object, 15. At this point in this example, all objects in document, 14, are able to communicate with each other to maintain and/or update their relationships. Now let's address the relationships between the objects in layout, 22.

Objects in layout, 22, can communicate with each other. Referring to FIG. 4, layout, 22, contains 20 Figures, 19, 200 labels, 18, (e.g., 18a, 18b, 18c, 18d), and an undisclosed number of graphics, e.g., 21a, 21b, 21c, 21d. Said 20 figures, 200 labels, and undisclosed number of graphics are all objects in Environment 1. In this object-based environment, Environment 1, no word processor is needed to maintain sequential numbering. Indeed, the sequential numbering of number objects in document, 14, is maintained by communication between objects, including communication between Environment Media, Environment 1, and its contents. Also, the sequential numbering of 200 label objects, 18, in 20 figures, 19, of layout, 22, does not require word processor control. Said sequential numbering is maintained by communication between objects in layout, 22, and between EM, Environment 1 and its contents, which include said 200 label objects, 18. Thus, it does not matter where each of said 200 label objects, 18, are located in layout, 22. The sequential numbering of 200 label objects, 18, is according to communication between said 200 label objects and Environment 1.

Note: Any one or more of said 200 label objects, 18, could exist on multiple devices, servers, and the equivalent, in any location, for instance in any country, that permits communication with Environment 1. This is a key power of the environment of this invention. Any user, located anywhere in the world, can engage any object of Environment 1 and said any object can communicate change to said any object in Environment 1 for every user of Environment 1.

Continuing with the discussion of objects in layout, 22, let's say that a user wishes to add a new label number into “FIG. 10”, (not shown) of layout, 22, in Environment 1. Let's say that this new label number is created as label number 60. Let's further say that said label number 60 is typed or spoken such that it appears at some location in layout, 22. At this point in time there will be two labels with the number 60 in layout, 22. But the creation of a new number 60 may mean little, until it is used to label some part of a graphic, device or other visualization of “FIG. 20.” A simple way to accomplish this would be to move the newly created label number 60 to “FIG. 20” and create a visual connection from said new label number 60 to a part of any visualization of FIG. 20. Said visual connection provides a context that causes the existing label number 60 to communicate to the newly created number label 60.

Many possible scenarios could follow. The following is one of them. The existing label number 60 communicates with said new label number 60 and recognizes its presence in “FIG. 20” as a valid label number in the sequence position, 60. Note: one of the characteristics of all label number objects is the ability to cause and maintain sequencing. Existing label number 60 uses this sequencing characteristic to renumber itself to number 61. Then or concurrently, said existing label number 60 communicates to all other existing label numbers in layout, 22, with the result that each existing label number is increased by one. Thus there are now 201 total label numbers in layout, 22. As an alternate scenario, all of the existing label numbers from 60 to 200 communicate with said newly created label number 60 and confirm said newly create level number as a valid label number in the sequence position, 60. As a result said existing label numbers from 60 to 200 change their numbers by one integer. The result is the same. There are now 201 total label number objects in layout, 22.

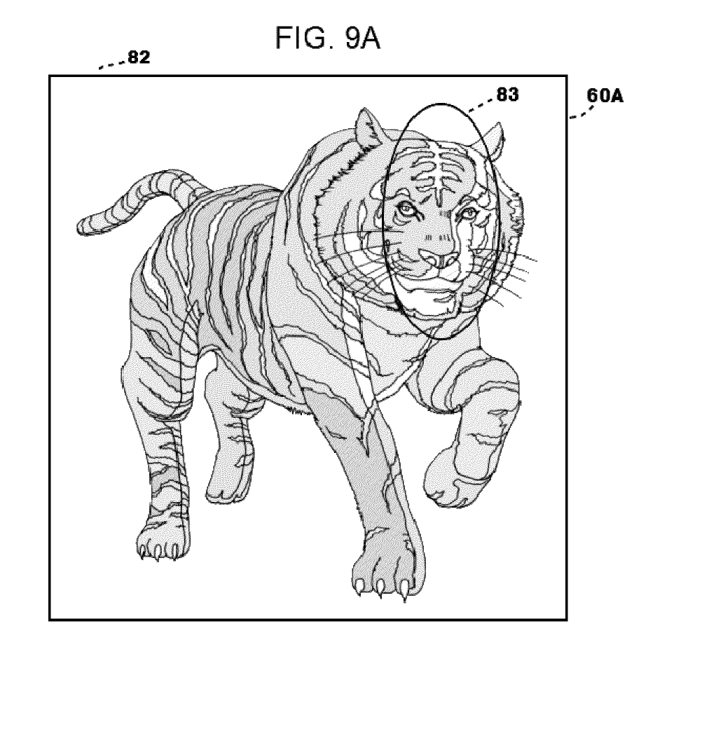

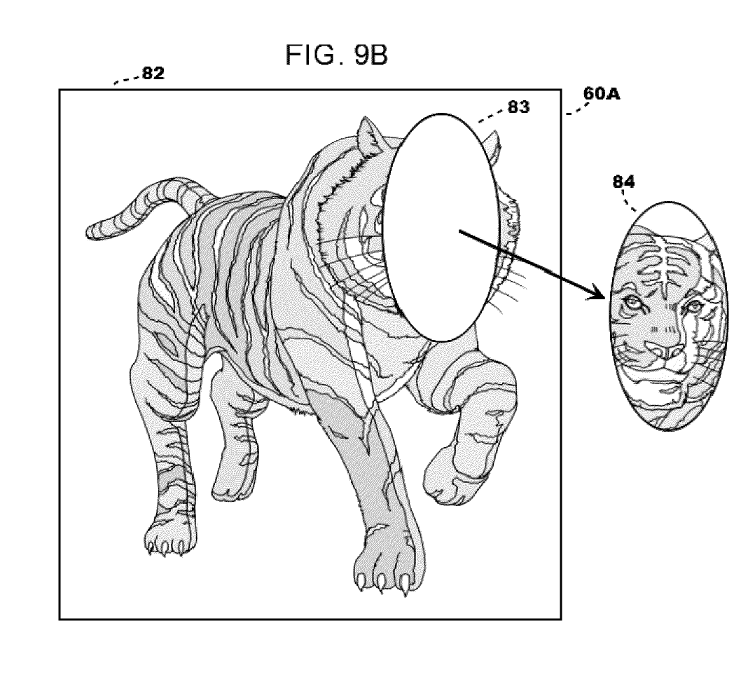

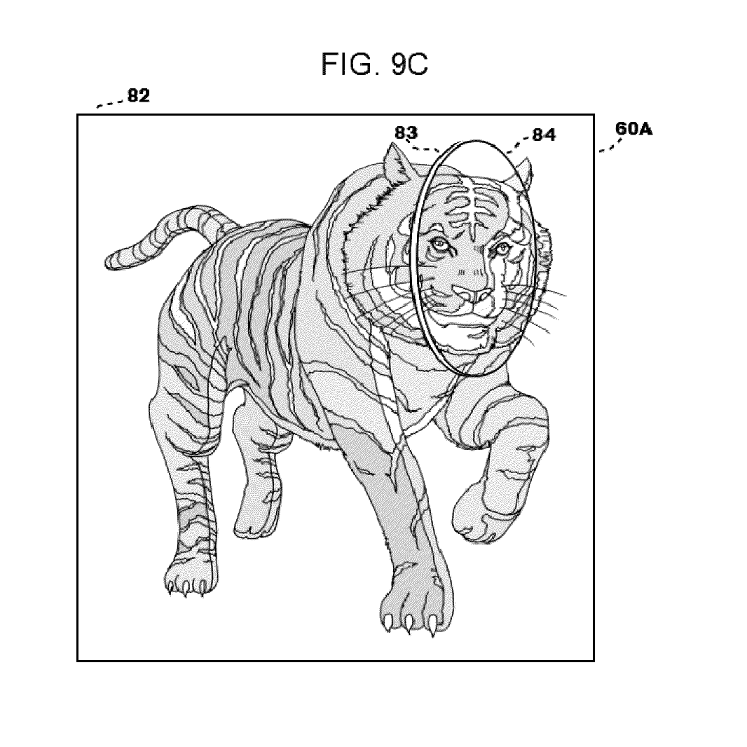

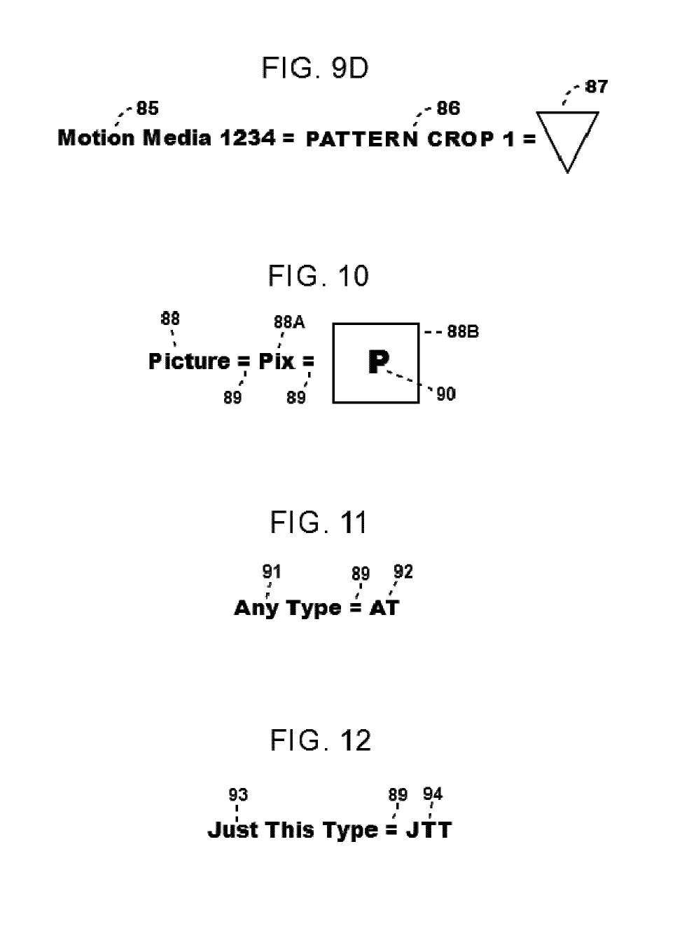

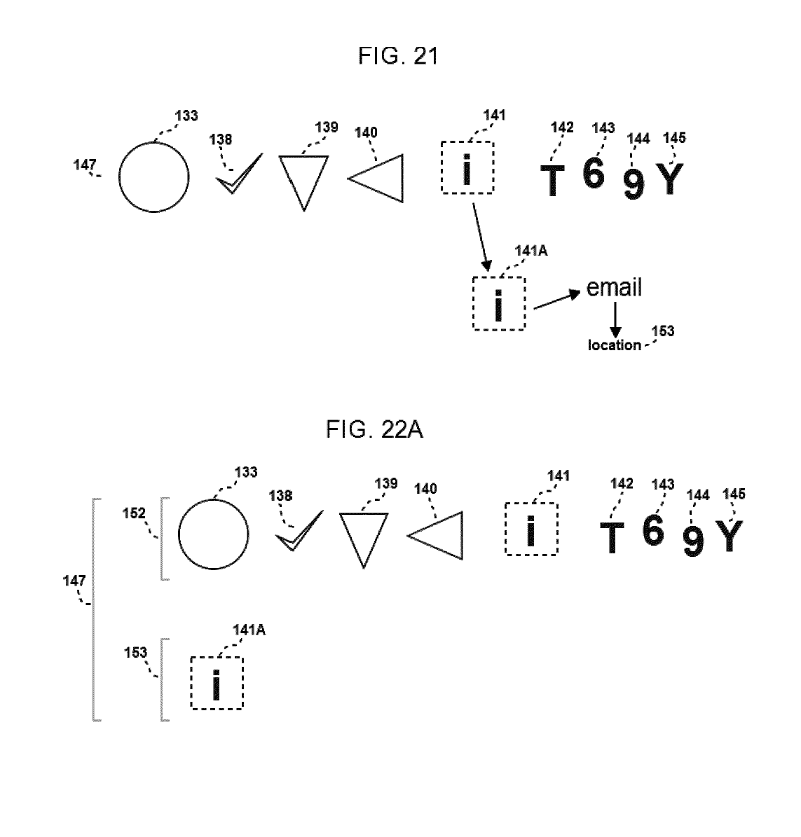

Let's now consider FIG. 4, not as depicting Environment 1, but as an illustration of two windows-based programs—a layout program that created layout, 22, and a word processing program that created document 16. Let's now say that a new figure is created and inserted before “FIG. 8” (not shown) of layout, 22. Let's say that said new figure contains 20 new labels. For a user to increase each label number in each location of layout 22, by 20 integers for every object in every figure from “FIG. 9” to “FIG. 21” would be very time consuming and prone to mistakes. If document, 14, were a windows-based program, it would be even more difficult to update of all the label references, 16, in document, 14, to accurately match changes in the label number objects, 18, in layout, 22, caused by the insertion of said new figure.

Now let's again consider FIG. 4 as an illustration of an Environment Media, Environment 1. The software of this invention permits Environment 1 to be defined by the relationships between the objects in document, 14, and the objects in layout, 22, (“EM1 objects”). Therefore at any time any one or more said EM1 objects can communicate change to any one or more other EM1 objects. Said communication can be bi-directional. Thus a change in any EM1 object can be communicated by said changed EM1 object to another EM1 object. In addition, communication can be ever changing and be affected, controlled or determined by many factors, including: context, user input, time, software configuration, an object's characteristics, and many more. Thus a relationship between any two or more EM1 objects can exist for any length of time and then change to something else at any point in time.

Objects in layout, 22, can communicate with objects in document, 14, as members of Environment 1. Referring again to FIG. 4: layout, 22, contains 200 label number objects, 18. Each of said 200 label number objects, 18, in layout, 22, is discussed in paragraph objects, 14a, 14f, 27a, 27b, 14g, 14h to #n (“14+”) in document, 14. As a result, each of said 200 label number objects, 18, appears as a label number in one or more of said paragraph objects of document, 14, for example, “Object 1, 16a (1 of 200), in paragraph object, 14a, and “Step, 200,” in paragraph object #n. Each of said 200 labels, 18, in layout, 22, and each recreated version (of said 200 labels) in document, 14, can communicate with each other. This communication is very valuable to a user.

Now referring to the example of a newly created label number 60 in layout, 22, as described in paragraphs [129] and [130] above. The communication that enabled all label number objects above number 60 to be auto sequenced in layout, 22, can also be applied to the recreated versions of label number objects, e.g., 16a (1 of 200) and 16b (200 of 200) in paragraph objects of document, 14. First, each label number object that is presented in a paragraph object, 14+, of document, 14, has a relationship to each original label number object in layout, 22. The reverse of this is also true. If said document, 14, and its paragraph objects containing 200 label number objects was created first, then each label number object in layout, 22, would either be a duplicate or recreation of the 200 label numbers created in paragraph objects of document, 14. Either way a relationship exists between said label number objects in document, 14 and in layout, 22 and this relationship enables communication between label number objects in layout, 22 and in document, 14. Therefore, any change in label number object in layout, 22, will automatically update the label number objects in document, 14. Conversely, any change in any label number object of document, 14, will automatically update any label number object of layout, 22. The communication and resulting change from said communication can occur anywhere said label number objects exist.

Auto-updating of a referenced object in a duplicated paragraph object. Let's say that paragraph object, 14a, “Object, 100, is described in [075] . . . ” is duplicated and copied to a new location in “Environment 1” that is not in document, 14. Wherever the duplicate of paragraph object, 14a, exists, it can communicate with the original paragraph object, 14a, in document 14. The relationship between the original and its duplicate enables any updating, modification, or other change in the original to be updated in its duplicate, regardless of where it resides. Also the reverse is true. Any change in a duplicate can be communicated to its original, regardless of the locations of said duplicate and original.

Composite Relationships

The presence of 200 label number objects, 16, in paragraph objects, 14a+, in document, 14, comprises at least 200 relationships with label number objects in layout, 22. There is at least one relationship between each label number object, 18, in layout, 22, and each recreated number object, 16, that appears in paragraph objects, 14+, of document, 14. For example, layout label 1, 18a, appears as a recreation in paragraph, 14a of text document, 14, as “Object, 1.” Note: a “recreation” means that label number “1” was not duplicated. It was typed or verbally placed or created by some other suitable means. Another example of a recreated label number object of layout, 22, would be label 200, 18#, which appears in paragraph object, #n, as “Step, 200.” Because of said at least 200 relationships, said 200 labels, 18, of layout, 22, become part of Environment 1. The objects in layout, 22, do not exist as a separate layout document or as a separate program. All objects in layout, 22, and in document, 14, exist in Environment 1. In fact, all objects in layout, 22, and in document, 14, which have relationships to each other and/or to a purpose define Environment 1. Specifically regarding the objects of layout, 22, Environment 1 includes not only 200 label number objects, 18, but also includes each graphic object, e.g., 21a, 21b, 21c, 21d to 21#, of layout, 22. The reason for this is that each of the 200 label number objects, 18, refers to one or more graphic objects, e.g., 21a-21d, in layout, 22. In other words, each of the 200 labels, 18, is used to label at least a part of a graphic object or other visualization in layout, 22. This labeling establishes a relationship between 200 label number objects, 18, and graphic objects, i.e., 21a-21#, in layout, 22. We'll call this “composite relationship 1”. One or more of said 200 label number objects, 18, of layout, 22, have a relationship to one or more label references, 16, of document, 14. We'll call this “composite relationship 2.” The graphic objects, e.g., 21a-21#, of layout, 22, have a relationship to one or more of the 200 label number objects, 18, in layout, 22; and said 200 label number objects have a relationship to one or more label references, 16, in paragraph objects, 14+, of document, 14. Therefore, said graphic objects, 21a-21#, of layout, 22, have a relationship to said one more label references, 16, of document, 14. We'll call this “composite relationship 3.”

Composite relationships can be used for many purposes. This includes, but is not limited to these three funcitons: (1) a composite relationship can be used as a data model to program Environment Media or other objects, (2) a composite relationship can be used to organize data and relationships, (3) a composite relationship can be used as a locale.

Undo Relationships

As is common in the everyday practice of computing, data can not only be changed, but it can be deleted. Even if data is deleted from an environment, it retains its existing relationship(s) in an undo stack for some period of time. The software of this invention provides for objects and data that are a part of any environment to maintain a relationship to one or more undo stacks. Said undo stacks can be of any size and have any length of persistence, from permanent undo stacks, to dynamically controlled undo stacks. Like all objects and data belonging to the environment of this invention, undo stacks and/or any member of any undo stack can be in any location and they can have their own dynamic relationship to an environment.

Dynamic Objects

According to the software of this invention, the maintaining of any relationship between any two objects, data, and/or locales of any Environment Media can be a dynamic process. Any relationship and any communication in an EM can be subject to change at any time. Any relationship that defines an EM can be dynamically controlled, such that said relationship can be changed by any suitable factor. This includes, but is not limited to: time, sequential data, context, assignment, user input, undo/redo, rescale, configuration, preprogrammed software and the like. Another dynamic factor in an EM is motion media.

Motion Media in Relationship to the Environment of this Invention

Any change in the environment of this invention can be recorded as a motion media. The change recorded in a motion media establishes a relationship between said motion media and the environment in which it recorded change. Thus to the environment of this invention an Environment Media, a motion media exists as an object that has one or more relationships to one or more environments to said Environment Media, to one or more objects that comprise said Environment Media, to other Environment Media, to one or more objects that comprise said other Environment Media and so on. For purposes of example only, let's say some changes have been recorded by a motion media (“motion media 1”) for an Environment Media, “Environment A”. Motion media 1 automatically has a relationship to Environment A by virtue of the fact that motion media 1 contains recorded change associated with data, and/or definitions and/or objects or the equivalent that comprise Environment A. Let's now say that Environment A is being operated by a user (“user 101”) in California. Let's say that motion media 1 is saved to a cloud server somewhere. Motion media 1 continues to be a part of Environment A, regardless of where it is. Let's say that another user (“user 102”) downloads motion media 1 to their system in Germany. As a result, the objects, states and change in motion media 1 for user 102 can communicate with objects in Environment A of user 101 and vice versa. In other words, user inputs from user 102 can affect objects and states in the Environment A of user 101 and vice versa. Environment A enables a free communication between all objects that comprise it. As each new relationship is established between any object of Environment A and a new object, said new object becomes a part of Environment A.

FIG. 5A presents an Environment Media, A-1, which is comprised of at least three objects, (1) fader track, 30, (2) fader cap, 31, and (3) function, 32, which have one or more relationships to each other. Said three objects comprise a fader device, 40, for the purpose of controlling the threshold setting, 33, for a threshold function, 32, of an audio compressor. Fader cap, 31, moves longitudinally along track, 30, from a top point, 34A, which equals a unity gain threshold setting (no compression), to a lowest point, 34B, which equals a minus 60 db (−60 db) threshold, or maximum compression for the compressor function controlled by said device, 40. Fader cap, 31, and fader track, 30, have various unique characteristics. For instance, fader cap, 31, is a Programming Action Object (PAO 1) whose task is to program an object with the ability to control setting, 33, for function, 32—the threshold for an audio compressor. Said task includes a control for increasing or decreasing an audio compressor threshold setting, 33, depending upon the location of fader, 31, along fader track, 30. One function of fader track, 30, is to act as a guide for the movement of fader cap, 31, along a vertical orientation. Both fader track, 30, and fader cap, 31, are capable of communicating change and/or characteristics to each other. For instance, fader cap, 31, is instructed by fader track, 30, to adhere to a longitudinal path along fader track, 30, in a vertical orientation. [Note: this behavior of fader cap, 31, could be context based. In other words, when fader, 31, is brought into the proximity of fader track, 30, fader cap, 31, could automatically acquire the behavior of adhering to fader track, 30.] Fader track, 30, determines the physical distance that fader cap, 31, can be moved down or up and fader track, 30, communicates said physical distance to fader cap, 31 and to function, 32. Fader track 30 also has a relationship to the movement of fader cap, 31, namely, the farther fader cap, 31, is moved downward along track, 30, the lower the compressor threshold setting, 33, and therefore the greater the amount of audio compression that will be applied to an audio signal being processed by device, 40. As just described, said relation of fader track, 30, to the movement of fader, 31, also creates a relationship between fader track, 30, and fader cap, 31, to function, 32. Fader track, 30, has a relationship to the mathematical shape of the audio scaling (e.g., logarithmic, linear, or route cosine), which shapes change being applied to the threshold setting of device, 40. Note: there is no program or application determining the operation of device 40, and the objects that comprise device 40. The construction and operation of device, 40, is determined by communications and co-communications between the objects that comprise device 40, namely, objects 30, 31, and 32. The various relationships between objects, 30, 31 and 32 enable said communications and co-communications in Environment Media, A-1. A key point here is that said device 40, is dynamic. It exists as a result of relationships and communications. It is not governed by rules of a program. Each object in Environment Media, A-1, maintains relationship(s) and communication(s) regardless of the location of said each object. Thus the size of EM, A-1, is infinitely variable, infinitely changeable and can include multiple operating systems, physical hardware, networks, cloud infrastructure, protocols and any equivalent. Any one or more objects in A-1 can exist in the digital domain and/or the physical analog world, e.g., in a physical device or device element that communicates to the digital domain.

Further exploring FIG. 5A, let's say that device, 40, is duplicated in a system located in the US and the duplicate of device, 40, is sent to a client in another country, e.g., Germany. The duplicate of device, 40, in Germany could maintain one or more relationships to the original device, 40, in the US by co-communicating with said original device, 40. Thus Environment Media, A-1, would include device, 40, in the US and said duplicate of device, 40, in Germany Both devices could communicate in one environment, Environment Media, A-1. Thus, any change said client in Germany made in the setting of duplicate device, 40, could be communicated to the original device, 40, in the US and vice versa. The communication between device, 40, and duplicate device, 40, would occur in Environment Media, A-1. Said communication would enable any level of redundant remote control and on-the-fly control of any system, including military and industrial systems, e.g., missile launch and drone control, or control of fluid flows in oil and natural gas refineries. Said communication could be peer-to-peer or point-to-point via direct addresses between original device, 40, and duplicate device, 40, or via a server network or via any suitable communication protocol. Further, said communication could consist of one or more messages, sent as XML or other data via any network. The software of this invention would enable the receipt of said data by original device, 40, and/or duplicate device, 40, using very little bandwidth, e.g., 2 kB.

Referring again to FIG. 5A, we pose a first question: “Does fader cap, 31, need fader track, 30, in order to perform the function of controlling an audio compressor threshold setting?” The answer could be both “yes” or “no.” If the answer is “yes,” (“Condition A”) the relationships between fader, 31, and fader track, 30, are fixed or binding or otherwise co-dependent. In this case there is no need for fader cap, 31, and fader track, 30, to share the same functional characteristics, since they work together as a single device and each can perform the same function within a single composite device. But, if the answer to the above first question is “no,” (“Condition B”), fader, 31, would have its own relationship to the functionality of device, 40, including: (a) audio signal processing, (i.e., controlling an audio compression threshold setting); (b) degree of change (i.e., without being bound to fader track, 30, fader cap, 31, could be moved any vertical distance to cause change); (c) scaling (i.e., without being bound to fader track, 30, fader cap, 31, could have a direct relationship to scaling, and therefore the output control of the movements of fader cap, 31 would not be according to the distance it travels in free space, like on a global drawing surface. Note: This discussion of relationships between fader cap, 31, and fader track, 30, could continue along many additional lines, but the above list is sufficient to support the following discussion of FIGS. 5B to 5F.

Referring to FIG. 5B, this is an illustration of the use of fader cap 31, to program a graphic that is not part of Environment Media, A-1. First some background. When fader cap 31, is moved along fader track 30, both objects operate together as one device, 40, to perform function 32. But when fader cap 31, is pulled from fader track 30, by some action (e.g., a quick jerk to the right or left), this motion acts as a context, recognized by fader track 30 and fader cap 31, that causes fader track 30, to communicate its characteristics to fader cap 31. Several possibilities can occur: (1) Fader cap 31, receives the communicated characteristics of fader track 30, and adds them all to its own characteristics, (3) Fader cap 31, receives the communicated characteristics of fader track 30, updates its own characteristics with unique characteristics of fader track 30, that have a relationship to the function of fader cap 31, (3) fader cap 31, receives a constant communication from fader track 30, that enables fader cap 31, to move along a linear path without being adhered to fader track 30, and (4) if fader cap 31, impinges fader track 30, the communicated characteristics of fader track 30, are removed from the characteristics of fader 31, by fader 31. This co-communication between fader track 30, and fader cap 31, establishes a dynamic relationship between fader track 30, and fader cap 31. No longer is fader cap 31, required to adhere to fader track 30. Instead, fader cap 31's operation includes a linear operation which can be performed by moving fader cap 31, in free space. In this case, regardless of where fader cap 31, is located, its co-communication with fader track 30, can remain active and valid. Thus, said co-communication maintains one or more existing relationships and supports one or more modified relationships between object, 30 and object 31. The existence of said one or more relationships maintains the existence of Environment Media, A-1, regardless of the location of fader track 30, and fader cap, 31. For instance, original fader cap 31 is sent to a client in another country, it would be capable of maintaining co-communicate with original fader track, 30, as a member of Environment A-1.

Now referring to FIG. 5B, fader cap 31, has been pulled from fader track 30, and moved along path 36, to impinge a vertical gray rectangle object 35, at horizontal position 37. The impingement of vertical gray rectangle 35, by the center point 31A, of fader cap 31, establishes a relationship between fader cap 31, and vertical gray rectangle 35. The point 37, where center point 31A, of fader cap 31, impinges vertical gray rectangle 35, determines the compression threshold control of location 37, of gray rectangle 35. This relationship is determined as follows: Fader cap 31 was at the very highest location 34A, of fader track 30, when it was pulled from fader track 30, and moved to impinge vertical gray rectangle 35. The threshold setting for fader track location 34A, is zero (“0”), or unity gain—no effective compression. Therefore, the impinging of vertical gray rectangle 35, at location 37, determines that location 37, of vertical gray rectangle equals a threshold setting of zero (“0”). Fader cap 34A acts as a programming action object to program graphic 35.

Vertical gray rectangle has its own characteristics, including, semi-transparency. By the means just described, fader cap 31, has been used to modify the characteristics of vertical gray rectangle object 35, by adding to object 35, the ability to control a threshold setting 33, for an audio compressor. Further, the unity gain or zero (“0”) setting for the threshold control of vertical gray rectangle 35, equals the bottom edge of gray rectangle 35, location 37. This means that as the lower edge of gray rectangle 35, is moved downward, the threshold setting controlled by gray rectangle 35, is lowered, which increases audio compression. Since fader cap 31, can be operated without fader track 30, vertical gray rectangle object 35, can also be operated as a compressor threshold control without fader track 30. Further, because vertical gray rectangle 35, now has a relationship with fader cap 31, vertical gray rectangle 35, becomes part of Environment Media A-1. Said device 40, now includes two operable elements, fader cap 31, and vertical gray rectangle 35, which can be utilized to alter the setting of threshold function 32.

Referring now to FIG. 5C, vertical gray rectangle 35, is assigned to a pointer object 39, by the drawing of a directional indicator 38, from vertical gray rectangle 35, (the source of the assignment) to pointer object 35 (the target of the assignment). Note: the completion of the assignment of object 35, to object 39, can be accomplished by many means, including the following: (a) a user touches the arrowhead of directional indicator, 38, to activate it, (b) upon the recognition of directional indicator 38, the software automatically completes the assignment of object 35, to object 39, (c) via any suitable verbal means.

FIG. 5D shows the state of pointer object 39, after the assignment of object 35, to object 39, has been completed. The vertical gray rectangle that has just been assigned to object 39 is now hidden. Note: to view assigned object 35, a user need only touch pointer object 39, and its assignment appears.

Referring now to FIG. 5E, pointer object 39, has been touched to call forth the vertical gray rectangle 35, assigned to pointer object 39. Note: The position of object 35, in relation to object 39, is preserved as part of the characteristic of the assignment of object 35, to object 39. The original position of object 35, to object 39, can be set by many methods. In the example of FIG. 5E, user input to placed object 35, and object 39, in their respective locations. The assignment of vertical gray rectangle (which now possess the functional characteristics of fader cap 31) to pointer object 39, creates a new device, 41. Said new device 41, possesses the same control for the setting 33, of function 32, as possessed by device 40. New device 41, is comprised of three objects: (1) pointer object 39, (2) vertical gray rectangle 35, that is assigned to pointer object 39, and, (3) function 32. New device 41 has relationships with device 40 and is therefore part of Environment Media, A-1. Regarding said relationships, vertical gray rectangle 35, has one or more relationships with fader cap 31, from which vertical gray rectangle 35, received its control of settings 33, for function 32. In addition, the assignment of vertical gray rectangle 35, to pointer object 39, establishes a relationship between these two objects. As a result of this assignment, pointer 39 has a relationship to fader cap 31. This is because vertical gray rectangle 35, has one or more relationships to fader cap, 31, as object 35, was programmed by fader cap, 31. Further, objects 39 and 35 have a relationship to function object 32, inasmuch as object 39 and 35 are collectively used to control settings 33, for function, 32. As a result of at least the above stated relationships, new device 41 and device 40 are both part of Environment Media, A-1. As a result of both devices existing in the same environment, both devices are capable of co-communication within Environment Media, A-1.

Referring now to FIGS. 5F and 5G, a key benefit of objects within an Environment Media is the relationships and communication between objects. FIG. 5F shows pointer object 39, and an audio volume LED meter 42, which is comprised of 8 LED objects 42x. The meter 42, is scaled such that the top LED object 42A, indicates clipped digital signals and the LEDs extending from said top LED to the lowest LED object 42B, in meter 42, represent audio signals of diminishing volume. In FIG. 5F all LED objects of meter 42, are “on” (“lit up”) due to a high level audio signal being metered by meter 42. A user wishes to engage an audio compressor including a threshold function 32, utilizing a device that enables said user to control threshold setting 33. To accomplish this task, a user causes a pointer object 39, to be presented adjacent to meter, 42. The outputting of said pointer object 39, can be accomplished by many means, including: drawing, via a verbal utterance, via a gesture, by dragging, via software, via a motion media, and via other suitable means. Referring to FIGS. 3E, 3D and 3F, and as a reminder, pointer object 39, contains an assignment, vertical gray rectangle, 35. Vertical gray rectangle 35 has been programmed to control threshold setting 33, for function 32.

In FIG. 5F, pointer object 39, is positioned at a location perpendicular to the vertical plane of meter, 42. In FIG. 5G, pointer object, 39, has been activated to present its assignment, object 35, the vertical gray rectangle that can be used to control the setting for function 32. (Note: when object 35, is hidden as illustrated in FIG. 5F, its function is not active. Only when object 35, is made visible is its ability to adjust setting 33, of function 32, active.) In FIG. 5G, pointer object 39, its assignment 35, and meter 42, work together to comprise another device, 43.

The overall task that is accomplished by device 40, of FIG. 5A, device 41, of FIG. 5E, and device 43, of FIG. 5G is the same, namely, controlling the setting for function, 32. The specific methods of accomplishing said overall task is different for each device. Device 40, is operated by moving fader cap 31, down and back up along fader track 30, which adjusts setting 33, of function 32. Device 41, is operated by moving pointer object 35, down and back up in a vertical orientation, which is one of the characteristics programmed into object 35, by fader cap 35, as shown in FIG. 5B. Device 43, is operated the same as device 40, except that in device 43, the movement of object 35, modifies the characteristics of one or more LED objects 42x, that comprise meter 42. Further, the semi-transparency of object 35, enables a user to view one or more LED objects 42x, in meter 42, that are impinged by object, 35. The farther down pointer object 35, is moved along meter 42, the lower the threshold 32, and the greater the compression. This approach can provide the same accuracy of operation as with fader cap 31, in device 40.

Regarding all three devices 40, 41, and 43, their ability to compress an audio signal depends upon each of said three devices having a relationship to one or more audio signals. Thus an audio signal would need to be associated or sent to each device in order for an audio signal to be compressed by each device. This association of an audio signal with a device, e.g., 40, 41, and/or 43, could be accomplished by many means, including: (a) impinging any one of said three devices with an audio file name or other equivalent, like a graphic object, or vice versa, (b) drawing a line or directional indicator from an audio signal to any one of said three devices, or vice versa, (c) via a verbal utterance, (d) via a gesture, (e) via a context, and the like.

The three devices 40, 41, and 43 can each exist as a separate environment or one or more of these devices can exist as one environment. Said three devices illustrate three different methods of performing the same task, namely, controlling the threshold setting for an audio compressor. The presentation of devices 40, 41, and 43 and the discussion of said three devices illustrates three different environments, all with the same task purpose. The software of this invention is able to analyze an Environment Media to determine its task. The same methods utilized to analyze motion media can be utilized to analyze an Environment Media (“EM”). Since an EM is defined by relationships between objects and by a task or purpose, the software of this invention can analyze the relationships that define any EM and determine a task.

Referring now to FIG. 6, this is a flow chart illustrating a logic that enables fader cap 31, to update vertical gray rectangle 35, with the task of fader cap 31, namely, controlling setting 33, for function 32, as shown in FIG. 5B. In general, the flow chart of FIG. 6, illustrates a general logic for an object being able to utilize one or more of its characteristics to update another object's characteristics. FIG. 5B also illustrates a context enabling a setting for an object. Below is a description of the flow chart steps of FIG. 6.

Step 44: A first object exists in an environment. In the example of FIG. 5B this first object could be fader cap, 31.

Step 45: The software checks to see if said first object has a characteristic that enables it to communicate a task to another object. If the software finds a characteristic enabling said first object to communicate a task to said second object, the process goes to step 46. If not, the process ends.

Step 46: The software queries: “is the first object associated with a second object.” Said association could be exemplified in many ways, including: first object impinges second object; first object is connected to second object via a gesture (like a directional indicator or a line), first object is associated with second object via a context; or first object is associated with second object via a verbal input or by any other suitable means. If no association with a second object is found, the process ends. If an association is found, the process goes to step 47.

Step 47: The software queries: “Is first object aware of its association with a second object.” This could mean that the software checks to see if a characteristic exists that enables context awareness for first object. As an alternate, the software checks to see if some function for said first object enables it to be aware of any association with another object and that said function is in an “on” state. If the answer to this query is “yes,” the software proceeds to step 48. If the answer is “no,” the process ends.

Step 48: The software queries: “Is the ‘transfer function’ set to ‘on’ for first object?” A transfer function is one of any number of names that can be given to this operation by a user via equivalents. [Note: equivalents enable a user to name any known operation in a system by any name that acts as the equivalent for said any known operation.] In step 48, the term “transfer function” means the ability for any object to transfer (apply) any one or more of the characteristics of said any object to update the characteristics of one or more other objects. Specifically, step 48 refers to the ability of said first object to update said second object with one or more characteristics of said first object. If the answer to this query is “no”, the process proceeds to step 49. If the answer to this query is “yes”, the process proceeds to step 50.

Step 49: The software checks to see if an association between first and second objects automatically activates the transfer function for said first object.

Communication.

There is another way to enable object awareness. It is defining context awareness as communication between objects. Consider steps 44 to 49 from the perspective of said second object. Further consider that steps 44 to 49 are being enacted for both said first object and said second object concurrently. In this case, both objects would be analyzing their relationship with each other. By this analysis both objects would be “aware” of each other. This awareness would include knowledge of the characteristics of each object by the other object, including whether either object can successfully share one or more of its characteristics with another object or utilize one or more of its characteristics to update the characteristics of another object. This would include determining whether a task of either object is valid for updating the other object. A task of one object could replace the task of another object or become the task of another object that contained no task. The processes that have just been described constitute a type of communication between two objects that can be bi-directional. This type of communication could be carried out between hundreds or thousands or millions of objects in a single environment or between multiple environments. Further, if two or more environments were communicating, then the objects that define those environments would be aware of each other and thus establish relationships. Therefore, said two or more environments would define a single composite Environment Media. Among other things, this level of communication is a powerful basis for supporting very complex scenarios applied to protocols in an Environment Media comprised of said hundreds or thousands or millions of objects, definitions or the equivalent, including objects that define other environments and other environments as objects, including Environment Objects and including locales.

Step 50: The software determines if a task exists for the first object. If the object is fader cap 31, of FIG. 5B, the task is controlling the setting 33, for function 32, but also the ability to move in a vertical orientation in free space to adjust setting 33, without being guided by fader track 30. If a task cannot be found, the process ends. If a task can be found the process proceeds to step 51.

Step 51: The software analyzes the characteristics of the second object.

Step 52: The software compares the characteristics of the second object to the characteristics of the first object.

Step 53: The software utilizes the analysis of step 52 to determine if the task of the first object can be applied to the second object. Let's say the second object is object 35, a vertical gray rectangle object with no task as part of its properties. In this case, the task of fader cap 31, would be valid for object 35, and could be added to the characteristics of object 35. If the task of the first object is valid for the second object, the process proceeds to step 54. If not, the process ends.

Step 54: The task of said first object, is added to the characteristics of said second object, such that it becomes the task for said second object. In this case, the task of both first and second objects would be the same.

Step 55: The software queries: are there any unique characteristics of said first object that are needed to support the task of said first object? If said first object is the fader cap 31, of FIG. 5B, there would indeed be unique characteristics needed to support the task of said first object. In part, the unique characteristics would include: the ability to move vertically in free space along a linear path; the ability to change setting 33, for function 32, without a guide object (e.g., fader track, 30); the ability to move vertically in free space controlled by a scaling, e.g., logarithmic, linear, route cosine and more; the list could go on. If there are no required unique characteristics, the process ends. If unique characteristics are required, the process proceeds to step 56.

Step 56: The software locates the unique characteristics required to enable the task of said first object, which is also now the task of said second object.

Step 57: The software adds the found unique characteristics of said first object to said second object to ensure that the task applied to second object from said first object can be successfully carried out by said second object.

Step 58: The process ends.

Invisible Programming Action Objects Controlled by Context in an Environment Media

Note: A PAO can be invisible or represented by a visible manifestation of any kind.

Referring now to FIG. 7A, an invisible PAO 2, 64, is being assigned to an invisible gesture object, 61. For the purposes of example only, invisible PAO 2, 64, is outlined by a light grey ellipse, 64A, so it can be graphically referred to in FIG. 7A. Invisible PAO 2, 64, is impinged by a line object 68A, that extends from PAO 2, 64, (the source object of line object 68A) to invisible gesture object 61, (the target object of line object 68A). A transaction for said line object 68A is determined by a context. Said context is the impingement of invisible PAO 2, 64, and invisible gesture object, 61, by line object 68A in the order: first impinge object 64, then impinge object 61. When the software detects the impingement of object 64, then object 61, by object 68A, the software sets the transaction of line object 68A, to be “assign the source object of line object 68A, to the target object of line object, 68A.” In summary, the transaction for line object 68A is “assignment.” The source object for object line 68A is invisible PAO 2, 64. The target object for object line 68A is the invisible gesture object, 61. The software determines if the “assignment” transaction for line object 68A is valid for objects 64 and 61. In other words, software determines if object 64 can be assigned to object 61. The software determines that the assignment of object 64, to object 61, is valid. As a result, the target end of line object 68A, changes its appearance to include a white arrowhead, 68B. White arrowhead 68B, is activated (e.g., by a finger touch—not shown) to cause the transaction of line object 68A, to be carried out. As a result, invisible PAO 2, 64 is assigned to invisible gesture object, 61. Note: when an object has an assignment to it, we call that object an “assigned-to” object. In FIG. 7B assigned-to object 61, is shown with its assignment PAO 2, 64, hidden. A logical question here might be: how does one assign an invisible object to another invisible object by graphical means? There are many methods to accomplish this. One method is to use a verbal command that can be any word or phrase as defined by a user via “equivalents.” Said equivalent can present a visible graphic that can be operated by a user or by software. Let's say object 64 was given an equivalent name by a user as: “show crop picture as video.” [Note: an equivalent can be any object.] A verbal command: “show crop picture as video,” could be uttered and the software could produce a temporary visualization of the invisible PAO 2, 64. Said visualization may simply be an outline, 64A, showing a location of invisible PAO 2, 64. Since PAO 2, 64, is a series of actions defined as a task, no visible representation is necessary for the utilization of PAO 2, 64. But a temporary visualization permits a user to graphically assign PAO 2, 64, to a gesture. Like PAO 2, 64, said invisible gesture object 61, does not require a visualization to be implemented, but gesture object 61, can also be represented by a temporary graphic shown as a dashed dotted ellipse, 61, in FIGS. 7A and 7B. The method to create said temporary graphic for invisible gesture 61, could be the same method used to present a temporary graphic for said PAO, namely, verbally state “show” followed by the name of invisible gesture, 61. Other methods for presenting visualizations for both invisible PAOs and invisible gestures could be via a menu selection, a gesture, activating a device, a context, a software configuration, a presentation according to time, and more.

Referring again to FIG. 7B, invisible PAO 2, 64 has been assigned to invisible gesture object 61, and the assignment to invisible gesture object 61, has been hidden. Upon the activation of invisible gesture 61, invisible PAO 2, 64, can be automatically activated. For instance, let's say a user moves their finger in an elliptical shape in free space. This finger movement could be detected by a camera recognition system or a capacitive touch screen, or a proximity detector, or a heat detector, or a motion sensor or a host of other detection and/or recognition systems. Once detected the shape of the finger movement (gesture 61, in FIG. 7B) could be recognized by software. In the example of FIG. 7B the gestural shape is an ellipse. The recognition of gesture 61 could cause the activation of gesture 61 and could therefore activate PAO 2, 64, which has been assigned to gesture object 61. However, it may not be valuable to activate the assignment of an object every time said object is recognized. A more valuable approach would be to control the activation of an object and its assignment via a context.

Before we address that, a more basic question needs to be addressed: “how does the software know to activate PAO 2, 64, upon the recognized outputting of gesture 61?” One method would be that the assignment of an invisible PAO to an invisible gesture object comprises a context that automatically programs an invisible gesture with a new characteristic. [Note: this behavior could be user-defined via any method disclosed herein or defined according to a configure file, pre-programmed software or any equivalent.] In FIG. 7A as a result of the assignment of PAO 2, 64, to invisible gesture object 61a new characteristic (not shown) is added to invisible gesture object 61. This characteristic is the automatic activation of PAO 2, 64, upon the activation of gesture 61. A modified characteristic would be the automatic activation of PAO 2, 64, such that the task of PAO 2, 64, is applied to the object impinged by gesture 61. In this latter case, the operation of a gesture can determine the target to which a PAO, assigned to said gesture, is applied. For instance, if a user outputs a recognized gesture to impinge a first video, the PAO assigned to said recognized gesture would be applied to said first video. If said recognized gesture is outputted to impinge a first picture, the PAO assigned to said recognized gesture would be applied to said first picture and so on. The automatic activation of the task or model or any action of any PAO that is assigned to any object is a powerful feature of this software. This enables user input, automated software input, context (and any other suitable means) to activate any object that contains a PAO as its assignment. The activation of any object would result in the automatic activation of the task, model, sequence, characteristics or the like contained in any PAO assigned to said any object. Further, the context in which said any object is outputted can determine the object to which the task of said any PAO assigned to said any object is applied.

Referring now to FIG. 7C, a second PAO 2, 65, is assigned to a second invisible gesture object, 62. As described in FIG. 7A, line object 68A, extends from object 65, to object 62. Upon the software's validation of the assignment of object 65, to object, 62, an assignment is completed. In the example of FIG. 7C, PAO 2, 65, is assigned to invisible gesture object 62. FIG. 7D illustrates assigned-to object 62, with its assignment (PAO 2, 65) hidden.

Referring now to FIG. 7E, Environment Media, 59, contains a picture, 60. In FIG. 7F, a hand 63, is moved in two gestures to form two shapes, a vertical ellipse and a horizontal ellipse. Upon recognition of said gesture shapes by the software, two invisible gesture objects, 61 and 62, are called forth to Environment Media, 59. As a result of the successful recognition of each invisible gesture object shape by the software, invisible gesture objects 61 and 62 are activated. As a result of the activating of invisible gesture object 61, invisible PAO 2, 64, is automatically activated. As a result of the activating of invisible gesture object 62, invisible PAO 2, 65, is automatically activated. As a reminder, and as shown in FIGS. 7A and 7C, gesture objects 61 and 62 each possess a characteristic that is the result of the assignment of PAO 2, 64, to gesture object 61, and the assignment of PAO 2, 65, to gesture object 62. Said characteristic provides for the automatic activation of PAO 2, 64, and PAO 2, 65, assigned respectively to gesture objects 61 and 62, upon the activation of said gesture objects 61 and 62.

Referring to FIG. 7F, the outputting of gesture object 61, over picture 60, is recognized by the software as an impingement of picture 60, by gesture object 61. Said impingement is a context that causes the task of PAO 2, 64, assigned to gesture object 61, to be applied to picture, 60. Also, the outputting of gesture object 62, over picture 60, is recognized by the software as an impingement of picture 60, by gesture object 62. Said impingement is a context that causes the task of PAO 2, 65, assigned to gesture object 61, to be applied to picture, 60.

Referring to FIG. 7G, gesture objects, 61 and 62, (no longer shown) have activated PAO 2, 64, and PAO, 65, respectively in Environment Media 59. PAO 2, 64, is now shown as a blank white vertical elliptical area, 64, to indicate that PAO 2, 64, is an invisible object. PAO 2, 65, is also shown as a white blank horizontal area, 65, to indicate that PAO 2, 65, is an invisible object. The size and proportion of the elliptical shape of PAO 2, 64, and PAO 2, 65, are determined by invisible gestures, 61 and 62, as illustrated in FIG. 7F. A characteristic of PAO 2, 64, and PAO 2, 65, is the ability to recognize a context that determines to which object the task of PAO 2, 64, and PAO 2, 65, shall be applied. The impingement of invisible gesture objects, 61 and 62, of picture 60, (shown in FIG. 7F) defines a context that is recognized by PAO 2, 64 and PAO 2, 65, and determines that the tasks of PAO 2, 64, and PAO 2, 65 are to be applied to picture 60.

Note: the two elliptical shapes, 61 and 62, of FIG. 7F could have been gestured in any size and/or proportion (as long as the proportion does not change an ellipse from a vertical to a horizontal position for gesture 61 and does not change an ellipse from a horizontal to a vertical position for gesture 62). Gestures 61 and 62 can be outputted via any suitable means, as long as the shape of each gesture is recognizable by the software. Suitable means includes: camera recognition systems, touch systems, wireless systems, brain activity response systems, holographic systems, hard wired systems, and the equivalent.

The invoking of a PAO does not require rendering an image that needs to be operated in a computer environment. Thus a PAO may remain invisible, but the result of the applying of its task to an environment or object can be visible. The operation of gestures (invisible, e.g., via a gesture, or visible, e.g., via drawing or other graphical operation) with PAOs assigned to them is fast and fluid. From a user's point of view, a user performs a gesture (e.g., by drawing, movement in free space, dragging, verbalizing) and one or more actions can be produced based on one or more contexts. [Note: the outputting of any gesture could be the result of software, (e.g., a pre-programmed condition, configuration, automated process, dynamic process or interactive process) as well as via a user input.]

An Environment Media Used to Produce an Action

The following is an alternate interpretation of FIGS. 7E-7G. In this interpretation, invisible gesture objects, 61 and 62, are Environment Media (“EM”). In FIG. 7F, two gesture shapes, 61 and 62, are outputted by motioning a finger above picture, 60. The software of this invention analyzes gesture shapes, 61 and 62, and searches for an Environment Media that is represented by, or has been made the equivalent of, or is in some way associated with said gesture shapes. In this example both gestural shapes are ellipses, a vertical ellipse, 61, and a horizontal ellipse, 62. [Note: The scope of the recognition of said gesture shapes can be determined by software. For example, vertical elliptical gesture shape, 61, could be required to be outputted within a percentage of a certain proportion, size or orientation. The rules of the recognition of said vertical elliptical gesture shape could be determined by a menu, configuration, context, user input, a combination of these factors, or via any equivalent.] If the software finds an Environment Media (“EM”) that matches an outputted gesture, (e.g., 61 and 62) the EM matching said outputted gesture is called forth by the software. [Note: Any EM can be assigned to any gestural shape or time scaled gestural shape and called forth by the outputting of said gestural shape in or to any computing system.] [Note: A time scaled gestural shape is a gesture whose function can be determined by the time in which it is outputted and/or the time it takes to output said gesture, or the rhythm of the outputting of said gesture. The use of “rhythm” means that the software considers the time it takes to output each part of a gesture. For instance, let's say gesture 61 is outputted by moving a finger in the shape of a vertical ellipse, as if the finger were “drawing” the ellipse in the air. The first part of gesture, 61, may be drawn fast, and then the next part of the ellipse may be drawn slower, and then the next part drawn at a different tempo and so on. The collective speeds of drawing said ellipse would comprise a rhythm, which can be interpreted by the software as a recognizable object.]

In the example of FIGS. 7E to 7G, the computing environment is Environment Media, 59. In this reinterpreted example of FIGS. 7E to 7G, EM, 61 and 62, are outputted to EM, 59. Note: The software of this invention supports any number of EM outputted to any number of EM and in any number of data and/or graphical layers. Therefore, one could output a second EM to a first EM and then output a third EM to second EM and output a fourth EM to third EM and so on. EM that can be called forth by a gestural shape can be readily and quickly utilized without menus, icons, or any windows structure. Consider gestural shape 61, that is outputted to EM, 59, in FIG. 7E. Consider EM, 59, to be on “computer system 1” in “location 1.” As the result of the outputting of gestural shape, 61, EM, 61, is called forth in EM, 59. Now consider outputting gestural shape 61, in another location, “location 2”, on another computer system, “computer system 2.” Said outputting of gestural shape 61, in computer system 2 will result in EM 61, being called forth to computer system 2. At this point EM 61, on computer system 2 will be able to communicate with EM 61, on computer system 1. It doesn't matter if EM 61, is outputted to an EM or to a non EM (any environment) on computer system 2, EM 61, on computer system 2 will still be able to co-communicate with EM 61, on computer system 1. Further, Environment Media, 59, on computer system 1, can include, EM, 61, on computer system 2 as part of EM 59.

This chain of communication can be continued by adding more computing systems. There is no limit to the amount of connected data within a single EM and there is no limit to the number of EM that can be managed, contained or otherwise associated with any EM. Referring again to FIGS. 7E to 7G, considering invisible gesture objects, 61 and 62, as Environment Media presents a powerful, yet easy to implement, method for a user. A simple gestural shape (e.g., outputted as a motion gesture, “invisible object,” or outputted as line or object “visible object”) can be outputted by a user to call forth an EM in any environment in any location.

In FIG. 7F, EM 61, is called forth in EM 59. EM 61, an invisible gesture object, impinges picture, 60. Software analyzes the characteristics of EM 61, and the characteristics of object, 60. Software determines that object 60 is a picture. Software finds an assignment to EM 61, PAO 2, 64. Software finds a first context which provides that the activation of EM 61 causes the assignment to EM 61, PAO 2, 64, to be activated. A second context is also found in the characteristics of EM 61, which determines that the task of PAO 2, 64, shall be applied to the object impinged by EM 61. The software determines that as a result of the existence of assignment PAO 2, 64, to EM 61, and the outputting of EM 61 to impinge picture 60, said first and second context are to be activated. Software activates both contexts. The software searches for a task contained in EM 61 that is valid for picture 60. The task of PAO 2, 64, is found to be valid. The software applies the task of PAO 2, 64, to picture 60.

Referring now to FIG. 7G, PAO 2, 64, contains a task that is defined according to the states and change recorded in a motion media from which PAO 2, 64, was derived. The elements of said task of PAO 2, 64, that modify picture 60, are described below.

Action 1: A segment of picture, 60, is cropped. The cropped area of picture, 60, is equal to the surface area and shape of EM, 61.

Action 2: Said cropped area 66, of picture 60, is rotated at a rate and direction set by one or more characteristics of PAO, 64. Let's say that this rate is one 360 degree clockwise rotation per 2 seconds.

Action 3: An input is required to determine the orientation of said 360 degree rotation of cropped picture segment, 66. Therefore the software waits for an input that presents an angle of orientation. Let's say that a characteristic of PAO 2, 64, determines that there can be only two orientations: vertical or horizontal. Let's say the orientation “horizontal” is input to the software. [Note: There are many possible inputs that would define a rotation orientation for object 66. This includes: user input, context, pre-programmed input, input according to a configure setting, input according to timed or sequential data]

Summary of Reinterpreted FIGS. 7E-7G.

[Note: Gesture 61 and EM 61 share the same location and shape in FIG. 7F. Thus they are referred to by the same number, 61.] When gesture 61, (an equivalent for EM 61) is outputted to EM 59, EM 61 is called forth to Environment Media 59. The recognition of gesture 61, by the software activates EM 61. As a result, the assignment to EM 61, PAO 2, 64, is activated. Further, the impinging of picture 60, by EM 61, produces a context which is recognized by EM 61, and/or by EM 59. As a result of the recognition of this context, EM 61 applies the task of PAO 2, 64, to picture 60. Further as a result, PAO 2, 64, automatically crops a segment 66, of picture 60, and generates a motion media that horizontally rotates said picture segment 66, in a clockwise fashion at a speed of one 360 degree rotation per 2 second time interval.

The same process applies to EM 62, which also impinges picture 60. As a result, EM 62 calls forth PAO 2, 65, which automatically crops a segment 67, of picture 60, and generates a second motion media. Said second motion media vertically rotates said picture segment 67, at a rate and orientation set by the characteristics of PAO 2, 65.

Referring now to FIG. 8, this is a flow chart illustrating a method that activates the task of a PAO via a recognized context in an Environment Media. Note a PAO can have many different relationships to an Environment Media that are not dependent upon said PAO being assigned to an Environment Media. For instance a PAO could be applied to any object that is part of an Environment Media. The applying of said PAO to any object in an Environment Media would establish a relationship between said PAO and said any object. This relationship would establish said PAO as part of said Environment Media.

Step 69: A gesture has been outputted to an Environment Media 1. A gesture could be many things, including a hand or finger movement, a movement of a physical analog object that is recognized by a camera-based digital recognition system, a movement of a pen in a capacitive touch screen or camera-based recognition device, drawing something, dragging something, a verbal utterance, manipulating a holographic object, the outputting of a thought to a thought recognition system, and more.

Step 70: The software attempts to recognize the gesture outputted in step 69. The recognition of said gesture could be via many means, including in part: the analysis of the shape of said gesture, the analysis of the speed of the outputting of said gesture, and/or the rhythm of the outputting of said gesture. If the software recognizes the outputted gesture, the process proceeds to step 73. If not, the process proceeds to Step 71.

Step 71: The software looks for a context that is associated with said outputted gesture. The reason for this is that if the software cannot recognize said outputted gesture with certainty, finding a context may further enable the software to establish a reliable recognition of said outputted object. Certain gestures may tend to be associated with certain contexts. Said contexts could include, the speeds of the outputting of said outputted gesture, the location, impingement of other objects, assignments of objects to said outputted gesture and more.

Step 72: If any one or more contexts are found, the software utilizes said contexts to enable successful recognition of said outputted gesture.

Step 73. A “yes” answer to Step 70 and a successful discovery and use of context in Step 72 result in the process proceeding to Step 73. In Step 73 the software confirms that a second Environment Media, “Environment Media 2” is associated with the recognized outputted gesture of Step 70. Stated another way, the software determines that said outputted gesture can call forth a second Environment Media, “Environment Media 2.”

Step 74: The software outputs Environment Media 2, found in Step 73 to Environment 1.

Step 75: The software determines if a PAO is associated with Environment Media 1. If “yes,” a to Step 76. If “no,” the process ends at Step 81.

Step 76: The software finds all actions that can be activated by said found PAO of Step 75. Note, said all actions may represent more than one task and could be organized according to multiple categories.

Step 77: The software determines that one or more actions of said PAO can be triggered by a context.

Step 78: The software determines that the context which triggers one or more actions of said PAO exists in said Environment Media 1.

Step 79: The software determines that said context is recognized by said PAO or by Environment 2.

Step 80: The software activates said one or more actions of said PAO that are triggered by said context.

Step 81: The process ends.

Programming Context-Based Actions

One way to program context-based actions is with object equations. This is both a consumer and a programmer methodology. Valuable elements in object equations are motion media equivalents. FIGS. 9A-9C depict the creation of a motion media to define a task, which can be used in an object equation. The creation of motion media is a powerful programming tool. If a user wishes to define a series of steps in performing a task, the user can simply perform a series of steps and record them as a motion media. The software can analyze said motion media and derive a task and the required series of steps to perform said task from said motion media. Regarding object equations, the name of a motion media or any equivalent name, object, gesture, verbalization, picture, video, and the like, can be used as an element in an object equation. An object equation can be used to define one or more tasks or used to program one or more objects, including Environment Media.

FIGS. 9A and 9C depict a series of steps that are recorded as motion media, 82. The recording of a motion media 82 is initiated by any means described herein. In FIG. 9A an elliptical object 83, is outputted to impinge a picture 60A. FIG. 9B is an example only of the utilization of an object to crop a segment of a picture. Object 83, is touched and held for 1 second then cropped segment 84, of picture 60A, is moved off. Said cropped segment 84, of picture 60A, equals the size and proportion of object 83. FIG. 9C illustrates an alternate method of cropping picture 60A, with object 83. In FIG. 9C elliptical object 83, is used to crop a segment of picture 60A, such that said cropped segment of picture 60A, matches the shape and surface area of object 83. [Note: In FIG. 9A, object 83, is shown as it would appear to a user, namely, an outline or wireframe. In FIG. 9B, object 83, is shown as it appears to the software, namely a solid object.] The ability to enable the entire surface of object 83, (even though to a user it appears as a wireframe) to be used to crop a segment 84, of picture 60A, is determined by one or more characteristics of object 83. These characteristics can be easily programmed by a user with no software programming experience. More about this later.

Referring now to FIG. 9C (and 9B), object 83, is used to crop a segment 84, of picture 60A. The crop method used in the example of FIG. 9C is as follows. Object 83, is touched. A verbal command: “Crop in place,” or any equivalent command is spoken. The software crops a segment 84, of picture 60A. Said segment 84, is equal in size and proportion to object 83, and cropped segment 84, is positioned in the exact location as object 83. [Note: cropped segment 84 is pictured in FIG. 9C as an offset to the position of object 83. This is only to enable a reader to better see cropped segment 84. In the actual crop performed in FIG. 9C, there would be no offset of cropped segment 84 compared to picture 60A. Cropped segment 84, perfectly matches the position of object 83.] The recording of motion media 82 is stopped and the software automatically names and saves motion media 82. Not shown.

Referring now to FIG. 9D, the newly created motion media, which recorded all elements and change depicted in FIGS. 9A and 9C, has been named: “Motion Media 1234”, 85, by software. Further, the motion media name 85 is an object. As an object, motion media name 85, can be used directly in an object equation as an equivalent for motion media 82. Accordingly, the use of motion media name 85 can be used to define one or more actions or tasks or create one or more equivalents of motion media 82. [Note: for purposes of discussion, motion media 82, shall be referred to as either 82 or 85.] FIG. 9D illustrates an object equation that creates two equivalents of motion media, 82: (1) object 86, “PATTERN CROP 1”, and (2) a triangle object 87. Note: an equivalent can be used as a replacement for the object of which it is an equivalent.

The equation of FIG. 9D can be typed, verbally spoken or inputted via any suitable means. Such means could include writing a script or programming software code. But a key idea of object equations is to remove the need for writing software by conventional programming means. Virtually any user could create object equations (with or without motion media equivalents) for any operation, including complex operations. The use of motion media in object equations is a powerful shortcut to defining operations. This is because with the use of motion media a user can create the elements that define one or more tasks simply by performing a task and recording that task as a motion media. [Note: creating an equivalent for said motion is optional, but it makes the utilization of one or more motion media in object equations easier to manage. Simply put, the use of an equivalent (especially a short equivalent, like triangle object, 87) makes it easier to utilize motion media in an object equation.]

There are many methods to utilize a motion media in an object equation. Two of these methods are: (a) utilize a motion media directly in an object equation, and (b) utilize a PAO 1 or PAO 2, which are derived from a motion media, in an object equation.

Method 1: Utilization of a Motion Media in an Object Equation.

The utilization of one or more motion media directly in an object equation can include placing the name or equivalent of a motion media directly into an object equation. Examples would include placing “Motion Media 1234”, 85, or “PATTERN CROP 1”, 86, or triangle object 87, directly into an object equation. If a motion media (or its equivalent object) is incorporated directly in an object equation, the software of this invention analyzes said motion media to determine the task of said motion media and/or the steps required to perform said task, and then applies said task and/or steps literally or as a “model” (which can contain one or more model elements) to an object equation. [Note: the software could directly apply the steps of a motion media, which is used in an object equation, to the object equation, but the result may be narrower than applying a model of said motion media to the object equation.] Thus the use of a model is important because it can broaden the scope of a motion media task. For instance, if a very narrow interpretation of motion media 85 were utilized, only an ellipse matching the shape of the ellipse recorded in said motion media could be used to crop a segment of picture 60A. But if a broader model of said motion media were used, any object of any size or shape could be used to crop a segment of any picture. Thus in a general sense a model has higher utility than a strict interpretation of the task and steps required for the implementation the task of a motion media. [Note: if a motion media is utilized in any object equation, the software can save the analysis and/or modeling of said motion media to a storage device or media and refer to it again as needed for use in other object equations.]

Method 2: Utilization of a PAO 1 or PAO 2, Derived from a Motion Media, in an Object Equation.

If a PAO 2, derived from a motion media, is utilized in an object equation, the software of this invention, can perform at least one of the following operations: (a) apply the steps required to perform the task of said PAO 2 to the object equation, or (b) apply a model, including model elements, to the object equation. Any object equation can be an Environment Media. Object equations of any complexity can be Environment Media which themselves can be represented by any object, including: a line, picture, video, website, text, BSP, VDACC, drawing, diagram, document, and the equivalent. Further, if any element of any Environment Media equation is copied or recreated, said copied or recreated element can be used to modify the Environment Media equation from which said element was copied or recreated. Further, said copied or recreated element can be used to modify said Environment Media equation from any location. Known Words. The software of this invention recognizes “known words.” Known words are objects that are understood by the software to invoke an action, function, operation, relationship, context, or the equivalent, or anything that can be produced, responded to or caused by the software of this invention. Users can use object equations to create equivalents for any known word. Referring to FIG. 10, a known word, “Picture,” 88, (meaning any type of picture) has been outputted, then followed by an equal sign 89, which is followed by the text, “Pix”, 88A, which is followed by another equal sign, 89, which is followed by a graphic rectangle 88B, impinged by a letter “P,” 90. Note: An object comprised of two or more objects can be referred to as a composite object. Thus the combination of object 88B and 90 comprises a composite object. As a result of the equation of FIG. 10, two equivalents are created for the known word “Picture,” 88: (1) “Pix,” 88A, and (2) a black rectangle, 88B, with a letter “P”, 90, impinging rectangle, 88B. Any equivalent of the word “Picture,” 88, can be used in an object equation. In this example the use of the equal sign 89, denotes the creation of an equivalent. The object to the right of the equal sign 89 becomes the equivalent of the object to the left of the equal sign 89. In one application of equivalents, the software automatically separates text strings (e.g., sentences) into individual text objects which are determined by the placement of equal signs 89, in said text string. For example, if a user types a continuous string of text starting with a known word, followed by an equal sign, following by any word or phrase, said word or phrase will become an equivalent and, as an equivalent, be considered an independent text object which is not part of the original text string from which it was created.

Referring to FIG. 11, the known phrase, “Any Type,” 91, has been followed by an equal sign 89, and then followed by the text, “AT,” 92. Thus the text, “AT,” 92, becomes the equivalent for the known phrase, “Any Type,” 91, and has the equivalent meaning of said known phrase “Any Type,” 91.

FIG. 12 is an example of the creation of the equivalent, “JTT”, 94, for a known phrase: “Just This Type”, 93. This equivalent can be applied to any object used in an object equation (including any Environment Media equation) to limit the types of objects or data to only the type of the current object used in said equation. For instance, let's say a .png picture with transparency is used in an object equation. By annotating said .png picture with the equivalent, “JTT,” the use of said picture would be limited to any .png image that has transparency. This would include any .png cropped image with a transparent background. But it would not include .jpg or .eps or .gif or any other type of picture.

Annotating Entries in an Object Equation.

There are many methods to annotate or add modifier comments to any entry in an object equation. Three of them are listed here. A first method would be to impinge an existing equation entry with a modifier object. This could be accomplished by drawing means, dragging means, verbal means, gesture means, context means, or the equivalent. A second method would be to output any modifier object to the environment containing an equation, and draw a line that connects said modifier to an entry in an equation. A third method would be to touch an entry in an equation and then verbally state the name of one or more modifiers.

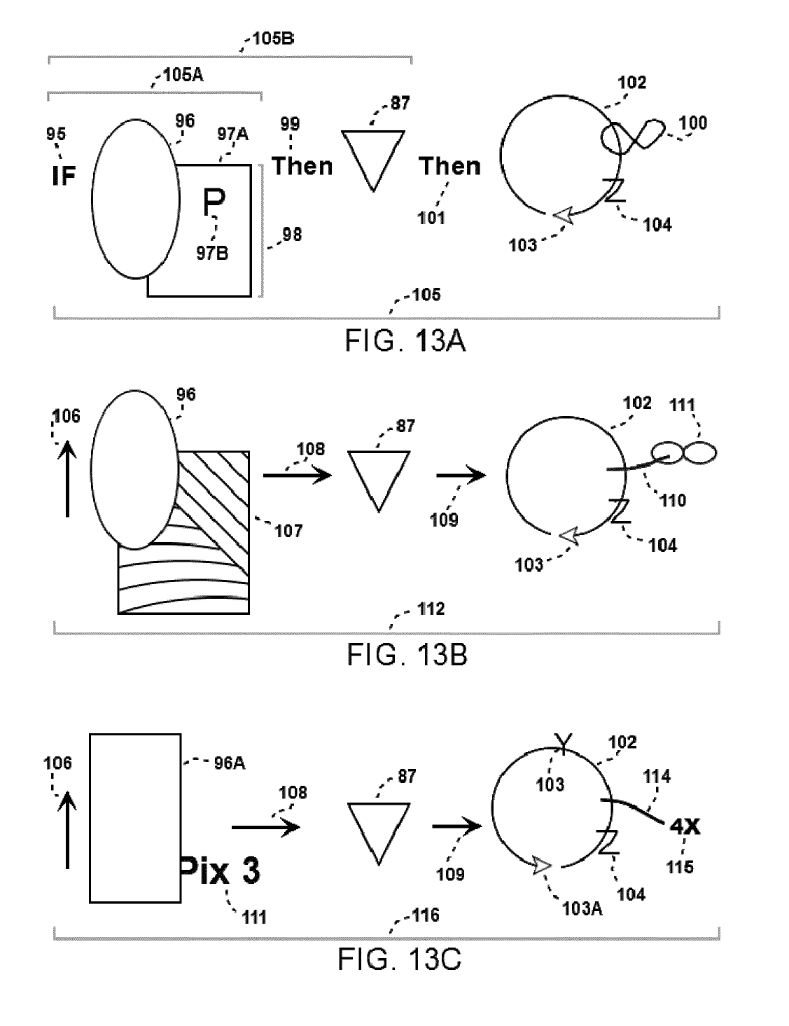

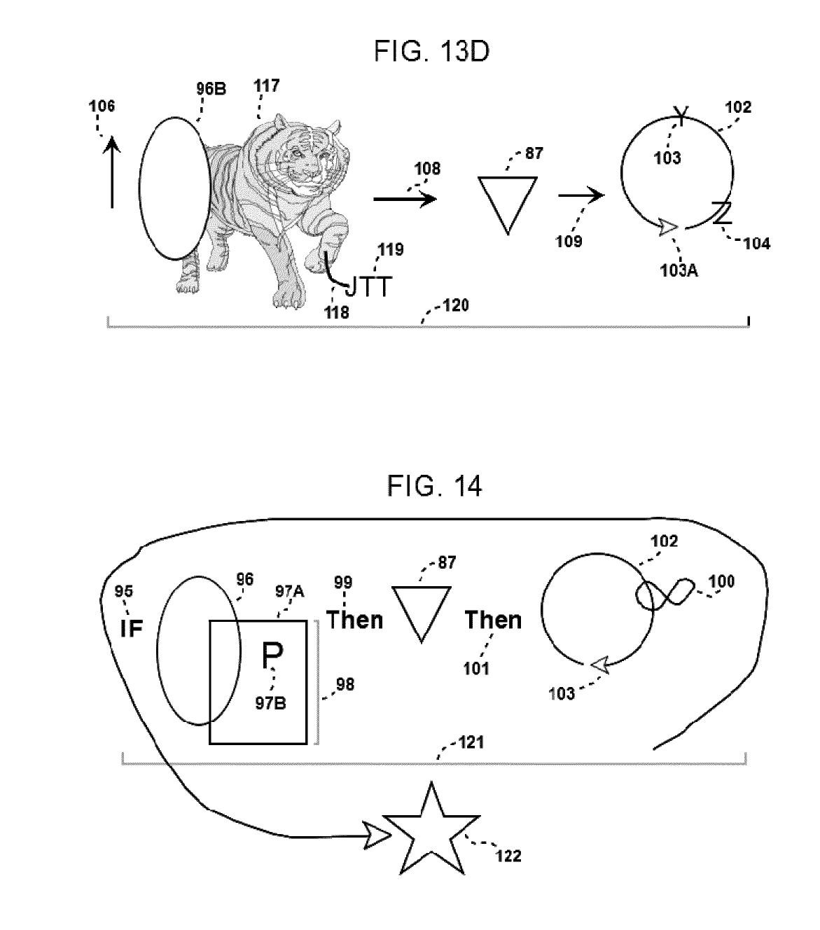

Referring now to FIG. 13A, this is an example of an object equation 105 that includes an equivalent for a motion media. The general logic flow of equation, 105, is: “If,” “Then,” “Then.” The entry “IF,” 95, is followed by two objects, 96 and 98. Rectangle object 97A, impinged by text object 97B, comprises a composite object 98, which is the equivalent for any picture. [Note: an equation creating this equivalent is shown in FIG. 10.] The software of this invention permits what we call “agglomeration.” Agglomeration is the ability for the software to recognize a first object and then recognize a second object that modifies said first object, such that the combination of said first and said second object comprise a single recognized composite object. By this method, rectangle 97A, combined with text object 97B, results in the software recognition of composite object 98, which in FIG. 10 is an equivalent for any type of picture, e.g., .png, .jpg, .gif, .eps, and so on.

Further regarding FIG. 13A, ellipse object 96, impinges composite object 98. Object 96 and composite picture object 98 are placed after text object 95 and before text object 99, thereby defining a context, which we refer to as “Context 1A”. Context 1A is further defined by the layering of object 96, over object 98. One description of Context 1A is: “A graphic object impinges a picture that is on a layer under said graphic object.” If we were to represent the first section 105A, of object equation 105, of FIG. 13A, as a logic condition, it would be: “If a graphic object impinges a picture object, which exists on a layer below said graphic object, then . . . ” Note: section 105A of object equation 105 defines the context which permits object 61, to designate object 60 as the programming target for PAO 2, 64.

There are many methods to apply the recognition of Context 1A to the remaining sections of equation 105. In a first method, if Context 1A is recognized by the software, the software looks to one or more of the remaining objects of equation 105, for a definition of one or more actions. In a second method, if the software recognizes Context 1A, object 95 communicates this recognition to object 99, which looks to one or more of the remaining objects of equation 105, for a definition of one or more actions. Said second method, operates equation 105 as an Environment Media that is defined by the relationships between the objects in equation 105. In a third method equation 105, operates as an independent Environment Media. One of the characteristics of said independent Environment Media is the ability to recognize the context defined by objects Context 1A. Another characteristic of said independent Environment Media is the ability to communicate to each object member of an equation. A further characteristic of said independent Environment Media is the ability to recognize a set of relationships that define an equation object. In said third method, Environment Media 105 recognizes Context 1A and communicates this recognition to the objects whose relationships comprise equation, 105.

The next object in equation 105 is a text object, “Then”, 99. A logic statement derived from the objects in section 105B of equation 105 could be: “‘If’ any object impinges any picture, ‘Then’ object 87 is enacted.” Object 87, is an equivalent for motion media 82, as illustrated in the example of FIGS. 9A and 9C. As a reminder, motion media 82 was named “Motion Media 1234,” 85, by software in FIG. 9D. Motion Media 82, shall now be referred to as Motion Media 85. Motion media 85, contains the necessary steps to enable an object to crop a picture. [Note: The cropping action of PAO 2, 64, in FIG. 7G, could be programmed by the presence of object 87, in equation 105.]

The next object in equation 105 is a text object, “Then,” 101. This object enables a modification and/or further defining of the action (task) of motion media, 85, represented by equivalent object 87. Object 102, is a circular line with an arrowhead, 103. The orientation of said arrowhead 103, determines a clockwise direction. The circular line 102, combined with said arrowhead 103, defines a clockwise rotation. Object 104, a letter “Z”, impinges object 102 and thereby defines the axis of clockwise rotation, namely, along the Z axis. Object 100, an infinity symbol, defines a number of rotations, namely, unlimited. In other words the rotation defined by objects, 102, 103 and 104 is continuous. This definition of rotation modifies the task of motion media 85, presented in equation 105, by the equivalent, 87. A statement of the logic conditions of equation, 105, could read as follows:
“If a graphic object is outputted to impinge a picture object, this defines a context. Said context determines the type of object that will be cropped according to the task defined in “Motion Media 1234.” Said motion media task causes the cropping of a segment of said picture object equal to the size and shape of said outputted graphic object. Further, said segment of said picture object shall be rotated continuously in a clockwise direction along the Z axis.”
   Equation 105 is a much simpler way to describe the same set of conditions.

Referring now to FIG. 13B, an equation 112, is shown, which presents the same general logic flow as equation 105. The differences are as follows. Instead of “IF”, “Then” objects, arrows are used. Vertical arrow 106, denotes an “IF” function and horizontal arrows 108 and 109, denote “Then” functions. Object 107, is a picture that serves the same function as composite object 98. Object 96 impinges object 107, to define Context 1A for equation 112. Regarding object 102, object 100, has been replaced with an equivalent, object 111, to define continuous rotation.

Referring to FIG. 13C, equation 116, contains a text object “Pix 3,” 111, which is an equivalent for any picture type. Object 96A, impinges picture equivalent 111, to define the same context, Context 1A, as presented in equations, 105 and 112. Object 102, defines rotation. Object 103A, defines a counter-clockwise rotation. Object 104, determines said counter-clockwise rotation to be along the Z axis. Further, an additional object 103, further defines said counter-clockwise rotation to also be along the Y axis. Finally, object 115 is connected to object 102, via an outputted line 114, which extends from object 115, to object 102, thereby enabling object 115 to modify object 102. As a result, object 115 limits the number of rotations of object 102, to four.

Referring now to FIG. 13D, object 96B, impinges a .png image 117 that contains a transparent background. Object 117, exists on a layer below object, 96B. Object 117, is modified by object 119. Line 118 extends from object 119, to object 117, enabling object 119, to modify object 117. The impingement of object 117, with object 96B, defines a context. We'll refer to this context as, “Context 1B.” Object 119, is an equivalent for a known phrase, “Just This Type.” In this example, the phrase, “Just This Type” limits Context 1B of equation 120, to the use of a .png picture that contains a transparent background. Thus, impinging a .jpg or .eps or other picture format with object 96B, would not produce Context 1B, defined by equation 120.

Regarding object 102, in equation 120, there is no modifier directly determining the number of counter-clockwise rotations defined by object 102, 103A, 103, and 104. In an attempt to determine the number of counter-clockwise rotations, the software analyzes object 102 and all objects that modify object 102. If any characteristic is found that defines the number of counter-clockwise rotations, said any characteristic will control the number of rotations. If no characteristic is found, then the number of rotations will be according to another factor, e.g., a configure setting or default setting.

FIG. 14 illustrates the assignment of an Environment Media equation 121, to a star object 122. It should be noted that any Environment Media Equation can be assigned to any object. Environment Media equation 121 includes the following: (1) a context, defined by objects 95 and composite object 98, (2) an equivalent 87, which equals “Motion Media 1234,” which equals motion media 82, of FIG. 9C, and (3) objects 102 and 103, modified by object 100, which collectively define a continuous counter-clockwise rotation of a cropped segment defined by motion media equivalent 87. It should be noted that Environment Media equation 121 does not include a determination of an axis for said counter-clockwise rotation.

A key value of assignments is that any implementation or activation of an “assigned-to object,” (namely, an object to which another object has been assigned) can be controlled in whole or in part by one or more characteristics of said assigned-to object. For example, let's consider object 122, a star object. Environment Media equation 121 has been assigned to it. Object 122, at least in part, could determine the activation of its assignment 121 or a context could determine this. For instance, object 122 could possess a characteristic (“auto activate”) that causes the automatic calling forth and activation of equation 121 when object 122 is activated by any suitable means. Thus an activation of object 122 possessing an “auto activate” characteristic would result in the automatic activation of Environment Media equation 121. An example of a context that could automatically activate object 122 would be incorporating object 122, (and Environment Media equation 121 as its assignment) in a second Environment Media equation (“2^{nd} Equation”). In this context object 122 would establish a relationship with one or more objects that comprise 2nd Equation. Part of this relationship would be the ability of object 122 to communicate with one or more objects that comprise 2nd Equation. This communication would modify said 2^{nd} Equation. With object 122 being a member of 2^{nd} Equation, the assignment to object 122, namely, Environment Media equation 121, would automatically become part of the information that defines said 2^{nd} Equation.

It should be further noted that any number of Environment Media Equations can be utilized in a single Environment Media Equation. This utilization is more easily facilitated by using objects to which Environment Media Equations have been assigned, inasmuch as assigned-to objects can replace a potentially complex and large set of objects comprising an object equation with a single very manageable object.

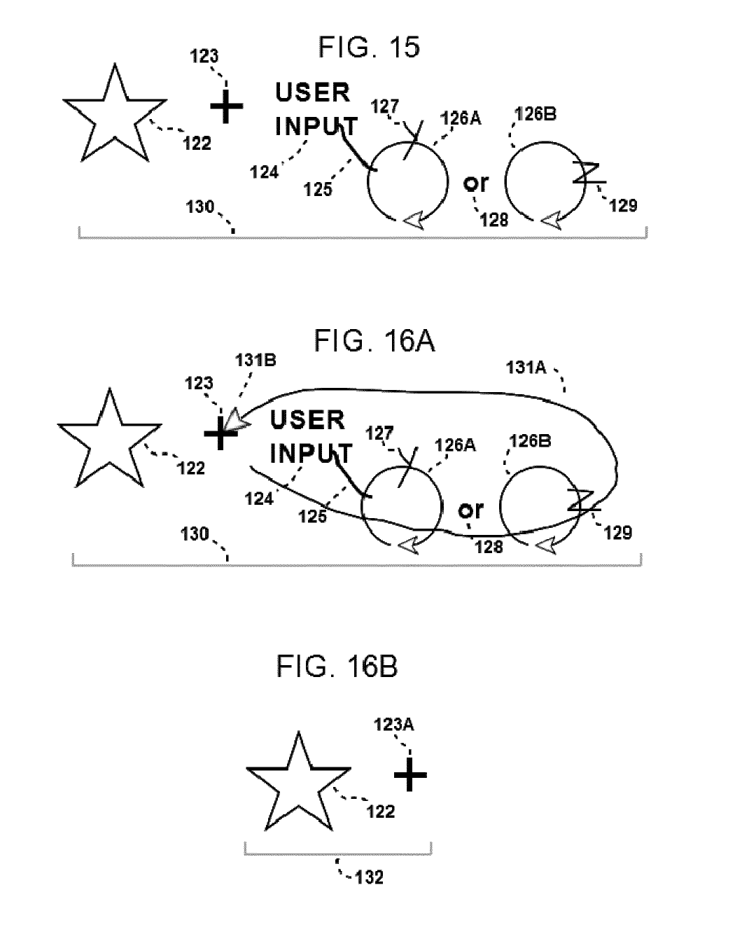

Referring now to FIG. 15, this illustrates the use of assigned-to object 122, as an element in Environment Media Equation 130. In equation 130, object 122, is an equivalent for Environment Media Equation 121, which defines a context and various actions as shown in FIG. 14. As a reminder, in Environment Media Equation 121, there is no definition for the axis of rotation defined by object, 102. Referring again to FIG. 15, Object 123, “+”, enables additional information to be appended to object 122. A phrase known to the software, “USER INPUT”, 124, has been entered into equation, 130. Object 126A, defines a clock-wise rotation. Object 127, defines the orientation of said clock-wise rotation to be according to the Y axis. Alternate object 126B also defines a clock-wise rotation. Object 129, defines the orientation of the clock-wise rotation defined by object 126B, to be according to the Z axis.

Object 128, “or” provides for an “either/or” condition, which applies to objects 126A and 126B. In equation 130, it is “either” the defined functionality of object 126A, “or” the defined functionality of object 126B. A line, 125, extends from object 126A to object 124. Object 125, enables objects 126A “or” 126B to modify object 124. One result of equation 130 is that a user input is required to determine the axis for the rotation provided for in Environment Media Equation 121, which contains no axis of rotation. There are only two choices presented in equation 130: (1) rotation along the Y axis, and (2) rotation along the Z axis. The type of user input is not defined therefore said type could be any input that can be received by the software.

Organization of Environment Media Equation Entries

The objects in an Environment Media Equation communicate with each other and are therefore not bound by rules of a program or other organizational structure. The objects and the relationships between said objects that comprise an Environment Media Equation can be in any location. Stated another way, the conditions and/or logical flow of any Environment Media Equation can be determined by the communication between its objects, regardless of their location. User input can be used to amend said conditions and/or logical flow, but it is not a requirement. Further, any one or more objects in an Environment Media Equation can be assigned to any object in an Environment Media Equation. One benefit is to simplify the size of said Environment Media Equation.

As an example, refer to FIG. 16A. Here all elements of object 124, “USER INPUT,” are assigned to object 123, “+”. Directional indicator 131A, is drawn to encircle objects 124 through 129 (“all objects”), and is then pointed to object 123. A user input activates the arrowhead 131B, of said directional indicator and the software completes the assignment of “all objects” to object 123. FIG. 16B shows the result of the assignment of said “all objects” to object 123. “All objects” have been hidden and the only visible object is the assigned-to object 123. This process greatly simplifies the Environment Media Equation 130, in FIG. 16A, as Environment Media Equation 132, in FIG. 16B. FIG. 16B presents the Environment Media Equation 130, of FIG. 16A, in a much simpler form, namely, as just two objects, 122 and 123A. Note: as previously mentioned one of the methods to activate an assigned-to object is via a context. The use of assigned-to object 123A, as an entry in Environment Media Equation 132, constitutes a context that enables the functionality defined by object 123 and object 124 (which is assigned to object 123) to be communicated to other objects in said Environment Media Equation, 132. In the case of the example of FIG. 16B, said communication can be to any or all of the objects in Environment 121, which is represented in Environment Media Equation 132, as object, 122.

Environment Media Equations as Security Devices

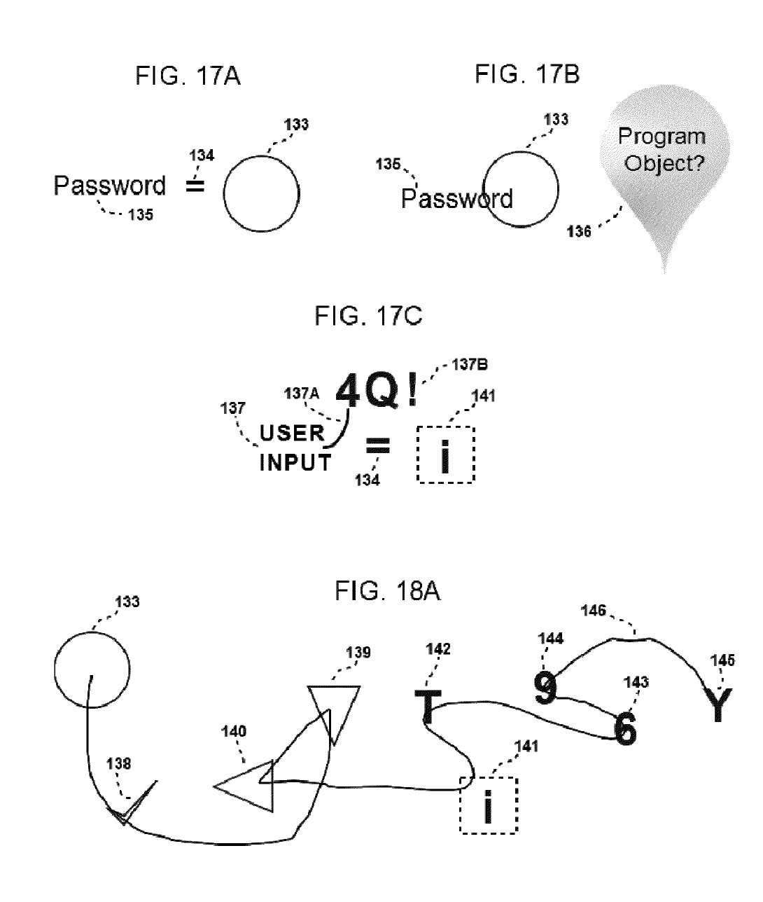

Referring to FIG. 17A, this is an Environment Media equation that creates an equivalent for the known word “Password”, 135. Known word “Password,” 135, has been outputted to a computing system. A text object, “=”, 134, (also known to the software) has been outputted and placed such that it impinges object, 135. Note: the maximum distance permitted to define an impingement can be set by many means, including: via a configure file, as a default, via verbal means and more. The software recognizes the word “Password” and all functions, actions, operations, and the equivalent that are part of the characteristics of Password object, 135. One action defined by one or more characteristics of the object “Password,” 135, is the ability for Password 135, to program any object that it impinges. Another action defined by one or more characteristics of the object Password 135, is that it can program objects that it impinges with the ability to become part of a collective of objects that comprise a single composite password that be used to protect (encrypt) any characteristic of any object. In FIG. 17A, object 133, is outputted in a location that impinges object 134. As a result, object 133, becomes the equivalent for object 135. Thus object 133, is programmed to be a password with the ability to convert any object that is impinged by object 133 to a password. In addition, object 133 is programmed with the ability to cause any object that it impinges to become part of a collective of objects that comprise a single composite password.

FIG. 17B illustrates an alternate method of programming object 133, to be a password. Object 135, is outputted to impinge object 133. An input is required to complete the programming of object 133. Many different inputs can be used to activate object 136, including: a verbal input, drawn input, touch input, automated software input and more. If object 136, receives an input, this activates the programming of object 133 with object 135. As a result object 133 is programmed as a password with the properties described in the above paragraph.

FIG. 17C illustrates an object equation with a modifier object that results in the creation of an equivalent object. Object 137, is a known word phrase, “user input.” Line object 137A, is outputted to extend from object 137B, to object 137. As a result, object 137B, becomes a modifier for object 137. In this example, line 137A, causes 137B, “4Q!” to become an assignment of object 137. Said assignment modifies the action for “USER INPUT,” 137. Said modified action is the outputting of a composite text object, 137B, according to a “show assignment” function, when object 137, is activated.

Object 134, a known character to the software, is outputted to impinge object 137. Object 141, is outputted to impinge object 134. As a result, object 141, is programmed to be an equivalent of object 137, including its assignment 137B, “4Q!” Thus, object 141, can be activated to show the assignment, “4Q!”, 137B. Referring specifically to object 137B, this is a composite object that contains three individual objects, a “4”, a “Q” and a “!”. It should be noted that at any time an input can be used to modify any of the said three individual objects comprising composite object 137B. For example, an input that activates object 141 would cause assignment object 137B, to be presented in an environment as “4Q!” Then one or more user inputs can be used to alter the characters of object 137B, or add to them. For instance, “4Q!” could be retyped to become any set of new characters, e.g., “5YP”, or new characters could be added to the existing assignment, e.g., “4Q!PVX#”, and so on.

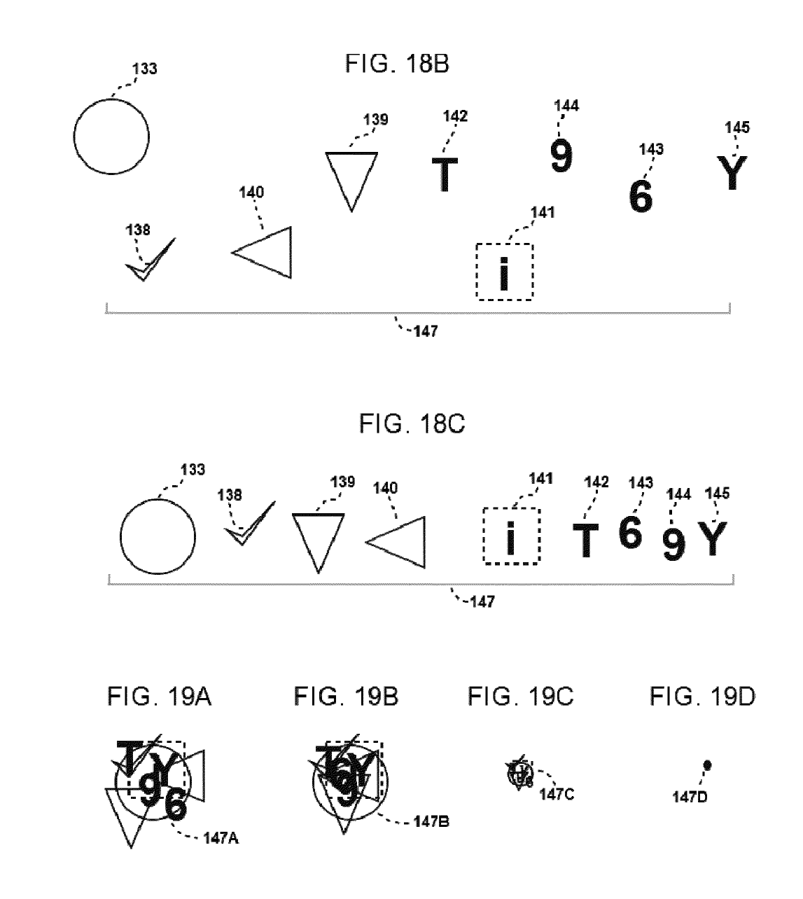

FIG. 18A shows a series of objects, 138 to 145, which are impinged in a sequential order by object 133, which is moved along path 146. Referring again to FIG. 17A, object 133, was programmed as the equivalent of known word: “password”, 135. As a result, the unique characteristics of said known word 135 have been added to the characteristics of object 133. Referring again to FIG. 18A, the order that objects, 138 to 145, are impinged by password equivalent object 133, along path 146, determines the order of objects, 138 to 145, in password object 147, as shown in FIG. 18B. Referring again to FIG. 18A, a sequential number is added to the characteristics of objects 138 to 145, according the order that each object is impinged by object 133. One approach to accomplish this is to label object 133 as “1”, then object 138 becomes “2” and object 140 becomes “3” and so on. Said sequential number for each object, 133-145, determines the entry position of each object in password 147. In addition, a location designation is added to the characteristics of each of said nine objects that comprise password 147. More about this later.

FIG. 18B shows the eight objects that were impinged by object 133 in FIG. 18A. All nine objects in password 147 have a relationship to each other, and support the task: “password.” Therefore, said nine objects comprise an Environment Media, which is a password. [Note: For purposes of discussion, password 147, shall sometimes be referred to as “Environment Media 147” or “object password 147” or “Environment Media password 147” in this document.] Each object, 133 and 138 to 145, pictured in FIG. 18B, share a relationship to the function “Password.” Further, each of the objects pictured in password 147, (also to be referred to as Environment Media Password 147) can communicate to each other, regardless of their location. As previously explained, locations of objects that comprise an Environment Media can exist in any location. This includes any digital object, device, computing system, and/or physical analog object, (“object-structure”). In addition, locations of objects that comprise an Environment Media can exist between multiple object-structures. Further said multiple object-structures can exist in multiple physical locations, including anywhere in the physical analog world (e.g. country, home, office, car) and, in the digital domain (e.g., server, cloud infrastructure, website, intranet, internet) or any other location. These facts form the foundation for the utilization of the objects that comprise an Environment Media password for a unique security coding system.

For reference, FIG. 18C shows the objects that comprise Environment Media Password 147 in a linear fashion. This is a typical and expected presentation of a password in existing computing systems. However, since Environment Media Password 147, is comprised of objects that can communicate to each other, the presentation of the password objects of password 147 is not confined to a linear order or list.

Objects in an Environment Media equation “know” what their order is and can communicate that order to each other regardless of where they are. FIGS. 19A to 19D are further examples of this. In FIG. 19A all nine objects that comprise password 147, are juxtaposed over each other as a new layout 147A, of password 147. One can still make out the individual objects, but there is no way to determine the sequential order by visual inspection. FIG. 19B shows a tighter juxtaposition 147B, of the nine objects comprising password 147. Here some of the objects obscure each other, making it harder to determine what all of the objects are, and of course, there is no way to determine the sequential order of said objects by visual inspection. FIG. 19C shows a much tighter and size reduced layout 147C, of password 147. Under magnification it may still be possible to decipher some of the objects that make up password 147C, but again the sequential order cannot be determined. Finally in FIG. 19D, it is neither possible to determine any of the individual objects nor is it possible to determine their sequential order since they all appear as a single small black ellipse, password 147, layout object, 147D.

It should be noted that in the examples presented in FIGS. 19A to 19D, each different visual layout of password 147, is fully functional and can be used to encrypt any one or more characteristics of any object. It should be noted that any Environment Media password can be used to encrypt any characteristic of any object, including any characteristic of any Environment Media password. An example of this illustrated in FIGS. 20A to 20D. In FIG. 20A, object 147D, receives a user input in the form of a finger touch. This selects PO147D. A verbal utterance is outputted to select two characteristics of selected PO147D. In this example said verbal utterance is: “size lock” and “group lock.” In FIG. 20B, password 147, object 147A is moved along path 151A, towards object 147D. In FIG. 20C, object 147A, impinges object 147D. Further regarding FIG. 20C, upon the impingement of object 147D, by object 147A, Password 147 communicates its password combination to the “size lock” and “group lock” characteristics of PO147D. [Note: said “size lock” and “group lock” are separate objects of PO147D.]

In FIG. 20D the finger touch is released and object 147A snaps back to its original starting position along path 151B. This completes the password encryption of two characteristics of object 147D. Now considering the encryption of object 147D, “size lock” prevents object 147D from being enlarged, so it is not possible to increase its size to view any of the individual objects that comprise it. Further, “group lock” prevents any individual object of password 147, from being moved from its layer in object 147D. This is an additional insurance to prevent anyone from visually inspecting object 147D to determine its individual password entries. As a reminder, there is no visual information in object 147D that would enable one to determine the order of the nine objects that comprise password 147, which is represented by object 147D. Note: in this example password 147 is used to encrypt two characteristics of an object that represents password 147. Thus password 147 is encrypting itself. Password encryption, as described herein, is not limited to any combination of password elements. Further, any Environment Media password can be used to encrypt any object.

To remove the encryption applied by password 147 to password layout 147D, any layout of password 147 could be moved to impinge object 147D. For example, to remove the password applied to object 147D, as illustrated in FIGS. 20A to 20D, a finger would move any layout of password 147 to impinge object 147D. Upon impingement, the finger would be lifted and said any layout of password 147 would snap back to its original position. This snap back action indicates a successful removal of the password protection applied to object 147D. If a different password, a password that was not used to encrypt an object, is moved to impinge that object, when the finger (or any apparatus doing the moving) is lifted, said different password will not snap back. Thus a user will quickly see that they chose the wrong password to unlock a password protected object. As a summary, any Environment Media password can be used to apply encryption to any object, including the same Environment Media password being used to apply the encryption.

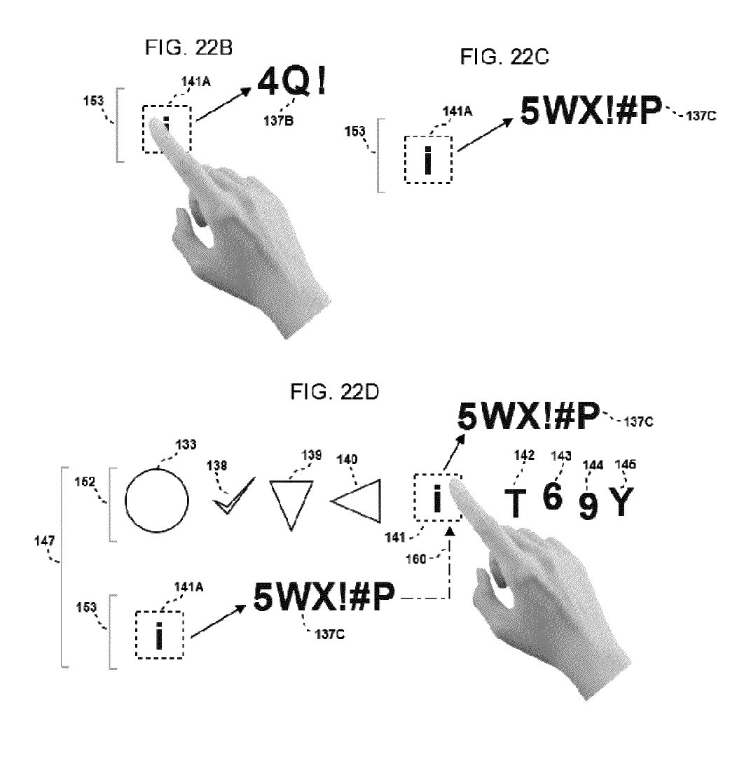

Referring now to FIG. 21, one of the password entries of password 147, object 141 is duplicated as object 141A. Object 141A is sent via email to location 153. FIG. 22A shows an expanded Environment Media password 147 that includes objects in two locations, location 1, 152, and location 2, 153. Duplicate object 141A, possesses all of the characteristics and relationships of object 141 from which it was duplicated. For instance, since object 141, is part of Environment Media password 147, duplicate object 141A, is part of Environment Media password 147. Since object 141 can communicate to one or more objects that comprise Environment Media password 147, duplicate object 141 has the same communication ability, plus the ability to communicate with object 141. Therefore, Environment Media password 147 now includes ten objects: the original nine in a location 1, 152, plus duplicated object 141A in location 2, 153. Locations 1 and 2 can be anywhere in the digital domain or in the physical analog world, yet they comprise one Environment Media, 147.

In FIG. 22B, object 141A in location 2, 153, has been activated by a finger touch to call forth the objects, 137B, assigned to it. [Note: these are the same objects that are assigned to object 141 in location 1, 152.] Said objects are the number “4”, the letter “Q” and the punctuation mark, “!”, labeled collectively as object 137B. Object 137B is sometimes referred to as a composite object. Object 141A and object 137B, including objects “4”, “Q” and “!” comprise another Environment Media. This Environment Media is defined by objects 141A and 137B and the relationships between objects 141A and 137B, and relationships between objects “4”, “Q” and “!” (comprising object 137B) and object 141A and object 137B.

In FIG. 22C Environment Media (“EM”) 137B, of FIG. 22B, has been modified with new characters, “5WX!#P”, labeled as 137C. As part of an Environment Media, each of these new character objects, “5WX!#P”, communicates with object 141A and with other objects with which 141A communicates. Referring now to FIG. 22D, object 141A, communicates new characters 137C, to object 141, in location 1, 152. This communication updates the characters “4Q!” in assignment 137B of object 141 with new characters: “5WX!#P.” A finger touch on object 141 calls forth the updated characters 137C, as a new assignment for object 141. In summary, at location 2, 153, one or more inputs create new text objects that modify composite object 137B characters “4Q!” to new characters, “5WX!#P”, presented as object 137C, which is assigned to Environment Media password entry, 141A. Object 141A (in location 2, 153) communicates changed assignment 137C, to object 141, (in location 1, 152) which alters password 147. This illustrates the ability to change an Environment Media password from a remote location.

It should be noted that the definition (the password “combination”) of an Environment Media password can be comprised of one or more objects, plus the characteristics of said one or more objects, plus the relationships between said one or more objects, plus any context. In the example of password 147, presented in FIG. 22D, there are 10 objects that comprise password 147. Objects 141 and 141A each have a composite object assigned to them. Each composite object, 137C, is a group of six text objects, “5WX!#P.” Said six text objects, 137C, are also entry objects in password 147, and therefore, greatly increase the complexity of password 147. This structure gives rise to even greater complexity. Every object that comprises an Environment Media password can have one or more assignments to it, consisting of any number of objects, possessing any number of relationships. Said one or more assignments can have one or more assignments to it and so on to create a complex chain of assignments and relationships. Said chain of assignments can exist in multiple locations without interrupting the communication between the objects in said chain of assignments and the communication between the objects in said chain of assignments and between other objects that comprise an Environment Media password containing said chain of assignments. To a user a relatively simple arrangement of objects and assignments could comprise an extremely complex, and therefore hard to crack password.

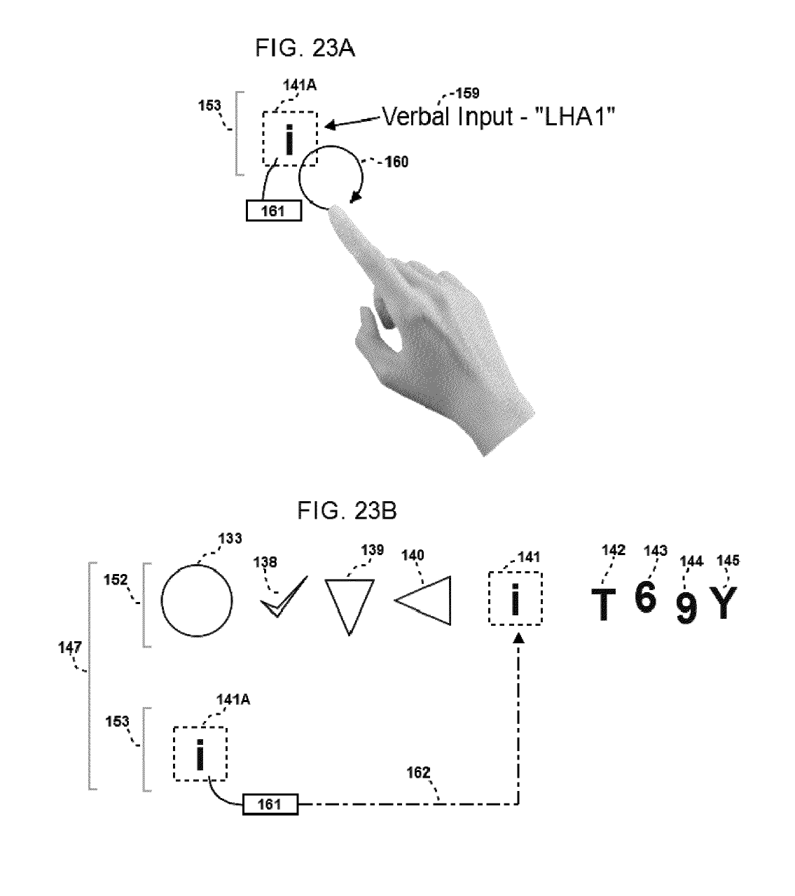

Referring to FIG. 23A, object 141A is selected with a circular gesture, 160. A verbal utterance 159 is outputted to create a modified characteristic 161, of selected object 141A. Said verbal input 159, is a verbal equivalent: “LHA1,” which is the equivalent for: “Lock: ‘Hide Assignment/location 1.’” Equivalent “LHA1” was created according to one or more methods described herein. Since an Environment Media can include objects in multiple locations, the software supports the ability to specify the location of any modification of any characteristic of any object in any location of an Environment Media. The updating of characteristics for any one or more objects in any locale of any Environment Media can be via an automated software process. In that case, the naming scheme of objects may be according to some predefined protocol. However, if a non-software automated process is used, a verbal designation of a location could be used. Said verbal designation of a location might be a familiar name of a location, like “NY” or “Floor 6”, or the like. As an example only, said verbal equivalent “LHA1” could have been the equivalent for: “Lock: Hide Assignment/NY” or “Lock: Hide Assignment/Floor 6” or “Lock: Hide Assignment at NY” or “Lock: Hide Assignment on Floor 6” and so on. For the purposes of this example, “LHA1” shall mean: ““Lock: ‘Hide Assignment/location 1.”

Now refer to FIG. 23B. In Environment Media 147, in location 2, 153, object 141A communicates the modified characteristic 161, to object 141, in location 1, 152, via a network connection 162, or its equivalent. Modified characteristic 161, sets the status of the “Lock: Hide Assignment” characteristic of object 141 to “on” and locks it to an “on” status. As a result, the assignment of object 141 can no longer be called forth and viewed in location 1, 152.

Location Encryption.

The ability to update one or more characteristics of any object in a first location of an Environment Media from an object in a second location of an Environment Media, plus the ability to specify the operation, condition, status or any other factor pertaining to said one or more characteristics as being distinct to a specific location, can act as a type of encryption. Objects that comprise an Environment Media are aware of their location. Stated another way, the location of each object that comprises an Environment Media is part of the characteristics of said each object. The location of any object that defines at least a part of an Environment Media can be an important factor in any modification to any object's characteristic in said Environment Media. The addition of a specific location for an “on” status of the “Lock: Hide Assignment” characteristic is an example of a characteristic amendment. The amended characteristic, “Lock: Hide Assignment,” of object 141 from an “off” status to an “on” status ensures that no assignment for object 141 can be viewed. Further, the locked “on” status for said characteristic amendment of object 141 is limited to location 152. Accordingly, assignment 137C, of object 141A, in location 153, can be viewed at will and changed at will. In addition, any change made to assignment 137C, of object 141A can be communicated to object 141, and as a result of this communication, assignment 137C, of object 141 will be updated to match said any change made to assignment 137C, of object 141A. One benefit of this relationship between object 141A and object 141 is that a user can secretly make changes to composite object 137C in location 153, and said changes will alter the assignment of object 141 in location, 152, and that changes password 147.

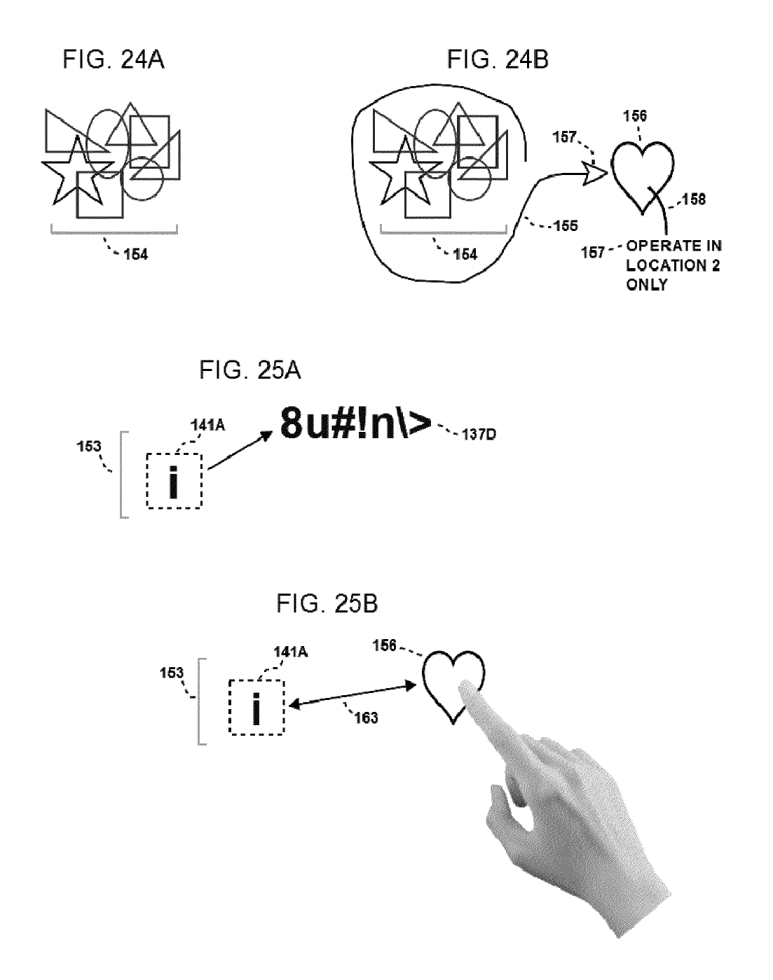

There are other ways to protect changes made to an object's characteristics in one locale from visual scrutiny in another locale. Referring now to FIG. 24A, a new Environment Media password 154, has been outputted. In FIG. 24B, a directional indicator 155, has been drawn to encircle password 154, and point to a heart-shaped object 156. An input, e.g., a finger or pen touch, (not shown) is presented to arrowhead 157, and thereby activates directional indicator 156, to complete the assignment of password 154 to heart-shaped object 156. Object 156, can now be used to apply new Environment Media password 154, to any object. Further, a modifier, 157, “OPERATE IN LOCATION 2 ONLY,” has been outputted and made to modify object 156, via a directional indicator line, 158. As a result, modifier object 157, programs heart object 156, with the condition that password 154 can only be operated in location 2, 153.

As a result of said condition, password 154 cannot be removed (deactivated) from an object in any other location of Environment Media 147. Therefore, a visual interrogation of the assignment to object 141 is not possible. Accordingly, when object 141 is touched (or otherwise activated) to unhide (show) its assignment, the software calls for password 154. Since password 154, cannot be operated in location 1, it cannot be used to unlock the assignment of object 141. Therefore the assignment to object 141 remains hidden.

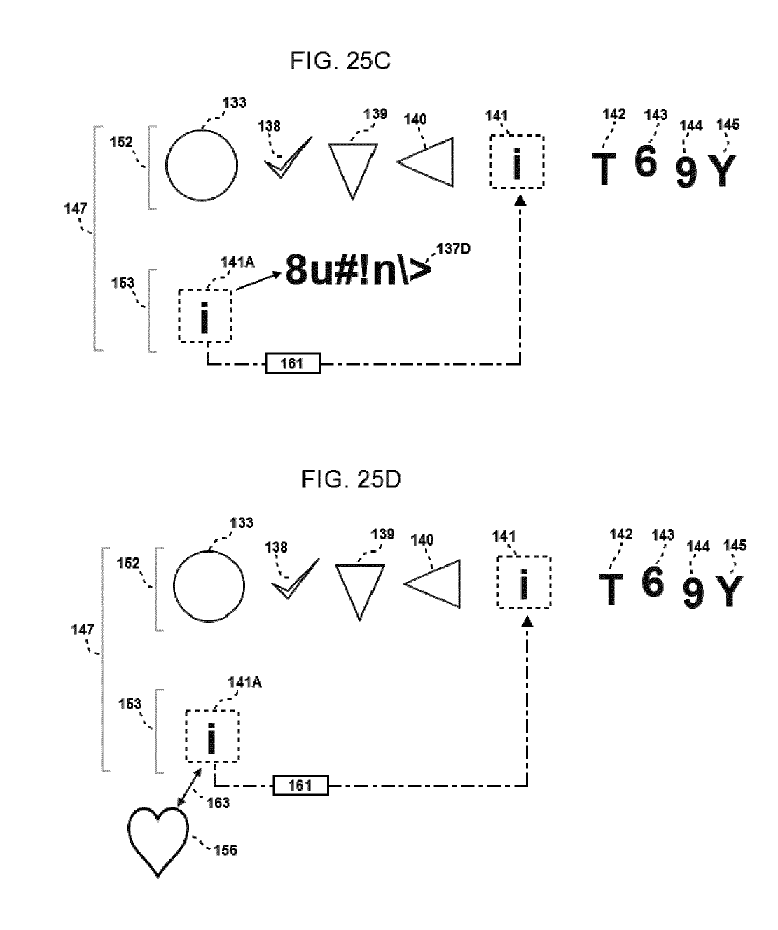

Now referring to FIG. 25A, the composite object assigned to object 141A, has been modified to contain new characters, “8u#!n\>,” labeled 137D. In FIG. 25B heart object 156, is used to encrypt object 141A with password 154. Note: One of the characteristics of heart object 156 is the ability to automatically apply its assignment (in this case, password 154), to any object that heart object 156, impinges. To perform the encryption of object 141A with password 154, heart object 156, is touched by a finger and moved to impinge object 141A, along path 163. Upon the impingement of object 156 with object 141A, the finger is released and object 156, snaps back to its original position along path 163. This simple visual snap action indicates that heart object 156, has successfully encrypted object 141A with password 154, in location 2, 153, of password 147. It should be noted that the operation described in FIG. 25B would not be successful if attempted in location 1, 152 of password, 147. The condition, 157, OPERATE IN LOCATION 2 ONLY” would prevent the successful encryption of object 141 by object 156 in location 1, 152 of Environment Media password 147.

Referring to FIG. 25C, the assignment of object 141A has been modified with new characters “8u#!n\>,” 137D. Object 141A, in location 2, 153, communicates its changed assignment, 137D, to object 141, in location 1, 152. As a result, the assignment of object 141, in location 1, 152, is changed to match the new assignment, “8u#!n\>,” 137D, of object 141A, in location 2, 153. Because of characteristic 162, the assignment of object 141 cannot be shown. But the assignment can be shown for object 141A in location 2, 153.

Referring to FIG. 25D, the assignment of object 141, composite object 137D, is hidden. [Note: As a reminder, heart object 156 is the equivalent of password 154. Further, heart object has been programmed to include a characteristic 157 that prevents heart object 156, from being operated in any location except location 2, 153. In addition, heart object 156 can encrypt any object that it impinges with password 154.] Heart object 156, is moved along path 163 to impinge object 141A in location 2, 153. The movement of heart object 156 is accomplished via any suitable means, including: a finger touch, pen touch, verbal input, context, PAO, and the like. Upon impinging object 141A, heart object 156 is released and it snaps back along line 163 to its original position. A previously explained, this snapping back action verifies that password 154 has successfully encrypted object 141. The encryption of object 141A with password 154, in location 2, 153, of password 147, is communicated to object 141 in location 1, 152, of password 147. The modifier object 157, “OPERATE IN LOCATION 2 ONLY” as illustrated in FIG. 24B, modifies heart object, 156. Modifier object 157 is communicated to object 141 as part of the encryption of object 141 with password 154. As a result, the encryption of object 141 with password 154 cannot be removed from object 141, in location 1, 152.

Thus a user in location 1, 152, has no access to any modification to the assignment of object 141 in location 1, 152, and no means to modify the assignment of object 141 in location 1, 152.

Therefore, an input in location 2 can cause any modification to the assignment of object 141A in location 2, which will be communicated securely and secretly to object 141 in location 1. The method described herein enables the remote updating of a password (e.g., 147) from any location in the world, thus a security code can be secretly updated from any remote site.

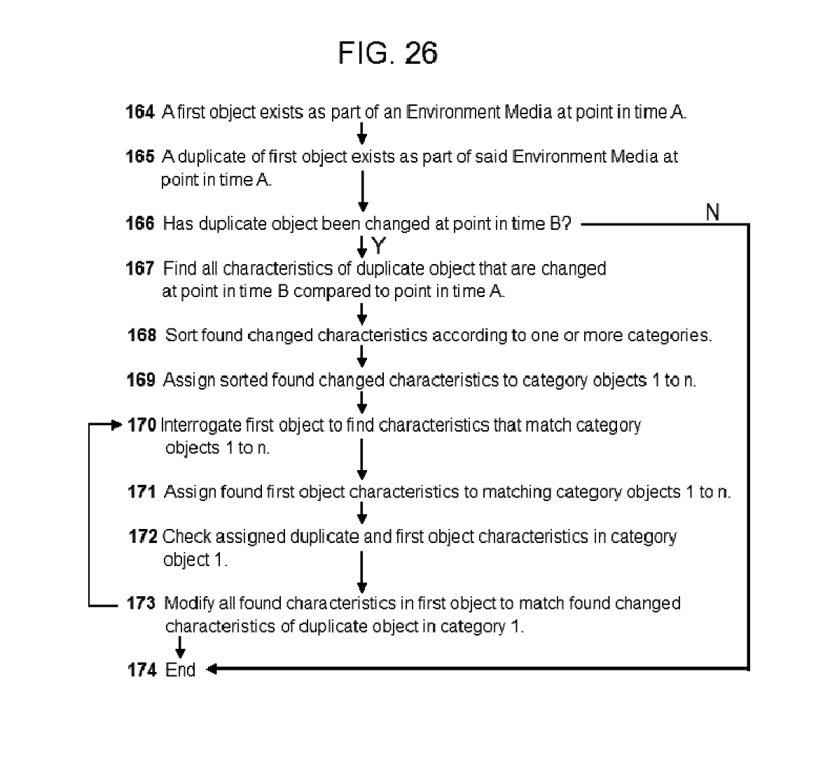

Referring now to FIG. 26, this is a flow chart that illustrates a method whereby a second object updates a first object of which second object is a duplicate. An example of this process is object, 141, (a first object), being updated by, object 141A, (a second object) which is a duplicate of first object, 141.

Step 164: A first object exists as part of an Environment Media at a point in time. For example, object 141, exists as part of Environment Media equation, 147.

Step 165: A duplicate of said first object exists in said Environment Media at the same point in time. An example of this would be object 141A, which is a duplicate of object 141. Note: when duplicate object 141A was created, it contained a duplicate of the characteristics of object 141, and thus established a relationship to object 141. Since object 141 is part of Environment Media, 147, duplicate object 141A is part of said Environment Media, 147.

Step 166: A query is made: “has duplicate object been changed at point in time B?” A change can be measured in many ways. For instance, “change” could be defined as anything that has occurred to an object that in any way modifies said object since the point in time when said object was created. Another approach would be determining change by comparing two or more points in time. The flow chart of FIG. 26 discusses the second approach, comparing two points in time: A and B. To determine change using two points in time, the software compares the state of the characteristics of said duplicate at point in time B, to the state of the characteristics for said duplicate object at point in time A. If said characteristics are the same, no change has occurred and the process ends. If the states of the characteristics of said duplicate are different, the process proceeds to Step 167.

Objects can be Self-Acting

The method described in FIG. 26 can be the result of many different software approaches. Three of them are discussed below. Approach 1: the software operates objects. For example, with regards to Step 166, the software interrogates said duplicate to determine if it has changed. Approach 2: objects are self-acting and contain the necessary software to perform any needed task, action, operation, function, communication or the equivalent. Approach 3: objects contain or have access to sufficient software (existing as one or more characteristics of said objects, or otherwise associated with said objects), to enable said objects to communicate with core software, or other software, to perform any needed task, action, operation, function or the equivalent. Let's say that in FIG. 26, the software approach is “Approach 3.” With regards to Step 166, said duplicate interrogates itself by calling whatever functions it needs from core software, or other software, or by accessing sufficient software that exists as one or more characteristics of said duplicate. Note: said core software or said sufficient software could exist anywhere, e.g., via a network, a cloud infrastructure, an intranet, a storage device, via another object—e.g., an Environment Media, the internet, or the equivalent. Note: the use of “software” or “the software” herein can refer to any approach, operation or its equivalent described herein.

Step 167: The software determines change in part by comparing two or more states of an object. The software finds all changes in said duplicate of first object by comparing the state of said duplicate object at point in time B to the state of said duplicate object at point in time A.

Step 168: The software analyzes the type of each found change and classifies each found change according to a category. By this process of labeling, each found change is sorted into one or more categories.

Step 169: The software assigns the sorted found change for duplicate object into one or more categories that match the type of found change. As an example, if the objects in FIG. 24A were duplicated and then compared to object 154, the common category would be “password.” As another example, if the text object characters of object 137D, (FIG. 25A) were compared to the text object characters of object, 137C, (FIG. 22C) a common category would be “assignment.” This category could also be “text objects,” or a number of other possibilities. A key point here is that by sorting and classifying change as a category, a single object, namely, a category, can be used to represent, program, modify, activate, or otherwise apply the collective “change” contained in a single category to anything in the digital domain or that can be addressed digitally in the physical analog world.

Step 170: The software interrogates the first object and looks for matches between characteristics of said first object and one or more categories to which matched objects of “change” have been assigned from said duplicate object. An example of the process of Step 170 would be comparing the text character objects of object 137C, (“5WX!#P”) to the text character objects (“8u#!n\>”) of object 137D. The category that is common to the text character objects for both object 137C and 137D is “assignment.” The category “assignment” is an object.

Step 171: The found first object characteristics are assigned to matching category objects.

Step 172: The software checks the assignments to category 1. The software finds all characteristics in said first object that match saved changed characteristics of said duplicate object in category 1.

Step 173: The software modifies said first object's characteristics assigned to category 1 with found changed characteristics of duplicate object assigned to category 1. An example of this would be the text character objects of 137C, (“5WX!#P”) of said first object that match the changed text character objects of 137D, (“8U#!N\>”) of said duplicate object. Note: the comparison here is not necessarily dependent upon the number of objects. Notice that the number of text character objects for object, 137C, is six (“5WX!#P”), but the number of text character objects for object 137D is seven (“8U#!N\>”). When the number of compared objects is not exactly the same, the software can utilize the category containing found objects of change (in this case found changed characteristics of said duplicate object) and found characteristics that match said found change (in this case the found characteristics of said first object) to “model” change. As an example, consider objects 137D and 137C. The software could replace all of the text characters of 137C with the changed text characters of 137D. In this case, one could think of the object that is being modified as an invisible object: the category “assignment.” An assignment object exists for object 141 (first object) and for object 141A (duplicate). The assignment object for object 141A (duplicate) doesn't necessarily care about the amount of changed characters it contains. The characters could all be changed or partially changed or be increased or decreased in number. The “model” could take many forms, but in general it is based on the fact that an assignment object has been changed to a new state. Thus in the example provided above, the state of assignment object 137D, for object 141A (duplicate object), is communicated to assignment object 137C, for object 141 (first object) and causes the assignment of 137C to match the assignment of 137D.

Further a more generic model could be derived from said category 1 object. One model could be: “any change to an assignment object can be communicated to any assignment object.” The model could be narrower, such as: “Any change to text objects in an assignment object can be communicated to any assignment object,” or narrower still, “Any change to a letter text object in an assignment object can be communicated to any assignment object,” and so on.

Iteration:

Upon the completion of Step 173, the process of interrogation, category matching, assignment and modification found in steps 170 to 173 is repeated for a next category. The iteration of these steps continues until no further objects of change can be matched between said duplicate object and first object. At this point the process ends at Step 174. Note: the process of iteration just described can be carried out concurrently, rather than as a sequential process.

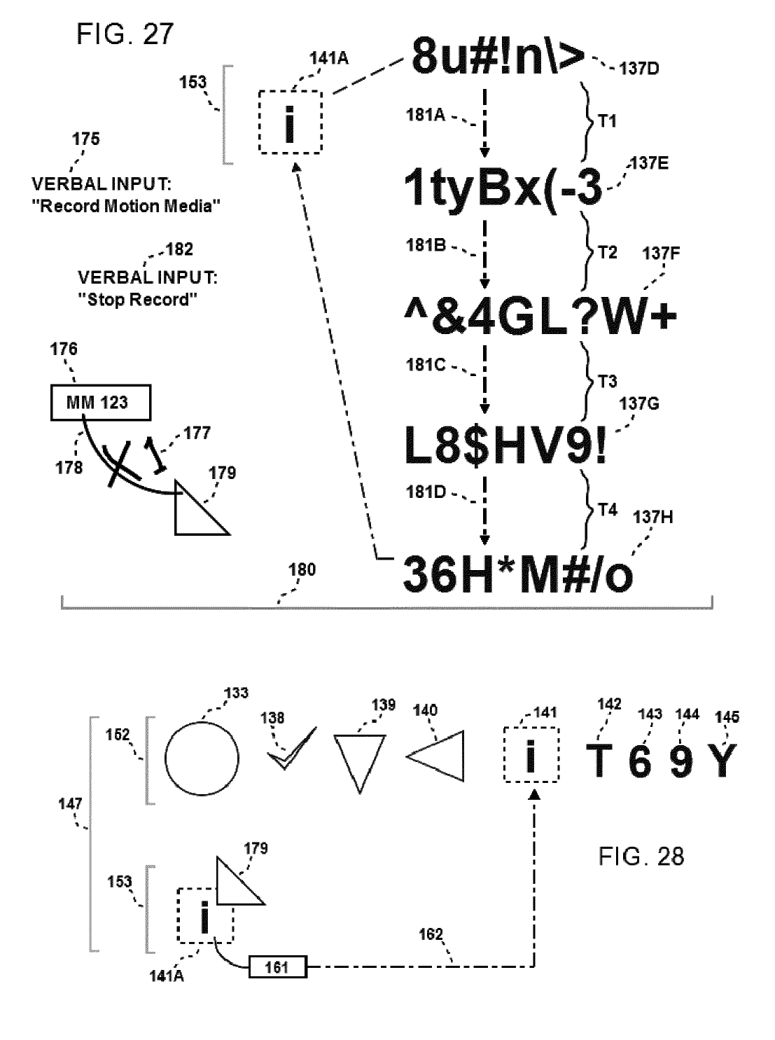

As previously mentioned, the updating of characteristics for any one or more objects in any locale of any Environment Media can be via an automated process. FIGS. 27 and 28 illustration the use of a motion media to create the automatic updating of a password.

FIG. 27 illustrates the creation of a motion media which can be utilized to cause a dynamic updating of the assignment to object 141A, as part of Environment Password, 147. A verbal input, “Record Motion Media,” 175, is presented to environment, 147. Verbal input 175 causes the recording of a motion media 180, to commence. A first input 181A, modifies object 137D, as object 137E. A second input, 181B, modifies object 137E as object 137F. A third input, 181C, modifies object 137F, as object 137G. A fourth input, 181D, modifies object 137G, as object 137H. [Note: The four inputs could be presented via any means supported in a computing system, including: any user input (e.g., typing, drawing, verbal utterance, dragging), any software input (e.g., preprogrammed operation, configuration, motion media), any context, or the equivalent.]

After input 181D modifies 137G to become 137H, a second verbal input, “Stop Record” 182, is inputted to Environment Media, 147, not shown. [Note: object 141A is in location 2, 153, of Environment Media 147 as disclosed in previous figures.] As a result of input 182, the recording of motion media 180 is concluded and software automatically creates an object, 176, to be an equivalent of motion media 180 and names said object “MM 123.” A graphic triangle object 179 is inputted to Environment Media 147. A line 178 is inputted that extends from record switch 176, to graphic object 179. A graphic, “X1”, 177, is inputted to impinge line 178. Note: said graphic 177, could be inputted by any suitable means, e.g., drawing means, dragging means, verbal means, gestural means. Line 178, extending from record switch 176, to graphic object 179, defines a context, which defines a transaction “assign” for line 178. Graphic 177, is an equivalent for the operation: “precise change.” Graphic 177, which impinges line 178, acts as a modifier to said transaction of line 178. Therefore, modifier object 177, “precise change,” modifies said transaction of line 178, to produce a new transaction: “assign precise change.” Said new transaction assigns objects 137E, 137F, 137G and 137H, their sequential order, and the time intervals (T1, T2, T3, and T4) between each change (“motion media elements”) to object, 179. Further, line object 178, extending from object 176, to object 179, comprises another context, which causes the addition of a characteristic (not shown) to object 179. Said characteristic is the ability to automatically apply the elements of motion media 180 to any object that triangle object 179 impinges, according to the modifier: “precise change.” As a result of the previously described operations, object 179 is programmed to be the equivalent for the “precise change” of motion media elements recorded as motion media 180. Thus object 179 is the equivalent for the precise characters of composite text objects 137D, 137E, 137F, 137G and 137G, plus the precise order that said composite text objects were created, plus the precise time intervals between the entering of each new composite text object.

It should be noted that the success of applying said “precise change” of motion media 180, as represented by object 179, to another object would depend upon said another object being a valid target for object 179. It should be further noted that the recording of motion media 180 involves objects that, in part, comprise Environment Media 147 (also referred to as password 147). It should also be noted that composite objects 137E to 137H contain modified characteristics of object 137D. Therefore, each set of text characters, that make up each composite object, “1tyBx(−3”, “̂&4GL?W+”, “L8$HV9!”, and “36H*M#/o”, has a relationship to each other set of text characters, to said composite objects and to objects 141A, 141 and to password object 147. Further, each individual character (e.g., “8” or “#” or “M”) in each set of characters is an object with a relationship to one or more of the other characters in objects 137D to 137H. In addition, time intervals, T1, T2, T3 and T4, are also objects (i.e., invisible objects) that can modified at will. And relationships are objects that can also be modified by any means described herein. Thus Environment Media password 147 is comprised of a complex array of visible and invisible objects and their characteristics, plus relationships (including assignment, order, layer and much more), time, locale, and context. Any change to any of these factors, including changes in time will change password 147, or any Environment Media password.

Summary of FIG. 27.

Object 137D is an assignment of object 141A. The text characters, “8u#!n\>”, that comprise the assignment 137D, are part of password object 147, (see FIG. 23B). Objects 137E to 137H are modifications of object 137D. Therefore, objects 137E to 137H are also assignments of object 141A, and thus are a part of password, 147. Motion media, 180, has recorded four changes to object 137D. Said four changes are recorded in sequential order as: 137E, 137F, 137G and 137H. Said four changes, saved as motion media 180, are used to program triangle object 179, via a line object, 178. The programming of object 179 by object 176 is modified by object 177, which enables object 179, to act as an equivalent for applying the four sequential changes recorded in motion media 180, to another object. One key idea here is that the programming of objects (including Environment Media) can be carried out by input that is recorded as a motion media. This has many advantages over existing software programming approaches. One advantage is that a user can simply perform any number of inputs, record them as a motion media, and use the changes resulting from said inputs to program one or more objects. Said inputs can be used as “precise change” or as models and/or model elements.

Referring now to FIG. 28, motion media equivalent 179, has been inputted to impinge object 141A, in location 2, 153, of Environment Media password 147. Upon impingement of object 141A, with object 179, the assignment 137D, of object 141A, is updated to become a dynamic sequence of five different assignment objects, 137D, 137E, 137F, 137G and 137H that are presented according to certain time intervals (T1, T2, T3, T4) as shown in FIG. 27. Once updated by object 179, object 141A, in location 2, 153, communicates its updated assignments to object 141, in location 1, 152. Object 141 communicates its updated assignments to password object 147, resulting in the following:
(1) Password 147 is modified from a static password to a dynamic password. In other words, password 147 is no longer a fixed set of entries that equals a password “combination.” Environment Media password 147, is further defined by a dynamically changing set of assignment characters
(2) The combination of password 147 is automatically altered according to a dynamic sequence of assignments of object 141, in location 1 and of object 141A in location 2.
(3) The communication of the sequence of assignments of object 141A to object 141 is modified by characteristic, 161.
(4) The assignment changes communicated to object 141, in location 1, 152, from object 141A, in location 2, 153, cannot be viewed in location 1, 152, thus said changes to password 147 are a secret to anyone who is not in location 2, 153.
(5) Any additional modification of the assignments to object 141 can only be controlled via modifications to object 141A in location 2, 153.

Dynamically Controlled Password Update

Consider that each of the other objects (152, 133, 138, 139, 140, 141, 142, 143, and 144), are duplicated in a separate location. For example, object 152 is duplicated in location 3, and object 133 is duplicated in location 4 and so one. Further consider that each duplicated object has a composite object assigned to it. Further consider that each duplicated object includes characteristic 161. This expansion of Environment Media password 147 would provide for nine more locations to have secure and secret access to the modification of password 147. Further consider that said access and future modifications to characters comprising each assignment to each of said nine duplicate objects in their respective locations are automated by a software process. Finally consider that each object in the above described modified password 147 has the ability as described in “Approach 2” and/or “Approach 3” above. As a result, password 147 and any Environment Media password constructed in a similar manner (“Dynamic Environment Media Password”), could become self-aware and therefore be able to protect itself from being hacked. In addition, any Dynamic Environment Media Password could be represented by any equivalent. Said any equivalent could become an entry in another Dynamic Environment Media Password.

Programming Invisible Objects

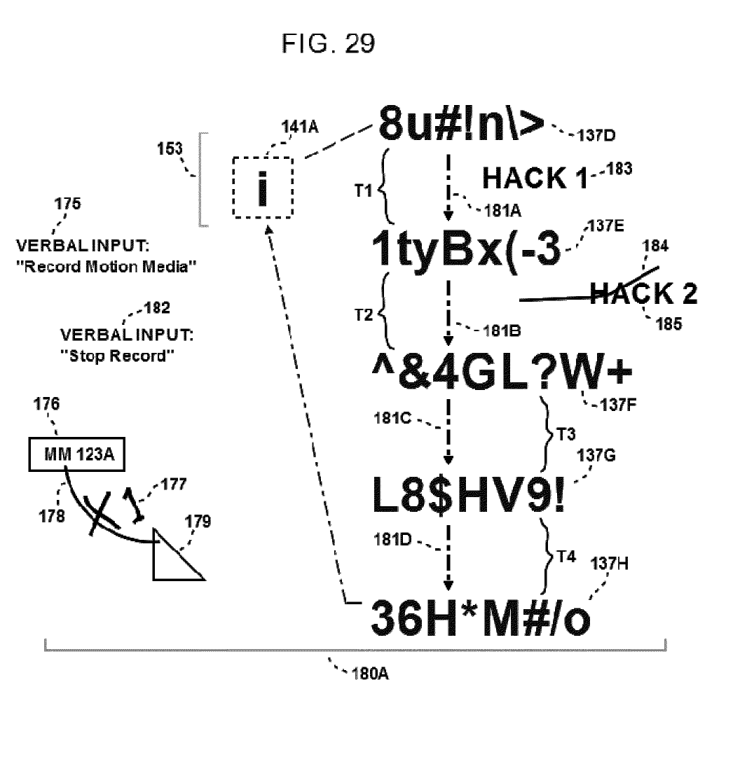

FIG. 29 illustrates the modification of invisible time interval objects (T1, T2, T3 and T4) in a new motion media, 180A. A verbal input, 175, commences the recording of motion media 180A. Object, “HACK 1”, 183, is the equivalent of the detection of a first attempted software hack of password 147. Said detection could be via any means in a computing system containing Environment Media 147. [Note: Equivalent 183 could be created by any means described herein, e.g., an object equation.] Object 183, “HACK 1” is moved to impinge the vertical space (indicated by T1, which also indicates the time interval required to modify object 137D as object 137E), between assignment object 137D and assignment object 137E. Said vertical space is an invisible object, which is impinged by object 183, “HACK 1.” Said impingement changes the length of time for interval T1, from a fixed time interval to an event-based time interval. Said event-based time interval is determined according to when a first attempted hack of password 147 is detected. Upon the detection of a software hack, the assignment for object 141A is automatically changed to object 137E. Changed assignment 137E in location 2, 153, of password 147, is communicated by object 141A to object 141 in location 1, 152, of password 147. Object 141 communicates its changed assignment 137E to password 147 which changes password 147.

It should be noted that the communication of said changed assignment, 137E, from object 141 to password 147 could involve a communication from object 141 to all entry objects that comprise password 147. As a reminder, the objects that comprise the entries of password 147 have a relationship to the task: “password.” Therefore all objects that comprise Environment Media password 147 are capable of inter-communication.

In FIG. 29 another method of updating an invisible object is illustrated by objects, 184 and 185. An object, HACK 2”, has been inputted to Environment Media 147. A line, 184, has been inputted to extend from object 185, into an invisible object filling the vertical space between object 137E and 137F, labeled as T2. As a result, time interval T2, is modified from being a fixed time interval to being an event-based time interval. Like T1, T2 is determined according to when a second attempted hack of password 147 is detected. Verbal input, 182, ends the recording of motion media 180A, which is saved as object 176A and named “MM123A” by software. Note: any input can be used to modify a name given to a motion media by software. Said input could include: typing, drawing, verbal utterance, context, time, a gesture and the equivalent. Object 179, can be utilized in an object equation to specifically modify assignment 137D of object 141 with the recorded change in motion media 180A. As an alternate, a model could be derived from the recorded sequential actions of motion media 180A, which could be used to modify the assignment of a wide variety of objects.

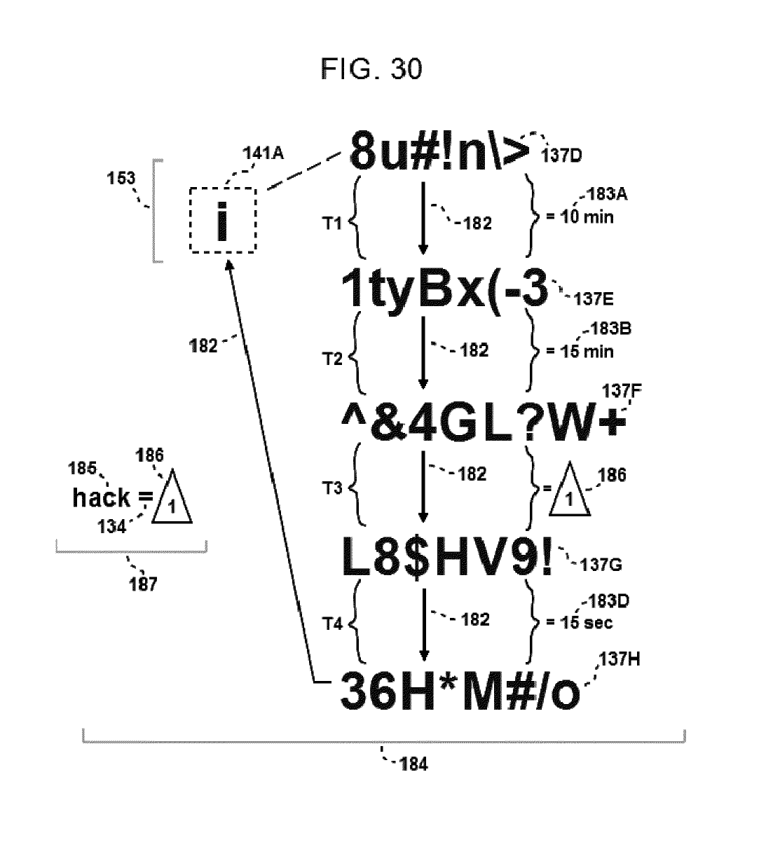

FIG. 30 illustrates an Environment Media equation 184. The logic flow of object equation 184 is determined by multiple factors which include, but are not limited to: (1) user input, (2) one or more states, (3) one or more relationships, (4) communication between one or more objects, and (5) context. Equation 184 is comprised of many relationships that in part define the steps of equation 184 for performing the task: “sequential update.” Object 141A, is an assigned-to object. The assignment of object 141A is changed to the characters “8u#!n\>”, 137D. Object 182 signifies the operation or logic: “Then.” Left and right brackets, { }, define invisible objects that are positioned vertically in between objects 137D, 137E, 137F, and 137G. For instance, T1 { }, equals a first invisible object whose vertical space is defined by the lower edge of text characters, 137D and the upper edge of text characters 137E. The left side of said first invisible object is defined by the left T1 bracket “}”. The right side of said first invisible object is defined by the right bracket “}” which is immediately followed by “=10 min,” 183A. Invisible objects T1, T3 and T4 are defined in size by the same arrangement of brackets “{ }”. [Note: There are other methods to define the size and shape of an invisible object. These methods include, but are not limited to:
User Input. For example drawing a rectangle and designating said rectangle as an invisible object. Methods to designate said rectangle as an invisible object could include: selecting rectangle, e.g., via a touch or verbalization, then using a verbal utterance (e.g., “invisible object 1”) to program the area of said rectangle as an invisible object or impinging said rectangle with an object that programs said rectangle as an invisible object.
Automatic process. Software could automatically create invisible objects determined by context. For example, in FIG. 30, if there were no brackets utilized in the equation of FIG. 30, software could automatically designate each vertical space between each pair of text objects (e.g., the space between object 137D and 137E) as invisible objects. The width of each invisible object could equal the width of the text objects 137D and 137E.

Further regarding FIG. 30, time designation “=10 min, 183A, programs invisible object T1, to equal a 10 minute duration. [Note: “T1{ }=10 min” is an equation that defines invisible object T1 to equal 10 minutes. We will refer to this as a “sub-equation” that is contained within Environment Media equation, 184. The objects that comprise sub-equation T1 partially define Environment Media equation 184. T1 communicates to Environment Media equation 184 to cause the following result. Ten minutes following the presentation of assignment object 137D, object 137D, is replaced with object 137E, which contains new characters, (“1tyBx(−3”). Object 137D could be presented by any activation of object 141A, to which object 137D is assigned. The object equation continues. Fifteen minutes after object 137E replaces object 137D, object 137F replaces object 137E. Each invisible object, T1, T2, T3 and T4, is defined by sub-equations that determine the length of time that each invisible object represents. Continuing through the object equation of FIG. 30, time interval, T3, is determined by an event 185, “hack”, which is represented by an equivalent 186. Equivalent 186 is created via an object equation 187. Object equation 187, has a relationship to object equation, 184, because it defines object 186 that is utilized in object equation 184. Therefore object equation 187, is part of object equation 184. It should be further noted that the manipulation of the size and shape of any invisible object can be used to modify or program the operation of said any invisible object. For example, if the lower edge of invisible object T1, in FIG. 30, were stretched downward, this could increase the length of time programmed for invisible object T1 from 10 minutes to a longer time. The increase of vertical height of invisible object T1 could automatically adjust all objects in object equation 184, downward by a distance that equals said increase of vertical height of invisible object T1. Alternately, T1 could be increased in height (to alter its programming) without altering the position of any object in object equation 184.

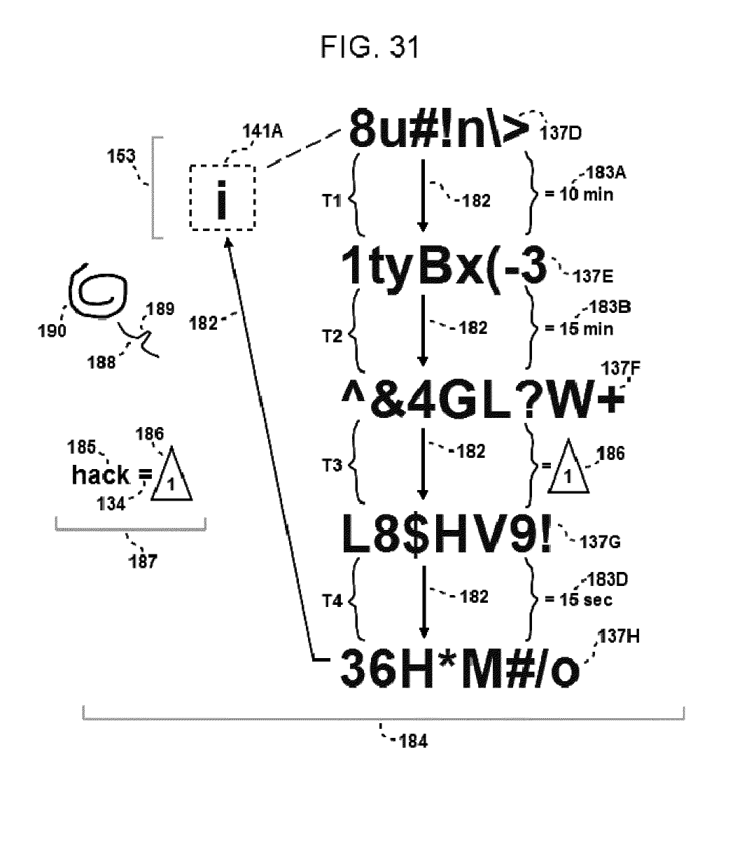

FIG. 31 illustrates the assignment of an object equation to a gesture object. Line object 188, contains a “V” shape 189, which is a recognized gesture that enables line object 188, to impinge any part of one object and assign said one object to another object. Line 188 is drawn such that it originates in Environment Media Equation 184, and extends towards gesture object 190, such that line 188 impinges object 190. As a result Environment Media equation 184 is assigned to gesture object 190. Gesture object 190, now represents Environment Media 184. To utilize gesture object 190, a user would output gesture 190, to impinge another object. Said output of gesture 190 could include: drawing on a screen; moving a finger in free space where the finger movement is recognized as an input to a computer system via a camera apparatus or its equivalent; creating a verbal equivalent for gesture 190 then verbalizing said verbal equivalent; manipulating holographic objects; thinking an operation utilizing gesture 190 via a thought recognition apparatus; and anything else that can be utilized as an input to a computing system of any kind. Upon the impingement of any object by gesture object 190, Environment Media equation 184 would be applied to said any object, as long as the application of Environment Media equation 184 is valid for said any object.

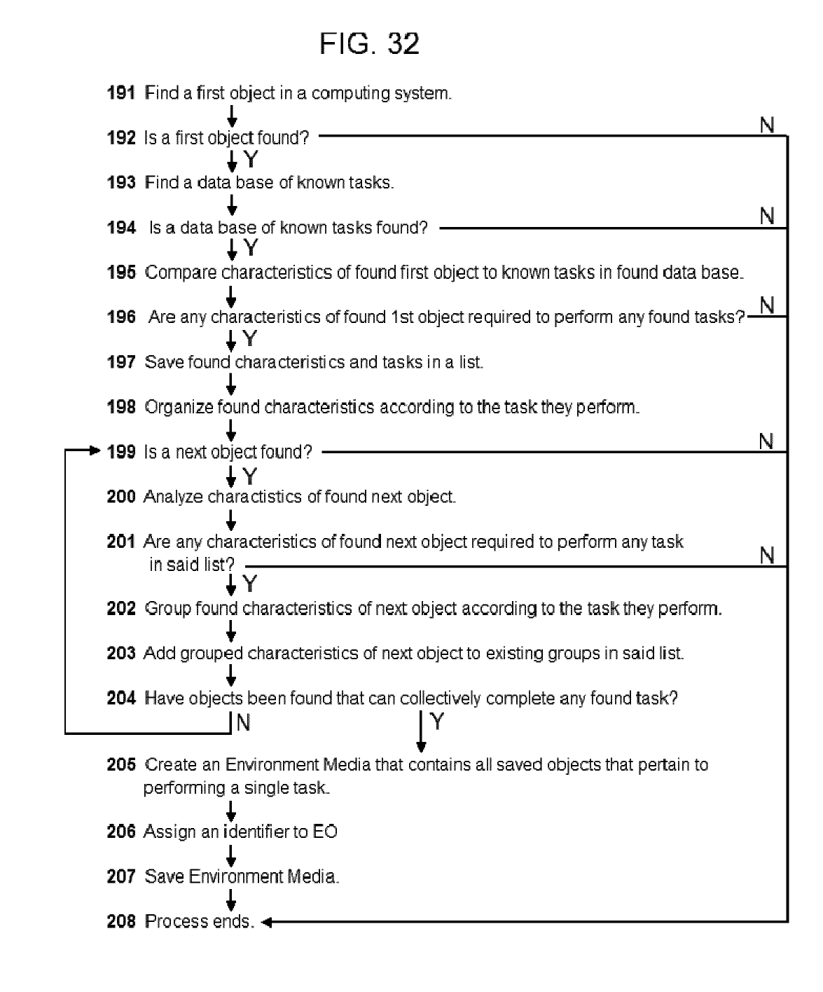

Now referring to FIG. 32, this is a flowchart illustrating the automatic creation of an Environment Media in a computing system. An Environment Media can include any one or more digital computers, including any device, data, object, network and/or environment, plus any one or objects in the physical analog world that can be recognized by a digital processor (e.g., via a digital camera recognition system), or that have any relationship to the digital domain, (e.g., via a digital processor embedded in an analog object). According to the method of FIG. 32, software analyzes objects and finds characteristics of said objects that support the performance of a common task or that share a common category. Referring now to FIG. 32, this is a flowchart illustrating the automatic creation of an Environment Media through analysis of individual objects in a computing system.

Step 191: The software searches for a first object in a computing system. This could be a physical analog object or a digital object. Said object could be invisible or visible, and could be any item found in the definition of an object provided herein, including a relationship, action, context, function or the like.

Step 192: If a first object is found, the process proceeds to Step 193. If not the process ends.

Step 193: The software searches for a data base of known tasks.

Step 194: If the software finds a data base of known tasks, the process proceeds to step 195. If not, the process ends.

Step 195: The software compares the characteristics of the found first object to the known tasks in the found data base.

Step 196: The software searches for any characteristics in found first object that are required to perform any task in the found data base. If one or more characteristics are found, the process proceeds to Step 197. If not, the process ends.

Step 197: The software saves characteristics found in Step 196 in a list.

Step 198: The software organizes saved found characteristics in said list according to the task said characteristics perform or support.

Step 199: The software searches for a next object. If a next object is found, the process proceeds to Step 200. If not, the process ends.

Step 200: The software analyzes the characteristics of the found next object.

Step 201: The software queries: are any characteristics of the found next object required to perform any task in said list? If the answer is “yes,” the process proceeds to Step 202. If not, the process ends.

Step 202: The software groups the characteristics of said next object that were found in Step 201 according to the task said characteristics perform or support.

Step 203: The software adds grouped characteristics of said next object to the existing groups in said list.

Step 204: The software queries, have objects been found that can collectively complete any task in said list? As previously mentioned, said objects can include “change”, function, operations, actions, and anything found in the definition of an object disclosed herein. If not, the process proceeds to Step 199 and iterates to Step 204 again. If the answer to the query of Step 204 is still “no,” the process again iterates through Steps 199 to 204. Once a group of objects has been found that can collectively complete any found task, the process proceeds to Step 205.

Step 205: The software creates an Environment Media that is defined by objects that were found via one or more iterations of Steps 199 to 204 and that can collectively complete a task.

Step 206: The software assigns an identifier to the Environment Media created in Step 205. An identifier can be anything known to the art.

Step 207: The Environment Media is saved.

Step 208: The process ends.

Motion Media as a Programming Tool

In another embodiment, the software of this invention enables motion media to be used to program one or more digital objects and/or environments.

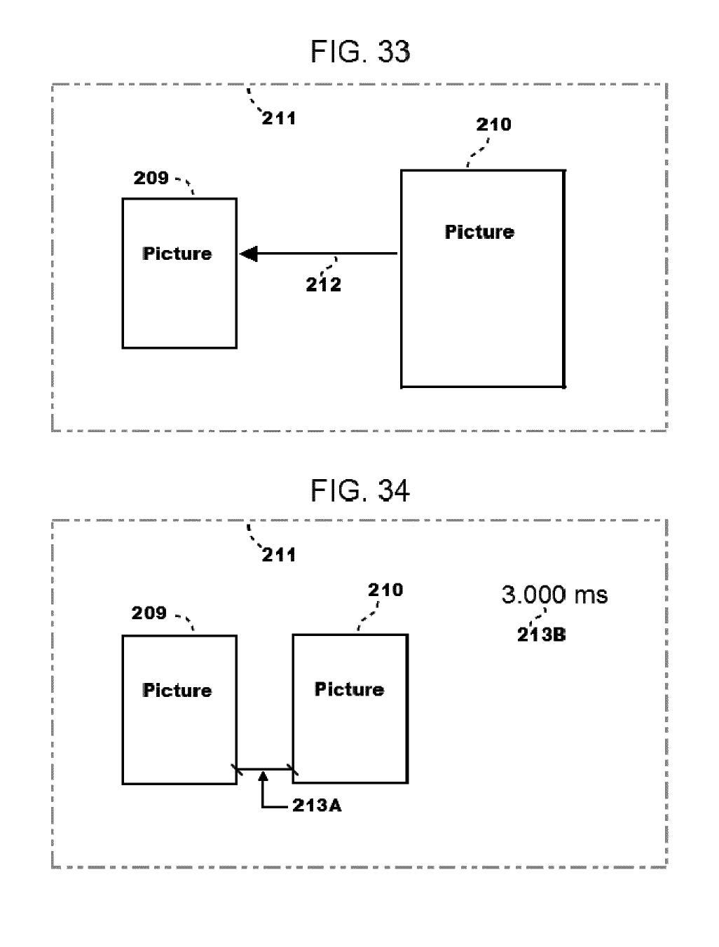

FIG. 33 shows a motion media environment with the following elements: Two pictures: one smaller picture 209 and one larger picture 210 which are placed in a computer environment 211. Moving larger picture 210 to impinge smaller picture 209 along path 212.

The objects and action described in FIG. 33 can be recorded in software. Said objects and said action can be played back in real time (the actual time that elapses from the point that the software is engaged to record a motion media to the point in time that the software is disengaged from the recording of motion media) or in non-real time (a time that is faster or slower than real time, including the fastest time possible for software to replay the events of said motion media of FIG. 33).

FIG. 34 illustrates the result of the impingement of smaller picture 209 with larger picture 210. As a result of said impingement, larger picture 210 is changed in size to match smaller picture. Further, larger picture 210 is located at a set horizontal distance from the right edge of smaller picture 209. This result is caused by one or more of the properties and behaviors of smaller picture 209. In this case, one of the behaviors of smaller picture 209 is having a “snap to object” function set to an “on” status.

Further, said “snap to object” function for smaller picture 209 has a horizontal snap to distance set for a specific distance—in this example this distance equals 40 pixels. Therefore, said snap-to-object function for smaller picture 209 determines that any object that is dragged along a path that is recognized by the software as being along a horizontal plane and that impinges smaller picture 209 results in said any object to be automatically resized to match the “size” (in this case the height and width) of said smaller picture 209. In addition, said “snap to object” function further determines that the horizontal distance 213A of said any object that impinges said smaller picture 209 along said recognized horizontal plane shall be positioned 40 pixels to the right edge of smaller picture 209.

Regarding the objects, action and results of said action depicted in FIGS. 33 and 34, the software of this invention has an understanding of the objects 209 and 210 and of the environment that contains said objects 209 and 210. Said understanding includes, but is not limited to, the following:
i. The behaviors and properties of smaller picture 209 and larger picture 210. The software of this invention analyzes smaller picture 209 and larger picture 210 to determine all of their characteristics.
ii. Any activated function, action or the like for smaller picture 209 and larger picture 210. In this case, “snap to object” has been activated for smaller picture 209 with a horizontal snap distance of 40 pixels.
iii. Any existing relationship between smaller picture 209 and larger picture 210. The motion media described in FIGS. 2 and 3 illustrates only one relationship, namely, upon larger picture 210 impinging smaller picture 209, a snap to object function activated for picture 209 will be applied to larger picture 210.
iv. Any existing relationship between smaller picture 209 and any other object. No other relationship is illustrated by the motion media of FIGS. 33 and 34. However, the software would be aware of various other relationships by analyzing the characteristics of smaller picture 209 and larger picture 210.
v. Any existing relationship between larger picture 210 and any other object.
   No relationship beyond snap to object is illustrated by the motion media of FIGS. 33 and 34. However, the software could be aware of various other relationships by analyzing the characteristics of smaller picture 209 and larger picture 210. For instance, smaller picture 13 209 and/or larger picture 210 could be assigned to another object that is not visible in the motion media depicted in FIGS. 33 and 34. If such an assignment existed, it could create other conditions and contexts and/or affect the result of a user input to larger picture 210 or smaller picture 209.
vi. Any existing dependency upon, relation to or any means by which context can affect smaller picture 209 and/or larger picture 210. The dragging of larger picture 210 along a recognized horizontal plane and the impingement of smaller picture 209 with larger picture 210 becomes a context for both smaller picture 209 and larger picture 210. No other context is apparent from the motion media of FIGS. 33 and 34.
vii. The relative positions of smaller picture 209 and larger picture 210 in computer environment 211.
viii. The relative position of smaller picture 209 and larger picture 210 to each other before, during and after larger picture 210 is moved (dragged) to impinge smaller picture 209. Knowledge of said relative positions can be useful in determining many things. For instance, the shape of the dragged path of larger picture 210 reveals something about how the software interprets a horizontal drag. The nature of the impingement of smaller picture 209 by larger picture 210 reveals something about the definition of an impingement by the software. For instance, was larger picture 210 dragged such that some portion of larger picture 210 intersected smaller picture 209? Or was larger picture 210 dragged to a distance from smaller picture 209, but did not actually intersect smaller picture 209?
ix. The relative sizes of smaller picture 209 to larger picture 210. In some cases, a size relationship beyond a certain percentage could result in no snap to object result. The fact that a snap to object action resulted from the impingement of smaller object 209 by larger object 210 means that the relative size differences between the two objects does not exceed any set size disparity limit on snap to object.
x. The speeds of the movement (the dragging) of larger picture 210. What is the overall and internal timing of the dragging of larger picture 210? Was it dragged at a consistent speed or did the drag change, i.e., speed or slow down during the drag motion?
xi. The shape of the path of the movement (the dragging) of larger picture 210. Was the path linear or constantly changing in shape? How much of the last portion of the drag was in a recognizable horizontal plane?
xii. The distance that larger picture 210 is moved. How far from smaller picture 209 was larger picture 210 positioned in the motion media? What was the resulting length of the path along which larger picture 210 was dragged? For instance, if the path was filled with curves, the resulting length of the drag (the distance larger picture 210 was moved) will be longer than if the path was a perfect straight line.
xiii. The distance that larger picture 210 is positioned away from the right edge of smaller picture 209 after the “snap to object” transaction is carried out. This would be a result of horizontal snap to object distance programmed for smaller picture 209. In the case of this example, the horizontal snap to distance for smaller picture 209 is 40 pixels.
xiv. The time it takes to change the size and location of larger picture 210 after the “snap to object” transaction is carried out. This time may be dependent upon many factors: including but not limited to, the software recognition algorithm that determines an impingement of smaller picture 209 with larger picture 210, the speed of the memory and processor for the device used to create the motion media of FIGS. 33 and 34, the complexity of larger picture 210. If it contains a complex array of pixels or a complexity of layers, its change in size and position could be slower than if it were a simple drawn rectangle.
xv. The fact that smaller picture 209 was not moved. The fact that smaller picture 209 is stationary simplifies the analysis of the action of the motion media depicted in FIGS. 2 and 3. If, for instance, smaller picture 209 was in motion when it was impinged by larger picture 210, the software may have to determine if said motion of picture 209 was a necessary condition for the applying of snap to object to larger picture 210, or if said motion in some way affected the applying of snap to object to larger picture 210.
xvi. The total elapsed time of the motion media itself (in the case of the example in FIG. 34, this is 3.000 ms 213E).
xvii. The state of any one or more saved initial conditions. The software is aware of all saved initial conditions in a motion media. Said saved initial conditions can provide new or changed characteristics, contexts and responses to inputs for any of the objects contained in a motion media. Therefore, said saved initial conditions can dynamically modify any of the above listed conditions.

Consider that the motion media described in FIG. 33 is to be utilized to program an object with the function “snap to object.” It should be noted that some of the above listed information under [380] is not strictly necessary for programming an object with a “snap to object” function and some of it is necessary. For instance, the speed of movement of the larger picture 210, the exact distance that larger picture 210 is moved, the total elapsed time of the motion media and the time taken to change the size and location of larger picture 14 210 after the “snap to object” transaction is enacted are not absolutely necessary information for programming an object with a “snap to object” function. But the information about the characteristics of pictures 209 and 14 210 and their relationships to each other are necessary for programming an object with a “snap to object” function.

In making a determination if there is sufficient information present in a motion media to program an object, there are various conditions that must be considered. Below are some of these. Please note that motion media data conditions are not limited to what is listed below.

Condition 1: Does any Information in a Motion Media Define a Programming Action?

Said information could include many aspects, including but not limited to: (a) the characteristics of any one or more objects in said motion media, (b) any one or more actions, transactions, operations, functions, or the like, presented in said motion media, (c) the environment of the motion media, (d) any one or more user inputs in the environment of the motion media, and (e) any one or more contexts.

If the answer to the above question is “yes,” then is there sufficient information contained in a motion media to fully define a programming action? If the answer to this question is “yes,” then what is the programming action that is defined by said motion media?

For the purpose of example only, referring to FIGS. 33 and 34, the motion media illustrated in these figures defines the programming action “snap to object.” The function “snap to object” is set to “on” for smaller picture 209. Dragging larger picture 210 to impinge smaller picture 209, results in a “snap to object” function (a property of picture 209) to cause a change in the dimensions and location of larger picture. Thus there is sufficient information depicted in said motion media illustrated by FIGS. 33 and 34 to be used to define a programming action.

Condition 2: What Information in a Motion Media is Needed to Enable a Programming Action, as Defined by Said Motion Media, to Program an Object?

Referring again to the motion media illustrated in FIGS. 33 and 34, the following information could be considered as necessary for programming an object with a programming action that is defined by said motion media illustrated in FIGS. 33 and 34:
i. A “snap to object” function is set to “on” for smaller picture 209.
   This setting causes a “snap to object” function to be activated for smaller picture and applied to larger picture 210 when smaller picture 209 is impinged by larger picture.
ii. Larger picture 210 impinges smaller picture 209 along a recognized horizontal plane. The software's recognition of a horizontal path enables a horizontal “snap to object” function to be applied to larger picture 210. Without said impingement, no “snap to object” function would be applied to larger picture, or if said path was recognized as a vertical path, the “snap to object” function would be applied to a vertical distance, according to what vertical “snap to object” distance was set for smaller picture 209.
iii. The “snap to” distance of 40 pixels (as part of the properties of picture 209).
   This determines the distance that larger picture 210, will be positioned to the right edge of smaller picture 209 after the “snap to” function is applied to picture, 210.
iv. The height and width of picture 209.
   These properties of smaller picture 209 determine the height and width of the rescaled larger picture 210 after the “snap to object” function is applied to larger picture 210.
v. The position of smaller picture 209.
   The position of smaller picture 209 determines the position of the right edge of smaller picture 209. The position of the right edge of picture 209 determines the position of the left edge of the repositioned picture 210 (40 pixels from the right edge of picture 209), after the “snap to object” function is applied to larger picture 210.

Condition 3: What Information is not Essential to Enabling a Programming Action, Defined by Said Motion Media, to Program an Object?

Referring again to FIGS. 33 and 34, the following information is not essential information for defining the programming action “snap to object”:
i. The time it takes to move larger picture 210 to impinge smaller picture 209 is not critical information, unless the time of this movement is desired to be preserved in the programming of an object as a real time motion. For the purposes of this example, it is not.
ii. The exact path along which picture 210 was moved is likewise not critical for the same reason and is therefore not essential to the programming of an object with a “snap to” function. Picture 210 could have been moved along many different shaped paths to achieve the same “snap to object” result.
iii. The specific distance that larger picture 210 is moved from its original position. Larger picture 210 could have been moved from any position in a computer environment to achieve the same “snap to object” result.
iv. The start and ending times of the recording of said motion media in FIGS. 33 and 34. The start and end recording times for the motion media illustrated in FIGS. 33 and 34 are not essential for the programming of an object with the “snap to object” function.
v. The total elapsed time of the motion media. Generally, the total elapsed time of the motion media illustrated in FIGS. 33 and 34 are not needed for the programming of an object with the “snap to object” function.
   NOTE: users can modify a motion media to alter its defined functionality. More on this later.

The software of this invention is able analyze a motion media in part by making many inquiries. A partial list of such inquiries is shown below.
What are the “object characteristics” of the objects in a given motion media?
Which object characteristics are important in defining a programming action?
What are the conditions for each of the objects in the motion media?
What conditions are important in defining a programming action?
What actions, elements, items or other existences comprise a context that can at any time affect any one or more objects in the motion media?
What contexts are important in defining a programming action?
What user inputs have been employed in a given motion media?
What user inputs are necessary to the defining of a programming action?
What are the timings, durations, persistence or any other time related conditions that exist in the motion media?
What time related conditions are necessary to the defining of a programming action?

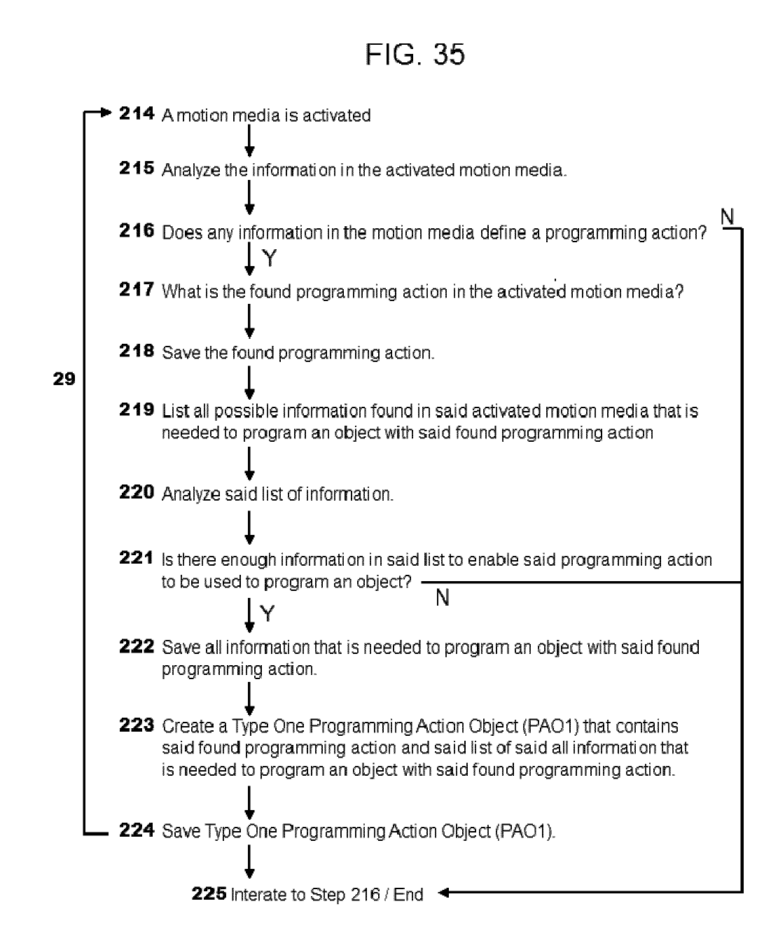

FIG. 35 is a flow chart that illustrates the analysis of a motion media and the saving of said programming action as a Type One Programming Action Object. FIG. 35 contains the following steps.

Step 214: A motion media is activated.

Step 215: The software of this invention analyzes the information contained in the motion media. In the example of FIG. 35, said motion media is live software operating in a Blackspace environment on a global drawing surface. Note: the software of this invention is not limited to a Blackspace environment or to a global drawing surface. In FIG. 35, the software analyzes information saved as a motion media. Said information includes in part the following:
i. One or more objects in a computing environment at one or more points in time. Said objects would include at least one or more of the following: a free drawn line, recognized object, graphic, picture, video, animation, website, action, invisible plane, arrow logic, and more.
ii. The properties and behaviors and other characteristics of said one or more objects.
iii. One or more tools in said environment.
iv. The state of the said one or more tools.
v. Any object to which said tools have been applied or assigned.
vi. Any context that can affect said one or more objects.
vii. Any assignments.
viii. Any object to which said one or more assignments have been applied.
ix. Any input.
x. Any change caused by anything, including any input, context, pre-programmed operation, software function or any other possible input to said environment.
xi. Any result of said any change.

Referring again to FIG. 35, since said motion media is being created live by software in a computing environment, said software is aware of the objects, tools, conditions, actions and anything else pertaining to the environment and its contents (“elements”). This permits the software's analysis of said elements to be very fast and reliable. This also permits the software of this invention to quickly apply the information assigned to, contained in or otherwise associated with a programming object to any object. This speed and reliability are key factors in the effectiveness of the defining of a programming action from information contained in a motion media. The software of this invention is generally cognizant of everything it needs to know regarding a motion media, (“motion media elements”), because without this knowledge, said software could not produce the motion media nor present it in a computing environment. That said, it is possible, indeed it is likely, that a motion media that is produced in software could contain conditions, contexts and the like that could produce new results via new inputs (like user input). In this case, some factors affecting said objects in a motion media would not be known by the software at the time of the playback of the motion media, unless the software were able to predict the likelihood of certain user inputs over time. This is discussed later.

Step 216: Does any information in a motion media define a programming action? Software analyzes a motion media's information and determines if any action, function, operation, relationship, context, user input, change, object property, behavior or the like can be used to define a programming action.

Step 217: What is the found programming action? The software of this invention determines if a programming action has been found and if so what is it?

Step 218: Save the programming action. Said software saves the found programming action. Note: as part of Step 218, the ability to name said programming action could be included. This could be accomplished by any method common in the art, e.g., via verbal means, typing means, drawing means, touching means or the equivalent.

Step 219: List all possible information found in said activated motion media. All information that is needed to program an object with the found programming action is listed by the software.

Step 220: Analyze said list of information. Said list of information is then analyzed by the software. The information in said list is checked to see if anything in the list that is critical to the programming of the found programming action is missing or if anything in the list is unnecessary.

Step 221: Is there enough information in said list to enable said programming action to be used to program an object? Based on the analysis of step 220, the software determines if there is sufficient information in said list to program an object with the found programming action. If there is not, the program ends. If there is, the program proceeds to step 222.

Step 222: Save all information that is needed to program an object with said found programming action. The software saves the information needed to program an object with the saved, found programming action of Step 218.

Step 223: Create a Programming Action Object that contains said found programming action and said list of said information that is needed to program an object with said found programming action. A Programming Action Object can be represented by virtually any visible graphic (including, a picture, line, graphic object, recognized graphic object, text object, VDACC object, website, video, animation, motion media, Blackspace Picture (BSP), other Programming Action Object or the equivalent or an invisible software object, (like an action, function, relationship, operation, prediction, status, state, condition, process or the equivalent).

Step 224: Save Type One Programming Action Object. The PAO 1 created in Step 223 is saved by the software of this invention.

Step 225: Once step 224 is finished the software method goes back to Step 214 and progresses through all of the steps again, searching for another defined programming action in said motion media. If another programming action is found and it meets the criteria described in steps 217 to 223, said another programming action is saved and the method goes again to Step 214 and the process starts over again. This continues until there is a “NO” at step 216 or at step 221. In that case the process ends and the reiterations are stopped.

NOTE: As an alternate step in the flowchart of FIG. 35, a user input could be entered after Step 19 (or thereabout), which states that there is to be one iteration or a specific number of iterations of the process described in FIG. 35. In this case when the process reaches Step 224 it will automatically end.

There are many methods to call forth a programming action from a Programming Action Object and apply it to one or more other objects. These methods include, but are not limited to, the following:
i. A Programming Action Object can be used to encircle, intersect or nearly intersect (“impinge”) one or more other objects.
ii. The impingement described under “i” above further including said Programming Action Object being moved along a path to form a gesture that is recognized by software wherein said gesture calls forth one or more programming actions contained in said Programming Action Object.
iii. A Programming Action Object can be called forth by verbal means and then said programming action of said Programming Action Object can be applied to any one or more objects via any suitable means, e.g., via a touch, mouse click, drawn input, gestural means and verbal means.
iv. A programming action of a Programming Action Object can be automatically called forth and applied to any one or more other objects via one or more contexts.

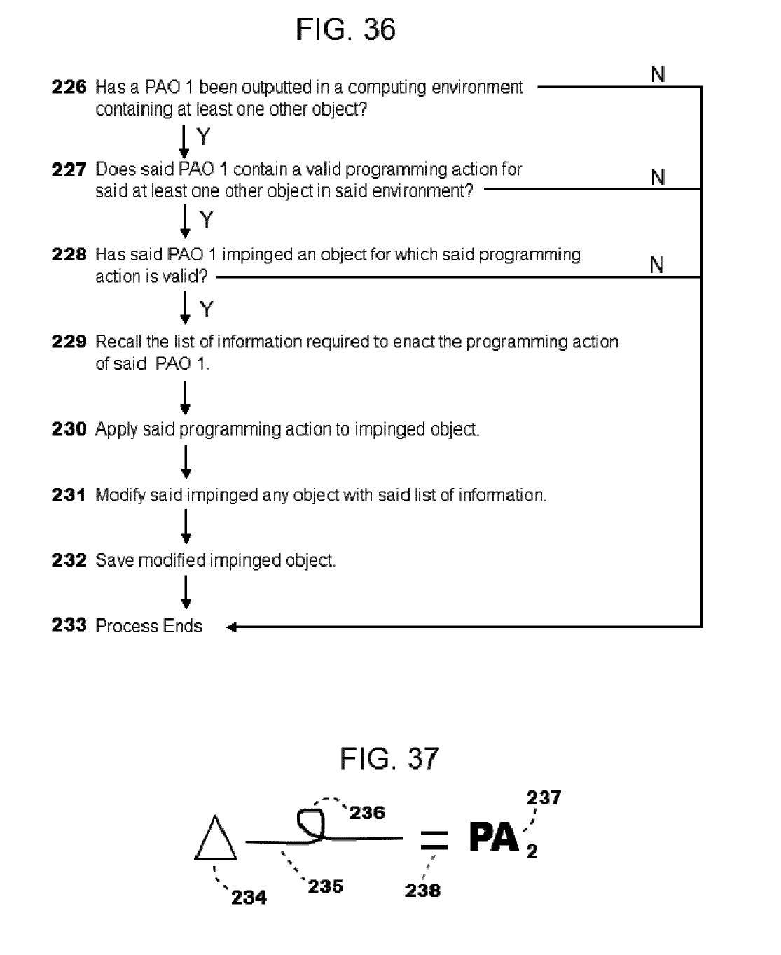

FIG. 36 illustrates the calling forth of a programming action from a Type One Programming Action Object and applying said programming action to an object via an impingement.

Step 226: The software checks to see if a PAO 1 has been outputted to a computing environment that contains at least one other object.

Step 227: The software queries said PAO 1 to determine if it contains a valid programming action for said at least one other object. In other words, does said outputted PAO 1 contain a list of information that is sufficient to successfully amend or in any way modify the characteristics of said at least one other object? If the answer is “no”, the process ends. If the answer is “yes” the software continues to Step 228.

Step 228: Has said outputted PAO 1 impinged said at least one other object? This impingement could be the result of said PAO 1 being dragged in the computing environment or it could be the result of a context or preprogrammed behavior or any other suitable cause. If “no”, the process ends.

Step 229: If the answer to the inquiry of Step 228 is “yes”, then the software recalls the list of information saved with said PAO 1.

Step 230: The software applies said programming action to impinged object

Step 231: The software modifies the impinged said at least one other object with the information in said list of said valid PAO 1.

Step 232: The modified impinged said at least one other object is saved.

Step 233: The process ends.

A Programming Action Object with Multiple Programming Actions.

Referring again to FIG. 35, let's say a second programming action is found in a motion media and let's further say that said motion media contains enough information to enable said second programming action to be used to program an object. In this case, said second programming action is saved along with a list of the information required to enable said second programming action to program an object. (Note: as an alternate the software could save the second programming action as a separate Programming Action Object.) Any Programming Action Object can contain any number of programming actions. Each programming action could include a list of all information required to program an object with said saved programming action.

FIG. 37 illustrates the designation of a gesture 236 to be used to select a programming action from Programming Action Object 234 to be applied to an object impinged by Programming Action Object 234. The idea here is that for a Programming Action Object that contains more than one programming action, the shape 236 of the path 235 along which said Programming Action Object 234 is moved can automatically determine which programming action of Programming Action Object 234 will be applied to an object impinged by Programming Action Object 234.

Said gesture 236 calls forth a selection action. Thus if the path 235 of Programming Action Object 234 includes gesture 236, when Programming Action Object 234 impinges one or more other objects, the programming action that will be applied to said one or more other objects will be programming action 2 (PA₂) 41 237. PA₂ 237, is called forth according to the recognition of gesture 236. It should be noted that any number of programming actions can be contained within one Programming Action Object. In summary, FIG. 37 illustrates an equation to program a behavior to a Programming Action Object “POA.” POA 234 is drawn followed by a path 235 which includes a gesture 236. This is followed by an equal sign 238. This equation creates a programming action (PA₂) 237.

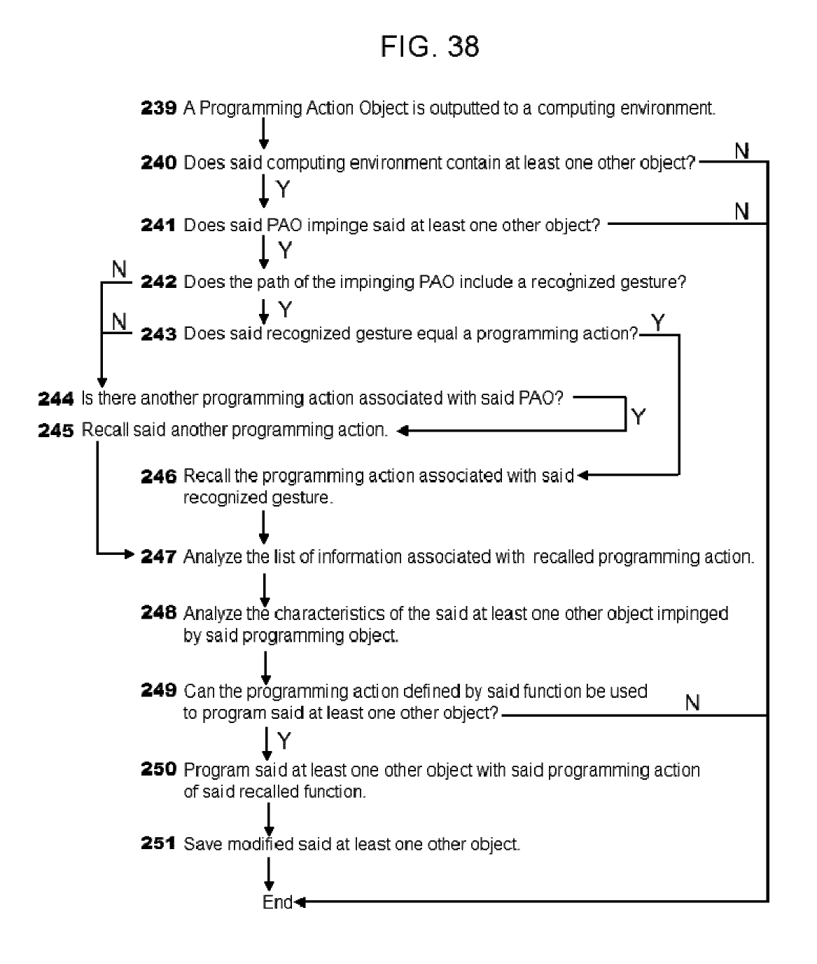

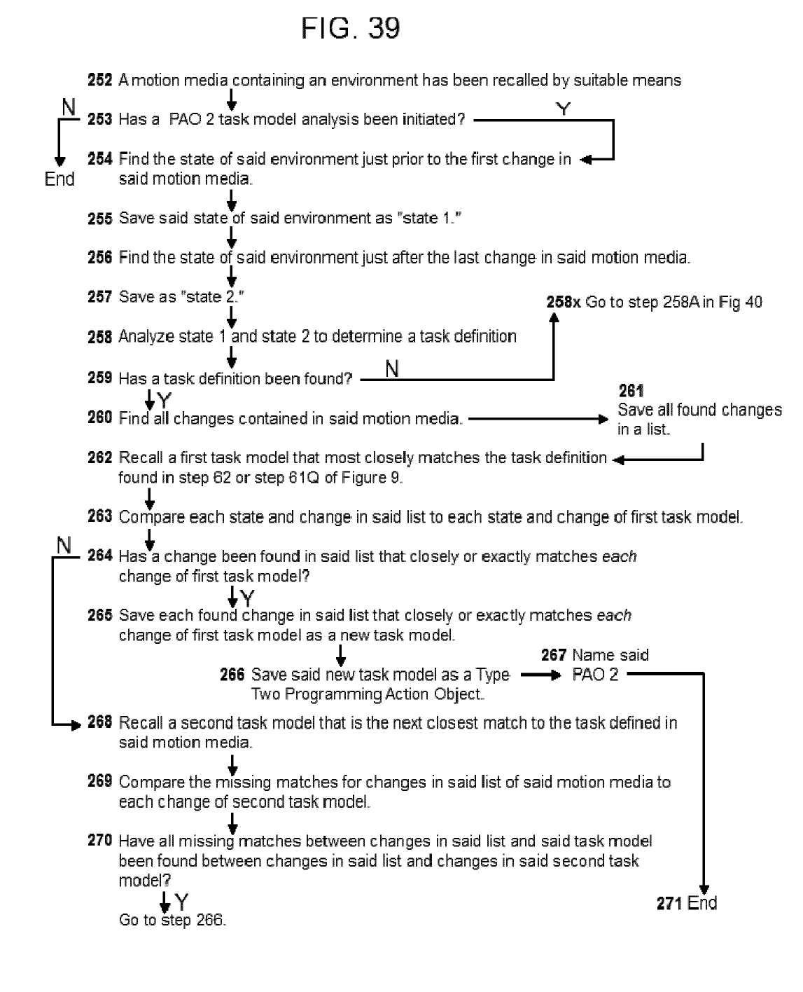

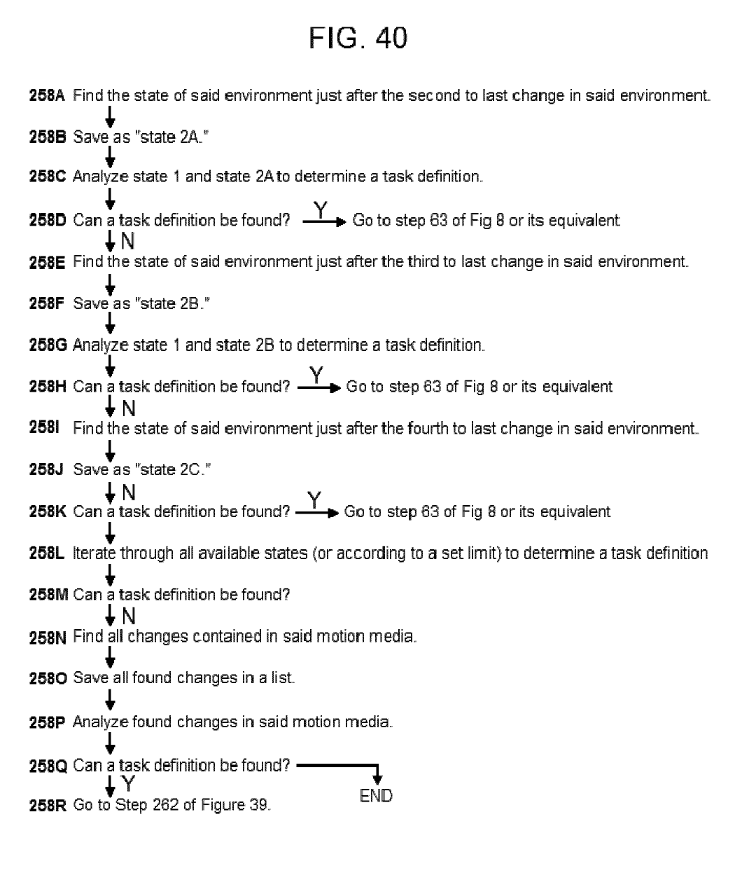

Referring now to FIG. 38, this is the flow chart showing the steps regarding impinging an object with a programming object where the path of the impingement includes a recognized gesture that calls forth a programming action. If any programming action object contains more than one programming action, said programming action object can be interrogated by many methods common in the art. These include, a gesture, verbal utterance, right clicking or double touching or otherwise causing one or more objects or menu or the equivalent to appear that shows a visual presentation of the programming actions in a programming action object. As an alternate to said menu, a digital audio response could present an explanation of said more than one programming action.

FIG. 38 is a flow chart that describes the programming of an object with a Programming Action Object containing more than one programming action. FIG. 38 further describes the use of a recognized gesture in the path of a programming action object that is used to impinge another object for the purpose of programming it. Please note that the definition of a gesture in FIG. 38 could be produced in many ways. The gesture could be defined with the motion of a hand or finger in the air. As an alternate, the gesture could be defined by a movement of some kind, like dragging a programming action object in a computing environment. Further, a gesture could be defined by drawing with a pen, finger, mouse or other suitable means in a computing environment. Other possibilities for creating gestures exist, for example, via verbal means or context means or via one or more relationships, user-programmed action, pre-programmed action, via a motion media, animation or any other means or method known to the art.

Step 239: A Programming Action Object is outputted to a computing environment.

Step 240: The software of this invention checks said computing environment to see if it contains at least one other object. Said at least one other object could be anything, including another Programming Action Object (PAO).

Step 241: The software of this invention checks to see if said Programming Action Object has impinged said at least one other object. If the answer is “yes,” then the method proceeds to Step 242. If “no,” then the method ends.

Step 242: The software of this invention analyzes the path of said Programming Action Object that has just impinged said at least one other object. The software checks to see if the said path includes a recognizable gesture, i.e., some shape that the software can identify and distinguish from the rest of the path. If “yes”, then the method proceeds to Step 243. If “no,” then the method proceeds to Step 244.

Step 243: The software checks to see if there is a programming action assigned to, equal to or otherwise associated with said recognized gesture. Accordingly, incorporating a gesture in a path that results in a Programming Action Object impinging another object will recall and/or activate the programming action that belongs to said gesture. If the software determines that said recognized gesture equals a programming action, then the method proceeds to Step 246. If the software determines that said recognized gesture does not equal a programming action, then the method ends.

Step 244: If said recognized gesture does not equal a programming action, then the software looks for another programming action.

Step 245: If another programming action is found in Step 244, the software recalls said another programming action.

Step 246: The software recalls said programming action associated with said recognized gesture.

Step 247: The software analyzes the list of information associated with the recalled programming action. Generally, this is the list of information required to enable a programming action to be used to program an object.

Step 248: The software analyzes the characteristics said at least one other object which has been impinged by said Programming Action Object. The reason for this analysis is that the software cannot properly determine if a programming action is valid (can be used to successfully program an object) until the software is aware of said at least one other object's characteristics.

Step 249: The software compares the programming action that was called forth in Step 245 or 246 of FIG. 38 to the characteristics of said at least one other object. The software makes a determination as to whether said programming action can be successfully used to program said at least one other object. In other words, “is the programming action a valid action for said at least one other object?” If the answer is “no,” then the process ends. If the process answer is “yes,” then the process proceeds to step 250.

Step 250: Said programming action is used to program—alter, modify, append or in any way be applied to or cause change to—said at least one other object.

Step 251: The software saves the newly programmed said at least one other object. As an additional step, the ability to name said newly programmed said at least one other object can be presented here. The naming of this object can be by any means common in the art.

Using a Type 1 Programming Action Object (“PAO 1”) to program an object is dependent upon the characteristics of the object being programmed by the PAO 1.

As previously described, the software of this invention can make queries to a motion media in order to determine if a viable PAO 1 can be derived from a motion media. The software searches a motion media to find every piece of data that can be used to define a programming action. In this process a key software query is: “How much of the data recorded as a motion media data is necessary to enable a PAO 1 to program another object?” The answer to this query can be quite complex. First, the software must find the data necessary to program one or more objects with one or more characteristics or a task and compile said data in a list. But the answer to this question depends upon not only said list, but also upon the characteristics of each object that a PAO 1 is being used to program. The characteristics of said each object would, at least in part, determine the validity of the PAO 1's ability to be used to modify said each object's characteristics.

At its simplest level a PAO 1 consists of three things: (1) the definition of a program action, (what does a PAO 1 represent and/or what does it do?), (2) an identifier, either designated by a user, pre-programmed, via context, relationship, controlled by an environment, or via any other suitable means, and (3) a list of the elements that define the function, action, operation, purpose, and the like, of the PAO 1. It should be noted that any Programming Action Object can be used to program any one or more objects and/or environments via any suitable means. This includes, but is not limited to: impingement, programmed action, drawing means (like a line, arrow or object), context means, verbal means, and the equivalent.

Programming Actions

One PAO 1 can have many different programming actions contained within it, assigned to it or otherwise associated with it. In other words, a PAO 1 can contain multiple programming actions. A programming action generally includes an identifier and a list of elements that define said programming action.

For the purposes of illustration only, let's say that we have one PAO 1 containing one programming action and one list. Let's now say that said PAO 1 is outputted to program another object in a computing environment or its equivalent. Given these conditions, the software of this invention would determine if said PAO 1 is capable of programming said another object by performing one or more analyses. Some of these analyses are listed below in no particular order.
a. Determine the characteristics of said one other object.
b. Analyze the programming action contained within the PAO, including analyzing a list of elements associated with said programming action.
c. Compare the characteristics of said one other object with said list of elements and make several determinations which include but are not limited to the following:
   Is the programming action of said PAO valid for programming said other object? In other words, can the programming action of said PAO be used to program any part of the characteristics of said other object?
   What part, if any, of the characteristics of said other object can be programmed by said PAO?
   Is the path, if any, of said PAO a factor in the programming of said other object with said PAO?
   Is there more than one “other object” required in order to produce a valid programming action of said PAO?
   Does any context exist in the computing environment where said PAO has been outputted that would in any way affect and successful implementation of any programming action contained within said PAO.
   In what specific ways would each found context affect the programming of any one or more objects with any one or more programming actions of said PAO?

Regarding section [436], line “a.” above, let's say that said PAO 1's programming action is to enable a certain type of equalization for a sound. Let's further say that said PAO 1 was outputted to program a blue circle that had no assignments to it. Said outputting of said PAO 1 would not likely result in said PAO 1 applying a valid programming action to said blue circle. In general, employing an audio graphic equalizer is not a valid programming action for modifying (programming) a blue circle object with no assignments to it. Continuing with this example, if said PAO 1 determined that its programming action was invalid for said blue circle, the software of this invention could further interrogate or otherwise analyze the contents of said PAO 1 to determine if any other programming actions exist within it. If an additional programming action is found, the software would compare said additional programming action to said blue circle's characteristics to determine if said additional programming action is valid for programming said blue circle.

Let's say the software found a second programming action defined in said PAO 1. Let's further say that said second programming action was a tweening action. The software would then determine if said second programming action could be used to program said blue circle. For example, let's say that said tweening action could be applied to a single graphic object. If that were the case, then said tweening action may be a valid programming action for said blue circle. But if said tweening action could only be valid if applied to more than one object, then the software would determine that said tweening action of said PAO 1 is invalid for said blue circle as a single object.

However, let's further say that said PAO 1 (with its tweening action) was outputted to program two objects instead of one. Now the applying of said tweening action of said PAO 1 to said two objects could be valid. In addition, said valid application of said tweening action could be modified or influenced by a context. An example of this would be the shape of a gestural path used to program said two other objects with said PAO 1. For example, if the path of said PAO caused it to impinge a first one of said two objects and then a second one of said two objects this would determine the direction of said tweening action. Thus the order of impingement would modify the result of the programming of said two objects with said PAO 1. Further, the path of said PAO 1 could be a factor in the programming of said two objects with said PAO 1. For instance, if in said list for said tweening action within said PAO 1 it is cited that the shape of a path can determine the way in which a tweening action is applied between two or more objects, then said shape of said path becomes a factor in the programming of said two objects by said PAO 1. An example of the shape of a path affecting a tweening action could be that the tweening of said first and second objects would progress along the shape of said path of said PAO 1.

Type Two Programming Action Objects

Type Two Programming Action Objects include sequential data, and enable the use of sequential data for the programming of one or more environments and/or the contents and/or data of said one or more environments or one or more objects, which would include Environment Media (“EM”). The software may consider all or part of an Environment Media as an object. This process can include the environment from which said sequential data was derived. Said sequential data can be user-generated, programmed, pre-programmed, determined via context, relationship, or any other procedure, operation, method, scenario, or the like, that is supported by said environment.

Regarding user-generated operations, a user can cause inputs to an environment that contains any set of conditions, objects, relationships, states, contexts, external links, networks, protocols, tools and anything else that can exist in, enabled in or be associated with said environment or Environment Media. Regarding said environment or said Environment Media, a user can create, produce and/or employ any series of operations, enact any number of scenarios on any number of protocols, and/or cause any change to said environment, its contents or anything associated with said environment, herein referred to as “user input.”

In another embodiment of this invention, as user inputs are performed in an environment or associated with an environment, the software of this invention records changes to said environment, which can include said environment's data and content, as a motion media. (Note: this approach applies to all types of Programming Action Objects.) Said motion media can also record states of objects, devices and the like, states of said environment, and characteristics of any object, device, data, content or the like associated with said environment. Also as part of this recording process, the software can record sequential data—which includes operations relating to time—and to what extent said sequential data affects change in said environment, its contents, and anything associated with or related to said environment. In the creation of a Type Two Programming Object, the focus of the software includes the environment, as well as the characteristics of the objects and data said environment contains, and objects, contexts, inputs and other data that may affect said environment and its contents.

The software of this invention can make many queries to a motion media. Some examples might include the following. “What is the state of said environment?” “What changes are occurring in said environment?” “What user inputs are occurring and how are said user inputs affecting (changing) said environment or its data?” “How do user inputs change the context of any one or more objects in said environment?” “How does any change in context affect any relationship between any one or more objects that exist in said environment?”

The software of this invention can track and record change in and associated with one or more environments and record the points in time where said change occurs. The software records sequential data that results in any change including: changes in the state of anything in said environment, changes in the characteristics of any object or data in said environment, changes in any context, changes in any relationship to said environment or to the contents of said environment. Further, the software records not only the objects that are changed and what is changed, but also how these objects are affected by changes in said environment and how said environment is affected by changes in said objects and how changes in said objects affect other objects and so on. Still further, the software records how the changes to or in said objects affect any one or more context that in turn affect one or more pieces of data and how said changes in said one or more context affect objects that are being interacted with via any means at any point in time. In short, the recording of a motion media can include all change of any kind in or associated with any environment or object.

Environment

In summary, An Environment Media can be a much larger consideration than a window or a program or what's visible on a computer display or even connected via a network. An Environment Media can be defined by any number of objects, data, devices, constructs, states, actions, functions, operations and the like, that have a relationship to at least one other object in an Environment Media (“environment elements”), and where said environment elements support the accomplishing of at least one task or purpose. Environment elements could exist in, on and/or across multiple devices, across multiple networks, across multiple operating systems, across multiple layers, dimensions and between the digital domain and the physical analog world. An Environment Media is a collection of elements related to one or more tasks. Said collection of elements can co-communicate with each other and/or affect each other in some way, e.g., by acting as a context, being part of an assignment, a characteristic, by being connected via some protocol, relationship, dynamic operation, scenario, methodology, order, design or any equivalent.

Sequential Data

Time is sequential in the sense that events of change occur according to time. But the order of said events can be linear, non-linear or both. As a result, the discovery of sequential data from a motion media and the use of said sequential data to produce a programming action may not result in the creation of a Type Two Programming Action whose sequential data exactly tracks the specific order of user inputs recorded in said motion media. In part, this is true because it is likely that said sequential data will not be limited to user inputs. In fact, it is possible that said sequential data will include non-user inputs and could even be made up of a majority of non-user inputs. In addition, like a Type One Programming Action, a Type Two Programming Action must include enough data to enable a programming action to be used to program something. Regarding a Type Two Programming Action, what it programs can be an environment, as well as one or more objects in an environment or more objects that exist outside any defined environment. Note: the amount of change in a given environment, including changes to various layers of that environment, could be substantial and could exceed the number of user inputs that are recorded in a motion media for said given environment. Further, the interdependence of objects in an environment can also be complex. Recording changes affecting this interdependence may result in a time sequence that differs from the strict recording of user inputs.

Another reason that said sequential data may not exactly track the order of user inputs, as recorded in a motion media, is that user inputs may contain mistakes, false starts, or changes in the user's approach to accomplishing the task being recorded by a motion media. Another reason is that user actions or any one or more results of said user inputs may not be directly associated with the task being accomplished by the user. As a result, the final sequential data in a motion media may have parallel elements and operations and/or branches of operations that may be much more complex than the original user inputs recorded in a motion media.

During the recording of a motion media, in part, the software is tracking and cataloguing change. The speed of this change may be according to the fastest time a given computer processor and its memory structure can compute commands to a computing system. Said speed may also be determined by the complexity of said change. Among other things, the timing input and output of a motion media may vary according to the processor and memory structure of the computing system used to record said motion media, and according to the complexity of said change that is recorded as said motion media.

Note: as previously noted, the software of this invention can regard an environment as an object. An Environment Media may be invisible to the user, but said Environment Media can have a visible representation and can be modified by applying one or more programming actions to said Environment Media via its visible representation.

There are many methods to derive a Type Two Programming Action Object from a motion media. Two such methods include: (1) Task Model Analysis, and (2) Relationship Analysis.

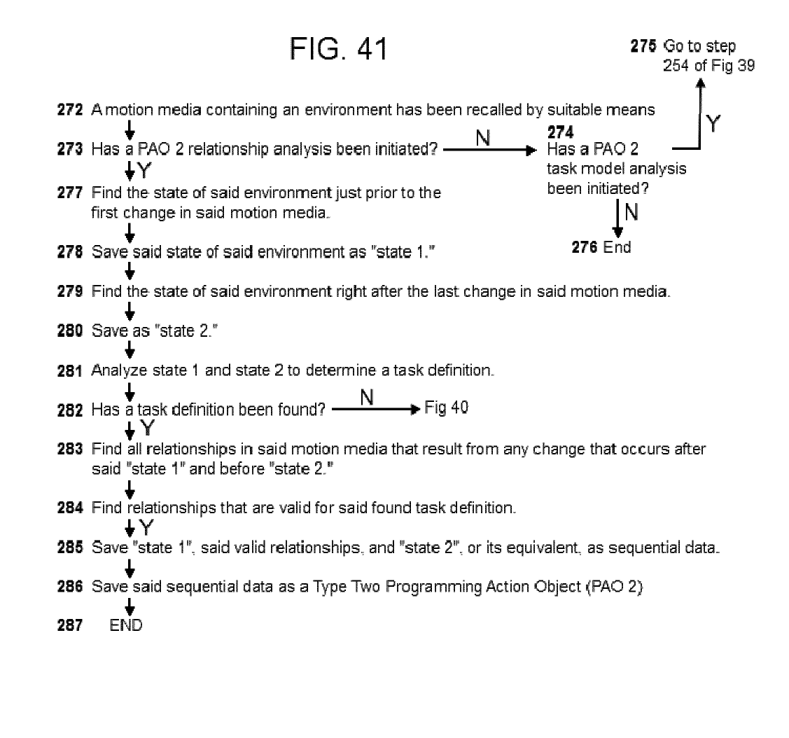

Referring now to FIG. 39, this is a flow chart illustrating a method of creating a Type Two Programming Action Object (“PAO 2”) using a task model analysis. As previously explained, a Type Two Programming Action Object generally involves sequential data. The flowchart of FIG. 39 is an example of possible steps in creating a PAO 2 from a motion media using a task model.

Step 252: A motion media has been recalled. Generally, a motion media will include an environment, but it is not a precondition of a motion media. In the flowchart of FIG. 39, the motion media that has been recalled does include an environment. Said environment can be recalled by many means common in the art, including, by verbal means, drawing means, typing means, gestural means, via a menu, icon, graphic, assigned-to object, and more. Further, said environment may include any of the following items: objects, definitions, image primitives, context, actions, inputs, devices, websites, VDACCs, other environments or the equivalent. Note: as previously described, an environment can be defined by one or more relationships between objects and between any data, regardless of where said objects and data are located. That would include data in a website, on the cloud, on a server or network, or any device, like a smart phone or pad. Thus said environment of Step 252 could include all data, inputs, contexts, actions, relationships, characteristics, and the equivalent, that are recorded in said motion media. Further an environment which is an object which can be invisible or be represented as some type of visualization.

Step 253: This step illustrates one of many possible approaches for creating a PAO 2 from a motion media. In step 253 the software receives an input that initiates a PAO 2 task model analysis. Said PAO 2 task model analysis is the software of this invention analyzing the states, inputs, relationships, changes, context and the equivalent, recorded as a motion media, to determine a definition of a task. Said analysis includes both static and dynamic data A PAO 2 task model analysis can include the analysis of sequential data or its equivalent.

Step 254: The software attempts to identify what type of task has been recorded as said motion media, recalled in Step 252. There is more than one way to make this determination of a task. Steps 254 to 258 illustrate one such approach. In step 254 the software identifies a state saved in said motion media, which is the state of said environment when the first change occurred in said environment. Said first change could be anything that is supported in the software for said environment. Said first change could be a change in the characteristics of an object, or an input, like a touch or drag or drawn input, or gesture, or anything that can produce a change of anything in said environment, including a change to said environment itself as a software object. Thus the software identifies the first change recorded in said motion media and then identifies the state of said environment at the point just before said first change occurs.

Step 255: Said state of said environment at the point just before said first change occurs is saved with an identifier of some kind. In step 255 that identifier is: “state 1”.

Step 256: The software determines the state of said environment just after the last change recorded in said motion media.

Step 257: The state found in step 256 is saved with the identifier: “state 2.” Said identifier is saved for said state of said environment just after the last change recorded in said motion media. This identifier can be user-defined, but it this case it is automatically saved in software and is assigned an identifier automatically.

Step 258: The software of this invention analyzes “state 1” and “state 2” and attempts to determine a type of task from the analysis of these two states. The general idea here is that a task starts from a point in time and from a definable state. The software is assuming that this starting state is “state 1.” A task usually ends at another point in time and at another definable state. The software is assuming that this end state is “state 2.”

Step 259: The software checks to see if a definable task (“task definition”) has been found. In other words, do states 1 and 2 define a task? The software uses the starting state and the ending state to attempt to define a task. The starting state is before any changes occur in said motion media, and the ending state is after the last change that occurs in said motion media. The idea here is that a task is a series of actions that start at one point in time and end at a later point in time. By analyzing the difference between the starting and ending states, software can often make a determination as to what task may have been accomplished. If the answer to the inquiry of step 259 is “no,” then the software goes to step 258x. This step takes us to step 258A found in FIG. 40. If the answer is “yes”, the software goes to step 260 of FIG. 39.

Step 260: Once a task has been determined, the software finds all changes and states contained in said motion media.

Step 261: All found changes and states are saved in a list. The process continues to Step 262 or the process of FIG. 40 continues to Step 262.

Regarding FIG. 40, step 258A: If no task definition can be determined, the software searches for another state to become the end state for the determination of a task. The software finds the state that exists at a point in time right after the second to last change occurs in said environment.

Step 258B: This new state is saved with the identifier “state 2A.”

Step 258C: The software attempts to define a task from a comparative analysis of “state 1” and “state 2A.”

Step 258D: Has a task been defined from said analysis of step 258C? If the answer is “no,” the software continues the process of finding another ending state. If the answer is “yes,” the software goes to step 63 of FIG. 8 or its equivalent.

Steps 258E to 258M: if the software cannot define a task from states “1” and “2A” it finds the state of said environment right after the third to last change occurs in said environment. The software then tries to derive a task definition from states “1” and “2B”. If a task cannot be determined from these states, the software finds the state right after the fourth to last change, as recorded in said motion media, and tries to define a task through analysis of states “1” and “2C”, and so on. The software either stops this process at set limit of iterations or stops this process when it can successfully define a task by analyzing two states.

Step 258N: If a task definition cannot be determined by an analysis of “state 1” and some ending state, the software finds all changes recorded in said motion media recalled in step 55 of FIG. 8.

Step 258O: all changes found in step 258N are saved in a list or its equivalent.

Step 258P: The software analyzes the changes in said list of step 258O. The software uses the analysis of these changes along with “state 1” and each of the previously analyzed end states (i.e., state 2, state 2B, state 2C and so on) to determine a task definition.

Step 258Q: Has a task definition been found? If the answer is “yes”, the software goes to step 262 of FIG. 8. If the answer is “no”, the process ends.

Referring again to FIG. 39, Step 262: The software searches a data base, network or any other source of task models and finds a first task model that most closely matches the task defined in Step 259 of FIG. 39 or in step 258Q of FIG. 40. Task models can take many forms. One form would be a list of changes that act upon a first state just prior to the first change and end at a state following the last change in said list. Thus a task model has a starting state, and ending state, and a series of one or more changes that exist between said starting and ending state. Task models can be created via many different means. This includes: via software programming, user definition, user programming, software analysis of user work patterns, software analysis of motion media, and the equivalent. Task models can also include logical statistics. Said logical statistics can include the likelihood of certain changes based upon one or more previous changes.

Step 263: The software compares each change in said list (of Step 261 or Step 258O) to each change found in the recalled first task model (of Step 262). It should be noted that the changes found in step 260 and saved in step 261 will likely include changes in states. Generally a change in any environment element will produce a change in the environment containing, related to, or otherwise associated with said any environment element. Said change in any environment element can comprise a change in a state of said environment. The software attempts to match each change found in said list, (saved in Step 261 or step 258O) to a change found in said first task model. The goal is to match every change in said first task model with a change found in said list of step 261 or 258O. Note: the matching of change is not necessarily dependent upon an exact criterion, but rather upon a category of change. For instance, a change in a task model might be a specific piece of text, like a specific number, e.g., number 12 or 35. The software is not concerned about the specificity of the number, unless the specificity itself comprises a category. If such is not the case, the software looks for a category of change. For purposes of an example only, if part of a task is adding an indent to the first word in a sentence of text, the characters that comprise the first word in the sentence are not of critical importance. What is important is the change to the indent of said sentence. That is the category that is modeled, not the exact characters that comprise the first word in said sentence.

Step 264: The software makes a query: has a match been found for each change in said list to each change in said first task model? If the answer is “yes” the process continues to step 265. If “no” the process goes to step 268. Note: there may be more changes saved in said list than what has been determined to match each change in said first task model. Thus all changes in said list may not be selected as a final list matching said first task model.

Step 265: Each change found in said list (of Step 264) that matches a change in said first task model is saved as a new task model.

Step 266: Said new task model is saved as a Type Two Programming Action Object (“PAO2”). Note: said new task model comprises a collection of changes that match the categories of changes found in said first task model found in Step 259. Note: If said new task model is an exact duplicate in both form and function of said first task model, then said new task model may be of little use. But more likely, said new task model may match or closely match the categories of said first task model, but may contain different actions, operations, characteristics of one or more objects, contexts and the like. Further, the matching of items in said list of step 264 to said first task model can be according to a percentage of accuracy. This percentage can be applied by any means known to the art. Some examples would include: via a user input (touch means, drawing means, verbal means), via a menu, via a context, via a configuration and many more possibilities.

Step 267: The saved PAO 2 is supplied an identifier. The supplying of said identifier can be via a user action or a software action, which could be programmed via a user-input or pre-programmed via any suitable means, like a configuration file.

Step 272: The process ends.

Step 268: Regarding a “no” answer to step 264, the method goes to step 268. This step is required in the case where the software cannot match every change in said first task model, (recalled in step 262), with a change in said list. In this case, there are one or more changes in said list that have not been matched to a change in said first task model. Accordingly, the software finds and recalls a second task model that is the next closest match to the task defined in said motion media.

Step 269: Regarding any change in said list that has not been matched to a change in said first task model (“missing changes”), the software works to find matches to said missing changes in said second task model.

Step 270: The software verifies that all missing changes in said list now have a matching change in said new task model. If “yes”, all changes in said list have been matched to a change in said first or said second task model, the process continues to step 266. If “no,” all changes in said list have not been matched to a change in said first or second task model, the process ends at step 271. NOTE: this process could be modified to permit the software to search through the changes in more than two task models for matches to changes in said list. The number of iterations through multiple task models would be determined by any suitable means.

Applying a Type Two Programming Action

The process of creating and using a type two programming action can generate a complicated set of software calculations. The good news is that from the user's perspective the use of a type two programming action is simple. It could be a simple action, like dragging a Type Two Programming Action Object (PAO 2) into an environment or impinging any visible representation of an environment with a PAO 2 or creating a gesture with a PAO 2 or making a verbal utterance or anything can initiate a PAO 2, including the activation of a PAO 2 as the result a context. Said simple action would cause the “list” of changes saved in said PAO 2 to be applied to an environment or object. The software figures out how to apply sequential data of a PAO 2 to an environment or to one or more objects. The hard work is done by the software, not the user. Thus a simple user action can result in a very complex series of actions. Many of these actions may occur in non-real time and in many cases may be invisible to the user.

In any event the programming of an object with a Type Two Programming Action is far from a simple playback of scripted events or user inputs, recorded as a macro. Regarding a PAO 2, one thing that the software of this invention accomplishes is the discovery of sequential data in a motion media and the analysis of said sequential data to create a list of changes that were recorded in said motion media. Further, the software analyzes said sequential data to determine what task said sequential data represents, namely, what task is being performed, if any, by said sequential data?

Regarding the creation of a PAO 2 from a motion media, the software analyzes the available data in a different way from how it creates a PAO 1 from a motion media.

To review the process for a PAO 1, the software derives a list of elements from a motion media that define a programming action, and then determines how many of said elements and/or events in said list are necessary to enabling a programming action to program an object. In other words, the software looks to see how many of the said listed elements or events are required for defining a valid programming action. The software must determine if there are enough elements in said list to define said valid programming action for one or more objects. Also the determination of said valid programming action is dependent upon the characteristics of the one or more objects that are to be programmed by said PAO 1. In other words, the characteristics, contexts, and other factors belonging to, associated with, or being used to control an object are a significant factor in determining whether a PAO 1 can be used to program any object. Thus the software must analyze each object that is to be programmed by a PAO 1 and compare the characteristics of said each object to said list of elements for said PAO 1. Note: The number of listed elements needed to program an object by a PAO 1 may vary depending upon the object being programmed by a PAO 1.

Regarding a PAO 2, the software can be concerned with both objects and the environment that contains these objects. For example, let's take a financial environment. A user is creating formulas and entering data in certain fields and the user is accessing additional data from one or more external sources, for instance from a data base via a network that enables the user to acquire data from said data base from said financial environment. In this case, the software of this invention can be used to record all user inputs and all changes to said environment and to said external data base. [Note: the software of this invention may treat said financial environment and said external data base as one integrated or composite environment or further as one object.] The software records the software operations in said financial environment. This includes each state of the environment and each change to each state of said environment and each change to each object in said environment. The software make many queries, such as: “What comprises the environment?” “What does the environment contain?” “What relationships does the environment have to any object, function, logic, network, cloud, server, data base, device, user, shared communication, collaboration or to another environment?” [Note: two environments that have shared relationships, contexts, objects, devices, protocols or the like can be considered by the software of this invention to be one environment or one Environment Media (“EM”).]

With a PAO 2, among other things, user operations are analyzed to determine what change, if any, said user operations cause to one or more objects in an environment, and also what change, if any, said user operation causes to the environment itself. An example of a change to the environment itself could be changing the identifier of said environment or removing one or more relationships which would alter the scope of said environment. As previously cited the software of this invention can consider an environment as an object and track all changes to said environment, which would include changes to objects associated with said environment. The recording and tracking of changes can be user controlled or via some automatic process. In either event the software can make other queries. For example: “Does a user operation change one or more relationships between one or more objects in said environment?” “Does any change in said one or more relationships produce a different context that affects one or more objects in said environment?” “If so, what objects are affected and does any change in context cause a change in any characteristic of any object in said environment?” “If so, what characteristics are changed, and so on?” In one view, any of the changes described above could be considered a change to an environment.

As previous disclosed, any Programming Action Object can be enabled by the use of state conditions. In part, change is catalogued or preserved in a motion media according to how said change affects objects and their characteristics. A new state condition could be saved to preserve any change in an environment. This could include any change in the environment's existing organization, positions of objects it contains, any relationship (both between objects contained in the environment and between the environment and external items), a change in any logic, assignment, dynamic event, context, configuration and anything else that can be operated or be associated with said environment.

Preserving changes in an environment by saving any changed state of the environment could result in a large number of new state conditions being saved. Different logics could be employed to manage a decision process of the software to determine when state conditions would be saved or not. For instance, if there were a change in the characteristics of one object, but this change did not affect any relationship, context or any other data in an environment, a new state condition may not need to be utilized. If however, said change in the characteristics of one object affected one or more characteristics of one or more other objects in an environment, a state condition reflecting said change may be required and would thus be preserved in a motion media.

For each change in an environment the software could analyze the change (and other changes to various environment elements, like context, relationship, assignment and more) and determine if said change significantly impacts a future operation that occurs in said environment. Thus, an assessment can be made by the software that takes into account what types of operations may likely be made based upon the last one or series of recorded operations. This assessment may further impact the decision of what prior state conditions are preserved in a motion media, if any.

If the software determined that a new change did impact a future operation or formed the foundation for next operations to be performed, the software could go back in time and preserve one or more state conditions of the environment just prior to the point in time that said new change occurred.

So the software may need to make a decision as to whether a state condition is needed dependent upon a future user operation. To enable this process, the software could temporarily save one or more state conditions. The software would analyze ongoing operations in an environment and make a determination as to what, if any, past state conditions are needed to be referenced to ensure that said ongoing operations (e.g., inputs that cause change) can be accurately recreated and/or modified in a motion media. If the software determines that any temporarily saved state condition is needed, the software can go through a list of temporarily saved state conditions and permanently save or flag any state condition. The circumstances or rules for saving temporary state conditions can be user-determined, pre-programmed, set by the software according patterns of use, context, input, or by any other suitable criteria or method. Thus the software could temporarily save state conditions as they occur and then flag, save or erase them as they may or may not be required by future events that have not yet occurred at the time the state conditions were saved.

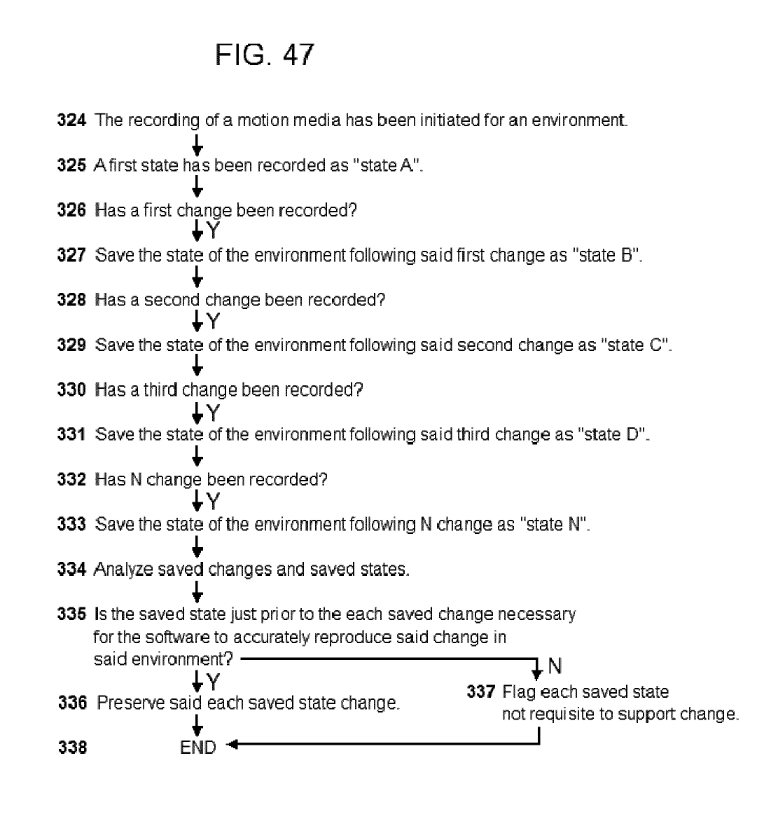

FIG. 47 illustrates an example of the above described method.

Step 324: The recording of a motion media has been initiated for an environment.

Step 325: A first state has been recorded as “state A” in said motion media. As is explained herein, the first state of a motion media contains important information to permit software to recreate change recorded in said motion media.

Step 326: The software checks to see if a first change has been recorded in said motion media. One key issue here is whether said first change significantly alters “state A” such that future changes in said motion media may not be correctly produced in software without starting from “state A.” This may not be practical for a viewer of said motion media. For instance, if it is desired to start the viewing of said motion media at some point beyond the start of said motion media, changes made in “state A” may complicate the software's ability to accurately reproduce any one or more results of said changes. By preserving more states, the software has more data to analyze and use to reproduce an accurate rebuilding of all conditions associated that may be caused by an given change recorded in said motion media.

Step 327: As a default operation for the recording of data for a motion media, the state of an environment can be recorded following each change made to said environment which includes a change to any of its contents. However, it may not be necessary to refer to every state that is recorded in a motion media in order to accurately produce all results of any single recorded change in a motion media. Through analysis of available recorded information in a motion media, the software can determine which states are requisite for reproducing any one or more changes recorded in a motion media and which are not. Those states that are not requisite can be deleted, flagged as backups, or preserved in some manner to permit access as may be needed.

Steps 328 to 333: The software that records a motion media saves all changes and all states just prior to each change. Note: states following each change may also be recorded. Note: changes in any state may include the results of any change caused by any input. Said changes could comprise a complex number of changes, some of which may be invisible to a viewer of a motion media. Examples of invisible changes could include: the status of any object or data, any transaction applied to any assignment, any characteristic of any object that affects that object's behavior, and so on.

Step 334: The software analyzes the saved changes and saved states in said motion media (recalled in step 324).

Step 335: For each saved state, the software determines if said state is necessary to enable software to accurately reproduce each change and all of the results of said each change. This is a iterative process and in part can be used as a self-diagnostic for the software to ensure that a motion media has recorded sufficient data to reproduce any one or more tasks that were recorded in said motion media. This process can also serve as an optimization process to enable the software to eliminate, subjugate, or save as an alternate or backup recorded data that is not directly needed to complete one or more tasks in said motion media.

Step 336-337: For each state that is required to support the accurate reproducing of recorded change in a motion, said each state is preserved. This preservation of states is subject to other criteria than may alter the decision process just described. For instance, if the software determines that a change (as recorded in a motion media) is not necessary to produce the task of a motion media, then said change can be deleted, subjugated or saved as an alternate or backup. Further, any new state created by said change can also be deleted, subjugated or saved as an alternate or backup. By this process any user mistakes in performing a task that are recorded in a motion media can be removed from consideration by the software. The decision to preserve data that is not directly needed to perform the task of a motion media can be user-defined, according to a configure file, preprogrammed in software, determined by context or via any other via method.

Step 338: When the software completes its analysis of change and states in a motion media the process ends.

Type Two Programming Object Models

Rather than just recording and playing back user inputs in an environment, the software of this invention can analyze a motion media and from this analysis produce one or more model elements. Said model elements are not necessarily specific to the objects that were interacted with during the recording of a motion media. The software creates models from change and from the results of change in the motion media that was used to record said change and its results. A model can be applied to any object, which can be an environment, and the result will be valid as long as the characteristics of said any object, including information in an environment, is valid to said software model(s).

In another embodiment of the invention software performs a categorical analysis of the list belonging to a programming action object. The software determines a list of categories and one or more tasks that can be performed within said categories. Further, the software determines what elements in said list fall within what categories. Note: elements in said list that belong to a single category are then analyzed to determine if they comprise a sequence of steps that can be used to complete one or more tasks. If said sequence of steps can be determined, it can be saved as data model. Said data model would include at least one category, a sequence of steps within that category and a task that said sequence of steps can produce.

The idea of a data model is that it can be applied to multiple environments, which exemplify a similar or same category, but contain different specific data from the PAO 2 being used to program said multiple environments. For instance, when a Type Two Programming Action Object is applied to an environment, the software analyzes said environment and determines if the elements in the environment are of a category that enables said environment to be programmed by said Type Two Programming Action Object. If this is the case, said PAO 2 is likely valid for said environment. If an environment is found to be valid for a given PAO 2, the software of this invention applies the data model said PAO 2 to said environment. Among other things, this could result in applying a chain of modeled events that has been saved in said PAO 2 for a category that closely matches the category of an environment. A key value of this model approach is that the specific data in an environment to be programmed by a PAO 2 can be completely different from the specific data in the environment from which the data model and sequential data were derived and which were saved as said PAO 2.

For instance, let's say that in the original analyzed environment a data base was being used to store and retrieve data. The existence of this data base and inputs resulting in the storage and retrieval of data to and from said data base would be recorded as part of a motion media from which a PAO 2 could be created. Further, considering said original analyzed environment as an object, said data base becomes part of the object definition of said original analyzed Environment Media. Regarding the applying of said PAO 2 to a new environment (other than the environment from which said PAO 2 was derived), the software analyzes the new environment and determines if it is of a same or similar category to said original analyzed environment. The software doesn't just search to find specific data from the originally analyzed environment. The software searches to find a closely matching data model. To do so, the software analyzes said new environment and creates a data model from the analysis. Then the software compares the two data models: the one pertaining to said PAO 2 and the one derived from said new environment.

Upon analyzing said new environment, let's say the software finds a different data base accessed by said new environment. Let's further say that said different data base, exhibits the same or similar categories of operation as the data base in the model saved as said PAO 2. It may not be necessary that said different data base and the data base saved in said PAO 2 are the same type with the same type of network protocols. What's important is that the model saved in the PAO 2 can be successfully applied to said different data base. This would depend in part upon the scope of these data models. Note: the data model contained in said PAO 2 can be applied to environments that are outside Blackspace. This includes windows environments, not just object-based environments.

Motion Media

An output resulting from the preserving, saving, chronicling, archiving, or the like, (“recording”) of change is called a motion media. Motion media can be many things, including: (1) software operating itself, and (2) a formatted video or other sequential media that is referenced to time, (3) a sequence of events including the results of each event, and more. Regarding item (1), a motion media is software producing change involving any one or more of the following: an environment, data, object, definition, image primitive, visualization, structure, logic, context, characteristic, operation, system, network, collaboration or any equivalent. A motion media can include, but is not limited to: any state, condition, input, characteristic, object, device, tool, data, relationship, or change. Said change includes, but is not limited to: a change to any object, data, context, environment, relationship, state, assignment, structure, characteristic, input, output or the equivalent.

The software of this invention is capable of recording all states and changes in an environment as motion media, which include, but are not limited to: (NOTE: as previously described the term object also includes any software definition or image primitive. An image primitive can be any size.)
The state of all objects when the recording of a motion media is started.
Any change in the state of an environment.
Any change to any object contained within an environment.
The conditions of all objects in an environment.
Any relationship between any object in an environment and any other object, and any change in the relationship between any object and any other object.
Any relationship between any object in an environment and any logic and any change in any relationship between any object and any logic.
Any context and any change in any context that is in any way associated with an environment.
The complete state of all protocols that pertain to, govern, control or otherwise affect an environment and any changes in these protocols.
And change to any external device, network, protocol or the like affecting an environment.
All scenarios that are applied to said protocols via any means, including: user input, programmed operations (both via any user or pre-programmed), dynamic media, and the equivalent.
Network connections and other links and the equivalent to and from internal and external data sources, and any change of any network, link or the equivalent.

All events, operations, actions, functions, procedures, scenarios, and the like can be preserved as motion media. Thus anything a user performs, operates, constructs, designs, develops, produces, creates, assigns, shares or the equivalent can be preserved by software as a motion media. Literally anything a user can do in any environment can be preserved as a motion media. The preservation (“recording”) of change in an environment is not just like a quick key or macro. It is not just a recording of a series of mouse clicks or simple user inputs. The preservation by the software of this invention includes everything pertaining to operating an environment, plus the characteristics, conditions, states, relationships, context and inputs and outputs comprising or affecting every element in an environment. Further the environment of this invention is not limited to a screen, window, display or program.

A motion media can contain static and dynamic data Both data types can include or be affected by inputs that can modify any object or data, change any relationship between any object and cause any change to an environment. Further user inputs include: inputs that provide dynamic and static contexts; that change existing contexts that create new contexts, or that impact of one or more contexts affecting any object or environment in said environment. Note: an environment (including an Environment Media) can contain multiple environments (or other Environment Media), which can exist as objects.

Recording a Task as Motion Media

Let's say the user wants to perform a task in an environment. While performing a task, the software of this invention records data associated with performing that task. This can include: the state of one or more objects in an environment, (this could include the state of the environment itself as an object), any change to one or more objects, any input, any result from one or more inputs, any change in context, characteristic, relationship, assignment, or anything else that is part of or associated with said environment, including external data, operations, networks, contexts, and the equivalent. To a user, when they are recording a motion media, they are just performing a task. But the software can preserve every element, relationship, context, input, cause, effect and all changes to anything, either visible or invisible to the user. This change could include changes made by the software, for instance, to modify invisible software objects in response to any input or change in any element in said environment. Note: the software may not record everything that occurs during a user's performance of a task. The software has the ability to determine what data is needed to accomplish a task and what is not. The data that is not deemed to be needed can be either deleted or saved as a backup to a motion media.

Converting a Motion Media a Video Format

A motion media of this invention can be converted from being operated as software to being a video file, i.e., mpeg, AVI, .flv, h.264, and the like. One method to accomplish this is for the software of this invention to define portions of a motion media according to time intervals, like 1/30^{th} of a second. The motion media data that occurs in each defined time interval would be converted to a frame of a video file of a certain format. Further, as part of this process, the software creates a file (“motion media recovery file”) that contains the information needed to reconstruct all or part of the original motion media from said video file. Said motion media recovery file can be saved in any suitable manner, including to the cloud, to any network, device, as part of the video file itself or to any suitable storage medium. One way to save a “motion media recovery file” in a video file is to save the “motion media recovery file” as a header associated with said video file. Said header, or its equivalent, is capable of accessing said motion media recovery file. Said accessing of said motion media recovery file can be accomplished directly from said video file or when said video file is converted back to a motion media and presented as live software. The converting of said video file back into a software motion media could be via any means common in the art, including a verbal command, a gesture, a selection in a menu, via context, time, programmed operation, script, according to a motion media, and the like.

A PAO 2 Compared to a Traditional Macro

As a practical matter, the recording of a traditional macro can require time consuming planning and often requires rehearsal to enact a particular sequence of events in a correct order. Although the editing of macros is available in many systems, editing a macro is more time consuming and sometimes breaks the macro. Creating a Type Two Programming Action Object (PAO 2) with the software of this invention does not require careful planning, nor does it require rehearsal. A user simply works to accomplish any task, for instance, in a Blackspace environment. The software dynamically preserves the environment, including all changes and the results of those changes pertaining to an environment and its contents. Further, change can be recorded for elements in said environment, even though said elements may reside on multiple devices, multiple layers, multiple planes, and may be using different operating systems, and/or residing on the cloud, server or any network. As a reminder, an environment, as defined by the software of this invention, is not limited to a window, program, desktop or the like. Further, the underlying logic of a PAO 2 is not always dependent upon a linear recording of events. In fact, the order of recorded events in a motion media may not be directly matched in a final PAO 2 derived from said motion media.

With the software of this invention a user simply completes a task from a starting point. As part of the completion of a task, the user may make mistakes. The user may go back over their steps and change them or modify objects in their environment (for instance, correct something that was not noticed when the recording of the motion media was started). A user may change their mind and alter a path of operation or delete an input or change a context that affects the characteristics of any one or more objects in the environment that is being recorded as a motion media.

In short, a user can work in a familiar manner to complete a task without worrying about making mistakes or making sure that every step along the way is exactly correct or is the most efficient way to accomplish a given task. The length of time or the number of steps required for a user to finish a task is not a major factor in the method of this invention. The user just completes a task and the software preserves the creation of that task as a motion media. Stated another way, the state of the environment when the user starts their task and every change made to that environment (both visible and invisible) can be preserved as a motion media. Note: A motion media can be saved anywhere that is possible for a computing system, including to the cloud, a server, intranet, internet, any storage device or the equivalent.

Once a motion media is recorded said motion media exists as a software object, definition, file or its equivalent. The software of this invention can analyze the motion media. As a result of this analysis of a motion media, the software determines what is needed to accurately and efficiently reproduce the task that was recorded as a motion media. The software analyzes said motion media and derives a list of elements, including states of the environment (plus the objects in said environment and associated with it), and changes to said environment, changes to any object, data, devices in said environment, and changes to any object, device or environment that has a relationship to said environment.

The software analyzes said list and determines which elements are needed to accurately reproduce a task defined by said list. If there are sufficient elements to accurately reproduce said task, the software creates a list that contains said sufficient elements, for example a “task model”. Part of this task model may include a sequential order of said elements. It should be noted that the software is “aware” of all information pertaining to the accomplishing of said task. This is true because said information is being created, managed by and/or controlled by the software itself. Indeed a motion media can be software reproducing change and the results of change.

Using the results of the above stated analyses, the software can create a Type Two Programming Action Object (PAO 2) from a motion media. One goal of the creation of said PAO 2 is for it to contain the most efficient method of producing a task. A PAO 2 can be represented by a visual manifestation, which can be user-defined or automatically defined by one or more software protocols. A PAO 2 can be utilized to program an environment, in other words, apply the task model of a PAO 2 to an environment. Note: it is not necessary for a PAO 2 to have a visual representation for it to be used to program something. For instance, a PAO 2 could be activated via a context. In this case, software would recognize a context to cause the automatic applying of the task(s) of a PAO to one or more objects, including Environment Media.

Referring again to various methods to derive a Type Two Programming Action Object from a motion media, a second method is “Relationship Analysis.” FIG. 41 is a flowchart describing the use of relationship analysis to derive a Type Two Programming Action Object from a motion media.

Step 272: A motion media is recalled. Said motion media includes an environment.

Step 273: The software seeks to confirm whether a Type Two PAO “relationship analysis” has been initiated. If “no”, the process proceeds to step 274. If “yes”, the process proceeds to step 277.

Step 274: In this step the software seeks to confirm if a Type Two PAO task model analysis has been initiated. If “yes”, the process proceeds to step 275, which proceeds to step 254 of FIG. 39. If “no”, the process ends at step 276.

Step 277: This starts the process of a relationship analysis. As in the flowchart in FIG. 39, the software finds the state of said environment at the point prior to where the first change occurs.

Step 278: The state found in step 277 is saved with the identifier “state 1”.

Step 279: The software finds the state of said environment right after the last change in said motion media.

Step 280: The state found in step 279 is saved with the identifier “state 2”.

Step 281: The software analyzes said state 1 and 2 in an effort to define a task definition. Among other things, the software analyzes the elements in the starting state and compares these elements to the elements in the ending state. By analyzing the elements of the start and ending state, the software can often determine a definition of a task. Note: if there is not sufficient information from said analysis of said start and ending state, the software can then analyze one or more of the changes between said “state 1” and said “state 2” and use this information to further determine a task definition. One key consideration here is for the software to analyze the relationships between one or more data and objects and changes regarding one or more data and objects (“elements”) in said motion media. As change occurs in an environment, it generally causes change in elements in said environment or in elements associated with said environment. These changes can affect one or more relationships between elements in said motion media and between said other elements. An understanding of said relationships and of “state 1” and “state 2” can define a task. Note: the “relationship analysis” of a motion media can yield a definition of a task without making a comparison to a task model.

Step 282: The software queries, “has a task definition been found?” If “yes”, the method proceeds to step 283. If “no”, the method proceeds to the steps contained in FIG. 40 and then back to step 283 of FIG. 41.

Step 283: The software finds all relationships in said motion media after the starting “state 1” and before “state 2” or its equivalent. This can be a complex process. One change may cause multiple changes in existing relationships or cause new relationships to come into existence. For instance, a single input may produce a chain of events that in turn could result in creating new relationships. The software tracks the results of each input or other change causing event, including changes to one or more relationships caused by any input or other change causing event.

Step 284: The software analyzes the relationships found in step 283. An important part of the analysis of relationships in step 284 is to determine if said relationships are part of the logical progression or performance of the task found in step 84 282. Another important part of the analysis of relationships in step 284 is to determine which of the relationships found in step 283 are needed to perform said task and which are not. One of the advantages of the software of this invention is that users can just work in a way that is natural and fluid for them as they perform a task. Users don't need to rehearse or operate with care to carry out a task. Users can perform a task as they wish. This includes making mistakes, changing one's mind, altering directions or whatever else one does to get a task finished. The software of this invention determines which relationships are necessary for accomplishing said task, and which are not. Relationships which are not needed to accomplish a task are removed from consideration. (Such relationships may not be deleted, but rather saved as extra data that can be accessed if needed for any reason.) Thus, if a user makes mistakes, the software detects the mistakes by finding them not valid for the accomplishment of said task and removes them from consideration. If the found relationships are not valid for said found task definition in step 282, the software searches for another task definition to which said found relationships are valid. If no such task definition can be found, the process ends at step 284.

Step 285: The software saves “state 1”, the relationships that were found to be valid for the accomplishing of said task, and “state 2” as sequential data One important element of sequential data is that said relationships have a position in an order of events. This does not necessarily mean that each relationship has a time stamp. The exact time of each relationship's occurrence in a motion media may not be critical to enabling a PAO 2 to program an environment. If exact timing is critical for any reason, the timing of the occurrence of relationships can be saved as part of the definition of said relationships. In summary of step 285, the software creates a sequence of elements. The sequence starts with “state 1”, followed by changes in relationships that are valid to the accomplishing of said task, and ends with “state 2” or its equivalent. Said changes are not just catalogued as specific events, but also as generalized models of change that are not dependent upon specific characteristics that are not relevant to the accomplishing of the task for a given PAO 2.

Step 286: The software saves the sequential data of step 285 as a PAO 2 and the process ends at step 287. As part of the saving process said PAO 2 is given an identifier. This can be a name, number, ID, or any definable designation. This identifier can be user-defined, software defined, context defined, pre-programmed or via any other suitable method.

Objects (including user-programmable objects) have many advantages over windows and windows structures. For instance, “structure” in a windows environment is static. It is represented by many forms, like task bars, tool bars, icons, set layouts, ruler configurations, delineations, perimeters, set orders of operation and much more. But in an Environment Media, structure can itself be programmable objects. In an Environment Media or its equivalent all elements can be objects, image primitives, definitions or the like. This includes: text, graphics, devices, tools, websites, video, animations, pictures, lines, markers and anything else that can exist in an Environment Media. A very powerful benefit of Environment Media objects is that they can communicate with each other and therefore can be used to program each other. Thus, relationships become powerful tools in this object world. One key relationship is objects' ability to respond to input, e.g., user input, such that said input builds, modifies, creates or otherwise affects relationships of said objects.

For example, consider the simple ability to copy something in a windows environment. Let's say it's a piece of text. Let's further say it's a number, like the number “10.” Copying a number in a windows environment produces a copy of the same number. The copied “10” can be pasted somewhere or have its size or font type changed, but it's a piece of text, controlled by the program in which the original “10” text was typed or otherwise created. The properties of said original “10” text and its duplicate are defined by the program that was used to create it, for instance a word program. Users generally cannot establish a unique relationship between the two “10” pieces of word text. In general, the relationship said pieces of “10” text possess is their relationship to the program that created them and to the rules of that program. Thus the original “10” text and its duplicate have no user-programmable relationship to each other—their response to input is governed by the program that created them.

Let's consider the same number “10” in an Environment Media, as an example environment only. In an Environment Media the “10” number is an object, with its own characteristics, including properties, behaviors, relationships, and the ability to individually respond to context and user input. The software of this invention enables many ways for a user to program objects, such as said “10” object (also referred to as “text number object”). As an example only, let's say that said text number object is to be programmed with user inputs that apply the following characteristics to said text number object: (1) the ability to be duplicated and to permit a duplicate of its duplicate where all duplicates of said text number object have the same characteristics, (2) the ability to sequence the numerical value of a duplicated text number object after said duplicated text number object has been moved to a new location, (3) the ability to impinge any existing text number object, with a non-duplicated text object where said non-duplicated text object's numerical value will be automatically be set to an integer that is one greater than the numerical value of the number object it impinges; and all other duplicated text number objects that have a greater number than said non-duplicated number object shall have their numerical values increased by one integer.

These three characteristics are not easy to describe and that's the point. Most users could not easily, if at all, program the relationships listed above in a scripting language. The mere act of accurately describing the cause and effect relationships described in (1), (2) and (3) above in section would be overwhelming for most users. But most users, including very young and inexperienced users can perform a task and initiate a record function to record their performance of that task. One benefit of a Type Two Programming Action Object is that the software of this invention can derive a task and the operations necessary to perform that task from a motion media. From the user's perspective, the user is working to accomplish something, which in being automatically (or manually) recorded as a motion media. The software of this invention can then analyze said motion media and discover or derive a series of changes (which can include changes in states and/or relationships) that can be used to define a programming action, (which could be a task), which in turn can be used to program an environment, object, image primitive, definition or any equivalent. Another benefit of a PAO 2 is that software can derive model elements from a motion media, where said model elements can be used to program a broad scope of environments. More about this later.

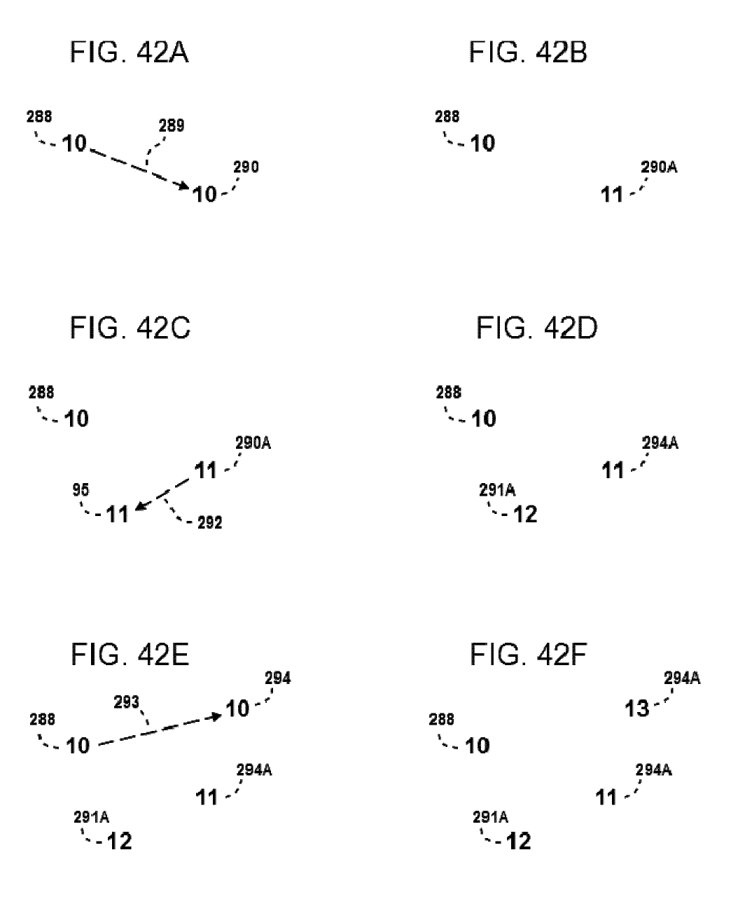

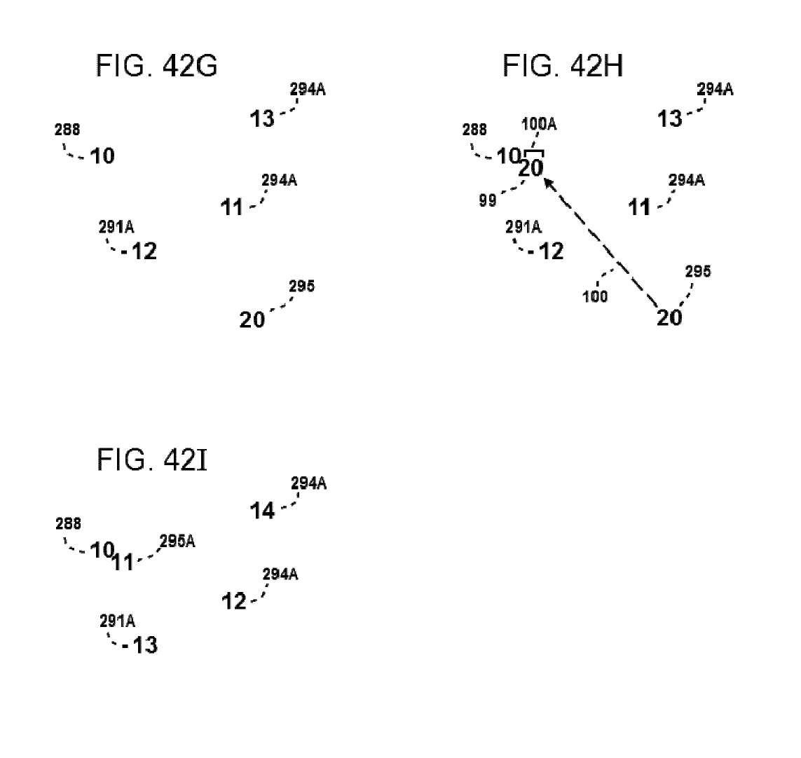

Referring now to FIGS. 42A to 42G, these figures comprise an example illustrating user inputs and changes resulting from said user inputs, recorded as a new motion media. Among other things, said user inputs define the three characteristics listed above in section [535]. Note: in FIGS. 42A to 42G user inputs could include: touching, holding, dragging, typing, gestural input or verbal input and are used to operate text number objects. In the example of FIGS. 42A to 42G, all user inputs and the changes they produce (including changes in relationships between objects) have been recorded as a new motion media.

Record Lock

It is possible to set any object to be in record lock. There are at least two conditions of record lock: (1) An object in record lock cannot be recorded in a motion media, and (2) Any change to an object in record lock cannot be recorded in a motion media but the presence of the object in an environment can be recorded. In other words, Record Lock enables a user to operate objects that are not to become part of a motion media [this is a (1) Record Lock function] or where the initial state of said objects can be recorded but not changes to said objects [this is a (2) Record Lock function]. An example of the employment of a (1) lock could be guideline objects that are used to align other objects, but which are not relevant to the task being performed and are therefore not recorded as part of a motion media. An example of a (2) lock could be a background color object that exists as part of a state but changes to said background color are not relevant to the task being recorded in a motion media.

Note: for the purposes of FIGS. 42A to 42G, the duplicating of an object is accomplished by the following user inputs: touch an object, hold on said object for a certain time (e.g., 1 second), drag a duplicate of the touched object to a new location.

As an overall perspective, FIGS. 42A to 42G illustrate user inputs being used to define characteristics (including relationships) for objects. In the example illustrated in FIGS. 42A to 42G all inputs and resulting change are recorded as a motion media. In this example, a user is working to establish number labels in a diagram. But by recording said user inputs and the changes they cause as a motion media, said recording can provide valuable data for determining relationships between objects with which said user is working. The software of this invention analyzes a motion media which includes analyzing changes in a motion media. As a result of said analyzing, the software determines the relationships and states produced by said changes. So a generalized idea illustrated in FIGS. 42A to 42G is that a user can effectively program operations by simple manipulations of objects in the process of performing a task. Software converts user inputs and change resulting from said inputs into usable models that can be utilized to program objects and environments.

Referring now to FIG. 42A, there is a “10” text number object 288. As a condition of FIGS. 42A-42I, let's say that text number object 288 has at least the following characteristics: object 288 can communicate with other objects, changes to object 288 are automatically transmitted to any duplicate of object 288, and the communication between object 288 and its duplicates is not dependent upon location. In FIG. 42A object 288 is duplicated. The duplicate 290 of object 288 is dragged along path 289 to a new location.

In FIG. 42B, a user input changes duplicated text object 288 to the number 11, shown as object 290A. Thus the numerical value of duplicated object 290A is changed to a next higher integer in a sequence of numbers, i.e., 10, 11 via a manual user input. The renumbered object 290 is shown as object 290A FIG. 42B. A manual user input changes the numerical number of object 290 from “10” to “11” and thereby demonstrates number sequencing.

In FIG. 42C a user input duplicates object 290A, which is a duplicate of object 288. The duplicate 291 of object 290A is dragged along path 292 to a new location. This series of user inputs defines a new object characteristic, namely, the duplicating of a duplicate object. In FIG. 42D another user input changes the numerical value of the duplicated object 291A to the number 12. Said user input illustrates another sequential behavior. Note: the changing of a text object's number can be by any suitable means, including typing, via verbal means, gestural means, drawing means, or the like.

In FIG. 42E a user input duplicates the original text object 288 again and positions its duplicate 294, moving it along path 293, in a new location. In FIG. 42F a user input changes the numerical value of text object 294 from the number 10 to the number 13, shown as 294A. The series of user inputs illustrated in FIGS. 42E and 42F define the following: when the original text object 288 is duplicated a second time, the number of duplicate 294 is changed to the next higher integer “13” (shown as object 294A) in the existing series of numbered objects. That existing series is 10, 11, and 12. Thus the duplicated “10” object 294 is changed to the number 13, shown as object 294A. NOTE: in this example the user is making needed changes to create sequential number labels for a layout, diagram or the like. The user isn't necessarily conscious of creating data that can be used to program other environments, devices, objects, networks, websites, documents, programming action objects, or even other motion media. The user is simply working to finish a task, and the process of accomplishing said task is being recorded as a motion media. The software of this invention can then derive from said user inputs, and the changes resulting from said user inputs, meaningful logics and models that can be applied to one or more environments and its contents.

In FIG. 42G the user creates a new number 20 object, 295. The creation of object 295 is not via a duplication process. It is a newly created object, e.g., it was typed, or entered via some other suitable means. In FIG. 42H, said “20” object, 295, is moved along path 100 to impinge object 288 at location 100A. After this impingement, object 295 is renumbered by another user input which changes the number of object 295 from “20” to “11,” shown as object 295A in FIG. 42I.

Further referring to FIG. 42I, following the user input that changes object 295 from the number “20” to the number “11,” (shown as 295A) three other user inputs change the numerical values of objects 290A, 295A, and 294A to one higher integer, as shown in FIG. 42I. More specifically, a user input changes the numerical value of object 290A from the number 11 to the number 12. A user input changes the numerical value of object 295A from the number 12 to the number 13. And a user input changes the numerical value of object 294A from the number 13 to the number 14. Said three other user inputs could be via any suitable means. For instance, each text object could be retyped or altered by a gesture or via a verbal command or the like. These inputs complete the sequencing of all text object labels in the example illustrated in FIGS. 42A-42I.

Further regarding the example of FIGS. 42A-42I, user inputs are manual inputs. [Note: The software of this invention is not limited to the recording and analysis of manual user inputs only and the change they cause. Other inputs or change causing phenomena can also be analyzed, including: context, software, user-defined characteristics, time, location, assignments, automatic inputs, preprogrammed inputs and more.]

The motion media of FIGS. 42A-42I preserve changes that result from user inputs and from other causes of change. Said change, including changes in relationships and/or the creation of new relationships, can be catalogued by the software. Further, “state 1” equals the conditions presented in FIG. 42A and “state 2” equals the conditions presented in FIG. 42I—the finished task. What is the task in this case? It is the creation, ordering and placement of number text objects according to user inputs; said inputs define the three characteristics enumerated in section [535] above. Said creation, ordering and placement were recorded as a motion media. Said motion media can be analyzed by the software of this invention to determine a task, a “state 1,” a “state 2,” and changes in the environment of FIGS. 42A-42I. The software analyzes said changes to determine any alteration to any relationship or the creation of new relationships. As illustrated in the flowchart of FIG. 10, the software can save said relationships as sequential data and said sequential data can be saved as a Type Two Programming Object. Note: the saving of said relationships is not limited to sequential data. Said relationships can be saved as many other data. For instance, relationships can be saved as a list or a collection of objects (for example, with each relationship comprising an object in said collection), and via any other suitable means. Further, said relationships by include concurrent occurrences of relationships or change in relationships. Said concurrent occurrences of relationships can exist as sequential data.

FIGS. 42A-42I Summary

The user inputs, as shown in FIGS. 42A-42I, which are recorded in a motion media, result in a series of changes that define the three characteristics enumerated in section [535] above. It is the software analysis of said motion media (including the analysis of relationships and changes to relationships in said motion media) that enables the formation of sequential data or its equivalent. In the example illustrated in FIGS. 42A-42I changes result from user inputs. Said sequential data, or its equivalent, can be used to create a PAO 2, which can then be used to program a new environment.

Compatible Category

The specific number for one or more text objects or the amount of number text objects in a new environment may not be relevant to determining if a new environment can be programmed by the PAO 2 created from the motion media of FIGS. 42A-42I. The means and methods as to how number text objects in said new environment are being utilized may be of more relevance. For instance, if said number text objects are being used as sequential labels (following a logical order) in a diagram or graphic or other visual illustration or document, this could be a compatible environment to be programmed by said PAO 2, created from the inputs and changes illustrated in FIGS. 42A-42I. But if said number text objects in said new environment are being sequenced by some means or method that is not according to any logical order, then said new environment may or may not be a suitable candidate for being programmed by said PAO 2. For instance, if said number text objects in said new environment were numbered by an arbitrary method that served a unique purpose, changing this arbitrary numbering could be undesirable. Note: when applying a PAO 2 to an environment, the software can require a user input to initiate the programming of said environment by said PAO 2. Using said PAO 2 to re-sequence or cause auto-sequencing of numbered objects or data in an environment could be a valuable use of said PAO 2. In the case that said re-sequencing or auto-sequencing would harm said environment, a required user input to initiate the programming of said environment by said PAO 2 could avert a potential mishap. Note: the utilization of a user input to initiate said programming of said PAO 2 could be via any means known to the art.

Applying a PAO 2 to an Environment

FIGS. 42A-42I, shall hereinafter be referred to as “FIG. 42.” As previously mentioned the software of this invention enables a user to record the accomplishing of a task as a motion media and enables the analysis of the data contained in said motion media. Said analysis can be used to create one or more PAO 1 or PAO 2. Among other things, said motion media records changes in relationships in the environment in which said task is being accomplished. Further, the software of this invention analyzes said motion media, and can create or derive one or more models or model elements from inputs, states, changes and any other data recorded as said motion media. Note: if the user inputs and resulting change exemplified in FIG. 42 were used to create one or more PAO 1, the resulting PAO 1's could be used to alter one or more characteristics of one or more objects. Some possibilities would be: (1) enabling a first object to be duplicated such that its duplicate contains all of its properties of said first object, (2) causing the numerical value of an object to be increased by a one integer value, (3) causing a new object that impinges an existing object to have said new object's number value increased by one integer higher than the number of said existing object, and so on.

Consider the user inputs that resulted in the duplication of text objects in FIG. 42. Object exhibited the following characteristics: object 288 can communicate with other objects; changes to object 288 are automatically transmitted to any duplicate of object 288; the communication between object 288 and its duplicates is not dependent upon location. How did objects 291, 291A and 294A come into existence? Object 291 is a duplicate of object 288. Object 291A is a duplicate of object 291 (a duplicate of a duplicate). Object 294A is also a duplicate of object 288, but object 294A has been moved to a new location.

As a result of the duplication of object 288, all of the objects depicted in FIG. 42 have the same characteristics except for object 295A, which was not a duplicate of an existing text object. Thus objects 288, 291, 291A and 294A have the same characteristics. Among other things, this means that objects 288, 291, 291A and 294A can communicate with each other. This communication enables auto-sequencing. Further, object 295A was renumbered by a user input and subsequent to said renumbering, objects 290A, 291A and 294A were renumbered by user inputs. Thus object 295A communicated auto-sequencing to objects 290A, 291A and 294A.

Changes in a Motion Media can be Modeled in Software

All objects in FIG. 42 have relationships that are defined and/or modified by various user inputs. These relationships are an important element to the software of this invention partly because model elements can be derived from relationships and changes that alter existing relationships and/or create new relationships. What are some of the potential model elements that can be derived from the series of user inputs and from the results of said user inputs as illustrated in FIG. 42? First, the duplication of an object or of its duplicate results in a network of objects that can communicate with each other. One result of this communication is sequencing. A potential model element is a network of objects that can communicate with each other, or a network of objects that can communicate sequencing with each other. Second, another potential model element would be that said sequencing is according to one integer increments in an ascending order. Third, another potential model element could be that said sequencing causes the number of each sequenced object to change to a new number that matches the same characteristics of said each sequenced object, i.e., the same font type, style, size, color, etc. The list can go on. Note: the utilization of modeling element details depends partly on the objects in an environment and said environment that is to be programmed with a PAO 2.

Regarding the first point above, namely, “the duplication of an object or of its duplicate, results in a network of objects that can communicate with each other,” this communication characteristic is not dependent upon a specific number of objects, or upon the location of these objects. Regarding location, there were two duplications of object 288, each was moved to a different location, and said duplicated objects “11” 295A and “13” 291A were part of the sequencing of all objects presented in FIG. 42. So the user actions causing objects 291, 291A, 294A and 295A to be presented in a sequential order provided a set of conditions. Looking at said set of conditions as a simple macro one would view them as a sequence of inputs. But looking at said set of conditions as a potential model element, of primary importance are the characteristics of the method by which said objects were presented in a sequential order as a result of user inputs. A model element can be derived from the characteristics of a method, in this case, from a set of user inputs that define a set of operations. Said model element can then be used to apply said set of operations to one or more objects and/or to one or more environments that may be quite different from environment and objects from which said model element was derived.

Further considering said set of operations from a modeling perspective, said user inputs of FIG. 42 could be ongoing. For example, the method to produce objects 291, 291A, 294A and 295A could continue to produce a larger object network comprised of any number of objects in any number of locations. Said any number of objects can exist in any location and all of these objects would be able to communicate with each other. The existence of a network communicating sequential information between said any number of objects is a new model element. Regarding compatibility of this model element to a new environment, the new environment could contain any number of objects in any location and said new model element could be successfully applied to them. In other words, said new model element would be valid for said new environment.

NOTE: If the characteristics of object 295, which was inserted into the existing number sequence (10, 11, 12, 13) of FIG. 42H, exactly matched the characteristics of object 288, all objects presented in FIG. 42 would have matching characteristics. If this were the case, all objects having matching characteristics would be another model element. For the purposes of this example, let's say that the characteristics of object 295A do not match the characteristics of objects 288, 290A, 291A and 294A. Regarding the second point, “sequencing is according to one integer increments in an ascending order,” this is another potential model element. This model element (we'll call it “Model Element X”) is not dependent upon a set number of objects or upon the location of these objects. Model Element X could be used to cause auto-sequencing (in one integer increments in an ascending order), of any number of objects existing in any location in an environment.

Regarding the third point, “sequencing causes the number of each sequenced object to be changed to a new number that matches the characteristics of each sequenced object,” the matching of the text characteristics of each renumbered text object to the original text of each renumbered object is another potential model element. Let's call it the “renumbering model element.” Referring again to the example of FIG. 42, in said example the renumbering model element was defined by user inputs. In the example presented in FIG. 42 each user input changed a text number to a new number (for example by retyping said text number) such that the characteristics of said new number exactly matched the characteristics of said text number. User inputs could have created said new text number in a different font, style, type, size or color, but this was not the case in the example of FIG. 42. Thus by the nature of the change caused by said user inputs, a potential model element was defined by said user inputs. In summary, inputs (user or other inputs) and the changes they cause can define one or more model elements in a motion media.

Applying Model Elements to an Environment

In the process of deriving model elements from a motion media, the software of this invention can compare said model elements to an environment and to the contents of said environment, like an Environment Media. As part of this comparison, said software can weigh different factors and determine their importance to the accomplishing of one or more tasks in an environment. In other words, said software can decide the importance of a model element to the accomplishing of a task to be programmed by a PAO 1 or PAO 2.

Note: if a model element can be successfully applied to an environment, said model element is considered valid. To continue this discussion, let's say that a PAO 2 which contains all three model elements, as defined above, is being applied to a new environment. These model elements are recapped below:
1) A network of objects that can communicate with each other.
2) Sequencing is according to one integer increments in an ascending order.
3) Sequencing causes the number of each sequenced object to change to a new number matching the characteristics of each sequenced object.

Let's further say that the first and second model elements are valid for a new environment. In other words, model elements one and two can be successfully applied to a new environment and its contents. Let's further say that said new environment contains a variety of number objects that do not have matching characteristics. For instance, said variety of number objects may be of differing sizes or color or font types. This condition does not invalidate model elements one, two and three. Regarding model element three's validity, applying said PAO 2 to said new environment, each number object in said new environment would be renumbered with a number that matches the characteristics of said each number object. So if every object in said new environment were different, model element three would still be valid and could be applied to these objects.

the Scope of a Model Element

As previously described, model elements can be defined by and/or derived from changes recorded in a motion media. There are virtually endless approaches to defining the scope of a model element. Said approaches can be static or dynamic, applied via user input, context, relationship, preprogrammed operation, and more. We will discuss a few of them.

One approach would be to have software initially define a model element according to the scope that best supports the accomplishing of the task of a PAO 2. In this case the scope of the change (recorded in a motion media) might be determined by what is strictly necessary to accomplish a specific task. The more specific the task, the narrower might be the model elements influenced by and/or derived from said change recorded in said motion media. Another approach would be to have software initially define a model element according to a scope that is determined by the characteristics of the objects being changed in a motion media. Referring again to FIG. 42, the characteristics of said objects could be many and could include: (a) said objects are text objects, (b) said text objects have the color black, the font type Palatino, the style normal, the size 12 point and so on. The more detailed the characteristics, the more narrow the scope of the model element defined by said characteristics.

Further considering model element three from paragraph [561] “the number of each sequenced object,” another approach would be to generalize the type and/or characteristics of an object in a model element. “Each sequenced object” is rather broad. If said model element is changed to read: “the number of each sequenced text object,” said model element would be much narrower in scope. With such a narrow scope (limited to text objects), the applicability of said model element to various environments would be more limited. For instance, let's say said model element, with the scope “sequenced object” were applied to an environment. Any object that already existed as a sequenced object or that existed with no sequencing could be valid to said model element. But if said model element was modified to read “the number of each sequenced text object,” it would be narrower and may only be directly applied to text objects or their equivalents.

Referring again to FIG. 42. Let's say that the PAO 2 containing the three model elements listed in Section [561] above, is being applied to another environment. Let's say that the environment contains a diagram with text labels that are a work in progress and are not auto-sequenced. Let's further say that some of the text labels in said new environment have been changed by retyping them, and that the characteristics of these retyped text labels do not match the characteristics of the original from which they were retyped. Note: knowledge of this would not be apparent from a simple visual inspection of the text labels in said another environment. But the software could discover this by analyzing the history of said changed text labels. One way that this could be enabled would be by enabling all change or relevant change in said another environment to be saved as one or more motion media. Said motion media would then provide a history of change that could be analyzed by software as part of the process of applying a PAO 2 to another environment. As part of this analysis, software could detect a difference between the characteristics of a text label before it was retyped compared to what it was after it was retyped. This change in characteristics could be weighed by the software and compared to use patterns or other data to determine if the change in characteristics is desirable, part of a continuing pattern, or according to some other consideration or process. The analysis of said motion media information could be an automatic process. Note: if the process of applying a PAO 2 to a new environment is not automatic, then a user input could be required to initiate or complete the applying of said PAO 2.

To continue with this example, as a result of the discovery that the characteristics of some changed text labels do not match the characteristics of the original labels, the software may decide to apply model elements one and two (cited in paragraph [561]) to said new environment, (since they are valid to said new environment), but not apply the third model element to said new environment. (Model element three would be invalid for said another environment.) As part of this decision process, the software may make this query: “is the applying of said third model required for the successful applying of the task being performed by said PAO 2?” In this case, the answer is probably “no.” For instance, if some text labels in said new environment are of a different font type, this does not prevent the communication between objects in said another environment nor does it prevent sequencing. Note: if objects can communicate with each other and they are sequenced, this equals auto-sequencing.

The graphical style of said text labels in said another environment of paragraph [561] is not relevant to the accomplishing of the PAO 2 task: “to enable communication between objects and enable sequencing.” Software can detect this and successfully apply said PAO 2's first and second model elements, but not apply the third model element to said text labels in said another environment. Further, if said new environment had missing labels or had a series of objects in a diagram that were not yet labeled, the application of said PAO 2 could be valid. In this case, said PAO 2 would cause the missing labels to be added.

Continuing the discussion of said third model element, the applying of said third model element may be harmful to said another environment. For instance, a user may have specifically used different styles of text labels in a diagram. If so, having these text label styles changed by the applying of a PAO 2 to said another environment containing these differing text label styles could be undesirable. But enabling all text number objects in said new environment to be auto-sequenced, regardless of their text style could be very desirable. What logic is used for a PAO 2 to decide not to use a model element? One logic is that the software determines if a model element of a PAO 2 is necessary for the successful completion of the task of said PAO 2 for a given environment. A key factor is “for a given environment.” The answer to this question depends upon the nature of said model element, the environment being programmed by said PAO 2, and the characteristics of the objects contained in said environment.

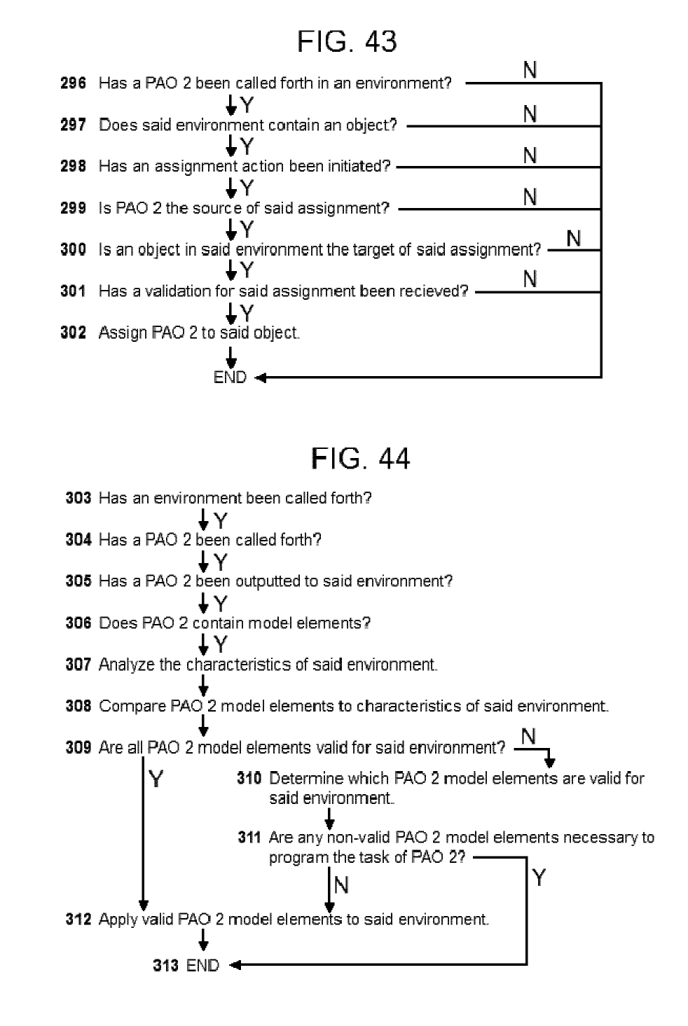

FIG. 43 illustrates a method of assigning a Type Two Programming Action Object to an object. As previously mentioned, PAO 1 and PAO 2 can exist as invisible objects and they can have a visual representation. One method of enabling a PAO 1 or PAO 2 to have a visible representation is to assign said PAO 1 or PAO 2 to an object. Note: the illustration of FIG. 12 can be applied to any PAO 1 or PAO 2 or the equivalent.

Step 296: The software checks to see if an environment has been called forth. In other words, is an environment present for a computing system? It should be noted that an environment can be an object.

Step 297: The software checks to see if the present environment (which may or may not be an Environment Media) contains an object.

Step 298: The software checks to see if an assignment action has been initiated. An example of an assignment action would be the inputting of a directional indicator such that the PAO 2 that was called forth in Step 296 is the source of said directional indicator and an object in said environment is the target of said directional indicator.

Step 299: The software verifies that said PAO 2 is the source of said assignment. For example, is said PAO 2 the source of said directional indicator?

Step 300: The software verifies that an object in said environment is the target of said assignment, i.e., the target of said directional indicator.

Step 301: The software verifies that a validation has been received for said assignment. Generally said validation would be some input that verifies that said assignment is to be activated. For instance, if a directional indicator was used, then a touch, click or other action, associated with said directional indicator, would serve to activate said assignment.

Step 302: After an activation input has been received, the software completes the assignment. At this point said object would represent said PAO 2. Said object could be used to enable any action, function, operation, relationship, context or anything else associated with the PAO 2 said object represents. For instance, said object could be used to permit said PAO 2 to be edited, amended or in any way altered. Further, said object could enable said PAO to be applied to (to program) an object, including an environment.

Referring now to FIG. 44, this is a flow chart that illustrates the applying of valid PAO 2 model elements to an environment.

Step 303: Has an environment been called forth? Is an environment present?

Step 304: Has a PAO 2 been called forth? Is a PAO 2 present?

Step 305: Has said PAO 2 been applied to said environment? Said PAO 2 can be applied to an environment via many methods. Said methods can include: dragging an object that represents said PAO 2 into said environment, drawing an object that represents said PAO 2 in said environment, verbally recalling said PAO 2 by citing a word or phrase that has been created to be the equivalent of said PAO 2, employing a gesture that is the equivalent of said PAO 2 and more.

Step 306: The software queries said PAO 2 to determine what model elements it contains.

Step 307: The software analyzes the characteristics of the environment to which said PAO 2 has been outputted in Step 110.

Step 308: The software compares the characteristics of said environment called forth in Step 108 to the model elements saved in said PAO 2 called forth in Step 304.

Step 309: The software queries: “Are all of the model elements in PAO 2 valid for said environment?” It should be noted that one or more model elements generally define a task. So one consideration in Step 309 would be to determine if the model elements and the task defined by said model elements of said PAO 2 can be successfully applied to said environment. If all model elements of said PAO 2 are valid for programming said environment, the process proceeds to Step 312. If this is not the case, the process proceeds to Step 310. [Note: all items, including, objects, devices, operations, contexts, constructs, data and the like that have a relationship to each other can comprise an environment. These environment elements can exist in any location or be governed by any operating system, or exist on any device. It is one or more relationships that bind said environment elements together as a single environment.]

Step 310: If the answer to the inquiry of Step 309 is “yes,” the process proceeds to Step 312. If the answer is “no,” the process proceeds to Step 310, where a determination as to which PAO 2 model elements are valid for said environment is made.

Step 312: The software applies the model elements of said PAO 2 to said environment. In other words, the software programs said environment with said PAO 2.

Step 311: The software determines if any model elements of said PAO 2 that are required for programming said environment are non-valid for said programming said environment. If “yes,” the process ends in Step 313. If “no” the process continues to Step 312.

Step 312: The valid model elements contained in said PAO 2 are used to program said environment. Then the process ends at Step 313.

Note: for the following discussions the term “PAO Item” shall be used to denote a PAO 1, PAO 2 or its equivalent.

Modifiers of a Model Element

A modifier model element for a PAO Item can be used for multiple purposes, including but not limited to the following: adding to existing model elements, replacing one or more existing model elements, altering or creating a context or relationship pertaining to one or more existing model elements. A key idea here is that a user can create an alternate model element or a modifier for a PAO Item by simply recording a new motion media that illustrates a new model element. Software would analyze said new motion media and derive a model element which could then be saved as a new PAO Item. Said new PAO Item could be used to modify an existing PAO Item. The one or more model elements contained in said new PAO Item could become part of the characteristics of an existing PAO Item or be saved as one or more alternate model elements for said existing PAO Item. Said one or more alternate model elements could be called forth and utilized by software when needed by said existing PAO Item. For instance, let's say one of the model elements in a PAO Item is found to be invalid for an environment. The software could search for an alternate model element in that PAO Item. If a suitable alternate is found, it can be substituted for the invalid model element and thereby enable said PAO Item to be successfully applied to said environment.

Referring again to the PAO Item that contained the three model elements listed in Section [225]. What if pictures were used to label items in a diagram in an environment? In this case, model element three may be invalid for such an environment since model element three requires “each sequenced object to change to a new number.” Furthermore, model element two may also be invalid for said such an environment because sequencing must be according to “one integer increments.” While it is true that invisible sequential data could be applied to pictures, this may not fully support the task of programming labels as auto-sequencing objects, for the simple reason that users could not see the sequential numbers. To remedy this problem, said PAO 2 may be modified to enable its model elements to be valid for a new environment and its contents. It should be noted that any PAO or PAO2 or any equivalent can be modified and there are multiple methods to do so.

One approach would be to record a new motion media that illustrates one or more model elements that could be used as alternate model elements for an existing PAO Item. As an example only, a user could create an environment and then operate a series of inputs for that environment, where said series of inputs and the changes resulting from said series of inputs are recorded as a new motion media. Software could derive a new model element from said new motion media. Said new model element could be saved as a new characteristic for an existing PAO Item, as an alternate model element for an existing PAO Item, or saved as a separate PAO Item. As an alternate for an existing PAO Item, the software could call forth said new model element as a replacement for an existing model element that was found to be invalid for an environment.

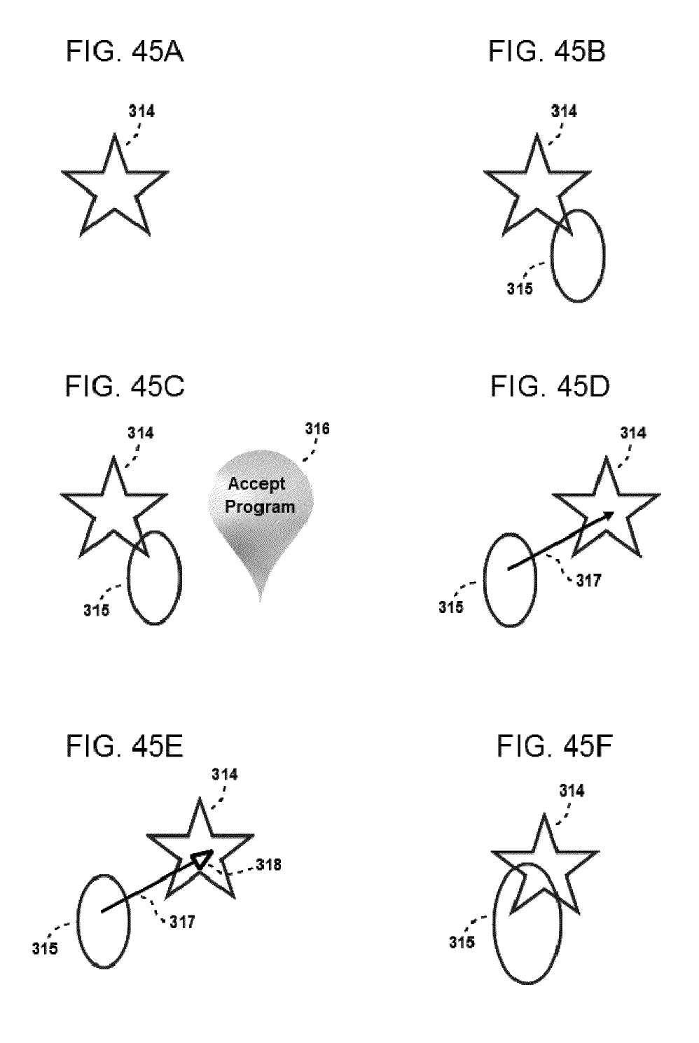

Said new model elements saved as a new PAO Item could be used to program an existing PAO Item. FIGS. 45A-45F illustrate one method of programming a PAO Item with another PAO Item. In FIG. 45A an object 314 is presented in an environment. In FIG. 45B, PAO Item 314 is impinged with another PAO Item 315. In FIG. 45C, as a result of the impingement of object 314 with object 315, an object 316 that accepts an input to activate the programming of PAO Item 314 with PAO Item 315 is presented in said environment. An input (not shown) is applied to object 316 to activate the programming of PAO Item 314 with PAO Item 315. Note: if a user did not wish to activate the programming of PAO Item 314 with PAO Item 315, object 316 could be deleted by any suitable means. Referring to FIG. 45D, another way to accomplish the programming of one PAO Item with another would be via gestural means. A directional indicator 317 is outputted in an environment. Said directional indicator 317 extends from PAO Item 315 and points to PAO Item 314. The source of directional indicator 317 is PAO Item 315 and the target of directional indicator 317 is PAO Item 314. Referring to FIG. 45E, upon the completion of the outputting said directional indicator 317, the software changes the visual presentation of the arrowhead 318 of directional indicator 317. A user action (for example, a touch) applied to the arrowhead 318 of said directional indicator 317 activates the programming of PAO Item 314 with PAO Item 315. Directional indicator 317 programs PAO Item 314 with PAO Item 315.

Another method would be to draw PAO Item 120 315 to impinge said PAO Item 119 314. Note: since a black ellipse represents PAO Item 315, any size ellipse can be drawn to recall said PAO Item 315. Referring to FIG. 45F, PAO Item 315 is drawn in a larger scale to impinge PAO Item 314. The result of this drawing enables PAO Item 315 to program PAO Item 314. The programming of PAO Item 314 could be automatic or according to an input to activate said programming Said input could be anything viable in a computing system.

Result of Programming a PAO Item with a PAO Item

There are many possible results from the programming of a PAO Item (“Target PAO”) with a PAO Item or with other objects (“Source Programming Object”). These results include, but are not limited to:
1. The task of the Source Programming Object is added as an alternate task to the existing one or more tasks of a Target PAO.
2. The model elements of a Source Programming Object are added as alternate model elements to the existing model elements in a Target PAO.
3. The sequential data of a Source Programming Object is added as alternate sequential data to the sequential data of a Target PAO.
4. “1”, “2” or “3” above can be used to replace the task, model elements or sequential data of a Target PAO.

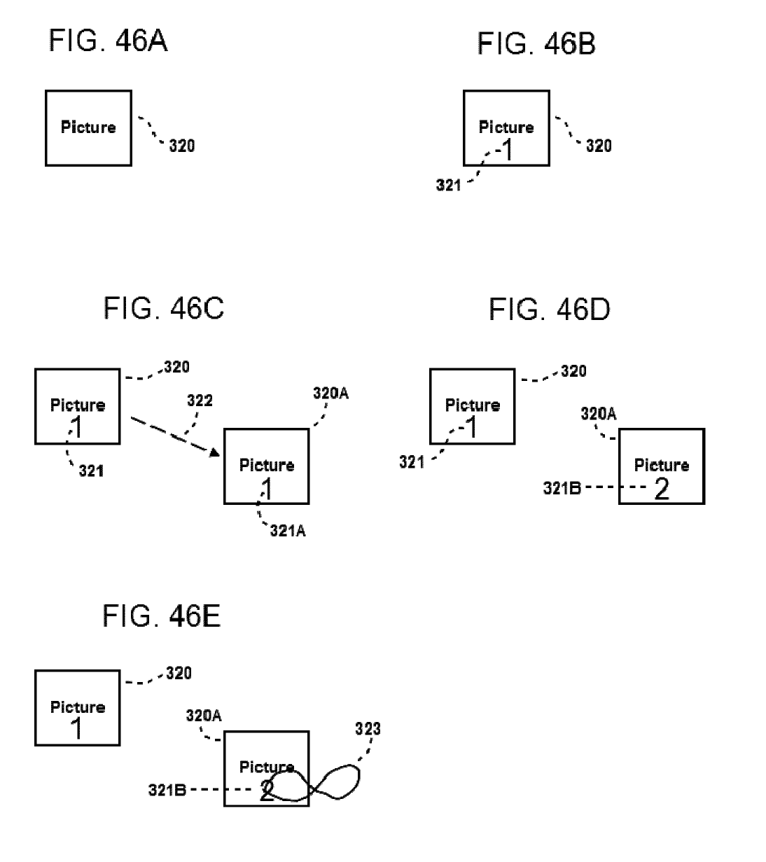

FIGS. 46A-46E are an example of the creation of a motion media that can be used to derive an alternate model element for a PAO Item. The idea here is to create an alternate model element to be added to an existing PAO Item as an alternate to one or more of the model elements of said existing PAO Item. Specifically, FIGS. 46A-46E illustrate the applying of a number object to sequence pictures. Referring to FIG. 46A, a picture 320 is presented in an environment. Referring to FIG. 46B, a user input enters a “1” number, 321, that impinges picture 320. Said user input could be via any method common in the art, i.e., typing, via a gesture, verbal command, touch, pen or more. Referring to FIG. 46C, picture 320 and number 321 are duplicated and moved to a new location along path 322. The duplicate of picture 320 is shown as 320A. The duplicate of “1” number 321 is shown as 321A. Note: the duplication of picture, 320, and number object, 321, can be via any suitable means. Including via a lasso, hand gesture, drawing means, verbal means, context means or the like. Referring to FIG. 46D, “1” number 321 is changed via a user input to the number “2”, 321B. Referring to FIG. 46E, a FIG. 8 (“infinity”) gesture 323 is outputted to impinge picture 320A and number “2” 321B. The outputting of said infinity gesture could be by a suitable means, including: drawing means, dragging, verbal means, context means, via a software program, via a configure file, or any other viable means. Said infinity gesture is understood by the software to mean that the process illustrated in FIGS. 46A-46E (recorded as a motion media) is to continue indefinitely. The process of continuing indefinitely could be a characteristic of said infinity gesture or it could be the result of a context whereby said infinity gesture impinges a picture and number object that is part of a continuing sequence of numbers.

Note: The software of this invention can analyze an environment. Let's say an environment 1 exists that contains a series of pictures. It would be possible for said software to ascertain if said series of pictures are being used in a similar or like manner, for instance as labels. One way to accomplish this would be for software to analyze each picture and the data that each picture either impinges or is closely associated with in environment 1. The software can look for one or more patterns of association, namely, a similar type of data that each picture impinges or is closely associated with. If a pattern of association can be found, the software can determine that said each picture is a candidate to be sequenced. Then the model element illustrated in FIGS. 46A-46E would be valid for programming said each picture in environment 1. Further, as more pictures were added to environment 1, said more pictures would also be sequenced by said model element illustrated in FIGS. 46A-46E. Note: the sequencing of said pictures would be according to the scope of said model element.

Thus the software of this invention can derive a model element from a motion media that recorded the inputs and resulting changes illustrated in FIGS. 46A-46E. One such model element could be: “The ability to add sequential numbers to pictures in an environment.” A broader model element would be: “The ability to add sequential numbers to objects in an environment.” A narrower model element would be: “The ability to add sequential numbers to objects that exhibit a similar or same pattern of use in an environment.” A still narrower model element would be: “The ability to add sequential numbers to pictures that exhibit a similar or same pattern of use in an environment.”

It would be possible to derive all of the above model elements and more from a motion media that recorded the inputs and resulting change illustrated in FIGS. 46A-46E. These model elements could be saved as a new PAO Item or saved as one or more modifier objects. Said new PAO Item could be used to modify or append an existing PAO Item. As an example, consider the PAO 2 with three model elements as listed below:
1. A network of objects that can communicate with each other.
2. Sequencing is according to one integer increments in an ascending order.
3. Sequencing causes the number of each sequenced object to change to a new number matching the characteristics of each sequenced object.

Utilizing an Additional Model Element for a PAO Item

For the purposes of example only, let's take a PAO 2 that includes the three model elements listed in paragraph [600]. Now consider that model elements of varying scopes that were derived from FIGS. 46A-46E, which we will refer to as “modifier object 15A”, are added to said PAO 2 to amend said PAO 2. (Note: “modifier object 15A” contains all different model elements with varying scopes described in part in paragraph [550]. The software can automatically create varying scopes as needed.)

Note: there are many possible methods to add one or more model elements to an existing PAO 2. Referring generally to FIG. 45, an object representing one or more model elements could be outputted to impinge an existing PAO 2; an object representing one or more model elements could be associated with an existing PAO 2 via drawing means, verbal means, context means and the like. Further, a menu, list, or other visualization or verbalization could be presented to a user to enable said user to select one or more model elements to be used to amend an existing PAO 2.

Let's call the amended PAO 2 in the example presented in paragraph [543] above, “PAO 2A.” Let's say that one of the scopes of “modifier object 15A” is: “The ability to add sequential numbers to existing pictures in an environment.” Let's further say that PAO 2A is used to program an environment that contains picture labels (“environment 2A”). PAO 2A model elements two and three, as listed in paragraph [600], would be considered invalid for programming said environment 2A. The reason is that the pictures of environment 2A do not contain visible numerical indicia. But this problem can be overcome by using said “modifier object 15A” in said PAO 2A to present the ability for said PAO 2A to add numbers to pictures.

When said PAO 2A is called presented to said environment 2A, the software looks for a way to successfully program environment 2A with said PAO 2A. To accomplish this, the software selects a model element from “modifier object 15A” and uses it to make PAO 2A's model elements two and three, (as listed in paragraph [278]) valid for said environment 2A. Thus, model element two, “Sequencing is according to one integer increments in an ascending order,” and model element three, “Sequencing causes the number of each sequenced object to change to a new number matching the characteristics of each sequenced object,” can be successfully used to program environment 2A.

The pictures contained in environment 2A could be according to any presentation, from being randomly placed to being in an organized list. The result of the applying of said PAO 2A to environment 2A would be to sequence each picture in some order. The order could be derived from the history of the creation of said pictures in environment 2A. For example, if the creation of said pictures had been saved as a motion media, the software of this invention could analyze the motion media that contained the history of the creation of said pictures and determine the order of the creation of said pictures. That order could be used to apply sequential numbers to each picture, e.g., the first picture created would be the lowest number and the last picture created would be the highest number. This approach would enable the software to successfully sequence pictures that appeared to be randomly placed in said environment 2A. If no motion media history or its equivalent existed for said pictures in environment 2A, said PAO 2A could apply number sequencing to said pictures via an arbitrary approach, set as a default, according to a configuration file, or by any other suitable means known to the art. The point here is that by amending a PAO Item with one or more additional model elements, the scope of said PAO Item is increased, thus enabling it to be successfully applied to more types of environments. Further, the software of this invention can by analysis of a PAO 2 and its model elements, and of an environment to be programmed by said PAO 2, determine which model elements of said PAO 2 should be used to successfully program said environment by said PAO 2.

Note: motion media history be an object. As an object it could be presented as any visualization or remain invisible. In either case, said motion media history object can be interrogated by the software of this invention and can be interfaced with by any user, e.g., via verbal, context or gestural means, (if invisible), or by verbal, gestural, drawing, dragging, context means (if visible).

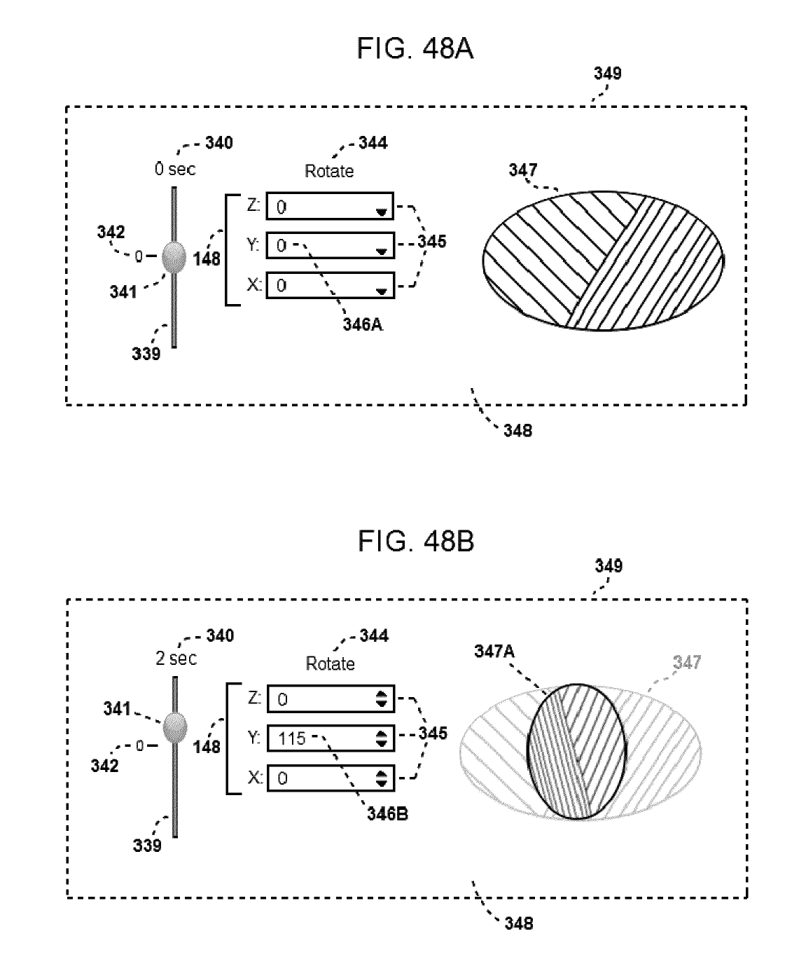

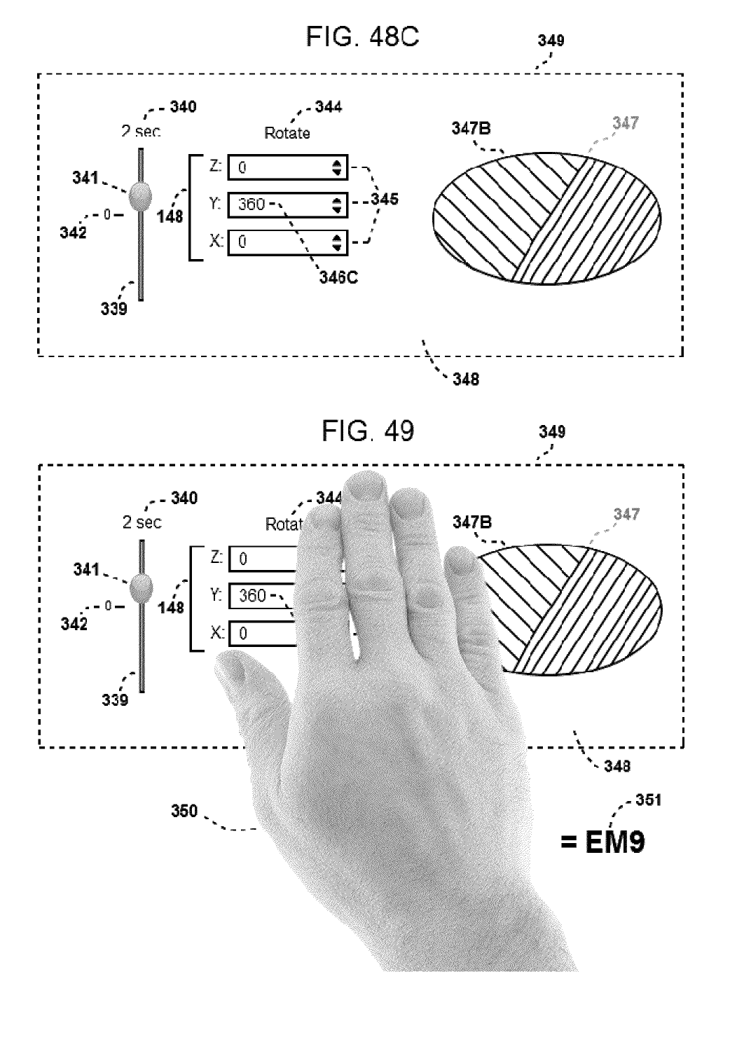

Referring now to FIG. 48A, an Environment Media, 349, contains a set of controls that are being used to program rotation for object, 347. Said set of controls are comprised of the following: (1) a fader device, consisting of a fader track, 339, a fader cap, 341, a time indicator, 340, and a zero point, 342, along fader track, 339; (2) separate value settings for the function “Rotate”, 344, along the Z, Y, and X axis, and up-down arrows, 345, for altering any value setting. Fader cap, 341, is located at center point, 342, along the vertical axis of fader track, 339. As shown in FIG. 48A, fader device has a value 0 seconds as shown in time indicator, 340. FIG. 48A shows the value for the Y axis, 346A, to be zero, namely, no rotation of object, 347, along the Y axis. The values for the Z and X axis are zero. For purposes of this example, all items and their settings and relationships, as depicted in FIG. 48A, comprise “State 1” of Environment Media, 349. A motion media, 348, has been activated to record all states, elements and relationships of any element, and any change to any state, element, and/or relationship of any element of environment, 349. The conditions presented in FIG. 48A comprise “State 1” of Environment Media, 349, as recorded by motion media, 348.

FIG. 48B shows a change of value, 346B, for the Y axis setting. Said change is caused by operating the upper up/down arrow, 345, for the Y axis to enter a new setting of 115 degrees. Fader cap, 341, has been moved upward along fader track, 339, to change time indicator, 340, to “2 seconds.” Said movement of fader cap, 341, programs the time it will take for object, 347, to rotate from its original position at a 0 position along the Y axis to a position of 115 degrees along the Y axis. Note: The 115 degree rotated position of object, 347, is shown as object, 347A, in FIG. 48B. Note: regarding the zero center point, 342, of fader track, 339, any movement of fader cap, 341, above the zero center point, 342, will cause a clockwise rotation, and any movement of fader cap, 341, below the zero center point, 342, will cause a counter-clockwise rotation. Further, what is depicted in FIG. 48B comprises another state that is recorded in motion media, 348.

FIG. 48C illustrates a 360 degree rotated position of object, 347. Note: a 360 degree rotated object has the same static image as a 0 degree rotation of the same object. For purposes of the example of FIG. 48C, object, 347, now rotated by 360 degrees, is labeled as object, 347B. Said motion media, 348, records every element and their settings and relationships as shown in FIG. 48C. For purposes of this example, the last change made to Environment Media, 349, is the changing of the Y axis setting from 115 degrees to 360 degrees, 346C. Therefore, the conditions depicted in FIG. 48C comprise the last state of Environment Media, 349. We'll call this, “State 2,” which is the final state of Environment Media, 349, recorded in motion media, 348.

Further regarding FIGS. 48A to 48C, the software of this invention can analyze the elements and change to Environment Media, 349, as recorded in motion media, 348. One result of the software analysis of motion media, 348, is the creation of a Programing Action Object (POA 1 or POA 2) from the recorded states and changes in motion media, 348. For instance, as part of the process of creating a POA 2, the software determines a starting and ending state for the states recorded in motion media, 348. Regarding this example, “State 1” is what is depicted in FIG. 48A and “State 2” is what is depicted in FIG. 48C. The state depicted in FIG. 48B is a transcendent state, which is neither the first nor last state. The software analyzes said “State 1” and “State 2” to see if said “State 1” and “State 2” define a task. The software can quickly determine via an analysis of the control settings of FIG. 48A and changes to said control settings, as shown in FIG. 48C, that a 360 degree rotation has been programmed for object, 347 (renamed 351 in FIG. 48C). Further the software can determine that the time for said 360 degree rotation is 2 minutes. Still further, the software can determine that said 360 degree rotation is clockwise. The software can make these determinations because the operations of said fader device and “Rotation” controls result in the clockwise rotation of object 347. Thus in this case, the software is able to make a highly accurate decision about what comprises the starting and ending state of motion media, 348. Further, by an analysis of the differences and other factors between said start and ending state, software can derive a task from motion media, 348. If there is any question about the reliability of the task decision, the software can check any one or more transcendent states and change associated with said transcendent states. In this example, the software would likely require any further analysis of addition change or states in motion media, 348.

Referring now to FIG. 49. Environment Media (“EM”), 349, includes motion media, 348. Therefore, “EM”, 349, includes all states, elements and change recorded in motion media, 348. FIG. 49 depicts the creation of an equivalent for EM, 349. In this case it is the word, “EM9”, 351. Said equivalent can be created by many methods. The method illustrated in FIG. 49 includes the following steps: (a) touch with five fingers 350, (b) type: “equals EM9” [as an alternate one could verbally state: “equals EM9”]. The software would create an equivalent: “EM9” for Environment Media, 349.

There are many benefits to creating equivalents for Environment Media. For instance, an equivalent can be verbally stated, typed or drawn to recall an EM to a computing device or its equivalent. An equivalent can be used in an object equation. An equivalent can be directly manipulated to alter the size, position, relationship, or any other factor belonging to or associate with an Environment Media.

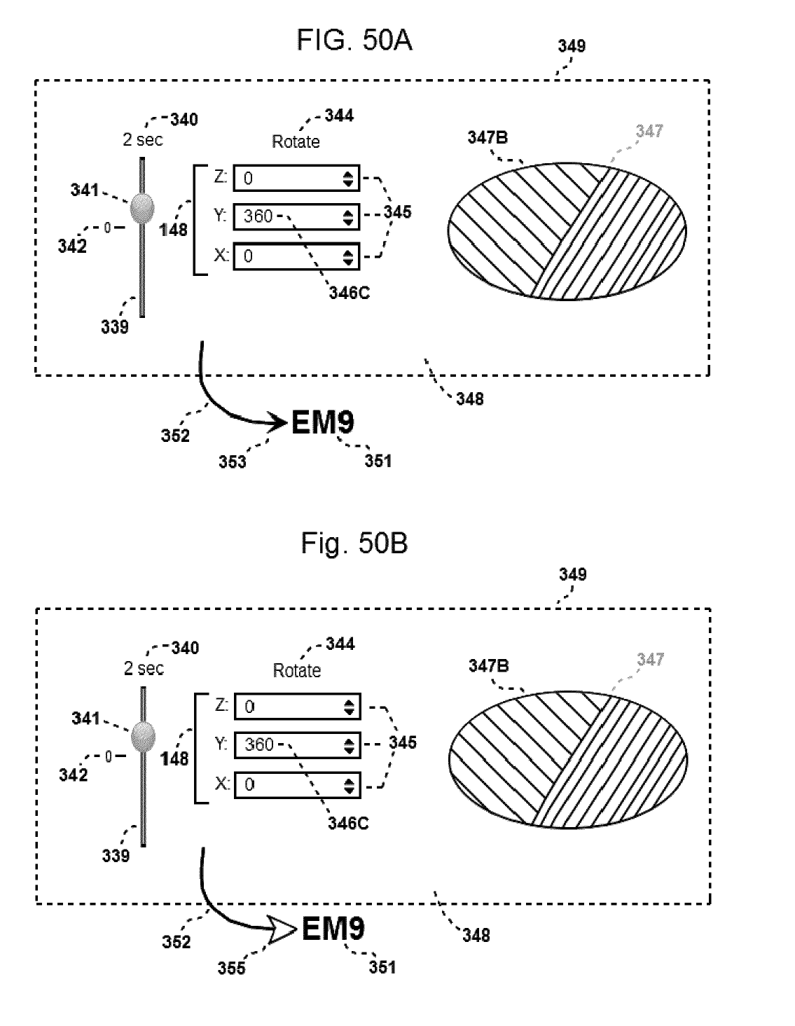

FIGS. 50A and 50B illustrate an alternate method of creating an equivalent for an Environment Media. A directional indicator, 352, is drawn from Environment Media, 349, pointing to a text object, 351. The directional indicator, including its arrowhead, 353, is solid black. In FIG. 50B software recognizes said directional indication, 352, as able to apply a valid transaction to text object, 351, and changes the arrowhead of said directional indicator to a large white arrowhead. An input, like a finger or pen touch, to said white arrowhead, 355, activates the transaction of said directional indicator, 352. As a result, text object “EM9”, 351, is made the equivalent of Environment Media, 349.

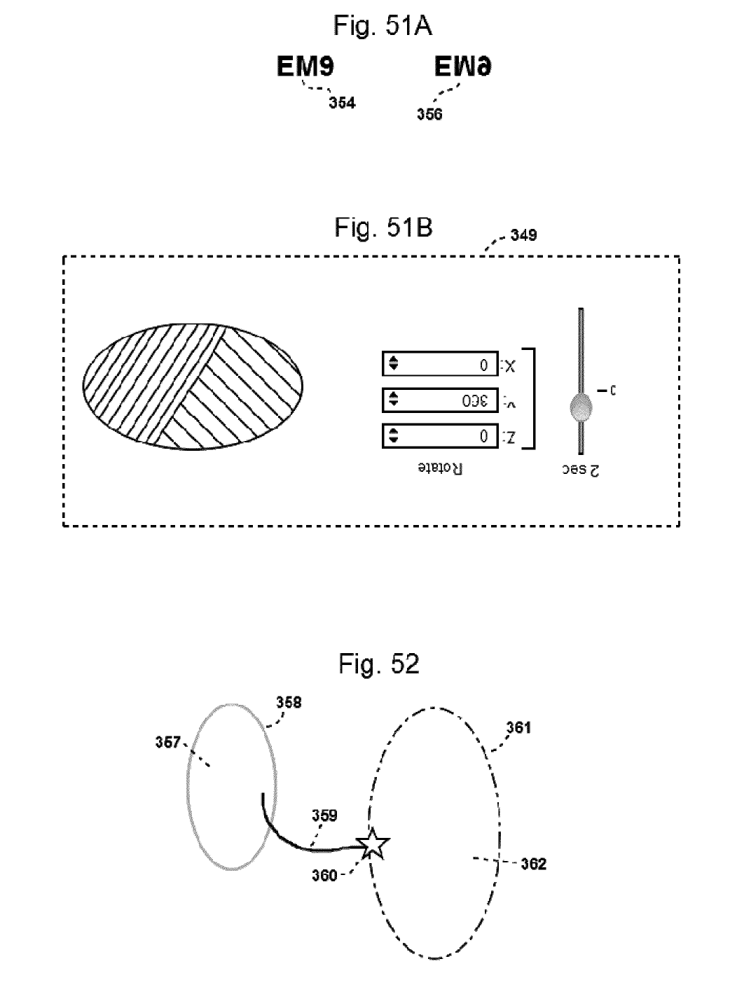

An equivalent can be manipulated to modify the object, data, element, or the like, that said equivalent represents. FIG. 51A depicts the manipulation of equivalent, 354, to a 180 degree rotation, 356. Referring to FIG. 51B, said 180 degree rotation results in the rotation of Environment Media, 349. Any manipulation of an equivalent can be carried out to achieve the same or a proportionate manipulation of the object that said equivalent represents. As a further example, if equivalent object, 356, were stretched or skewed or altered in color, “EM”, 349, would be altered in the same manner, in a proportionate manner or via a percentage, e.g., 30% of the change applied to equivalent, 356, would be applied to EM, 349. An Environment Media can manage all of the elements that comprise said Environment Media. Thus if an equivalent of an Environment Media is altered, all of the elements that comprise said Environment Media can be equally or proportionately altered.

Referring now to FIG. 52, this is an illustration of the assignment of an invisible PAO2 to an invisible gesture. Note: for purposes of discussion, invisible PAO 2, 357, is outlined by a light grey ellipse, 358. Invisible PAO 2, 357, is impinged by a line object, 359, that extends from object 357, (the source object) to a graphic 361, (the target object) which represents an invisible elliptical shaped gesture. Further a transaction for said line object 359 is activated by a context. Said context is the impingement of invisible PAO 2, 357, and the impingement of invisible gesture 361, by directional indictor 359. The software analyzes the transaction of line object 359, to determine if the transaction of said line object, 359, is valid for invisible objects 357 and 362. Upon the software determining that said transaction is valid, the target end of line object 359, changes its appearance to a star, 360. Star 360, is activated (e.g., by a finger touch) to cause the transaction of line object 359, to be carried out. Said transaction is “assignment.” Thus invisible PAO 2, 357, is assigned to invisible gesture 362.

A logical question here might be: how does one assign an invisible object to another invisible object by graphical means? There are many methods to accomplish this. One method is to use a verbal command that can be any word or phrase as determined by a user via “equivalents.” Let's say object 357 was given an equivalent name by a user as: “show crop picture as video.” A verbal command: “show crop picture as video,” could be uttered and the software could produce a temporary visualization of the invisible PAO 2, 357. Since PAO 2, 357 is a series of actions, no visible representation is necessary for the utilization of PAO 2, 357. But a temporary visualization permits a user to graphically assign PAO 2, 357 to a gesture. Similarly, PAO 2, 357, invisible gesture, 362, does not require a visualization to be implemented, but said gesture can also be represented by a temporary graphic, shown as graphic 360, in FIG. 52. The method to create said temporary graphic for said gesture could be the same method used to present a temporary graphic for said PAO 2. Other methods for presenting visualizations for both invisible PAOs and gestures could be via a menu selection, a gesture, activating a device, a context, time, and more.

Referring again to FIG. 52, upon the activation of invisible gesture 362, invisible PAO 2, 357, can be automatically activated. For instance, let's say a user moves their finger in an elliptical shape in free space. This finger movement could be detected by a camera recognition system or a capacitive touch screen, or a proximity detector, or a heat detector, or a motion sensor or a host of other detection and/or recognition systems. Once detected, the shape of the finger movement (gesture 362, in FIG. 52) could be recognized by software. In the example of FIG. 52 the gestural shape is an ellipse. The recognition of gesture 362 would cause the activation of gesture 362 and would therefore activate PAO 2, 357, which has been assigned to gesture 362. It should be noted that it may not always be desirable to activate the assignment of an assigned-to object every time an assigned-to object is recognized. Another approach would be to control the activation of an object and its assignment via a context.

Before we address that, a more basic question needs to be addressed: “how does the software know to activate PAO 2, 357, upon the recognized outputting of gesture 362?” One method would be that the assignment of an invisible PAO to an invisible gesture object comprises a context that automatically programs an invisible gesture with a new characteristic. In FIG. 52, as a result of the assignment of invisible PAO 2, 357, to invisible gesture object, 362, a new characteristic (not shown) is added to invisible gesture object 362. This characteristic is the automatic activation of PAO 2, 357, upon the activation of gesture 362. A modified characteristic would be the automatic activation of PAO 2, 357, such that the task of PAO 2, 357, is applied to the object impinged by gesture 362. In this latter case, the operation of a gesture can determine the target to which a PAO, assigned to said gesture, is applied. For instance, if a user outputs a recognized gesture to impinge a first video, the PAO assigned to said recognized gesture would be applied to said first video. If said recognized gesture is outputted to impinge a first picture, the PAO assigned to said recognized gesture would be applied to said first picture and so on. The automatic activation of the task or model or any action of any PAO that is assigned to any object is a powerful feature of this software. This enables user input, automated software input, context (and any other suitable means) to activate any object that contains a PAO as its assignment. The activation of said any object would result in the automatic activation of the task, model, sequence, characteristics or the like contained in any PAO assigned to said any object. Further, the context in which said any object is outputted can determine the object to which the task of said any PAO assigned to said any object is applied.

Another embodiment of the invention is directed to a user performing a task in the physical analog world to define digital tools that can be utilized to program and/or operate an Environment Media, which includes the digital domain and/or physical analog world. One idea here is that a user can perform a task in the physical analog world that can be recorded as a motion media. The change recorded in said motion media is analyzed by software to derive a PAO 2 that can be utilized to program an object, including an Environment Media. Further said Environment Media programmed by said PAO 2 could be used to operate a task in the physical analog world. One key element permitting the accurate recording of a user's actions to perform a task in a physical analog environment is the recording of relationships between objects that comprise said physical analog environment as part of the state and changes in said state of said physical analog environment. Many different methods can be utilized to establish relationships between the digital world and the physical analog world. Some are discussed below.

Computer Processors Embedded in Physical Analog Objects.

“Physical analog objects” are objects in the physical world, like clothes, spoons, ovens, chairs, paintings, tables, etc. These objects are not digital. Digital processors, MEMS, and any equivalent (“embedded processors”) can be embedded in virtually any physical analog object from a rug, to a picture, to clothing, to a lamp. We'll refer to these objects as “computerized analog objects” (“CAO”). As an example only, consider CAO with a relationship to food preparation. This could include embedded processors, or the equivalent, in refrigerators, freezers, blenders, electric mixers, and smaller objects, like individual shelves in a refrigerator, cartons of milk and other liquids, measuring spoons, mixing bowls, knives, peelers, graters, pepper mills, spice racks, individual ingredient containers and so on.

Computer Processors that can Recognize Analog Physical Objects.

In addition to embedded digital processors, digital recognition camera systems, optical recognition systems, and the like can be utilized to recognize physical analog objects and their operation. Such systems may be able to recognize any object that is within view of a digital camera or its equivalent. For the following example, a generalized example of a computer recognition system would be one or more cameras which are mounted in a kitchen and that communicate, via software, data received from the physical analog world to a computing system or its equivalent. As an example, a cook could work in a customary manner to prepare and cook something in a kitchen, and a computer camera recognition system in said kitchen would record the cook's operation of physical analog objects as a motion media. The recording of said cook's operation could include any level of detail. For instance, it could include: selecting ingredients, the order that said ingredients are used, how ingredients are combined (e.g., the rate of pouring, stirring, mixing, blending, plus the method used, e.g., a wooden spoon, plastic spoon, silver spoon, electric mixer, shaking ingredients in a container and the like), the temperature of the oven, the cooking sheet, cake pan, roast pan, and the like used for cooking, how the prepared food is placed on cooking sheet or other cooking pan and so on. Said motion media would then be analyzed by software to derive one or more Programming Action Objects (“PAO”) from said motion media. [Note: the processes of recording change, analyzing change, and deriving of a PAO from a motion media could occur concurrently, depending upon the processing power of the computing system being used.]

Combined Embedded Processor and Digital Recognition System.

The two approaches described above could be merged into one system. With this approach, each physical analog object could include an embedded processor (what we refer to as “computerized analog objects” (“CAO”) and be associated with a digital camera system. Said embedded processor would receive information as the result of each physical analog object being operated by a user. In addition, the manipulation of physical analog objects would be converted to digital information via a digital recognition system or any equivalent. Both the embedded processors and digital recognition system communicate user operations in a physical analog environment to a computing system or its equivalent. Thus, physical analog objects (with or without embedded digital processors) could be used to supply information to a digital system. Said information can be used to modify and/or program embedded processors in physical analog devices, program one or more computers to which said embedded processors communicate, program one or more Environment Media, and/or program any digital processor or computer. A group of physical analog devices (with or without embedded digital processors) that are operated to achieve a task can define a digital Environment Media. An Environment Media can be entered from the digital domain or from the physical analog world. In either case, a user has access to and can communicate with all objects that define said Environment Media. Said embedded processors and said digital recognition system could act as redundant systems to provide checks and balances to each other to minimize errors. Alternately, said embedded processors and said digital recognition system can work together to provide more complete information regarding a user's operations in a physical analog environment.

User-Defined Programming Tools.

A key point here is that a user can work in any physical analog and/or digital environment to perform a task. Information from said task can be used to create an object tool, (like a PAO 2), which can be used to program an environment and/or one or more objects. The user does not need to know how to program anything. The user just works as they normally would to complete a task. A user-defined programming tool can contain very specific information pertaining to the user whose recorded operations define said programming tool. For instance, let's say a user is baking chocolate chip cookies. Just following a chocolate chip cookie recipe will not ensure that the cookies that are baked will taste the same as the chef who created the recipe. The final baked cookies are dependent upon many factors, including: quality of ingredients, order of combining ingredients, the speed of stirring and mixing with hand utensils, the choice of hand utensils, the types of appliances used, e.g., electric mixer and its speeds of operation, type of baking sheets used, oven temperature, distance of the oven rack from the bottom or top of the oven, and many more factors. The method of this invention enables a user to program digital information that can be used to recreate precise or generalized operations used by a specific user to perform any task. The recording and analysis of sufficient detail of a cook preparing and baking chocolate chip cookies in a kitchen can result in the formation of a digital tool (e.g. a PAO 2) that can be used to recreate said detail to produce the same end result as said cook.

Exploring this idea further, let's discuss the creation of a Programming Action Object, which we will refer to as: “Chocolate Chip Cookie Recipe” or “CCCR.” A cook in a kitchen makes chocolate chip cookies by following an analog recipe printed in a book, or written on a scrap of paper, or from memory, or maybe by following a recipe on a smart phone. The cook locates the ingredients, prepares them, mixes them, sets an oven temperature, puts cookie dough on a cookie sheet, and bakes the cookies. The cook, the kitchen and the recipe exist in the physical analog world. The idea here is to turn the execution of the analog recipe into a digital object (e.g., a PAO 2) that can be used to program and/or direct the task, Make Chocolate Chip Cookies, (“MCCC”) in an analog and/or digital environment. For purposes of this discussion, let's say this environment is an Environment Media, called: “Cookie World.” As the cook follows the recipe and makes cookies in a kitchen. The cook's actions (which create “change” in the state of the physical analog kitchen environment) are recorded as a motion media. For reference, we'll call this motion media, “MM Cookie.” The recording of “MM Cookie” is accomplished via a digital recognition system (which could include digital cameras, MEMS, associated computer processors and any other suitable method or device) that can digitize the cook's actions and report them to a computing system or its equivalent. [Note: the recording of said “MM Cookie” could be to a persistent storage medium or to a temporary storage medium.] It doesn't matter how long the food preparation and baking process takes, every change that results from the cook's actions in the kitchen is recorded as motion media, “MM Cookie.” [Note motion media “MM Cookie” is generally given its name at the time it's saved, but could be renamed at any time by any means common in the art.] Software analyzes motion media “MM Cookie” and derives a PAO 2 (which we've named “CCCR”) from the “change” recorded as “MM Cookie.” The task of said PAO 2 is: Make Chocolate Chip Cookies, “MCCC.” Said task is based upon the actual change to the analog kitchen environment that resulted from each action of the cook during the preparation and baking of chocolate chip cookies. Thus PAO 2, “CCCR”, is not a mere recipe. Said PAO 2 is, in part, sequential data that can be used to program every action and the resulting change to an environment that is required to complete the task “MCCC.” The order of events, amounts of ingredients, timing, and other factors that comprise PAO 2, “CCCR,” are determined by what the cook performed in a physical analog kitchen. [Note: Said PAO 2, “CCCR” could be either a specific set of actions required to complete the task “MCCC” exactly as it was performed by said cook in the physical analog kitchen (“precise change”), and/or said PAO 2 could be one or more models of the task “MCCC.” The choice of “precise change” or a model could be up to the user of said PAO 2 or it could be determined by context and other factors.]

In summary, software analyzes a motion media and determines each change that is required to perform a task. In the case of a cook making chocolate chip cookies in a kitchen, each change is likely to be the result of some user input. As the cook works in the kitchen to make and bake chocolate chip cookies, each change made in the kitchen is recorded as a motion media. The cooks operations in an analog kitchen are used to define a programming tool that can be applied to a digital and/or analog environment. In this example, the Environment Media “Cookie World” contains digital objects and physical analog objects, which define “Cookie World.” It should be noted that change made to physical analog objects that do not have embedded processors can be recorded as a motion media and utilized by a digital system to create programming tools, e.g., a PAO 2. [Note: One type of PAO 2, presents the exact steps that were employed by said cook as they prepared and baked chocolate chip cookies in said kitchen. This is an example of “precise change” recorded in said motion media. As an alternate, a model of the change recorded in said motion media would allow other types of cookies to be made by substituting or adding ingredients. In an analog world this might be called: “being inventive in the kitchen.” In a digital world this is called: “updating.”

Environment Media have many benefits. One benefit just discussed is directed to a user performing a task in the physical analog world to define digital tools that can be utilized to program and/or operate an Environment Media, which can include the digital domain and/or physical analog world. Below the software of this invention is directed to a user performing a task in the physical analog world to define simple to very complex tasks which can be used to program, guide and/or define operations of mechanical agents, which we will refer to as “robots.” Generally, robots are programmed by very complex software. The discussion below concerns a method whereby a user performs a task in the physical analog world to define one or more digital tools that can be utilized to program, operate, direct, and/or control the actions of a robot.

Consider a physical robot which has been given the task to make chocolate chip cookies in a physical analog kitchen. How would the robot begin? The robot could search for an Environment Media that includes the required task. The robot finds an Environment Media that is at least in part defined by said task, and enters the environment. Let's say the robot enters the Environment Media, “Cookie World.” In “Cookie World” are a set of objects that have a relationship to each other and to a task, namely, “MCCC.” A robot can move around and manipulate physical analog objects and a robot can send and receive digital information to and from a computing system. As an example, let's say a kitchen has embedded processors in every object, e.g., ingredient containers, utensils and appliances, needed for accomplishing the task: Make Chocolate Chip Cookies (“MCCC”). We'll call this group of ingredient containers, utensils and appliances: “cookie elements.” All cookie elements have a relationship to at least one other cookie element and are used to complete a common task, namely, “MCCC,” in the Environment Media, “Cookie World.”

Upon entering “Cookie World,” it is activated, and PAO 2, “CCCR” is automatically outputted to program Environment Media, “Cookie World.” There are many methods to accomplish this. One method would be to establish the activation of Environment Media, “Cookie World” as a context that automatically calls forth PAO 2, “CCCR” to program “Cookie World.” As a result, the robot can easily follow each “change” programmed by PAO 2, “CCCR” for “Cookie World.” As previously mentioned, each object in the analog physical kitchen includes an embedded digital processor or its equivalent. The physical analog environment (the kitchen) is defined by the digital Environment Media “Cookie World.” Thus each object in the analog physical kitchen that is required to complete the task “MCCC” of “Cookie World” can communicate to each other in the physical analog kitchen. In other words, the digital objects, “cookie elements,” of “Cookie World” have an analog duplicate (or recreated counterpart), in a physical analog kitchen. In addition, each said analog duplicate can communicate to each other, to “Cookie World,” and to the robot. Through this communication the robot is guided to recreate the programmed change of PAO 2, “CCCR” to accomplish the task “MCCC” in a physical analog kitchen.

The robot can communicate to each analog and digital cookie element in “Cookie World. There is only one Environment Media here, “Cookie World.” The Environment Media, “Cookie World” includes both the digital domain and the physical analog world, which are connected via relationships that support the task, “MCCC.” The embedded processor in each analog cookie element contains information about said each cookie element that can be understood by the robot and by the computing system, or its equivalent, associated with “Cookie World.” This communication is very efficient. For instance, if the robot is pouring oil into a mixing bowl, the oil container can communicate a change in the container's weight to the robot, who in turn responds by tilting the oil container back at exactly the right time to produce the exact measured amount of oil defined by PAO 2, “CCCR.” As another example, if any ingredient is missing or there is not enough to fulfill the requirement of PAO 2, “CCCR,” an ingredient container can communicate this to the robot. For instance, if there is not enough flour in the flour container, said flour container can communicate this to the robot who knows that cookies cannot be made without this ingredient. In fact, the robot can communicate to all cookie elements before beginning the task of “MCCC” to determine if all of the necessary ingredients to accomplish the task “MCCC” exist in a physical analog kitchen. The cookie ingredient containers with insufficient amounts of ingredients can communicate to the robot who can notify the Environment Media, Cookie World, which can log the missing cookie elements and issue a notice to purchase what is missing. Said notice to purchase could be sent directly to a grocery store or other food supply outlet computer from Environment Media, “Cookie World.” Further, any grocery supply store computer that responds with the needed ingredients can become part of the Environment Media, “Cookie World.”

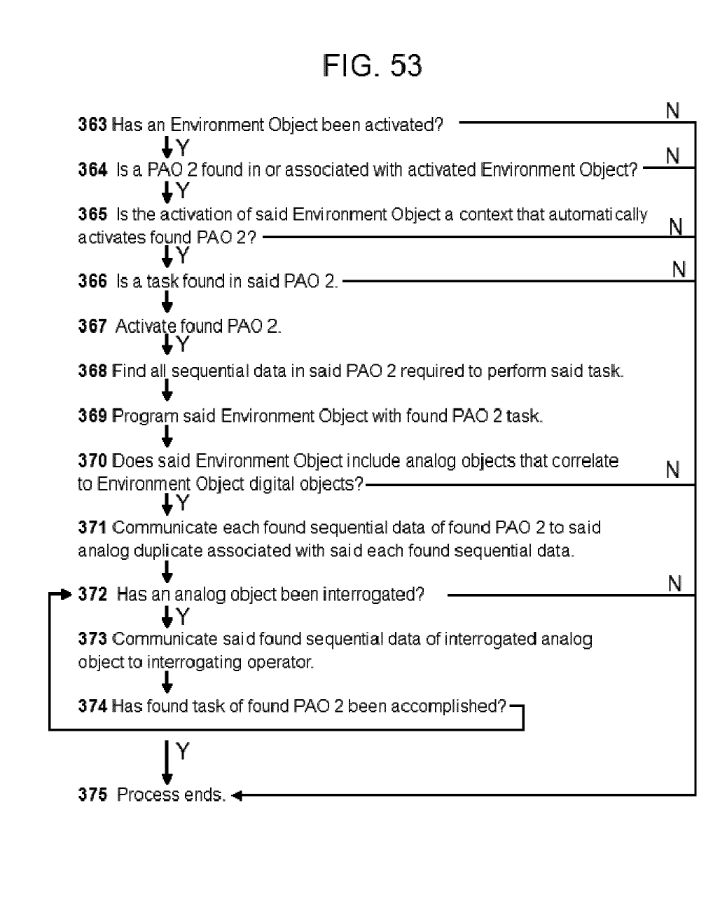

Referring now to FIG. 53, this is a flow chart illustrating the interrogation of an Environment Media with an interrogating operator. Said interrogating operator could include anything capable of interrogation, including: a mechanical agent, an Environment Media, any object, software, a person, an avatar, e.g., in a video game, or any other source of interrogation.

Step 363: Software queries, has an Environment Media been activated? If an Environment Media is recalled and entered by any means, this equals the activation of said Environment Media. If the answer to the query of Step 363 is “yes,” the process proceeds to Step 364. If not, the process ends at Step 375.

Step 364: Software queries, is there a PAO 2 that in part defines or is associated with the activated Environment Media? If “yes,” the process proceeds to Step 365. If not, the process ends at Step 375.

Step 365: Software queries, does the activation of said Environment Media constitute a context that is recognized by said PAO 2? And does said recognized context cause the automatic activation of said PAO 2? If “yes,” the process proceeds to Step 366. If not, the process ends at Step 375.

Step 366: Software queries, is a task found in the PAO 2 found in Step 364? If “yes”, the process proceeds to Step 367. If not, the process ends at Step 375.

Step 367: The PAO 2 is activated.

Step 368: Software finds all sequential data in found PAO 2 that is required to perform the task found in Step 366.

Step 369: Found PAO 2 programs said Environment Media with the found task of said PAO 2.

Step 370: Software queries, does said Environment Media include analog objects that correlate to digital objects in said Environment Media? In other words, for each analog object in said Environment Media is there a digital version of said each analog object? If the answer is “yes,” this means that said Environment Media includes objects in both the digital domain and analog world that communicate with each other. An example of this can be found in the example of cooking chocolate chip cookies in a physical analog kitchen. Here physical analog objects in a physical analog kitchen were utilized to define the task: “MCCC.” In Environment Media, “Cookie World,” each physical analog object was recreated by software as a digital object, which was therefore part of “Cookie World.” If “yes”, the process proceeds to Step 371. If not, the process ends at Step 375.

Step 371: Said Environment Media communicates information regarding each step found in said PAO 2 to each physical analog object that was originally used to define said each step of said PAO 2. Note: the steps that comprise the task of said PAO 2 were derived from a motion media that recorded each user operation of each analog object (e.g., utensils, ingredients, appliances, and the like) in an analog kitchen. As a reminder, each physical analog object either has an embedded digital processor and/or is recognized by a digital recognition system.

Step 372: Software queries, has an analog object been interrogated? Referring again to the example of “Cookie World,” said Environment Media communicates to each analog object in a physical analog kitchen. Said communication is via an embedded processor in said each analog object and/or via a digital recognition system. In Step 372 said Environment Media searches through the group of physical analog objects that define said Environment Media to find any physical analog object that has been interrogated. In a simple sequential task, each said analog object may be interrogated one at a time. In a more complex task, multiple analog objects may be interrogated concurrently. If the answer to the query of Step 372 is “yes”, the process proceeds to Step 371. If not, the process ends at Step 375.

Step 373. The Environment Media, or its equivalent, communicates information associated with the interrogated analog object to the interrogating operator. As an alternate method, said interrogated analog object communicates information to the interrogating operator. As a further alternate method, the digital object that is a recreation of said interrogated analog object communicates information to the interrogating operator. By any of these methods an interrogating operator can interrogate each physical analog object according to the steps in the task defined by said PAO 2. For instance, if the first step in the task “MCCC” is get milk from the refrigerator, said interrogating operator would first interrogate the refrigerator object in said Environment Media activated in Step 363.

Step 374: The Environment Media activated in Step 363 queries, has the task of found PAO 2 been accomplished? If not, the process goes back to Step 372, which causes the interrogation of a next analog object. This is followed by an iteration of Step 373 whereby said interrogated analog object communicates its information, or the equivalent, to said interrogating operator. Said information could be anything that pertains to the operation of said interrogated analog object. For example only, if it were a container object containing the spice “cinnamon,” information pertaining to this analog container device would likely include the exact amount of cinnamon dispensed from the container, and perhaps the method of dispensing the cinnamon. The process of FIG. 53 iterates between Steps 372, 373 and 374 until all steps required to accomplish said task of said PAO 2 are fulfilled. Then the process ends at Step 375.

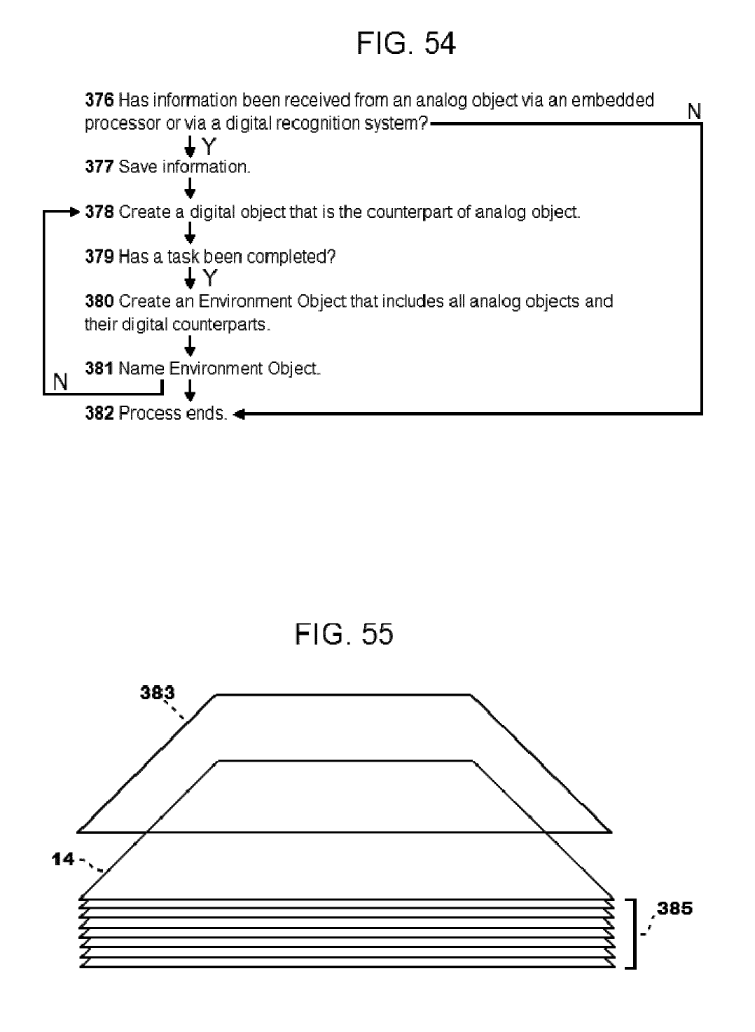

Referring now to FIG. 54, this is a flow chart that illustrates the creation of an Environment Media from physical analog object information that performs a task.

Step 376: Software queries, has information been received from an analog object via an embedded processor or via a digital recognition system? As an illustration only, referring to the example Environment Media “Cookie World,” multiple physical analog objects are operated by a cook in a physical analog kitchen to prepare and bake chocolate chip cookies. The combined operations of said physical analog objects by said cook define the task: Make Chocolate Chip Cookies, “MCCC.” In Step 376 software checks to see if a digital system or any equivalent has received information from a physical analog object. In the example of “Cookie World,” when a cook operated a first physical analog object, (e.g., taking butter out of a refrigerator), said first analog object communicates information to a computing system.

Step 377: The information received from said analog object is saved.

Step 378: The software creates a digital object that is the counterpart of said analog object of Step 181. Said digital object is an equivalent of said analog object. As an equivalent, said digital object can communicate to said analog object.

Step 379: The software queries: has a task been completed? In the case of the “Cookie World” example, the operation of one analog object did not complete the task: “MCCC.” If the answer to the query of Step 184 is “no,” the process goes back to step 376 and iterates through Steps 377, 378 and 379. This process is repeated over and over again until a completed task is defined by the information from “n” number of analog objects. When the combined information from “n” number of analog objects defines a complete task, the process proceeds to Step 380.

Step 380: The software creates an Environment Media which is defined by “n” number of analog objects (and a digital counterpart for each analog object) that define a complete task.

Step 381: The software names newly created Environment Media or affords the opportunity for a user to name said Environment Media.

Step 382: The process ends.

Method for the Operation of Data Via an Environment Media

Another embodiment of the invention is a method of modifying existing content via an environment comprised of objects which are derived from said existing content. In another embodiment of this method content exists as a series of modifications to the characteristics of objects derived from existing content. In another embodiment of this method content exists as a series of modifications to the characteristics of objects created via inputs to said objects and/or via communications between said objects. In another embodiment of the invention software recognizes at least one user action as a definition for a software process, which can be utilized to program any object in any environment media and/or any environment media. In another embodiment of the invention a first object in a first environment media can communicate its characteristics and/or the characteristics of any number of other objects, which have a relationship to said first object, to at least one object in another environment media as a means of sharing content. In another embodiment of the invention environment media and the objects that comprise environment media are derived from or modified by the analysis of EM visualizations pertaining to apps, programs and/or environment media.

Regarding the modification of existing content, the software of this invention analyzes content and creates digital objects that are derived from said content and/or from software environments. Said digital objects are saved as a new media called “environment media.” Said digital objects and/or the environment media that contains them can be synced to original content from which said objects are created, or an environment media and the objects that comprise an environment media can be used as a standalone environment which is not synced to any existing content. By syncing an environment media and the objects it contains to content, users can alter any existing content, including pictures, graphs, diagrams, documents, websites and videos, such that no edits occur in said existing content. Also it is not necessary for a user to copy said existing content. All alterations of existing content take place via objects comprising an environment media synced to existing content. Users can select any portion of any existing content to be analyzed by the software of this invention. For instance, an entire video frame could be selected for analysis, or a small section of said video frame, even one pixel or sub-pixel. A selected area of any content is called a “designated area.” When an input defines a designated area of any existing content, the software can automatically convert said designated area into one or more objects, software definitions, image primitives and/or any equivalent (“objects”). Said one or more objects, which comprise an environment media, recreate the image data (and, if applicable, the functional data associated with said image data) in said designated area of existing content. Content does not need to be copied by a user. The software analyzes content and recreates it as dynamic objects (“EM objects”) that comprise an environment media which is itself an object. Environment media objects are dynamically changeable over time. EM objects can be modified with regards to any of their characteristics, including, but not limited to: color, shape, rate of change, location, transparency, focus, orientation, density, touch transparency, function, operation, action, relationship, assignment, and much more. As part of the method of modifying existing content, the software employs one or more EM objects to match the characteristics of content and data. EM objects can change their characteristics over time. Change to EM objects can be derived from virtually any source, including: communication from other EM objects, analysis of content, any input, relationship, context, software program, programming action object, and more. Change to EM objects is recorded as software, which is referred to herein a “motion media.” A motion media, which includes states, objects and change to said states and objects and relationships between said objects and other objects and change to said relationships recorded by said motion media, can be used to program objects in an environment media. Motion media is software delivering change to software objects. Motion media is not a video being played back. Further, a programming action object can be derived from a motion media. Said programming action object can be used to program EM objects and/or environment media.

Regarding EM visualizations, the software of this invention can record image data pertaining to at least one state and/or change to said state of any program as one or more EM visualizations. In this disclosure an “EM visualization” is defined as any image data (and any functional data associated with said any image data), either visible or invisible, that is presented by, or otherwise associated with, any app, program, operation, software, action, context, function, environment media or the equivalent. The software of this invention can perform an analysis of recorded EM visualizations and any change to said recorded EM visualizations. The software compares the results of said analysis to EM visualizations saved in a data base of known visualizations, to obtain a match or near match of recorded EM visualization image data, and change to said image data, to one or more existing visualizations in said data base (“comparative analysis”). Each visualization in said data base includes the action, function, operation, process, procedure, presentation (“visualization action”) that is carried out as a result of said visualization. Thus by comparing recorded EM visualizations to known visualizations in a data base, the software of this invention can determine the “visualization action” for said EM visualizations, recorded in any environment not produced by the software of this invention.

In one method, as a result of the comparative analysis of visualizations, the software creates a set of data and/or a model of change as a motion media. In another method, as a result of the comparative analysis of visualizations, the software creates a set of data and/or a model of change as a programming action object. Said motion media (and/or programming action object) can be used to program one or more EM objects such that said EM objects can recreate the image data and “visualization actions” of recorded visualizations as one or more environment media. Consider a first state of a program. According to one method the software records said first state of said program as a visualization. The software analyzes said visualization. This analysis does not require the software of this invention to be able interpret or parse the software that was used to write said program, or understand the operating system supporting said program, or understand the operation of the device that is presenting said program. The understanding of a recorded visualization of a program, or any equivalent, is accomplished via the comparative analysis of said visualization and change to said visualization. [Note: change to visualizations can also be recorded as visualizations.] Said analysis of one or more visualizations can be accomplished by any method known in the art or by any method discussed herein.

A key capability of an EM object is the ability to freely communicate with other EM objects, with environment media objects, with server-side computing systems, with inputs, and with the software of this invention. Also, environment media and the objects that comprise environment media (“EM elements”) have the ability to analyze data Data can be presented to EM elements via many means, e.g., presenting a physical analog object to a camera input to a computing device, like a smart phone, pad or laptop; drawing a line to connect any data to any EM element; via verbal means, context means, relationship means and more.

As an example, imagine that you have a page from a digital book presented as an environment media. Said page is not content as book pages have existed previously. As an environment media said page is comprised of multiple objects that recreate the image data of said page and the functionality, if any, presented via said page. Pixel-size EM objects could recreate every pixel on the display presenting said book page. As an alternate, larger EM objects could represent sections of said page. Either way, EM objects can be programmed to change their characteristics in real time to become any content, like successive pages in said digital book or deliver any function. To continue our example, some EM objects could change to become different text characters on a successive page in said digital book, while other EM objects could change to become an image wrapped in said different text characters. A single group of objects that comprise an environment media could reproduce an entire book, video, slide show, website, audio mix session, or any other content. One might think of EM objects as chameleons that can change their characteristics at any time to become virtually anything. Said EM objects can communicate with each other, communicate with external processors, e.g., server-side computer systems, and receive and respond to input, e.g., user input or any other input source. In this example of the digital book, a single group of EM objects could be programmed to change their characteristics to present every page in said digital book. It wouldn't matter what is on the pages: text, video, pictures, drawings, diagrams, environments, devices, and more.

A key characteristic of an environment media is that all change that occurs to said environment media or to any object comprising said environment media can be saved by the software of this invention as one or more motion media. Among other things, motion media saves and records change to states and objects and the relationships between said objects and other objects and change to said relationships recorded by said motion media for the purpose of performing a task. Motion media can also be used to record any state of any program, content, computing environment, analog environment or the equivalent, and convert said state to an environment media. A “first state” could be what you see when you recall any media or launch any program. Changes to said first state occur as said program is operated to perform one or more tasks. The state of said program after the completion of a task is called the “second state.” Let's use a word processor program as an example. When a word program is opened that does not contain a document, a significant amount of structure appears. There are visible icons, and tabs that select additional rows of icons, tool tips, menus, rulers, scroll bars and more. These are all structure. Further, if a user opened an existing document in a word program, there is more structure. This structure could include any one or more of the following.
(a) Text structure—font type, size, color, style, headings, and outlining.
(b) Paragraph structure—leading, kerning, line spacing, indentation, line numbers, paragraph numbers, breaks, hyphenation rules, columns, orientation, text wrap and much more.
(c) Page structure—top and bottom page margins, left and right page margins, pagination, footnotes, page borders, page color, watermark, headers, footers,
(d) Insert structure—text boxes, word art, date and time, shapes, drawn imagery, pictures, audio, video, clip art, charts, tables and the like.
   Other aspects and advantages of the present invention will become apparent from the following detailed description, taken in conjunction with the accompanying drawings, illustrated by way of example of the principles of the invention.

In an exemplary embodiment of the invention, the software converts each pixel in a designated area of an existing content into separate pixel-size objects. Said pixel-size objects comprise an environment media. In one embodiment, each pixel-size object in an environment media is synced to each pixel of the content from which said each pixel-size object was created. Said existing content and the environment media in sync with said content can exist in separate locations and remain in sync with one another. In another embodiment of the invention, an environment media and the objects it contains can be operated independent of any existing content as a standalone environment. As a standalone environment, environment media can act as a new type of content. An environment media can be used to modify any existing content produced by any program, on any device, and supported by any operating system. An environment media can exist locally, (e.g., on a device) or remotely on a server, and can be displayed and manipulated within web browser applications, or any similarly HTML-capable applications. There are many uses of an environment media. A few of these are listed below.

Modifying Existing Content without Editing Said Content

An environment media can act like a pane of glass where a user can operate objects in sync to content on a layer below them. Thus by modifying objects in an environment media, an existing piece of content, to which said environment media is synced, can be modified without copying or editing the original content. This process can remove the need for video editing, picture editing and text editing programs. All editing can be accomplished via one or more objects in an environment object synced to content.

Transforming any Static Media into a Dynamic User-Defined Environment

As a result of these and other processes, any video frame can be transformed from a static image to a dynamic user-defined environment. Objects in an environment media that are synced to content can be addressed by any suitable means (e.g., touching, verbal utterances, context and the like) to activate assignments made to said objects in said environment media. Note: from a user's perspective, they are looking through an environment media to content on a layer below. It appears as though modifications and assignments and other operations (“object edits”) are being applied to existing content, but in reality these object edits are being applied to objects in an environment media synced to original content. This removes the need to copy, edit or manage the original content being modified.

Using any Video as a Collaborative Space

Environment media can include objects in multiple locations across multiple networks. An environment media is comprised of objects that have one or more relationships to each other. Each object in an environment media possesses the ability to communicate to and from any object that has a relationship to it, regardless of where that object is located within an environment media. A user can input messages to any object in an environment media and said any object can communicate said messages to another object across any network inside any environment media. Objects that are sync with any video frame, or any designated area of any video frame, or any pixel on any video frame can be utilized to send and receive personal messages between people in a collaborative session.

Converting any Video into a Personal Workspace

The software can recreate designated areas of image data on one or more video frames as objects in an environment media. As a part of this process, said objects are synced to the designated areas of said one or more video frames. By modifying any of said objects in said environment media, the image data in sync to said objects is modified.
Users can modify any designated area of any video frame as just described above to perform functions and operations and actions that suit a user's personal needs.
Users can assign any data, including documents, videos, pictures, websites, other environment media or any other content, to any objects in an environment media to create a unique workspace that looks and operates according to a user's desires.
Users can add any content to an environment media that is synced to any one or more video frames of any video. Added content can include: pictures, drawings, lines, graphic objects, videos, websites, VDACCs, BSPs, or any other content that can be presented by any digital system or its equivalent. Without altering the original content, a video can be turned into a piece of social media or a personal diary or a personal storage device or an interactive document or be modified to serve any other personal purpose.

With an environment media synced to an existing video, the processes described above result in the appearance of a video being edited and/or modified. But in reality the modifications are taking place in an environment media in sync to said video. Each object comprising said environment media is synced in time and location to content from which said each object was created.

Location Sync

Let's say a video frame contains an image of a plane, and said plane is traced around by a user to create a designated area that matches the shape of the plane. Among many possible alternates, software could recognize an image of a plane and a user could verbally input a command to select said plane. Let's say the plane is comprised of 4000 image pixels on said video frame. The software of this invention can create a “pixel-based composite object,” comprised of 4000 separate pixel-size objects that comprise an environment media. Each separate pixel-size object matches the size, color, and other characteristics, including the location, of the pixel in said plane image from which said each separate pixel-size object was created.

Time Sync

If said plane image appears on multiple frames in said video, said 4000 separate pixel-size objects in said environment media are changed by the software to match each change to each pixel in said plane image on said multiple frames of said video.

Assignments to Environment Media Objects

All objects in an environment media can receive inputs and data from any object in said environment media. Any information assigned to any object in an environment media can be shown by touching or otherwise activating said any object to which an assignment has been made. In the case of an environment object synced to an existing content, said activating appears to be caused by touching the content itself. But in reality user input is presented to the environment media synced to said content, not to the device, program and/or operating system enabling the presentation of said content. Further, said any object in an environment media that contains assigned information can directly receive an input. Said input can be used to modify, update, copy, or delete the assignment said any object in an environment media. Inputs can be internal to an environment media or external. An internal input would include communication from other objects in an environment media, a communication from a server-side computing system which speaks the same language as said environment media, or a communication from an environment media to any object it contains. An external input would include, a communication from a server-side computing system which does not speak the same language as an environment media, a software message speaking a different language from an environment media, a user input, a context that automatically causes a communication to said any object from any source, a message from an operating system, computing system, software program or the like.

Communication Via the Same Language

Objects in environment media can freely talk to each other and freely talk to one or more server-side computing systems that perform analysis and other computations, as requested by any object in any environment media or as requested by any environment media (“EM”). The end points of all communication between all environment media elements talk the same language. Environment media elements (“EM elements”) include: objects that comprise an environment media, the environment media object, the server-side computing system performing computations for said objects, and the software. With all of these EM elements speaking the same language, the integration of said EM elements is much simpler, because all EM elements are working in a homogeneous environment. With all EM elements speaking the same language, there is no need to have any translation between said EM elements at the level that they are communicating. Thus is it much easier for said EM elements to communicate and there is much less overhead.

EM Elements Redefine Content

The intercommunication between EM elements redefines the concept of static content. Through methods described herein, the software of this invention converts static content into environment media, which is comprised of objects which freely communicate with each other for many purposes, including: modifying existing content, creating new content, analyzing data, and collaborating. In a certain sense, the software of this invention enables objects to “think” on their own. Objects in an environment media can communicate with each other in response to context, patterns of use and the like. Further, said objects can perform their own analysis of content, user input, other objects' characteristics and data sent to them from a server-side computing system from which said objects can request analysis and other information.

The methods described herein also redefine what is currently called dynamic content, including, video and websites. Content which is presently considered dynamic can be converted into self-aware EM elements by the software. Environment media and the objects that comprise environment media can not only receive and respond to user input (including non-software programmer user inputs), but said objects can use these inputs to perform tasks of great complexity that go far beyond the inputs received from a user. EM elements can be used to enhance and amplify an individual's thought process. Video, websites, interactive books and documents can be transformed into living dynamic “self-aware” environment media, capable of receiving a very simple instruction and responding with complex and dynamically updatable operations. Said environment media can update itself based upon learned information. Said learned information is the result of the communication between individual objects that comprise an environment media, from said objects' communication with a server-side computing system performing analysis and other computations for said objects, and from external inputs and said individual objects' responses to said external inputs.

In an exemplary embodiment of the software, original content is recreated as a series of pixel-size digital objects or elements of other visual technology, like rings or the equivalent for a hologram. It doesn't matter what the content is: pictures, drawings, documents, websites, videos or any other type of content, including content from the physical analog world. The software of this invention enables objects that comprise environment media to exhibit their own human-like behaviors and work with any input, including user input, to create a new content—intelligent environments where interactivity is not limited to responses to input, but includes free interactivity between the objects that comprise said environment. With this new media, users and the objects they create can communicate with other users and with the objects they create. This defines a new world of content, where communication is multi-dimensional and can be used to enhance personal media, social interactions, and manage unspeakably complex data that a consumer could not easily organize or manage.

During the course of the modification of existing content via an environment media, intelligence will increasingly be built into the modified media to enable multiple levels of communication: (1) users can talk to environment media, which are objects, (2) users can talk directly to objects in environment media, (3) environment media can talk to other environment media and to objects that comprise environment media, (4) objects comprising environment media can talk to each other, (5) all objects, including environment media and objects comprising environment media, are capable of analyzing data and making decisions independent of user input and other input, (6) all objects comprising environment media are capable of receiving and responding to inputs from any input external source; said all objects are capable of sharing said inputs with any object with which they can communicate, (7) environment media and objects comprising environment media are capable of maintaining primary and secondary relationships with other objects, users, and server-side computing systems, cloud services, and the like, (8) objects and systems that share one or more relationships define environment media.

The above described “intelligence” provides a powerful approach to manipulating content. For example, let's say a user holds up a physical analog teddy bear to a front facing camera that is connected to computing device, which enables a picture to be taken of said teddy bear. Said image of said teddy bear is saved as a .png picture and named “Teddy Bear 1.” “Teddy Bear 1” is now a piece of static content. The software of this invention analyzes the “Teddy Bear 1” content and creates an environment media comprised of multiple pixel-size objects that are synced to said “Teddy Bear 1” content. Each pixel-size object is a recreation of one pixel in said “Teddy Bear 1” content. As an example, if said picture, “Teddy Bear 1,” contained 10,000 pixels, the software would create 10,000 pixel-size objects—one pixel-size object for each pixel in said picture “Teddy Bear 1.” These 10,000 pixel-size objects would comprise an environment media. We'll call this environment media: “EM Teddy Bear 1A.” At this point all 10,000 pixel-size objects are in sync with said “Teddy Bear 1” content. So if a user views said “Teddy Bear 1” content through environment media “EM Teddy Bear 1A,” nothing is changed. The user sees an un-altered picture, “Teddy Bear 1.”

Now a picture of a kangaroo (“Kangaroo 1”) is presented to one of the 10,000 pixel-size objects in said “EM Teddy Bear 1A” environment media. We'll call this pixel-size object: “1 of 10,000.” The presenting of picture “Kangaroo 1” to pixel-size object 1 of 10,000 could be accomplished by many means. For instance, said “Kangaroo 1” could be dragged to impinge object “1 of 10,000.” (The specific method for accomplishing this is discussed later.) A line could be drawn from “Kangaroo 1” to impinge object “1 of 10,000.” A verbal command could be inputted to said object “1 of 10,000” in environment media, “EM Teddy Bear 1A.”

Let's say that “Kangaroo 1” is presented to pixel-size object “1 of 10,000” by dragging “Kangaroo 1” to impinge object “1 of 10,000.” As a result of this impingement “Object 1 of 10,000” sends a request to a server-side computer to analyze the pixels in received “Kangaroo 1” image. Said server-size computer performs the analysis and returns the results to object 1 of 10,000 in “EM Teddy Bear 1A”. Object 1 of 10,000 communicates the results received from said server-side computer to the other 9,999 pixel-size objects that comprise environment media, “EM Teddy Bear 1A”. For instance, the characteristics (color, opacity, position, focus, etc.) of pixel 2 of 10,000 in said Kangaroo 1” image are communicated to object 2 of 10,000 in environment media “EM Teddy Bear 1A”. The characteristics of pixel 3 of 10,000 in said “Kangaroo 1” image are communicated to object 3 of 10,000 in said environment media “EM Teddy Bear 1A”, and so on. As the result of the communication of the characteristics of said 10,000 pixels of “Kangaroo 1” to said 10,000 objects in “EM Teddy Bear 1A”, the 10,000 objects in “EM Teddy Bear 1A” change their characteristics to become the image “Kangaroo 1.” At this point, if a user views the original content, “Kangaroo 1” through environment media “EM Teddy Bear 1A,” they will see the image “Kangaroo 1” superimposed over the image “Teddy Bear 1.” If this is the effect desired then the process is complete. However, if environment media “EM Teddy Bear 1A” is un-synced from the original content “Teddy Bear 1,” environment media “EM Teddy Bear 1A” could be renamed and used as a standalone piece of content. Let's say we name this new content: “Kangaroo EM1.” To summarize the operations to this point, a static image of a Teddy Bear has been converted to an environment media, which we named: “EM Teddy Bear 1A.” Environment media “EM Teddy Bear 1A” was reprogrammed to become “Kangaroo 1” by communicating to one of the pixel-size objects in “EM Teddy Bear 1A.” Said “EM Teddy Bear 1A” environment media was saved under a new name as a piece of standalone content: “Kangaroo EM1.”

In the example above, the two environment media, “EM Teddy Bear 1A” and “Kangaroo EM1,” were each saved as separate content. One of these environment media matches the appearance of picture “Teddy Bear 1,” and the other environment media matches the appearance of picture “Kangaroo 1.” This is a typical way of saving content in existing computing systems. But it's not needed with environment media. The software is capable of memorizing all change that occurs in an environment media. Thus it would not be necessary to save “EM Teddy Bear 1A” and “Kangaroo EM1” as separate pieces of content. In reality, they are the same piece of content which has been dynamically modified at a point in time. The software provides a mechanism for dynamically modifying environment media. This mechanism can talk to any one or more objects contained in any environment media. This mechanism is called a “motion media.”

Let's look back at the example above. A picture of a teddy bear was recreated as 10,000 pixel-size objects by the software of this invention. Before these pixel-size objects were created, the software first created an environment media object. When said environment media object was first created it contained no objects other than itself. Then the software analyzed picture “Teddy Bear 1,” and recreated each image pixel in said image “Teddy Bear 1” as 10,000 dynamic pixel-size objects. The process of analyzing said image “Teddy Bear 1” and creating 10,000 pixel-size objects to match each pixel of said “Teddy Bear 1” image is recorded as a motion media. A motion media records change to states of an environment and to characteristics and to relationships of objects contained by an environment. The individual changes are then deleted and replaced by a motion media. A motion can “replay” any of the changes contained within it at any time. A motion media is the software of this invention playing back its own operations, either in real time or non-real time.

Thus instead of saving the environment media in the above example as two separate pieces of content, the software could create two motion media that preserve the changes to an initially created environment media. Said first created environment media became “EM Teddy Bear 1.” The processed to create “EM Teddy Bear 1” are recorded as a first motion media. The analysis of said “Kangaroo 1” picture and subsequent modification of said 10,000 pixels sized objects to become “Kangaroo 1” is recorded as a second motion media. Thus a single environment media could be saved that contains 10,000 pixel-size objects and two motion media. At any time either motion media can be recalled and used to apply its recorded series of change to the environment media that contains said motion media.

Another benefit of a motion media is to prevent saved data from getting too large. To accomplish this, the software analyzes saved change for any environment media until there is enough saved change to define a task. The software is aware of thousands or millions or billions of tasks via its own data base, via accessing other data bases or via the acquisition of information via any network, including any website or the equivalent. Once the software can derive a task from a group of change, it converts said group of change to a motion media and deletes said group of change. A motion media usually represents less data than said group of change from which said motion media was created, so converting saved change as motion media generally compresses said change data Motion media also acts as an organization tool—separating groups of change into definable tasks. As a further step in organizing recorded change, any motion media can be converted to a Programming Action Object (PAO). A PAO can contain one or more models of change and the task associated with said change. A PAO enables a model of change to be applied to anything that is valid to receiving the model of a PAO to program it. A PAO can be used to program an object or an environment.

Focusing now on video content, an environment media can contain multiple layers that can be operated in sync with one or more video frames of any video or any content. Environment media can exist as separate environments from the content they are being used to modify. Environment media are not limited by the content they are modifying. For instance, environment media can be any size from a sub-pixel to the size of a city or larger. Environment media can exist in the digital domain, the physical analog world or both. Environment media can contain any number of objects ranging in size from a sub-pixel to the size of the environment. Said objects are capable of co-communicating with other objects, with external data, computing systems and input, e.g., user input. Environment media can be programmed by user input, a motion media, communications from objects contained in an environment media, communications from another environment media, a PAO, a computing system, or any equivalent. This includes both physical analog and digital environments.

Further regarding Environment Media:

The software of this invention can be utilized in any computer system, network, device, construct, operating environment or its equivalent. This includes, but is not limited to, computer environments that recognize objects and their properties, behaviors and relationships and enable any one or more of these object's definitions to be defined, re-defined, modified, actuated, shared, appended, combined, or in any way affected by other objects, by time, location, input, including user-input, by context, software or any other occurrence, operation, action, function or the equivalent.

In one embodiment, the method in accordance with the invention is executed by software installed and running in a computing environment on a device. In another embodiment, the method in accordance with the invention is executed by software installed and running in a browser or its equivalent. The method is sometimes referred to herein as the “software” or “this software” or “EM software.” The method is sometimes described herein with respect to a computer environment referred to as the Blackspace” environment. However, the invention is not limited to the Blackspace environment and may be implemented in a different computer environment. The Blackspace environment presents one universal drawing surface that is shared by all graphic objects within the environment. The Blackspace environment is analogous to a giant drawing “canvas” on which all graphic objects generated in the environment exist and can be applied and interacted with. Each of these objects can have a relationship to any of all the other objects. There are no barriers between any of the objects that are created for or that exist on this canvas. Users can create objects with various functionalities without delineating sections of screen space. In the Blackspace environment, one or more objects can be assigned to another object using a logic, referred to herein as “assignment.” Other relationships between objects in an environment media exist and are discussed herein.

The software of this invention enables a user to modify any content without having to copy, edit or manage the content being modified. The modification of any content is accomplished via an environment media, such that either said environment media and/or any object that comprises said environment media is synced to said content. Regarding video, with the utilization of an environment media a user could modify any video in any environment on any device. An environment media frees the user to sync data to any part of any video frame or other content, such as a section of a picture or document or any other content, including apps and programs. The method described herein also frees the user to make any modification to any content without copying or editing the original content. Any content can be altered or edited by the modification of objects derived from said content and that exist on one or more layers of an environment media.

Further regarding video, with the utilization of an environment synchronized to video playback, running in an application, any video frame, playing back at any frame rate, using any codec, being presented in any environment on any device that can access the web, can be modified by a user without changing the original content. The alterations to content are accomplished via objects in an environment media, which can be presented as a fully interactive, software environment, or as one or more motion media, or as one or more programming action objects. Objects in an environment media have the ability to analyze original content and co-communicate with other objects in an environment media, with a user, and with software, including but not limited to, the software presenting an environment media.

Regarding the modifying of content, environment media can present what it referred to herein as “motion media.” A motion media is software that presents change in any state, object and/or environment. A motion media is itself a software object. To a viewer, motion media resembles rendered video, but a motion media is not rendered video and relies on no codecs. A motion media is software presenting change to objects. Said change includes any change to any state, relationship, assignment and anything associated with said objects. Although the presenting of a motion media as software does not require rendering video, motion media can be converted to any video format. However, motion media is more powerful as software. A motion media, existing as software, does not require a sizable bandwidth to present high definition environments. A motion media is simply as high definition as the device or medium that presents it. A motion media is fully interactive and affords the viewer immediate access to operate any object in a motion media.

Now regarding an environment media (which could contain any number of motion media), the environment media has a relationship to the original content which is modified by the environment media. This relationship can be multi-faceted. For instance, one relationship can be the syncing of an environment media to the play back of a video. One way to accomplish this is to present an environment media in a browser in a visual layer on top of a layer in which video content is presented. An environment media can act as a web page, where its web object layer is synced to a video, any video frame, and/or any designated area of any video frame (“video content”) presented on a device. In one embodiment of the invention said environment media is transparent and contains one or more objects on its web object layer. Further, said one or more objects can be modified by inputs, e.g., user inputs, which result in the visual and/or audible alteration of said video content without altering said video content, and without employing any video editing program. Via one or more environment media and objects that comprise said environment media a user can modify any video content presented via any operating system, running on any device, being displayed by any video player, using any codec.

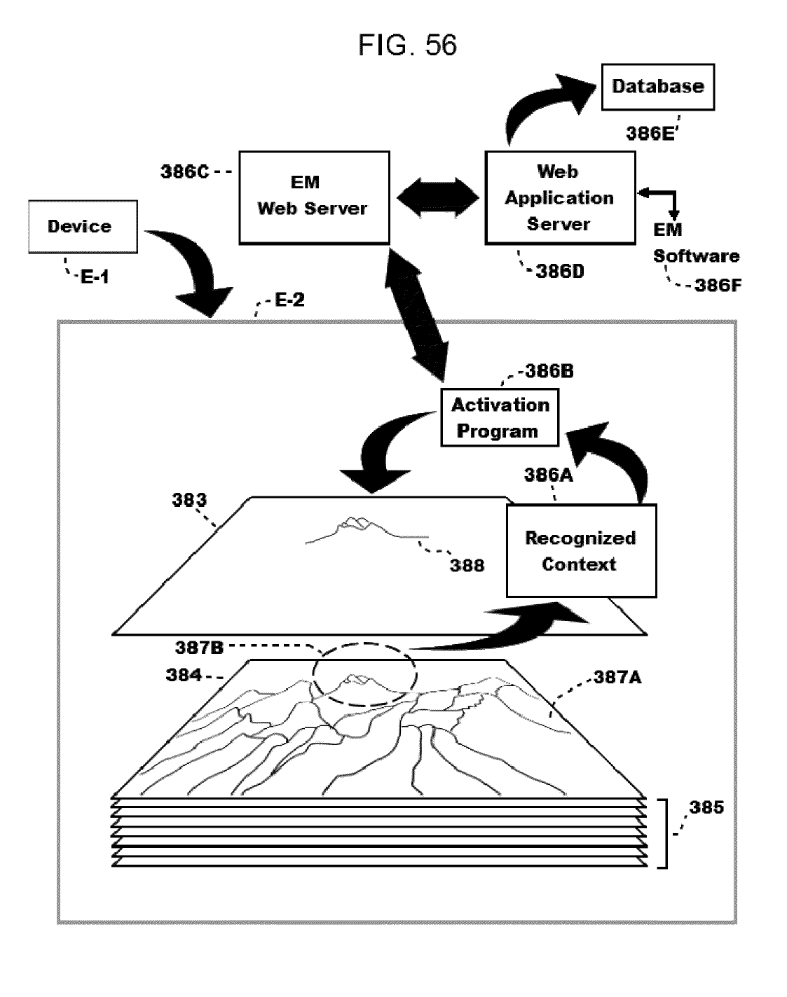

FIG. 55 illustrates the use of an environment media 383, to modify video frame, 384. A user has recalled a video 385, by any means common in the art, and then stopped the video on frame 384. Then the user has engaged an environment media 383, which the software syncs to frame 384, of video 385. One way to engage environment media 383, would be to select video frame 384, (e.g., by a finger touch) and utter a verbal command, e.g., “Create Environment Media.” Upon this command, the software would create environment media 383, and sync environment media 383, to frame 384, in video 385. In FIG. 56, environment media 383, matches the size and proportion of video frame 384. To enable environment media interactive functionality on a device, a small app can be saved to said device. Said app is activated by an input (e.g., a verbal command), gesture, context or any other causal event.

FIG. 56 illustrates the utilization of a gesture to produce a transparent environment media. An EM activation program 386B, is installed on a device E-1, which supports an environment E-2. A user traces around part 387B, of the image 387A, on video frame 384, in environment E-2. Once the tracing action travels a certain distance (e.g., 10 pixels), the activation program 386B, recognizes said user trace as a context 386A. As a result of the recognition of context 386A, activation program 386B, sends instructions to EM Web Server 386C. EM Web Server 386C receives said instructions from activation program 386B, and sends them to the Web Application Server 386D. One of said instructions is to verify that video 385, is archived in a safe location. If video 385, is not archived in a location listed as a reliable source in Web Application Server 386D, the Web Application Server 386D, requests a copy of video 385 from its source and sends said copy of video 385 to a Database Server 386E, which updates the data base addressed by said Data Base Server 386E with video 385. An example of such a database would be the “Wayback Machine” at the Internet Archive. Another instruction received by said Web Application Server 386C, is to activate EM Software in environment E-2. Thus Web Application Server 386D, responds to Web Server 386C, with an activation of EM Software 386F, which is activated as a transparent overlay window 383 in environment E-2 in device E-1

To the user creating said trace, they are drawing on video frame 384. But in reality they are drawing on a transparent environment media 383, which results in the automatic creation of object 388 by the EM software. The software automatically syncs environment media 383, to frame 384, of video 385. The method of sync could take many forms. One method could include: (1) determining a frame number, counting from a first frame of video 385, (2) matching the order of frame 384 in video 385, and (3) matching the location of frame 384 in the computing environment E-2. Let's say for example that frame 384, is frame number 244 in video 385. When environment media 383 is created by the software, the software syncs environment media 383, to frame number 244, 384, in video 385. As a result, when video 385 is positioned at frame 244, 384, object 388, in environment media 383 matches a section of image data 387B, on frame 384. Further, when video 385 is positioned at frame 245, environment media 383 is no longer visible.

Referring to FIG. 57, with references to FIG. 56, a close up of object 388 is shown. As previously described in FIG. 56, the tracing action, resulting in the creation of object 388, is a definable context, which is interpreted by an activation program 386B to activate EM software 386F. But in the example of FIG. 57, an environment media 389 matches the shape of object 388, not the shape of video frame 384, as shown in FIG. 56. In the example illustrated in FIG. 57, the software creates environment media 389, following the recognition of context 386A. Environment media 389 equals the shape of object 388, which matches a traced section of image 387. In reality, the user drawn lines that extend beyond a first drawn line length of 10 pixels occur on environment media 389, not on video 385. [NOTE: the first 10 pixels required for the recognition of content 386A, are recreated in environment media 389 as part of object 388.] Environment media 389 is presented in environment E-2 via a transparent overlay window 389. It should be noted that any number of environment media can exist in sync with any number of video frames or portions of video frames or other content. Further, any number of environment media can contain multiple layers that are synced to video frame 384.

An environment media can be any size, any shape, exhibit any degree of transparency from 100% opaque to 100% transparent. An environment media can be controlled dynamically by the software. As a result, an environment media can automatically be changed over time to match one or more changes in content to which an environment media and/or its objects are synced. This includes changes in content from one video frame to another. Thus an environment media is not limited to modifying static media, like a single frame of video or a picture. An environment media and/or the objects that comprise an environment media (“EM elements”) can be used to modify any number of frames in a video, pages in a digital book, facets of a 3D object, layers of data or the like. Further, EM elements can be dynamically changed to match any change to any image data of any content. By this means, EM elements can be used to modify any image data on any video frame to which EM elements are synced.

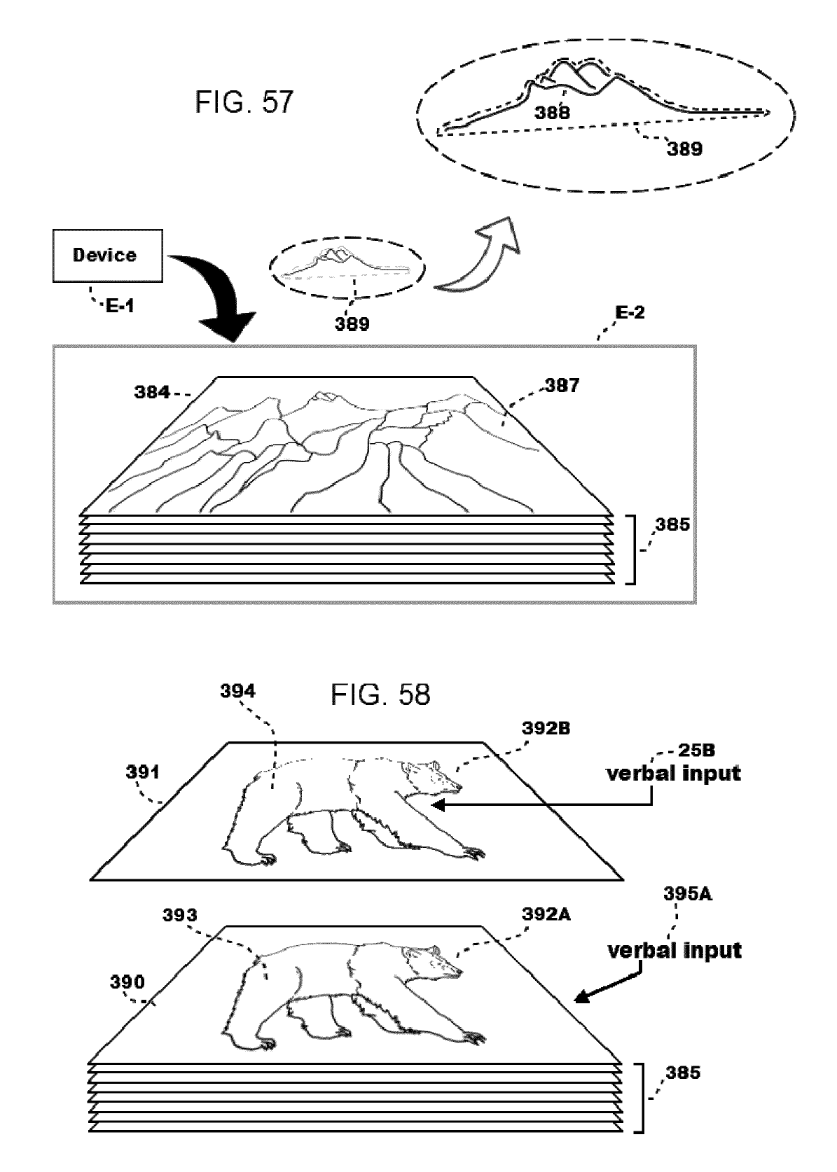

Referring now to FIG. 58, frame 390, of video 385, contains the image of a walking brown bear 392A. Video 385, has been positioned at frame 390, and a verbal input 395A, has been presented to video 385. The verbal input is: “brown bear.” Using object recognition known to the art, the software analyzes frame 390, looking for a brown bear. A brown bear image is found as part of the image data of frame 390, and as a result the software creates an environment media 391, and syncs environment media 391, to video 385, and to frame 390, of video 385. On environment media 391, the software presents a software object 392B, that represents bear 392A, on frame 390. The position of object 392B on environment 391, matches the size, location within frame 390, and other characteristics of found image 392A, like color characteristics. The creation of software object 392B is as accurate as the software is capable of producing given the resolution, lighting and other factors affecting an accurate recognition of image 392A on frame 390 of video 385. Further regarding FIG. 58, object 392B, is selected (e.g., by a touch, verbal command, lasso, gesture, thought, or the equivalent). A verbal input 392B, in uttered. Said input 395B, is: “change the bear color to black.” As a result of said input 395B, the software changes object 392B to the color black, 394. Since object 392B is in sync with frame 390 and with image 392A, changing object 392B to the color black, 394, changes the color of image 392A, to black. Note: as a practical matter, the color black, 394, applied to object 392B, would be applied in a way to tint the brown bear to become black. For instance, a RGB color, R:0, G:0, B:0 would turn the brown bear image 392A, into a silhouette of black. That might be an interesting effect, but it would not be a way to change the existing image 392A from brown to black. Thus a black color would be applied as a tint that preserves the image detail of image 392A, now represented on environment media 391, as object 392B. The software can “know” to do this by many means, including a default setting, a user input, or by an analysis of user actions that enable the software to anticipate how to apply the user input: “change the bear color to black” for image 392A. In this example, object 392B, is derived from image 392A. By altering the color of object 392B on environment media 391, the appearance of object 392A is modified on frame 390, of video 385. The viewer is looking through environment media 391 to frame 390 of video 385. [Note: environment media 391 can be in any location, including on any network, in any country, on any device, operated with any OS or any equivalent.] Any web browser based environment media can be synced to any content that exists anywhere, providing that the environment presenting said any content has access to the web or the equivalent, which would include an intranet. As an alternate, EM elements can be operated locally on a device via an installed version of the software running on said device.

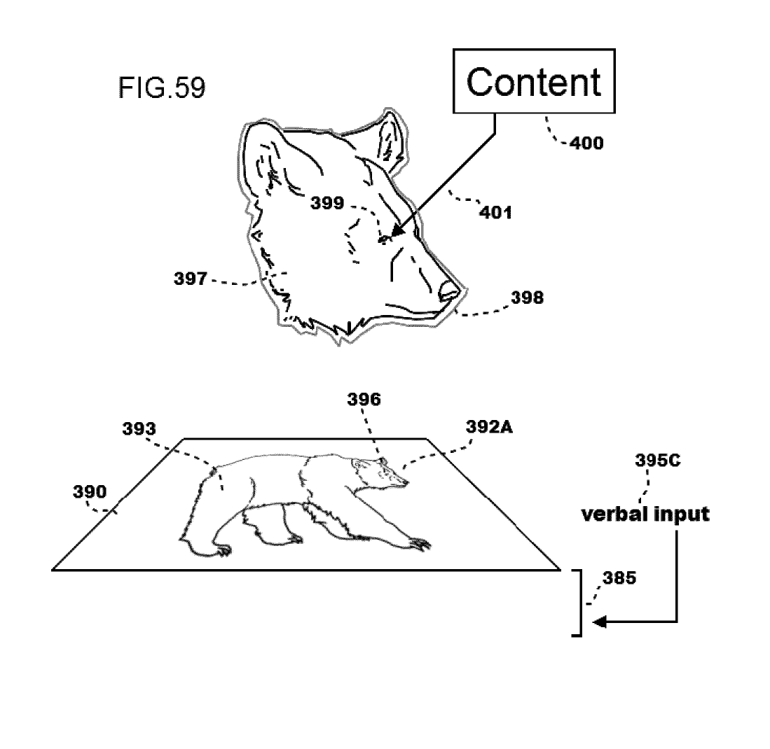

How much of any content that is presented or modified via EM elements can be controlled by many factors, including: user input, context, a software instruction, a motion media, a programming action object, time, location and more. Referring now to FIG. 59, data is being assigned to the eye 396, of the bear 392A, on frame 390, of video 385. In FIG. 59 a verbal input 395C, has been presented to video 385. Verbal input 395C has two parts: (1) the name of the video: “Bear Walking Video,” and (2), a description of the desired frame: “First image that contains a brown bear.” Verbal input 395C can be stated in virtually endless ways and still be understood by the software. For instance: “Bear Walking Video showing first frame of brown bear,” or “Bear Walking Video and first appearance of walking brown bear,” and so on. The point is that a user will likely remember some image in a video that they wish to modify or assign data to or otherwise alter. We will call this “sub-content.” But a user will likely have no idea where the sub-content they want is located in a video. And there is an even more remote possibility that a user would know what the frame number is for the sub-content they seek. So being able to ask for a description of sub-content (e.g., “The first time a brown bear appears in the video: ‘Bear Walking Video’”) in content is very useful. Referring again to FIG. 59, the software receives verbal input 395C followed by a drawn input (not shown) that traces around the head of the bear on frame 390 of video 385. The software creates environment media 398, which matches the shape of said drawn input on frame 390, of video 385. Further, the software creates a bear head object 397, from an analysis of frame 390 of video 385 and presents the bear head object 397, in environment media 398. Further regarding the example of FIG. 59, environment media 398, and the bear head object 397, could be the same size. They are shown as separate lines for clarification. In either case, the environment media 398 would generally be transparent, so a user would only see bear head object 397, synced to frame 390 of video 385. Thus any change to bear head object 397, would visually change the head of bear image 392A without editing said bear image on frame 390 of video 385.

Note: when a user is viewing bear head object 397, they see it in perfect registration with the bear head of image 392A on frame 390 of video 385. A feature of this software can automatically lock object 397 in place. This way when a user is working to modify this object, it won't move. If a user wishes to move object 397, the lock can be turned off. This can be done by a verbal command: “delete move lock,” “turn off move lock,” “cease move lock,” and the like. Or this could be accomplished by a context. An example of a context would be a user touching object 397 and starting to drag it beyond a certain distance, e.g. 20 pixels. Upon reaching a 20 pixel distance, the move lock for object 397 would be automatically turned off and the object can be freely moved. If object 397 is moved, it will no longer be in perfect registration with the bear head of image 392A on frame 390 of video 385. This might be exactly the effect a user is trying to achieve.

[Note: any number of environment media of any size and shape can be synced to any content or sub-content.] In the example of frame 390 in FIG. 59, any number of environment media could be presented in sync with frame 390. Referring once again to FIG. 59, some content has been assigned to the eye 399, of bear object 397, on environment media 398. This content could be anything: one or more websites, videos, documents, pictures, drawings, recognized objects, other environment media, data from the physical analog world, or anything else that can be presented in a digital environment. The assignment is accomplished by drawing an arrow 401, from the content 400, and pointing the arrow 401, to a target, in this case, the eye 399, of bear object 397. Upon completing the drawing of arrow 401, the software prompts the user to accept the assignment or delete it.

NOTE: in the case of sub-content, the software may increase the sub-content size so the user of the environment media has an easier time altering or operating any software object in an environment media. An increase in the sub-content size is shown in FIG. 59. Bear head object 397, and environment media 398, containing said bear head object have been enlarged for easier viewing and user modification. As another approach to a similar issue, if an object, e.g., a picture, is being dragged to impinge a pixel-size object in an environment media, said pixel-size object and its surrounding neighbors can be automatically enlarged. At the same time said object being dragged to said pixel-size object may be automatically reduced in size to make it easier to impinge a pixel-size object with the dragged object.

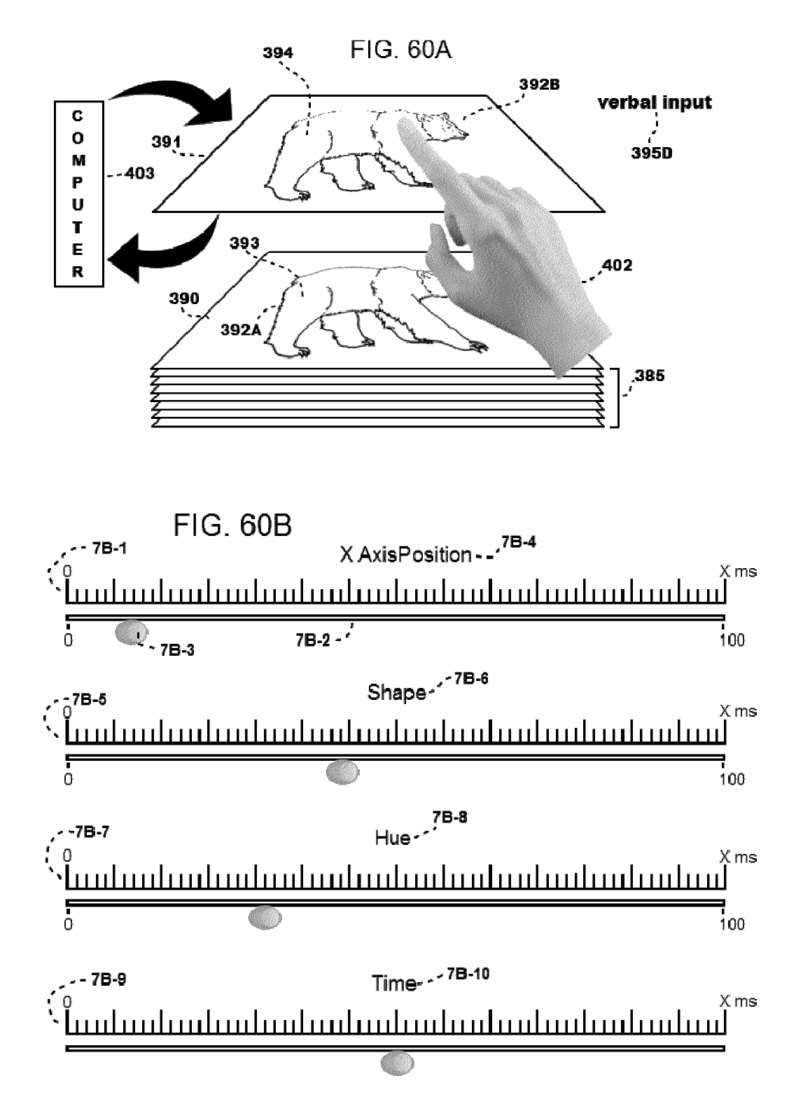

Referring now to FIG. 60A, if one is modifying an action in a video, it may not make much sense to change the color of a bear from brown to black for a single frame, as shown in FIG. 58. In FIG. 60A, color 394, is made to persist for as many frames as the bear image 392A persists in video 385. To accomplish this, object 392B, is made to match each change to the bear image 392A, for each frame that bear image 392A appears in video 385. In FIG. 60A, a hand 402, touches bear object 392B to select it. A verbal input 395D, is presented to the bear object on environment media 391. The verbal input is: “match black bear in video 385 to the end of the video.” Note: a user is likely to say “black” bear because that is what they will be seeing, since bear object 392B on environment media 391 has turned the brown bear 392A to the color black on frame 390. Refer to the discussion of FIG. 58.

Upon receiving verbal input 395D, and recognizing it as a valid command, the software analyzes the changes in the characteristics of each bear image 392A on each video frame where bear image 392A appears in video 385. As a result of this analysis, the size and shape (and other characteristics, such as color, angle, skew, perspective, transparency, etc.) of bear object 392B on environment media 391 are changed to match each change in the bear image 392A, on each frame in video 385 that bear image 392A appears. By this means, the color 393, of bear image 392A is maintained as the color 394, of bear object 392B on environment media 391.

Syncing Objects in an Environment Media to One or More Images on a Video Frame.

An environment media is synced to a video and/or to one or more video frames. The environment media looks for an input that selects a video frame or a portion of the image data on a video frame. If an input selects an entire video frame, the software analyzes the entire image area of the selected video frame. If a portion of a video frame is selected, the software analyzes just that portion (“designated area”) of the video frame. The software then creates one or more objects that are derived from the analyzed selected image(s) on a video frame. Said one or more objects are placed in the environment media in sync to said selected image(s) that said one or more objects in said environment media were derived from. The software continues to analyze changes to the selected image(s) on continuing frames in said. The software uses the results of this analysis to update said objects in said environment media to match each change in said image(s) on multiple video frames in said video.

The following is a more detailed explanation of the example presented in FIG. 60A. The software analyzes changes in the characteristics of the brown bear image 392A, in each successive video frame beyond frame 244 390. Let's say said bear image 392A appears in 1000 frames in video 385. As a result, the software performs 1000 separate analyses—one for each of the 1000 frames in which said bear image 392A appears. [Note: each said separate analysis could include an analysis of each pixel in the image data of said bear on said each successive frame in video 385. If, for example, there were 10,000 pixels in said bear image on one of said successive frames in video 385, the software could conduct 10,000 analyses on said image on one frame of video 385. Therefore analyzing 1000 frames would require 10 million pixels to be analyzed by the software.]

Using the results of the analysis, the software applies 1000 models of change to object 392B. Said 1000 models of change are synced to the changes of image 392A in each of the 1000 frames where image 392A appears in video 385. For example, let's say in frame 245 (the first of said 1000 frames) bear image 392A moves its legs as part of a walking motion. Further, the lighting on said bear image 392A is slightly changed, which changes the colors of image 392A. All of these changes and more are represented in a model of change for frame 245. Said model of change for frame 245 is applied to bear object 392B in environment media 391. This insures that the motion and visual characteristics of object 392B match the motion and visual characteristics of image 392A in frame 245.

[NOTE: as part of the software analysis of changes to bear image 392A, the software could also analyze layer information in the video frames containing said bear image 392A. For instance, the bear may walk behind a branch or behind part of a rock. In this case, the software could analyze the images layered in front of the bear and create additional objects on environment media 391. This is a powerful creative advantage to a user, because they can move these additional “layered” images to create new alterations to video 385 if desired. So by this means, the environment media becomes a vehicle for the software to reconstruct the image data on one or more video frames and present them to a user as a series of objects that are easy to manipulate in an object-based environment, synced to original content, which is not limited to a video. An environment media can be used to modify any content, including a website, document, blog, drawing, diagram, different video, another environment media or any other content capable of being presented in a digital or analog environment.]

Dynamic Sync.

Another type of sync dynamically controls the presence of an environment media and its objects in sync to a video. For example, as part of the software analysis of image 392A in FIG. 60A, when the bear image 392A is no longer visible in a video frame, the software detects this and the environment media object 392B, disappears. Thus as a result of the analysis of the image data of any video frame, the software can dynamically present one or more environment media and objects in those environment media to match any image on any video frame for a video to which said environment media is in sync with. The objects on said environment media match the changes of said image on one or more video frames. One type of change that is matched is simply the presence of an image on a video frame. When a video image, which is being matched by a software object in an environment media, no longer appears in a video frame, the software object matching that image also disappears. When a video frame image, which is matched by a software object in an environment media, reappears, the software object matching said video frame image in an environment media reappears.

Environment Media

An environment media is an object that contains at least one object, which can be itself. Said at least one object can be used to add data to any content or sub-content, assign any data to any content or sub-content, or modify any content or sub-content. For purposes of this discussion we will be focus on video, but an environment media can be synced to any content, including pictures, websites, drawings, individual pixels or sub-pixels, graphic objects, documents, text characters, and more.

Motion Media.

Referring again to FIG. 60A, in an exemplary embodiment of this invention, the software analyzes each change to each pixel of image 392A in each frame that image 392A appears. The software finds every change that it can for image 392A. This change is then analyzed according to many criteria, such as color variation, shading, transparency, shape, position, angle, clarity, definition, and time to name a few. Regarding time, the software can measure time by any unit (e.g., seconds, ms, frames, sub-frames). But whatever the unit of time, the software is concerned about the occurrence in time of each change in each category of change. Let's take bear image 392A as an example. Image 392A is comprised of “X” number of pixels. Some of these pixels may not change for many frames, while other pixels in image 392A may change every frame. As a result of the analysis of changes that occur to image 392A, e.g., as the bear image moves through various frames in video 385, the software can categorize each type of found change according to time. Using this approach, each change within each category of change is catalogued on a time continuum, like a timeline or the equivalent. The timeline for color variations may be quite different from the timeline for changes in position and this timeline may be quite different from the timeline depicting changes in definition and so on. A key goal of the software in the example of FIG. 60A is to take each found change, in each category of change for image 392A, and match it with changes to object 392B that occur at the same rate over the same period of time. This process maintains sync between object 392B and image 392A. But this process can be computationally intensive. To ameliorate this problem, object 392B, environment media 391, and the software can freely communicate with one or more server-side computer systems 403, that speak the same language as said EM elements. For instance, said EM elements can request that server-side computer 403, performs the analysis required to accurately change object 392B to match each change in image 392A in video 385.

After completing the requested analysis, computer system 33, delivers its analysis to environment media 391, object 392B and/or the software. As just described, said analysis can be delivered as categories of change over time. Said categories of change are applied to object 392B in environment media 391 by the software. The recording and replay of the occurrence of change to any object presented as software is called a “Motion Media.” Motion Media can look and feel like video, but a motion media is live software producing change in objects, including environment objects, over time. The advantage of motion media is that it can be viewed like a video, but when stopped at any point in time, any object being presented by a motion media can be interacted with, as a live software object. Referring again to FIG. 60A, the changes to object 392B, which were derived by software from an analysis of changes to image 392A in video 385, can be a motion media. Video 385 is a view only media. But the presentation of change to object 392B in environment media 391 is a dynamic, user-definable, fully interactive software environment. At any time an input can be used to alter any change that the software is making to object 392B. By this means, a user can change any characteristic of image 392B and thereby alter image 392A on any frame in video 385.

To explore this idea further, the motion of objects in an environment media is the result of software producing change associated with or applied to software objects. A motion media is as high definition as the device used to display the objects presented by said motion media. Further a motion media is lossless and low bandwidth because it is software producing change in an environment, rather than a rendered video being played on a video player. A motion media can be easily shared, because it can be represented as a set of messages, rather than as a large complex file. Said set of messages can be shared via a network utilizing about a 2 Kb/sec in bandwidth. It should be noted that a motion media can deliver access to the original content that was used to model change via analysis of said original content. As a part of this process, a motion media can present all operations that were used to create objects in an environment media in sync to existing content. The recipient of a motion media can apply the recorded change of said motion media to their own environment media.

An environment media supports any number of layers that can be operated in sync to any video content regardless of the video's codec, format, size, location, playback device, operating system or any associated structure or attribute. EM elements deliver the ability for a user to modify any video on-the-fly and share video content modifications via any network by sharing a motion media that has recorded said modifications as occurrences of change over time. Using this approach, each change within each category of change is catalogued on a time continuum, like a timeline or the equivalent. The timeline for color variations may be quite different from the timeline for changes in position and this timeline may be quite different from the timeline depicting changes in definition and so on. A key goal of the software in the example of FIG. 60A is to take each found change, in each category of change for image 392A, and match it with changes to object 392B that occur at the same rate over the same period of time.

Referring to FIG. 60B, four categories of change are depicted as timelines. A first timeline 7B-1, contains a fader 7B-2, whose fader cap 7B-3, can be moved horizontally to either increase of decrease the value for the category of change, X Axis Position 7B-4, controlled by said fader 7B-2 and its cap 7B-3. A second timeline 7B-5 controls the change category Shape 7B-6. A third timeline 7B-7, controls a third change category 7B-8. And a fourth timeline 7B-9 controls a fourth change category Time 7B-10. Many other categories of change can be presented by the software as timelines of change. Each timeline and its associated fader comprise a timeline unit. There are two scales associated with each timeline unit: (1) A time scale—delineated along each timeline in milliseconds or some other unit of time set by a default, user input or other suitable method, e.g., a configuration, context, relationship, assignment, or PAO, and (2) an arbitrary scale from 0 to 100 representing the value of the category of change displayed along a timeline.

The method of operation for timeline units is as follows. As a video content is played, scrubbed, or otherwise caused to be displayed over time, the fader belonging to a given category of change timeline tracks the average changes of the EM elements synced to video content for said category of change. For example, as the position of a video image moves along the X axis from one video frame to another in said video, the fader cap 7B-3, moves to a new position along timeline 7B-2 to match each change in position of said image. [Note: an X Axis Position timeline would likely be accompanied by a Y Axis Position timeline for 2D and a Z Axis Position timeline for 3D.] If a user repositions fader cap 7B-3 to the right, the increase in value measured from the starting position of said fader cap to the new position of said fader, is added to each new position of fader 7B-3 as it tracks each movement of said image in said video from one frame to another. As an alternate method of operation, any timeline fader can be moved in real time while said video is playing to alter the position of the EM elements synced to said image data of said video.

Timeline units may best be utilized for EM elements that are not synced to video content, but are standalone content. In this case, changes to any timeline fader will alter the EM elements that were derived from video content, but are not longer being presented in sync with it. Thus no original video content would be presented. The EM elements and all timeline units tracking changes in said EM elements are operated as their own user modifiable content. As a further method of operation, any change applied to any timeline fader can be recorded as a motion media. Said motion media is added to the characteristics of an environment media and/or to any object that comprises said environment media. Said motion media can be used to modify EM elements by applying said motion media to them. This can be accomplished by many means, including: dragging a motion media object to impinge an EM element. Drawing a line gesture from any motion media to impinge an EM element. Verbally directing a motion media to modify an EM element and the like.

Automatic Software Management of Data

One of the benefits of the software of this invention is that the user does not need to manage any content that they utilize in the creation of user-generated content. Further, the user does not need to copy or edit any original content that they utilize in the creation of user-generated content. In addition, no editing software programs are required for modifying any content, including pictures, videos, websites, documents and more. With the software of this invention, a user does not need to organize the original content that is being modified by any environment media. The user does not need to put any of the content they are modifying into a folder or label it or place it somewhere so it can be located and used. The software takes care of this automatically. Original content is not itself modified. Instead all modifications are performed via one or more environment media. Stated another way, modifications to existing content are performed in software in one or more environment media. The software, presenting said one or more environment media, manages the content being modified by said environment media. An environment media can include any one or more tools, functions, operations, actions, structure, analytical processes, contexts, objects and layers to name a few.

Automatic Management of Original Content

Once an environment media is synced to piece of content, the software automatically archives the content or verifies an existing archive and saves the content's name and URL of the archive containing the content's URL. An example of automatic archiving would be copying the content to the Internet Archive using the Wayback Machine. (See: en.wikipedia.org/wiki/Wayback_machine). An example of another existing archive would be Youtube. Whether the content is already safe in an existing archive or is copied to an archive by the software of this invention as part of the process of creating an environment media, whenever possible, the software automatically archives the content so that it cannot be lost in the future. Where it is not possible, for instance because of copyright laws protecting a proprietary website, the content is directly synced to at its found URL location, by an environment media. In any event, there is generally no need for the software to directly copy content into an environment media, although this can be done if desired and if legally permissible. An environment media includes the location of the content to which said environment media is synced. When an environment media is recalled, by any means known in the art or described herein, the software locates the content to which said environment media is synced and causes that content to be presented on a device, cloud environment, virtual space, or any other means that said content can be presented. The environment media synced to said content can be presented in its own environment transmitted from a cloud service to a device via locally-installed software (e.g., web browser or other EM capable applications) that permits said environment media to be synced to said content and modify it.”

User Actions in an Environment Media

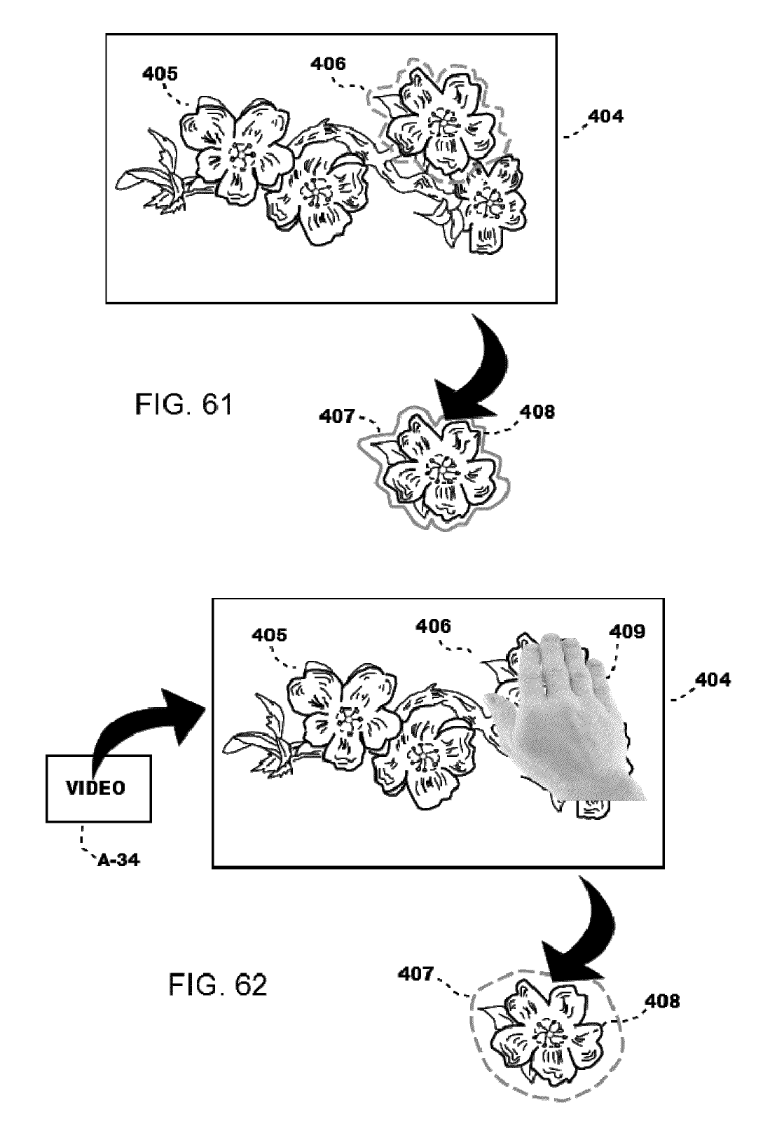

The following list of user actions can be used to alter environment media objects
Drawing
   A user could draw on a video frame, possibly tracing around something on the frame. In FIG. 61, a line 406, is drawn around a portion of a flower image 405, on a video frame 404. The drawing of line 406, designates the area of image 405, to be matched by an object in an environment media. In this example the drawing of line 406, produces an environment media 407, and a software object 408, that matches the size and shape of the encircled portion of flower image 405.
Gestures
   Drawing is a gesture, but any gesture recognized by the software can be utilized by a user to communicate to any object in any environment media for any purpose.
Touching
   A user could touch a video frame with various fingers, a pen or other suitable device. Regarding a hand touch, a group of finger touches could be converted into a definable shape that encloses a portion of a video frame image. In FIG. 62, fingers on a hand 409, touch a portion of image 405, on video frame 404, which is in video A-34. The touching of fingers 409 on video frame 404 designates a segment of image 405 to be matched by an object in an environment media. As a result of the hand touch 409, the software creates a region derived from the position of the fingers of hand 409. The software analyzes the portion of image 405, enclosed by said region and creates an environment media 407, which equals the size of said region, and a software object 408, in environment media 407. Note: environment media 407, and software object 408, would likely be the same size. They are shown in FIG. 62 as separate lines for clarification only.
Lassoing
   A user could lasso a portion of the video frame or the entire frame. In addition to lassoing, any graphical method of selection could be used.
Verbal Input
   A user could verbally select an entire frame by an utterance, like, “select frame.” Or a verbal utterance could be used to select any segment of the image on a frame, like, “select the tree with red leaves.” Such a request would require the software to analyze the frame's image, e.g., the number of pixels that comprise said frame image for a screen display device.
Thought Input
   Where possible, a user could “think” to control any object in an environment media.
Holgraphic Input
   Where possible a user could engage with holographic imagery or the equivalent to operate any object in an environment media.
Operating Physical Analog Objects and Devices
   Physical analog objects in the physical analog world can be presented to any environment media or to any object in any environment media via a visual recognition system that can input visual data into a computing system, now common in the art.

Automatic Designation of Content

It should be noted that a designation of content to be synced to an environment media can be the result of an automatic process and not only initiated by user input. A software process can automatically designate content to be modified. This automatic designation could be triggered by a context, relationship, pre-determined response or anything under software control. An example of this would be Automatic Object Detection. As part of this process the software could perform automatic object detection, as known to the art, on any original media. For instance, a user could stop on a video frame. The software, or an object recognition plug in, would then analyze the image data on said video frame and via analysis attempt to recognize various shapes and objects contained in said image data of said video frame. Upon the recognition of said various shapes and objects, the software could present the recognition to a user. For instance, said frame includes a tea pot, a saucer, a ladle, a spoon and a box of tea. Then a user could simply select the object they wish to address. The selected object would be recreated as an object in an environment media, (synced to the content from which it was derived), ready to be modified by a user.

After a designation is made regarding content or a portion of content to be modified, that content or portion of content is analyzed by the software. Referring again to FIG. 61, if a user drew around a segment of flower image 405, on frame 404, this segment 406, of flower image 405, would be analyzed by the software. The moment the user started to draw line 406, the software could create environment media 407. In other words, the drawing of line 406, produces a context that triggers the creation of environment media 407, by the software. The trigger could be based on many factors, for instance, time. The software could recognize a certain time interval as a context to trigger the creation of an environment media. Let's say the time interval that triggers the creation of environment media 407, is 0.25 seconds. Thus 0.25 seconds from the start of drawing line 406, the software creates environment media 407. Or the context could be distance. For example, once the drawing of line 406 travels 10 pixels, the software creates environment media 407. The software responds to a context very quickly, such that the input is likely finished on environment media 407, the creation of which was triggered by the drawing of line 406. Further considering a drawn input, the drawing starts in any environment, on any device, but after 0.25 seconds or after a distance travelled of 10 pixels, the drawing takes place on environment media 407, not on the content itself. The drawn input 406, designates a segment of image 405, on video frame 404. This segment of image 405, is recreated on environment media 407 as object 408. As part of the syncing of environment media 407 with video frame 404, the software is aware of the frame number to which flower image 405 belongs. Let's say its frame 150. In addition, the software is aware of the location of flower image 405 within frame 404. Said location could include the coordinates of image 405 in relation to the center position, corner positions, perimeter, etc., of frame 404. The drawn input 406 that encircles or nearly encircles a segment of flower image 405, defines a specific area (“designated area”) that comprises a selected portion of flower image 405. Through analysis, the software determines the colors and other information, like shapes, color gradients, delineations such as lines, and other distinguishing characteristics of the image data in the designated area outlined by line 406. The software then makes a determination as to what is represented in the designated area. In other words, what is it—is it a bear, a tree, a rock, a flower? If no determination can be made by analyzing the information inside the designated area, the software may analyze other portions of video frame 404 in order to better understand what is inside said designated area. If no definable determination can be made, the software presents to environment media 407, what it can determine. This would likely include any one or more of the following: color, hue, saturation, contrast, gradation, transparency, shape, size, orientation to the center and edges of the frame, and other definable attributes. Plus any assignment, relationship, or association of said image data with any other data, object, environment, process, operation, action, or the like. Thus, even if the software cannot make a determination of what a designated area is the software can accurately recreate the image in the designated area as an object in an environment media, and recreate any relationship said designated area may have to anything. Upon finishing an analysis of the image in said designated area, the software creates an object representation 408, of the designated content in an environment media 407. Object 408 is not a copy of the designated content, but a software object created from information derived from an analysis of the designated area of the content. As an alternate process, a copy of the designated area encircled by line 406 could be presented in environment media 407, along with or in lieu of one or more software objects, e.g., 408, that represent the designated content. If a copy of the designated area is presented in environment media 407, said copy can later be analyzed and the software can create a software object from the analysis.

In another embodiment of the invention, an environment media exists as an object, said object being presented in a web browser as a layer that is synced in memory to the position and location of a video frame or other content. Said web browser content is preferably transparent, and as such, cannot be seen by a user. Said web browser content is managed by the software of this invention that includes presenting EM elements in sync to content, e.g., the content from which said EM elements were derived.

Since the environment media is transparent, the user can freely look through the environment media to the video. So to the user, they are directly modifying a video frame or other content. But in fact they are operating on a separate environment media. Further, the environment media is not only visually transparent. It is also dynamically touch transparent. More about this later.

Sharing an Environment Media.

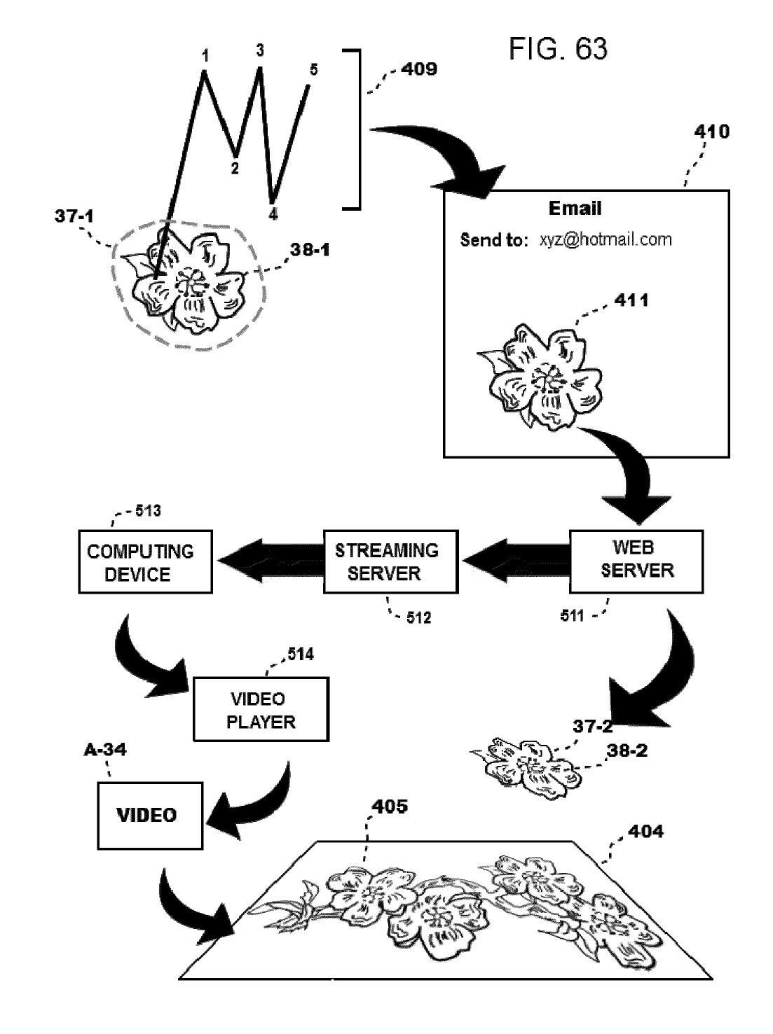

Referring to FIG. 63, an environment media 37-1, which is comprised of object 38-1, is moved up and down five times in a gesture 409. The software recognizes the gesture 409, and automatically places a visual representation 411, of environment media 37-1, and object 38-1, in email 410. Visual representation 411, could be a simple flattened image that has a pointer, or the equivalent, to a web server that hosts environment media 37-1 as a web page. As an alternate, said visual representation 411, could be a web browser content (or web browser layer), a web page, a web page managed by a Blackspace object like a VDACC, or any equivalent that communicates to a web server that hosts environment media 37-1 as a web page. For this example we will consider said alternate. Thus when a recipient opens their email and activates object 411, (e.g., by a double touch, verbal command or via any other suitable activation), object 411 sends a request to web server 511, to present environment media 37-2 and object 38-2 in a transparent web page. Further, as a result of this request, web server 511, sends a request to streaming server 512 to deliver video A-34, to which environment media 37-2 and/or object 38-2 are synced. Streaming server 512, sends video A-34 said recipient's computing device, which utilizes video player 514 to play video A-34. Object 38-2 in environment media 37-2, synced to video frame 404, modifies video frame 404 of video A-34. By this method, any change to object 38-2 will modify the appearance of the area of image 405 on frame 404 to which object 38-2 is synced.

Environment media, represented in email 410, as object 411, can have an auto activation relationship to environment media 37-1. Said relationship enables environment media 37-1, to be automatically activated by a context. An example of a context could be opening the email 410, and dragging object 411, from email 410, to any destination. Once said context triggers activation of said relationship between object 411 and environment media 37-1, video A-34 is streamed from its location to the destination device to which object 411 was dragged. Environment media 37-2, in sync with video A-34 and/or frame 404, modifies frame 404.

Note: As an alternate, environment media 37-1 could be automatically assigned to object 411 in email 410. As an assignment, environment 37-1 could be accessed by activating object 411 to view its assignment. A method of activation of object 411 could be a double touch or a verbal command, e.g., “open assignment.”

Note: An environment media that modifies multiple frames of a video or slides in a slide show or other motion-based media is not a rendered video. It is a motion media—a software presentation of objects and change to those objects. Note: environment media 37-1 is shown two ways in FIG. 63. Towards the top of FIG. 63, environment media 37-1 is shown as a dashed line around object 38-1. This is one way of creating environment media 37-1 from the drawing of line 406, as shown in FIG. 61. Here environment media is transparent, but it's a little larger than object 38-1, which it contains. Lower in FIG. 63, environment media 37-1 is given another number, 37-2. This is the same environment media. The numbers “1” and “2” are used to clarify references to said environment media 407 before it is opened by a recipient in an email “37-1” and after it has been sent, received and activated “37-2” by a recipient of email 410. The same approach is used for object 408. The number “38-1” refers to object 38 before it has been sent, received and activated by a recipient of said email 410. The number “38-2” refers to the same object, but after it has been activated by a recipient of email 410. It should also be noted that environment media 37-2 is shown as the same size as object 38-2. This is another way of creating an environment media from the drawing an outline, such as line 406, which defines a designated area to be created as an environment media. In this lower part of FIG. 63 object 38-2, and environment media 37-2, are shown with the same geometry.

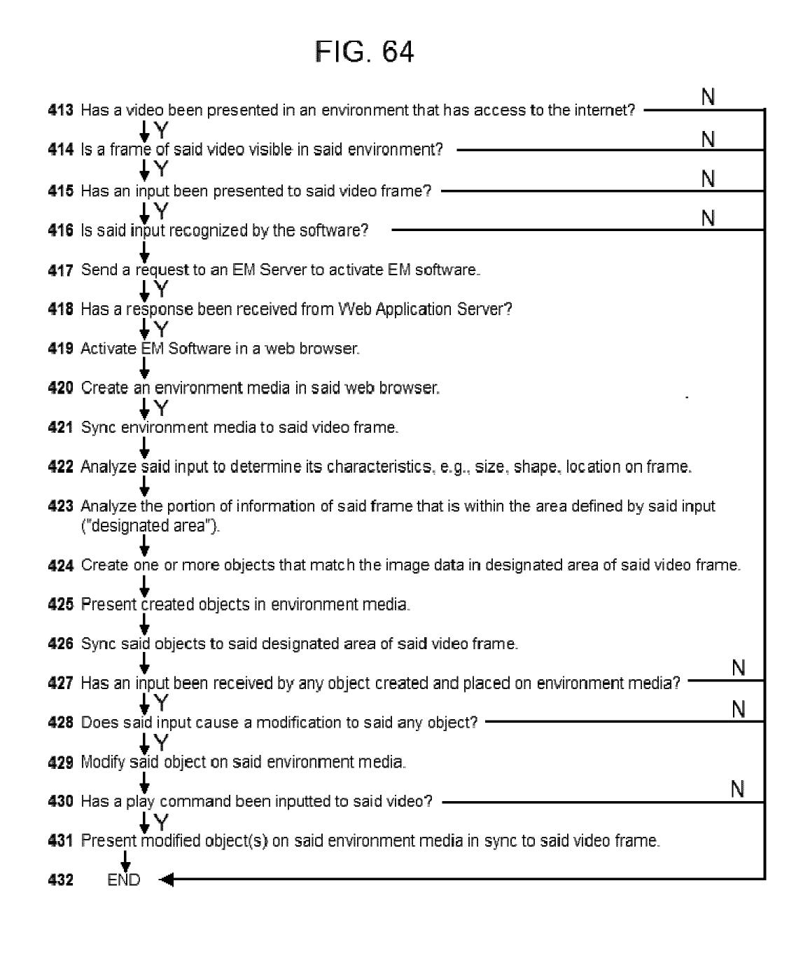

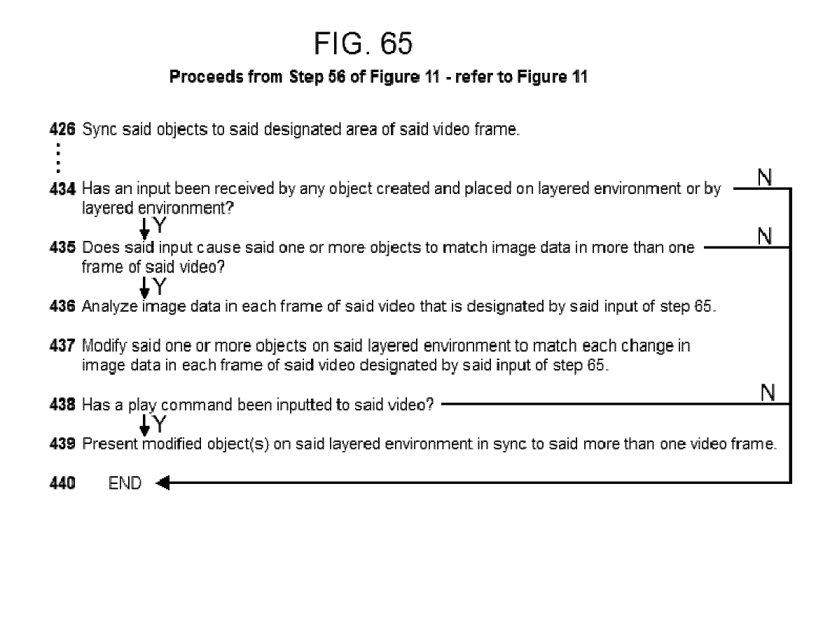

Referring now to FIG. 64, this is flow chart illustrating the process of automatically creating an environment media in sync to a video and/or a video frame.

Step 413: Has a video been presented to an environment that has an access to a network? In said environment, has a video been activated in a player on any device using any operating system, cloud service or the equivalent? If “yes,” the process proceeds to step 44 414. If “no” the process ends.

Step 414: Is a frame of said video visible in said environment? A video would likely be streamed to a device. If an environment media is being created to modify the entirety of a video (e.g., data that applies to an entire video—like notes, comments, a review, associated videos, or any other data that a user may wish to connect to a video), then presenting an individual frame in an environment would not be necessary. An environment media could be created to be applied to the video generally. If, however, information is being applied only to a specific video frame, is it easier if that frame is visually present on a device, computing system, or its equivalent. The flow chart of FIG. 64 describes the process of using an environment media to modify any single frame in a video. Thus, if a frame of a video is visible in an environment, the process proceeds to step 415. If not, the process ends.

Step 415: Has an input been presented to said video frame? The software recognizes many types of inputs, including: verbal, written (typed), gestural (which includes drawing), brain output from one's thinking, context, relationship, software driven input, and any equivalent. If the answer to this query is “yes,” the process proceeds to step 46 416. If “no,” the process ends.

Step 416: Is said input recognized by the software? For example, if the input is a gesture, the recognition of said gesture can provide a context for the automatic creation of an environment media.

Step 417: When the software recognizes an input, it sends a request to an EM Server to activate the EM software. The input could be a verbal command to load EM software, or as mentioned above, a gesture that comprises a context that triggers a function. [Note: Actions are objects, for example, the tracing of a portion of the image on said video frame can be an object. Said object can be programmed as a context, (e.g., said tracing travels beyond 10 pixels), to trigger an action, (e.g., “send a request to the EM Server to activate EM software”). Putting these things together could produce the following: when a drawn input (tracing around a portion of the image on a video frame), travels beyond a certain distance (10 pixels), the software recognizes the distance traveled by said gesture as a context. Said context causes the software to send a request to an EM Server.

Step 418: Has a response been received from a Web Application Server? If the answer is “yes,” the process proceeds to step 419. If not, the process ends at step 432.

Step 419: The Web Application Server delivers EM Software to said EM Server. As a result EM Software is activated in a web browser. The web browser content (or web browser layer) can have any level of opacity and said level is changeable over time. If said input of step 45 415 is directed towards creating a designated area of said video frame, said web browser content (or web browser layer) would likely be fully transparent.

Step 420: Create an environment media. Upon its activation, the software creates an environment media in said web browser within a new view layer. [The use of the term “view layer” generally refers to a “browser view layer”. Browsers implement composited views, as do most popular operating systems. A “composited” view is one where an image to be presented is composed by rendering visible content in layers, from back to front. This is often referred to as the Painter's Algorithm.

Step 421: Sync environment media to said video frame. The software syncs said environment media to said video frame by any means described in this disclosure or by other means known in the art. Further, if said drawn input defines a designated area of said video frame, the software syncs said environment media to said designated area of said video frame. [NOTE: In an exemplary embodiment of this invention, the recognition of an input and the resulting creation of an environment media are nearly instantaneous. Considering a drawn input as an example, by the time a drawn input reaches 10 pixels in length, it is being drawn in an environment media. Thus the drawn input starts on a video frame in said environment of step 413, but is finished in said environment media created in step 50. Therefore, said drawn input would be received by said environment media after reaching 10 pixels in length. If said input is drawn in a computing system that is slow to respond, said input is stored in memory and then sent to said environment media when it is created. In a fast computing system, only the first 10 pixels may be stored in memory and then transferred to the newly created environment media.]

Step 422: Said input is analyzed by the software to determine its characteristics. If said input is a gesture, e.g., a drawn line input, its characteristics would include the size, shape, and location of said drawn line within said video frame. If said input is a verbal command, its characteristics would include the waveform properties resulting from said verbal command.

Step 423: If said input, analyzed in step 422, is a gesture that outlines or otherwise selects a portion of the image on said video frame of step 414, said portion would define area of said video frame to be analyzed by the software. The software analyzes the portion of information of said frame that is within the area defined by said input (“designated area”). For example, let's say the video frame contains an image of a brown bear and that said input is a line drawn around the circumference of the brown bear. First, the drawn input could be used literally as it was inputted. In this case, the precise perimeter and shape of the drawn line would determine the exact area of the brown bear image to be addressed by the software. As an alternate, the software could modify the drawn input according to an analysis of the brown bear image on said video frame. By this method, said drawn input could be adjusted to exactly match each element comprising the perimeter of the brown bear image. In other words, as the software performs an analysis of the brown bear image on said video frame, some of the found image elements (e.g., pixels) may lie outside the drawn input on said environment media. In this case, said drawn input would be automatically adjusted to include each found brown bear image pixel. [Note: If the video is being displayed on a screen, the element would be pixels or sub-pixels. If the video is being displayed as a hologram, the element could be ring shaped patterns that convey information on both angular and spectral selectivities, or the equivalent for a different holographic system. Any type element can used to adjust said input of FIG. 64.]

Step 424: Using information from the analysis of the image in said designated area of said video frame, the software creates one or more objects that represent the image information in said designated area. There are many ways that this can be accomplished. For purposes of discussion the image of a brown bear will be used. This is the image data of said designated area of said video frame. There are various possible approaches to the creation of one or more objects in step 54. Some of the approaches are discussed below.

Copy

The simplest way to create an object that represents the brown bear of said video frame is to copy the brown bear image and present it on said environment media in perfect registration to the brown bear on said video frame. Said copy could be a single object presented on said environment media. In the case of a copy, the software would automatically perform a copy function, which would copy the area of said video frame defined by said input, (“designated area”) to said environment media. It should be noted that at any point in the future the software could analyze said copy and create an interactive object that recreates said copy in an environment media or other environment.

Create an Object

Based upon the analysis of said image in said designated area of said video frame, the software creates an object that matches the dimensions, and other characteristics (like hue, contrast, brightness, transparency, focus, color gradation and the like) of said brown bear image in said designated area of said video frame. Said object would be created by the software and presented in said environment media such that said object matches the position and orientation of said brown bear image on said video frame. In finely tuned software, the matching of said image in said designated area of said video frame by said object in said environment media in step 55 is sufficiently accurate that when said video frame is viewed through said environment media, nothing appears changed to the viewer. In other words the recreated version of said brown bear video frame image is perfectly matched by said object in said environment media.

Create a Composite Object

Based upon the analysis of said image in said designated area, the software creates a series of objects that together recreate an image from said video frame. Let's say the image is a brown bear. Said series of objects could be of any size, proportion or have any number of characteristics applied to them. Said series of objects (“composite object elements”) together on said environment media would recreate said brown bear image on said video frame. For instance, one composite object element could be the head of the bear, another composite object element could be the tail of the bear, and another each foot of the bear and so on. All composite object elements would operate in sync with each other and thus together represent the entirely of said brown bear image on said video frame. In addition, a user-defined or software implemented characteristic could be automatically applied to one or more said composite object elements, whereby one or more of the composite object elements can communicate with each other. If all composite object elements were enabled to co-communicate, an input to any one of said composite object elements could be communicated by said any one of said composite object element to the other composite object elements that comprise the composite object to which they belong.

Create a Micro-Element Composite Object

In this approach, based upon the analysis of said video frame image in said designated area, the software creates a group of micro element objects that together recreate said brown bear image on said video frame as a “micro-element composite object” on an environment media. A “micro-element” is usually the smallest division of visual information that can be presented for any display medium, including holograms, projections of thought, and any display. Any “micro-element” can comprise any object in an environment media. Assuming that visual information is being presented via some type of computer display, each pixel of said brown bear image on said video frame is recreated as a separate pixel-size object on said environment media by the software. An object comprised of pixel-size objects shall be referred to as a “pixel-based composite object.” In an exemplary embodiment of the invention, each pixel-size object that comprises a pixel-based composite object is able to communicate with each of the other pixel-size objects that comprise said pixel-based composite object. [Note: Regarding pixels as micro-elements, sub-pixels could also be used as micro-elements for a display. However, the default micro-element for a display is the pixel. This is due to practical considerations, one of which is to prevent data from becoming too complex for the software to quickly analyze and manage. Using a combination of sub-pixels and pixels is also a possibility and can be used as required.]

Sharing Instruction

A “sharing instruction” or “sharing input” or “sharing output” is something that contains as part of its information a command to be shared with other objects. For purposes of this example, consider a pixel-based composite object (“PBCO 1”) comprised of 2000 pixel-size objects. Let's say a user instruction is inputted to just one of the pixel-size objects (“Pixel Object 1”) in said pixel-based composite object, “PBCO 1.” Said user instruction could be via a verbal utterance, typed text, a drawing, a graphic, a context, a gesture or any equivalent. Let's say said instruction is a sharing instruction to proportionally increase the size of the pixel-size object receiving said instruction by 15%. We'll call this pixel-size object “Pixel Object 1.” Since all of the pixel-size objects that comprise said pixel-based composite object “PBCO 1” are capable of communicating to each other, Pixel object 1 can share its received sharing instruction with the 4,999 pixel-size objects that comprise PBCO 1. As a result, PBCO 1 will be increased in size by 15%.

As an alternate approach, Pixel Object 1 could share its received sharing instruction to a second pixel-size object (“Pixel Object 2”) in pixel-based composite object PBCO 1. Pixel Object 2 shares its received sharing instruction to a third pixel-size object (“Pixel Object 3”) in pixel-based composite object PBCO 1, and so on. This process is continued until all 5000 pixel-size objects have increased their size by 15%, thus completing a 15% size increase of pixel-based composite object PBCO 1. The point here is that a shared instruction need only be delivered to a single object in a composite object, and this single shared instruction can be automatically shared with all objects that comprise said composite object. It should be noted that a sharing instruction can include a more specific set of directives for the sharing of the information in said sharing instruction. Said directive could include a list of objects to which said information can be shared or a context in which said information is to be shared or a time or any other factor that modifies the sharing of information supplied to any object as a sharing instruction.

Step 426: Sync said objects to said designated area of said video frame. The software matches the one or more objects in said environment media that were derived from said image on said video frame, with said image on said video frame. In this step the software makes sure that said one or more objects on said environment media match the visual properties of the image on said video frame. Visual properties would include, shape, proportion, color (saturation, brightness, contrast, hue), transparency, focus, gradation and anything else that is needed to accurately recreate the image from said video frame as one or more software objects in said environment media. Further, the software syncs said one or more objects to said video frame and/or to the image on said frame from which said software objects were derived. As part of this syncing process, said one or more objects on said environment media are placed in exact registration to said image on said video frame. This can include positioning said one or more objects on said environment media such that they match the distance of said image on said video frame from the outer edges of said video frame and to the center position of said video frame and the like.

Step 427: The following steps in FIG. 64 relate to the operation of objects in said environment media. The software checks to see if an input has been received by any object in said environment media. Inputs can be received by each individual object in said environment media or inputs can be received by said environment media itself and transmitted to any individual object in said environment media. If “yes,” the process proceeds to step 428. If “no,” the process ends.

Step 428: The software checks to see if said received input causes a modification to any object in said environment media. If “yes,” the process proceeds to step 429. If “no,” the process ends. One purpose of recreating video frame image data as environment media software objects that are synced to video frame image data is to enable a user to easily modify said video frame image data without editing it in the original video content or copying it to said environment media. A method to modify video frame image data is to present one or more user inputs to one or more objects on an environment media in sync to the image data of a video frame. Said user inputs modify said one or more objects of an environment media. As a result of these modifications, the video frame image data, to which one or more objects are synced, appears as modified data, even though it has not been altered. Another advantage of recreating image data of a video frame, or other content, as objects in an environment media is that a simple user sharing instruction can be input to any object in an environment media such that the combined communication between all multiple objects in said environment media can result in a series of operations that the user does not need to manage. They can be managed by the objects themselves.

Step 429: The software modifies the object that has received an input according to the instructions in said input.

Step 430: The software checks to see if a play command has been inputted to said video. A video can be operated from said environment media. If “yes,” the process proceeds to step 431. If not, the process ends at step 432. Note: there are two general modes of operation regarding the “presenting” of objects in an environment media:
(1) Said objects can remain in sync with the content which they modify; in the case of said video in step 413 of FIG. 64, said objects are presented in perfect sync to each image data from which they were created as said image data is presented during the play back of said video.
(2) Said environment media and the objects that comprise said environment media operate independently of the content from which said objects were created. In this case, said environment media and said objects that comprise said environment media are not synced to the content from which they were derived. Said environment media and said objects that comprise said environment media exist as a standalone environment.

Step 431: When said video is played, the software presents said objects on said environment media and any modifications to said objects in sync to said designated area of said image on said video frame of said video.

Referring now to FIG. 65, this is a flow chart illustrating the matching of multiple video frames of a video with objects in an environment media.

Step 426: This is the same step as described in FIG. 64.

Step 434: The software checks to see if an input has been received by any object or by said environment media.

Step 435: The software checks to see if said input causes any one or more objects on said environment media to match the image data on more than one frame of said video. If “yes,” the process proceeds to step 66. If not, the process proceeds as described in the flowchart of FIG. 11 64.

Step 436: The software analyzes the designated image area for each frame of said video specified in said input. For example, let's say that said input is a verbal command that states: “Make the brown bear black for every frame in which it appears in this video.” In this case the software determines which frames in said video contain said brown bear image. Then the software analyzes each frame in said video that contains said brown bear image to determine any changes to the image data of said brown bear on each frame. The software utilizes this analysis to apply one or more changes to one or more objects of said environment media, such that said one or more changes match changes of said brown bear image on each frame in said video. For example, let's say one object on said environment media matches the eye of said brown bear in said video. We'll refer to this as the “eye object.” For each frame in said video where the eye of the bear image changes, the eye object on said environment media is changed in the same way. Changes could include, position on the video frame, color characteristics, transparency, lighting effects, e.g., reflection, skew, angle or anything that changes the presentation of the eye of said brown bear from one frame to the next in said video. Further, changes applied to the “eye object” are timed to match the timing of the changes in the eye of the bear image data from one frame to another in said video.

Further regarding step 436, the following is a more detailed explanation. For purposes of this explanation the part of the video frame image data that equals the eye of the bear in said video shall be referred to as “eye of the bear” and the object on said environment media that matches the “eye of the bear” will continue to be referred to as the “eye object.” This illustration considers changes in the eye of the bear between two frames. For purposes of this illustration, let's say its frame 50 and frame 51. Let's say from frame 50 to frame 51 the eye of the bear moves twenty pixels to the right along the X axis and 21 pixels up along the Y axis. For this example we will consider the video containing said brown bear to be 2D, so there is no X axis. In addition to the positional change, the eye of the bear, changes its color properties due to lighting, angle, change in the environment in which the bear is walking and other factors. The software analyzes all aspects of the eye of the bear. The most accurate analysis of the eye of the bear would be to analyze each pixel of the eye of the bear image to determine any change in its characteristics, including: the color characteristics of each pixel comprising the eye of the bear image, and any change to the position of any pixel comprising the eye of the bear image. For instance, let's say that the eye of the bear image contains 40 pixels. Then 40 separate analyses or more could be performed for the eye of the bear image by the software. For instance, the RGB values of each of said 40 pixels could be determined for frame 50 and for frame 51 and then compared. Let's say that in frame 50 the RBG color for pixel 1 of 40 is R:122, G:97, B: 73 and the RGB color for pixel 1 of 40 in frame 51 is R:132, G:105, B:79. As a result of this analysis the RGB values for the eye object that match pixel 1 of 40 in the eye of the bear image on frame 50 would be changed from R:122, G:97, B: 73 to R:132, G:105, B:79 to match the eye of the bear image data on frame 51. [Note: as is well known in the art, this RGB number represents many visual factors, including: brightness, hue, saturation and contrast.] The software would then repeat this process for the other 39 pixels of the eye of the bear image for frames 50 and 51. If the eye of the bear does not change from frame 50 to frame 51 for any pixel, said eye object that corresponds to that pixel would not be changed. By this process, the software modifies each eye object in said environment media as is needed to ensure that each eye object accurately matches each change in each eye of the bear image pixel to which it is synced. If any of the 40 pixels comprising the eye of the bear image change between frame 51 and 52, the above described process is repeated, and so on for each frame in said video where the eye of the bear image changes in any way.

Note: Change to objects in an environment media can be saved as a motion media or converted to a Programming Action Object. A motion media can be used to record all changes that are discovered by the software's analysis of image data on any number of video frames. Further, a Programming Action Object (PAO) can be derived from said motion media. As an alternate, a PAO can be derived directly from the changes made to objects on said environment media to enable said objects to remain in sync with changes to the image data between various frames in a video.

Step 437: The software utilizes the analysis of said image data in each frame of said video designated by said input of step 435 to modify the characteristics of said one or more objects on said environment media. The modifications to said one or more objects enable said objects to match each change in the image data on multiple video frames of said video.

Step 438: As in the flow chart of FIG. 64, a play command or its equivalent can be presented from said environment media to cause said video to be played on whatever device is being used to present said video, either via streaming from a streaming server, by playing a saved video, or by any other means supported by said device.

Step 439: The software presents modified objects on said environment media in sync to said image data on said more than one video frame. Thus as said video plays, the objects on said environment media are presented by said environment media (or by the software) in sync to the image data on said more than one frame, such that said objects on said environment media modify said image data on said more than one frame.

Regarding Modifying a Video with Objects in an Environment Media

When a user performs a task in an environment media, that task can become part of the content it modifies or not become part of the content it modifies. If said environment does not become part of the content it modifies, it remains a separate environment. Among other things, this environment can be shared, copied, sent via email or some other protocol, or it can be used to derive a motion media and/or programming action object, which can contain models of changes to states and objects in said environment media. If an environment media is being used to modify content as a separate environment, it continues to reference content. However, it does not become part of the content it modifies and it doesn't cause the original content that it modifies to be edited. Regarding video, an environment media and the objects that comprise an environment media do not become embedded in the video they modify. Note: an environment media can be used as a standalone object. In this case, an environment media would not sync to the original content from which one or more of its objects were created. However, said environment media would continue to maintain a relationship to any content from which any object contained in said environment media was derived. Said relationship would enable said environment media to access said any content if needed at any time.

For purposes of the discussion below the example of a brown bear video as presented in FIG. 58 will be referred to. The inputs, 395A and 395B, and the definition of object 392B and designation of image 392A shall be redefined for purposes of this discussion. Let's say a user draws around the perimeter of the bear image on frame 390, of video 385, as shown in FIG. 58. This drawing (not shown) defines a designated area. Said designated area is shown in FIG. 58 as image 392A on frame 390. [Note: there may be more image data on frame 390, but said drawing designates the bear image as a selected area shown as image area 392A in FIG. 58, hereinafter referred to as “bear image” or “brown bear image.”] For the most accurate result, the software analyzes every pixel contained in bear image 392A. To preserve the highest accuracy of the analysis, the software recreates each pixel found in said designated area as a pixel-based composite object 392B, in environment media 391. Let's say that 5000 pixels exist in bear image 392A. Thus 5000 pixel-size objects are created as composite pixel-based object 392A on environment media 391. Each recreated pixel-size object is in sync to the pixel from which it was modeled after in the bear image 392A of video frame 390. Thus each pixel-size object comprising object 392A on environment media 391, is in perfect registration to the position of each bear image pixel on frame 390 from which said each pixel-size object was created.

Further considering image 392A, on video frame 390, of FIG. 58, the bear image on video frame 390 is the color brown 393. As stated above, the entire bear image 392A of frame 390 has been recreated as 5000 pixel-size objects comprising a pixel-based composite object 392B, on environment media 391. Each pixel-size object comprising object 392B has the ability to communicate with any of the other 4999 pixel-size objects comprising object 392B. Further, an input can be presented to any one of the 5000 pixel-size objects of environment media 391, and the pixel-size object which receives said input can communicate said input to the other 4999 pixel-size objects comprising object 392B or to any other object that has a relationship to it. More on this relationship issue later. Further, any of said 5000 pixel-size objects can also communicate to a computer system (not shown) or its equivalent on a network, server, cloud or the equivalent. Said communication is bi-directional.

Continuing to refer to the redefined FIG. 58, a user selects one of the brown pixel-size objects comprising object 392B on the environment media 391, and issues a sharing instruction, 392B. Said sharing instruction could take many forms. For instance, the user could say: “I want you to be black, and tell all the other brown pixels to turn black.” Since all of the pixel-size objects 392B, can communicate with each other, they know what pixel-size objects are brown, which are blue, which are lighter in color, etc. Some of the pixel-size objects comprise the eye and the nose of the bear, which are not brown. The pixel-size objects communicate to each other and compare their characteristics and determine which pixel-size objects are brown or comprise a range of brown colors that comprise the color of the bear image 392A, on frame 390 of video 385. In this example, the pixel-size object that received the user issued sharing instruction could act as a digital repository for the data shared and compared between the other 4999 pixel-size objects.

A question arises: “what is the color brown?” This inquiry could be answered by said 5000 pixel-size objects comparing their own characteristics and determining a range of hue, contrast, brightness and saturation that are shared by most of the pixels. As an alternate, each pixel-size object comprising composite object 392B, could query the software to acquire a definition for the term “brown.” The software of environment media 391 could respond to this query and perform its own analysis of the colors in bear image 392A. Based on its analysis the software could define a range of brown colors 394 that are represented in the bear image 393 on frame 390 of video 385. This defined range of colors could then be communicated to the 5000 pixel-size objects 392B or communicated to one of the 5000 pixel-size objects, which in turn communicates the information to the other 4999 pixel-size objects. The pixel-size objects could then use this range of color characteristics to determine if they are within that range, in which case they would be considered brown.

As another alternate to the two approaches just discussed, a user could communicate a definition of the word “brown” to the 5000 pixel-size objects 392B. One way to accomplish this would be to select one pixel-size object and “teach” it about the color brown. For instance a user could hold up one or more physical analog color cards that contain ranges of brown to be used by said pixel-size object to define the word “brown.” The cards would be in the physical analog world and would be viewed by a digital camera and recognized by a digital image recognition system, now common in the art. The digital camera could be a front facing camera on a smart phone or a webcam on a laptop or pad or any equivalent. The user could say to said pixel-size object: “share this color definition with all objects that make up the bear object.” The physical analog color cards would be converted to digital information by said digital recognition system and then said digital information would be supplied to said pixel-size object by the software. The user's sharing instruction would instruct said pixel-size object to share color information derived from the analog color cards with the other 4999 pixel-size objects that now comprise object 392B in environment media 391. As a result the 5000 pixel-size objects comprising object 392B “understand” the meaning of the color “brown” as defined by said user.

Objects' Ability to Analyze Data

In order to share a new color definition, the pixel-size object must be able to properly interpret the color shade cards being held up to the camera and associated recognition system. The interpretation of the color cards held up to a camera by said user could be accomplished by a digital recognition system in conjunction with the software. However there is another possible approach to the interpretation of said analog color cards. Any object in an environment media is capable of analyzing data. One way of analyzing data is to communicate with a processor to perform analysis. For instance, the pixel-size object receiving data from said digital recognition system could send said data to a processor to perform analysis on said data This processor could be local, namely, using the processor in a device. Or it could be a server-side computing system that can communicate directly to said pixel-size object. This computing system performs analysis and returns the results to the pixel-size object that communicated with said computing system. Said pixel-size object communicates said results from said computing system to the other 4999 pixel-size objects comprising pixel-based composite object 392B.

The final step in this example is defining the word: “black.” This can be accomplished by the same means described for defining the color brown. Once said 5000 pixel-size objects change their color to black, this changes image 392A on frame 390 black. So what if the resulting change to image 392A is too black or too opaque? This can be easily changed by communicating a new shade of black to the 5000 pixel-size objects comprising composite object 392B on environment media 391.

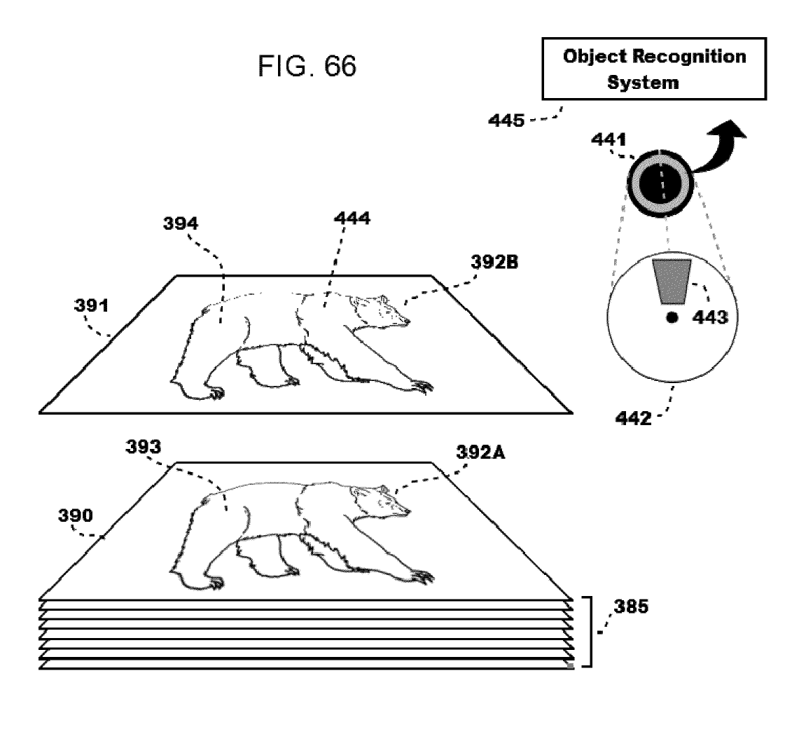

Referring now to FIG. 66, item 442, is a physical analog color wheel that contains multiple shades of black where only one shade at a time is revealed through a window 443, as the color wheel 442, is turned. A user selects one of the 5000 pixel-size objects 444, which comprise pixel-based composite object 392B. The user operates the color wheel 442, in front of camera 441, which is attached to an object recognition system 445. As the user turns the physical analog color wheel 442, in front of a camera 441, different shades of black are presented one by one to the object recognition system 445. The software analyzes each shade received from said object recognition system and delivers information describing said each shade to object 444 with a sharing instruction, like: “change your color to each new shade of black and share this instruction to make the body of the bear black.” Complying with this instruction, for each new shade of black received from the software, object 444 communicates said each new shade of black to every pixel-size object that comprises the color of the bear's body in pixel-based composite object 392B. As a result, the color of the bear image 392A, on frame 390, of video 385, appears to change to match each new shade of black that is presented to the camera recognition system 445, by the color wheel 442. But in reality, no changes are being made to image 392A on frame 390 of video 385. Since the pixel-size objects in 392B are in sync with the pixels of image 392A, any change to the pixel-size objects of object 392B changes the appearance of object 392A, without actually changing anything in image 392A.

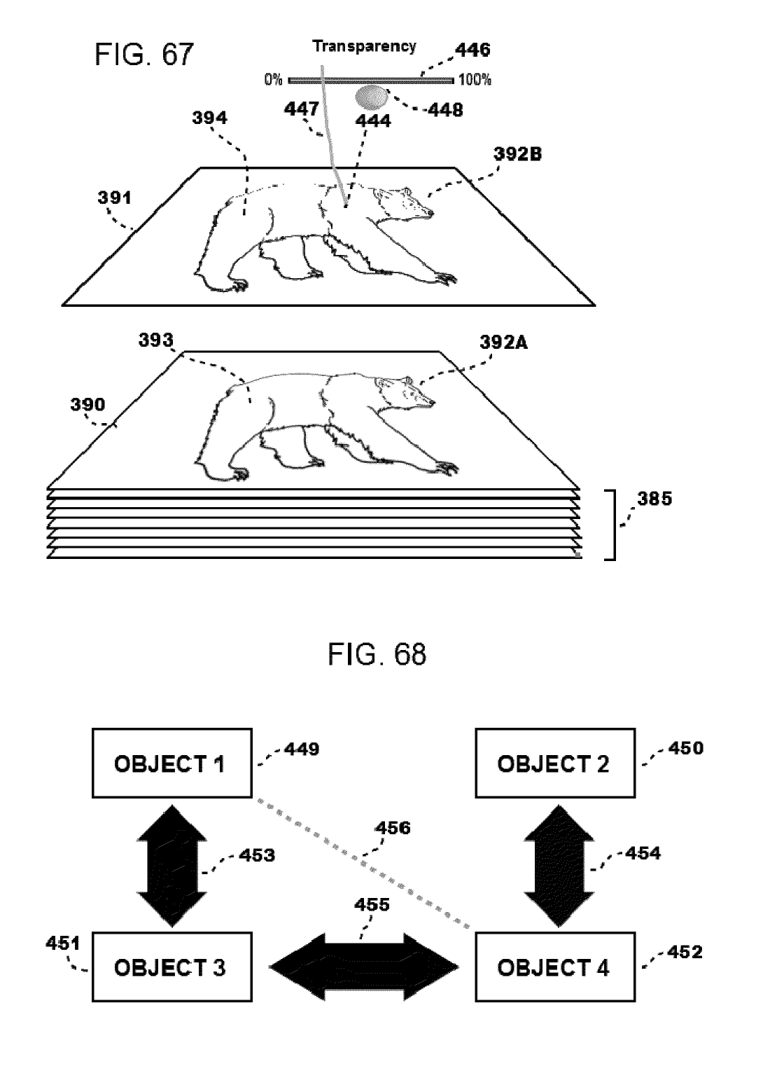

An equivalent of the above described process could be performed in the digital domain. Referring now to FIG. 67, a fader object 446, is drawn in an environment media (not shown) and fader object 446 is recognized by the software and converted to a functioning fader device. The function “transparency” is applied to fader object 446, by any suitable means, e.g., dragging a text object “transparency” to impinge fader 446, or touching fader 446 and verbally uttering: “transparency.” One of the 5000 pixel-size objects 444, is selected and the fader 446, controlling transparency is connected to it. Said connection is accomplished by drawing a line 447, from fader 446, to pixel-size object 444. Once connected, the fader object 446 is operated by moving the fader control cap 448, right or left to change the amount of transparency for pixel-size object 444. Pixel-size object communicates the change in transparency to the other 4999 pixel-size objects that comprise composite object 392B on environment media 391. Thus as the transparency value of fader 446, is changed, the transparency of the color is changed for each pixel in composite object 392B via communications from pixel-size object 444, to the other 4999 pixel-size objects that comprise composite object 392B. These changes take place on environment media 391, and are not edits of the bear image 392A, on frame 390. The visual experience from a user's perspective appears as a modification of image 392A. However, the increase or decrease of transparency is a modification of 5000 pixel-size objects on environment media 391 that are in sync with the 5000 pixels of bear image 392A on frame 390.

Object Communication and Analysis Capability

A partial list of the tasks that objects in an environment media, or its equivalent, can perform is shown below.
Exhibit and maintain separate characteristics and co-communicate said characteristics to other objects in the same environment media that contains said objects.
Query other objects and receive information from other objects in the same environment media that contains said objects.
Communicate directly with any environment media, to which said objects have a relationship. Note: environment media are objects. Impinging one environment media object with another establishes a relationship between the two environment media and between the objects that comprise said two environment media.
Query and/or send instructions to computing systems that have a relationship to said objects.
Directly receive information from computing systems that have a relationship to said objects.
Receive inputs and respond to said inputs from sources external to the environment that contains said objects.
Analyze data
Create a new relationship with any object, device, function, action, process, program, operation, environment media, and any object on any environment media that is either external to the environment media containing said all objects, or on the environment media containing said objects.
Communicate to one or more objects between different environment media, when said one or more objects share at least one relationship.
Modify content that is presented by software other than the software of this invention.
Modify content that is not contained in the environment media synced to said content.
Modify content that is synced to at least one object in an environment media.

One key to the communication ability of environment media objects are “relationships.” A first object can communicate with any second object (in or external to the environment media that contains said first object) with which said first object has any kind of relationship. Any object of an environment media can communicate with any environment media or any external system, operation, action, function, input, output, or the like, with which said any object has a relationship. Said relationship includes either a primary relationship or a secondary relationship. A primary relationship is a direct relationship between an object and something else. A secondary relationship is discussed below.

Secondary Relationship

A secondary relationship is defined in FIG. 68. A first object 449, has a primary relationship 453, to third object 451, but not to second object 450, or fourth object 452. Second object 450 has a primary relationship 454, to fourth object 452, but not to third object 451, or first object 449. Fourth object 452, has a primary relationship 455, to third object 451. The relationship between first object 449, and fourth object 452, is a secondary relationship 456. If second object 450, had a primary relationship to the third object 451, then second object 450, would have a secondary relationship to first object 449. A secondary relationship is a valid relationship between objects in an environment media, and between objects in an environment media and computing systems, processes, operations, actions, contexts, programs, other environment media and the like, which are external to the environment media that contain said objects.

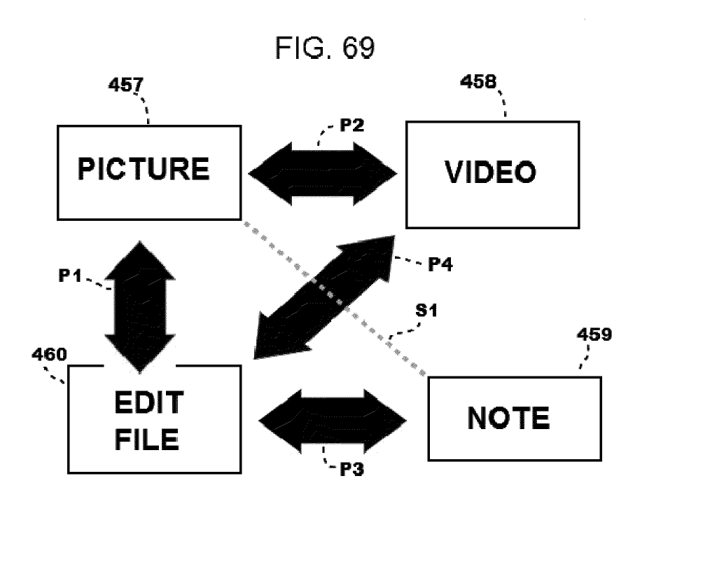

One way to understand primary and secondary relationships is to think about the process of searching. Referring to FIG. 69, let's say a user is searching for a picture 457. The user knows that picture 457, is a blue artistic abstract image, but they don't remember the name of picture 457, when it was created or where it was saved. But they remember what they were doing when they first found picture 457. They were editing a video 458. They remember the name of the video 458, but when they view it, picture 457 does not appear in the video. They try searching for key words like “blue,” “artistic,” “modern,” and the like, but they don't find picture 457. But they find a note 459, a README text file. Note 459, contains a reference to the name of a video editing file 460, which was used to create video 458. The editing file 460 is located, and in the clip bin of video editing file 460 is picture 457. The name of said video editing file 460, has no commonality with the name of video 458, nor with the name of picture 457, nor with the name of note 459. But picture 457, video 458, note 459, and video edit file 460, share relationships. The video edit file 460 has a primary relationship P1, to picture 457, since picture 457 appears in the clip bin of video edit file 460. Video 458 has a primary relationship P2, to picture 457, because picture 457 was used in video 458 and then deleted. Note 459, has a primary relationship P3, to video edit file 460, because note 459 contains a reference to the name of video edit file 460. Video edit file 460 has a primary relationship P4, to video 458 because video edit file 460 was used to edit video 458. Note 459 has a secondary relationship to picture 457 because it has a primary relationship to video edit file 460, which has a primary relationship to picture 457.

The software of this invention saves all relationships between all objects in environments maintained by the software. In environments operated by the software of this invention, picture 457, video 458, note 459 and video editing file 460, are objects. The relationships between these objects enable them to communicate with each other and with any other object to which they have either a primary or secondary relationship. These relationships can also enable a user to find picture 457 when key words and other search mechanisms fail. To find picture 457, a user could select video 458 or note 459 or video edit file 460 and request any of these objects to present every object that has a relationship to them. In the list of objects presented by video 458, note 459 and video edit file 460 will be picture 457.

Preserving Change as Motion Media

The software of this invention is capable of recording all changes to any object controlled by said software. Included as part of this change is any primary or secondary relationship that is created between any objects for any reason in any environment operated by the software. Further, the software of this invention can store any change, including a change to any relationship, for any object as part of that object's characteristics.

Further, the software can save any relationship between any object to any data containing “change” for said any object, whether said any data is saved on a server (including any cloud service), or a local or networked storage device or the equivalent. Relationships serve many purposes: (1) relationships are objects which can be queried by the software, by a user, by other software, by any object or the equivalent, (2) relationships permit a direct communication between objects, (3) a relationship can be used to modify other relationships, (4) relationships can be used to program environments and objects, (5) relationships permit any object that is controlled by the software to directly query or instruct a local or server-side computer processor or computing system to conduct any operation, including any analysis, action, function, or the like, and communicate the results of said any operation to the object making the query or sending an instruction.

Referring again to the example in FIG. 69, the software, a user, or an object could query note 459 and request all objects, operations, functions, actions, processes, computing systems, inputs or anything else that constitutes a primary or secondary relationship to said note 459. As an alternate a request could be presented to note 459, asking for only objects that have a relationship to note 459. Picture 457, would be part of the objects presented by note 459 as a result of both queries.

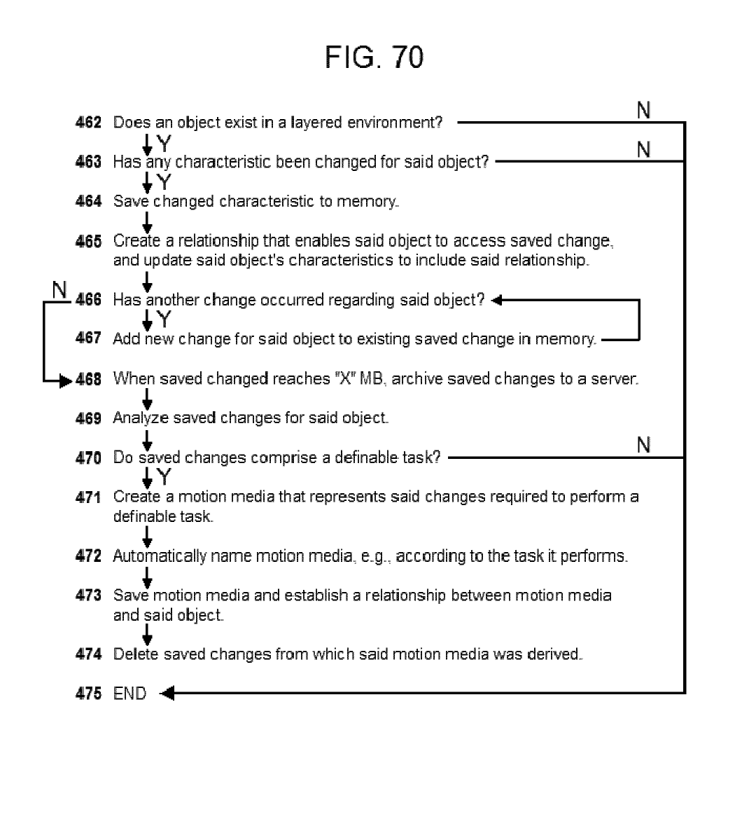

FIG. 70 is a flowchart illustrating a method of automatically saving and managing change for an object in an environment operated by the software of this invention. One key tool for managing saved “change” data for any object is the converting of said “change” data into one or more motion media objects.

Step 462: The software verifies that an object exists in an environment operated by said software. If no object is found, the process ends at step 475.

Step 463: The software checks for any change to any characteristic of said object. If no change is found, the process ends at step 475. If a change is found, the software proceeds to step 464. This is an ongoing process. The software is continually checking for any change to said object that affects it in any way. This could be a change to a characteristic, a context, to another object that shares a relationship with said object, or to a property, behavior or the equivalent of said object. All of these changes are considered changes to said object's characteristics. See the definition of “characteristic.”

Step 464: The software saves found change (“change data”) to memory. This is an ongoing process. For each change found for said object, the software saves that change to memory. This memory could be anywhere.

Step 465: The software creates a relationship that enables said object to access change saved to memory. A relationship is established between said object and the saved change data for said object. Said relationship can be represented as any software protocol, rule, link, lookup table, reference, assignment or anything that can accomplish the establishment of said relationship in a digital and/or analog environment.

Step 466: The software checks to see if any new change has occurred. As previously explained, the checking for change is an ongoing process by the software. The time interval to check for any new change for any object can be variable. Said time interval may be dynamically changed for any purpose by the software, via an input, via a context, via a programming action object, and any equivalent.

Step 467: The software saves each new found change for said object to memory.

Step 468: Depending upon the size of available memory, speed of the memory and other factors, the software determines the maximum size of saved change data for said object in memory. This maximum size can be dynamically adjusted by the software, depending upon the availability of memory and the use of memory for other purposes, like saving change data for other objects. This maximum size could be altered by a user input. When the size of saved change data for said object reaches a certain size, the software archives the saved change data to a server, local storage or both.

Step 469: The software analyzes saved change data for said object. This step could occur before saved change data is archived, or it could be a process to keep archived change data from growing too large, or it could occur for archived change data.

Step 470: As part of the software analysis of saved change data for said object, the software determines if any one or more changes of said change data comprise a definable task. A task could be any action, function, operation, feature or the like that is recognized by the software. [Note: the software can gain a new awareness of tasks by analyzing user input.]

Step 471: If the software determines that a set of change data defines a task that set of change data is used to create a motion media, update an existing task for an existing motion media, or update an existing motion media with an additional task. As an alternate, a user could select a group of changes and instruct the software to create a motion media from said group of change data. In that case, a task need not be found. Said group of change data is saved as a series of changes.

Step 472: An ideal naming scheme may be to name each motion media according to the task it performs, but the naming of motion media is not limited to this approach. Any naming scheme can be used. [Note: A motion media is an object that records and presents change to one or more states and/or to one or more objects' characteristics. A motion media can exist as compressed data Compressing the data of a motion media can be done automatically or upon some external input, based upon the need to preserve storage space.] Step 473: The newly created motion media is saved by the software. When said motion media is named, the software saves said motion media to a server, cloud service, local storage or any equivalent. Further, the software establishes a relationship between said saved motion media and the object(s) and/or environment from which it was derived.

Step 474: Once a motion media is created, the software deletes the change data from which said motion media was derived. This prevents saved change from getting too large on a server, local storage or equivalent.

Environment Media Establish and Maintain Relationships with Existing Data.

A user can cause the recording of a motion media, and/or the creation of a PAO, by simply performing one or more operations with software they already use. In a similar manner in which an environment media and objects that comprise an environment media can be used to modify existing content, as shown in the examples of FIGS. 58, 59, 60A, 60B, 66 and 67, environment media can be used to establish and maintain relationships between existing data in any program on any device, using any operating system, as long as said existing data is operated on a system that can access the web.

A key element in the software being able to modify existing content is the “relationship.” Relationships can be established between digital objects created by the software and data that exists external to environments operated by the software of this invention. Said relationships can be established between environment media and objects that comprise environment media and content in programs, apps, and computing systems which are external to the environments of the software. When a user operates any content, the software can automatically (or via some input) create one or more environment media that have one or more relationships to said content. [Note: an environment media can be any size or proportion.] Relationships define the environments of the software. For instance, any number of objects that have at least one primary or one secondary relationship to each can comprise an environment media. The objects that comprise an environment media can exist anywhere, in any location, on any server, on any device, and their presence in an environment media can be dynamically controlled. Thus relationships become the “glue” that binds objects into environments—not screen space, applications, devices, servers, computing systems or the like. Below is a brief discussion of various types of relationships, however, there is no limit to the kinds of relationships or the number of relationships that can: (1) exist between objects in environment media, and (2) exist between objects in environment media and data (including content) that is external to environment media.

Using Relationships to Define Environments and Enable Communication

The following examples are for purposes of illustration only and are not meant to limit the scope or user operation of the software of this invention. The relationships below are a partial list of possible relationships with the software of this invention. These relationships are discussed in part from the vantage point of using relationships to search for objects, instead of using key words to search. However, the relationships cited below are not in any way limited to search.

Time Relationship

Let's say a user creates two picture objects (“Pix 1” and “Pix 2) about the same time in an environment of the software. The software establishes “time” as a relationship between Pix 1 and Pix 2 and adds said time relationship to the characteristics of Pix 1 and Pix 2. The software monitors the utilization of Pix 1 and Pix 2 and saves any change that is associated with either object. Said any change is not limited to change that directly involves Pix 1 and Pix 2 being used in some combination, such as they're being used in a composite image object or one of said pictures is used to modify the other. Said change also includes any change to either picture object individually, and not directly involving the other picture object. Said any change could be the establishing of a new relationship or the acquiring of a new characteristic or the modification of an existing characteristic. [Note: All saved change for any object or environment produced by the software, or saved change for any content or program or equivalent produced by any other software, shall be referred to as “change data”] Change data is saved and maintained by the software. In this example of a time relationship, each change data saved for Pix 1 and/or Pix 2 has a relationship to Pix 1 and Pix 2. Said change data can be converted to one or more motion media when said change data reaches a certain archival size. Further, a Programming Action Object (PAO) can be derived from said motion media as needed by a user or as requested by any object in an environment operated by the software. For the purpose of this discussion we will refer to all change data, motion media, and PAOs created from the recorded change data of Pix 1 and Pix 2 as “Pix 1-2 Elements.” All “Pix 1-2 Elements” are objects. All “Pix 1-2 Elements” have a relationship to both Pix 1 and Pix 2. All “Pix 1-2 Elements” can communicate to both Pix 1 and Pix 2. All “Pix 1-2 Elements” can communicate to any object that has a relationship to Pix 1 or Pix 2. Thus a user instruction could be inputted to any object that has a relationship to Pix 1 or Pix 2 and said any object could communicate said instruction to all other objects that share a relationship with Pix 1 and Pix 2. Regarding a search example, if a user could not find a piece of data for Pix 2, including Pix 2 itself, a query to find any data that has a time relationship with Pix 1 could be submitted to any object that has a relationship to Pix 1 or to Pix 2. Among the data presented by said object would be Pix 2, plus any change data associated with Pix 1 and Pix 2, and any motion media objects and PAOs derived from said change data associated with Pix 1 and Pix 2.

Reference Relationship

Further considering objects Pix 1 and Pix 2, let's say that an assignment of a document is made to Pix 1. In this assigned document is a reference to Pix 2 and to other picture objects created with or by the software. Said reference can be any text, visualization, object, audio recording, environment media, motion media, PAO or the equivalent. The reference in said assignment constitutes a relationship between Pix 1 and Pix 2. Any change to Pix 1 and/or Pix 2 are saved by the software and the resulting saved change data, including any motion media, PAO or other object derived from said change data, also have a relationship to Pix 1 and Pix 2 and to each other. The relationships between Pix 1, Pix 2, any saved change data for Pix 1 and Pix 2, and any objects derived from said change data define an environment media. Said environment media is not dependent upon a device, application, or operating system. Said environment is defined by objects that have one or more relationships to each other and to said environment media, which is also an object. [Note: an environment media can be defined by one object that has a relationship to said environment media.] As a result, of said one or more relationships, said environment is fully dynamic. As said relationships change, said environment is changed. If additional relationships are created, said environment is increased to include said additional relationships. If any object is removed from an environment media and relocated to another environment or environment media or assigned to any object, or the equivalent, the relationship of said any object to said environment media is maintained by the software until permanently deleted. If said relationship is not permanently deleted, said relationship continues as part of the characteristics of said environment media. Said relationship can be used by said environment media or the software to communicate with said relocated object and vice versa.

As previously stated, an environment media is an object. The characteristics of an environment media object include the relationships between the objects that define said environment media. Relating this now to a search, a user may ask the software to find all objects that reference or are referenced by Pix 1. As a response to this query, Pix 2 and all change data associated with Pix 1 and Pix 2 and any other object referenced in said assignment to Pix 1 are presented as part of the search. A query presented to Pix 1, or to any object that has a relationship to Pix 1, is not limited to search. For instance, a sharing instruction could be presented to any object that has a relationship to Pix 1, and Pix 1 could share that instruction with all objects with which it shares a relationship. Note: said sharing instruction could contain a limitation, e.g., the sharing of said sharing instruction could be limited to objects that have a primary relationship to Pix 1. In this case, any object with a secondary relationship to Pix 1 would not receive said sharing instruction.

Content Relationship

One advantage of the objects of the software of this invention is that they can contain and manage data themselves. Said objects can contain and share content. Any object that is created by the software (hereinafter: “software object”) can contain other software objects. One or more software objects can be placed into another software object by various means, including: by drawing or other gestures, by dragging, by verbal means, by assignment, by gestural means in an analog environment via any digital recognition system, by presenting a physical analog object to any digital recognition system, by thinking, via an input to a hologram and any equivalent. Any software object can manage other software objects by communicating with them. Said any software object can co-communicate with any software object with which it has a relationship. Therefore software objects that have relationships to each other can manage each other by analyzing each other's properties, communicating sharing instructions or other types of instructions, making queries to each other, updating each other's properties, recording change data, converting change data to a motion media, and so on.

Referring back to our content relationship example, Pix 1 can contain and manage content. Any assignment to Pix 1 would contain content. As a result of said assignment, said content would have a relationship to Pix 1. Through this relationship, Pix 1 could manage said content. As an example, Pix 1 could send sharing instructions to software objects contained in an assignment made to Pix 1. The process would essentially be the same as a user presenting a sharing instruction to a software object in an environment media. But in this example, Pix 1 communicates a sharing instruction on its own directly to a software object, computing system, browser or similar client application, environment, or the like. The issuing of said sharing instruction by Pix 1 could be in response to an input, context, software generated control, default software setting, configuration, communication from another object, query, or any other occurrence from any source, capable of communicating with Pix 1, that requires a response. A response from any source creates a relationship between said software object and said any source. Relating this process to search, the software can find any software object that shares one or more pieces of content with another software object. If, for instance, Pix 1 and Pix 2 shared any piece of content, searching for all items that have a “content” relationship with Pix 1, would cause Pix 1 to present Pix 2 in its list of relationships. Said content relationship would be a primary relationship. Software can search for secondary relationships as well. An example of a secondary relationship would be as follows. Pix 1 and Pix 1 have a primary relationship. This could be anything. Let's say they share a same piece of content. Let's say that an assignment has been made to Pix 1. Further, said assignment contains multiple pieces of content. A request is made to any of said multiple pieces of content to located all objects that have a secondary relationship to said piece of content. As a result, Pix 2 would be found in the search.

Structure Relationship

If any two software objects share any structure, this comprises a structure relationship. In the software of this invention, structure is an object and tools are objects. For purposes of this discussion, structure includes, but is not be limited to: layout, format, physical organization, and the like.

Context Relationship

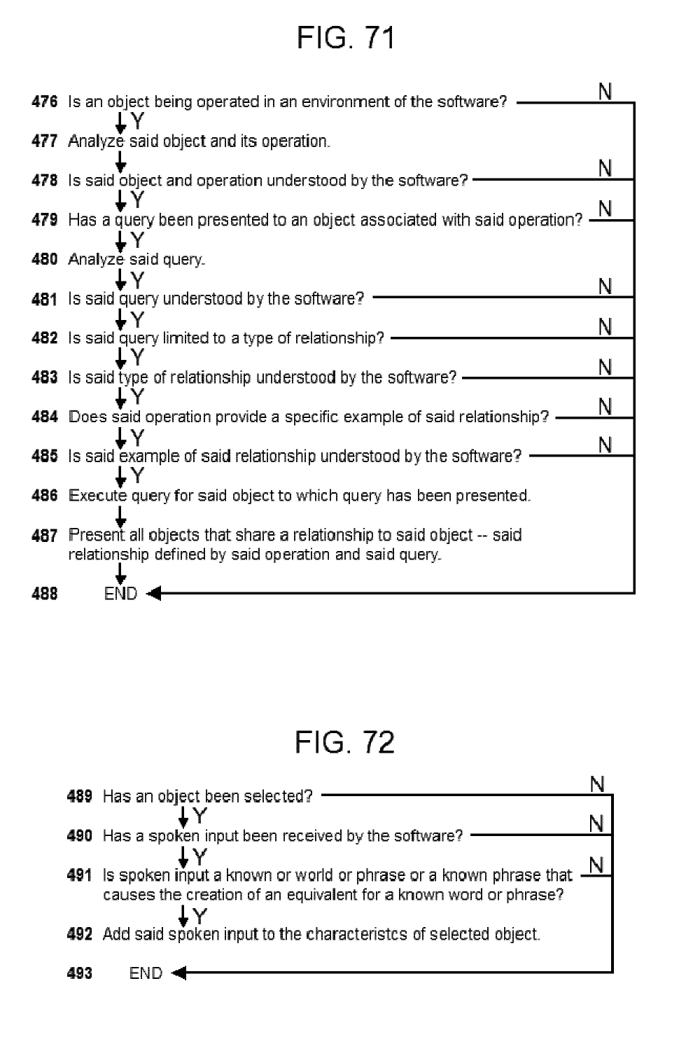

Let's say a user created a motion media that recorded the typing of an email address into a send field of an email application in the software of this invention. Weeks later, the user needs to locate this motion media, but doesn't remember what the name of the motion media is or where it was saved. The user searches for things like “email,” “typing,” and “send mail,” but the motion media they are searching for is not found, in part, because the words they search for are not part of the name for said motion media. In order to find said motion media, the user could operate the context in which the motion media was created. To accomplish this, the user could open their email application and start to type an email address in the send field of said email application. At this point in time, the user makes a query to the email application and request: “any software object that has a relationship to the current context.” In this case the current context is: typing an email send address in said email application. It should be noted that said “current context” is also a software object. As a software object, said current context has a relationship to the motion media that recorded the typing of an email address in said email application, and to the email data object containing the send field, and to the typed send address text. All of these objects share the same context relationship. The email data object recognizes said query and as a result, said email data object supplies all software objects that have a relationship to said current context. The software then produces all motion media which have a relationship to said current context. The above example presents a method for a user to program a software object by simply operating an environment in a familiar way. Referring to FIG. 71, this is a flowchart wherein software recognizes a user action as a definition for a software process.

Step 476: Is an object being operated in an environment of the software? This could include the result of any input, e.g., any user input or software input or any other input recognized by the software. Said input could be a user operating their environment in a familiar way. If the answer to step 476 is “yes,” the process proceeds to step 477, if not, the process ends at step.

Step 477: The software analyzes said object and its operation in said environment. For instance, if said object is an email application and the operation is the typing of a send email address into an email data object, the exact text being typed may not be so important. What may be more important is the action itself of typing any address into the send field of said email data object.

Step 478: Is said object and operation understood by the software? The analysis of said object and operation results, among other things, in an attempt by the software to define said operation. In the example just cited, the definition of said operation could be: typing an address into the send field of an email data object, or it could be something more specific, like typing a specific address. As part of the analysis of said object and its operation the software considers whether the specific text that comprises said object is significant in determining a relationship. At this point in the analysis, the software does not know, so all results of the analysis are considered.

Step 479: Has a query been presented to an object associated with said operation? The software checks to see if any object that has a relationship to said object or its operation (which can also be one or more objects) has received a query.

Step 480: The software analyzes said query.

Step 481: Is said query understood by the software? Based on the analysis of said query, the software determines if it matches known phrases, words, grammar and other criteria understood by the software. The software by some method, like matching the query to criteria understood by the software, tries to interpret the query. If said query is understood by the software, the process proceeds to the next step. If not, the process ends at step 488.

Step 482: As part of the analysis of said query the software determines if said query is limited to a specific type of relationship.

Step 483: Is the type of relationship cited in said query understood by the software? Let's say the query includes a limitation of a context relationship. The software would detect this and limit the query to objects that have a context relationship with said object and its operation. If the answer is “yes,” the process proceeds to step 484, if not, the process ends at step 488.

Step 484: The software refers to its analysis of said operation in step 477. The analysis of said operation is utilized by the software to determine if said operation provides an example of a specific relationship. Let's say the software finds a “context” relationship. The software further considers its analysis to determine to what level of detail said operation defines said context relationship. Referring to the example of the email application, typing a send email address can be considered by the software as a specific type of context.

Step 485: This step is really part of step 484. In order for the software to consider the typing of an email address as a specific type of a context, the operation of typing said email address would already be understood by the software.

Step 486: After a successful interpretation of the scope of said query, the software executes said query.

Step 487: As a result of said query, the email data object presents all objects that share a relationship to said object, where the scope of the relationship is defined by said operation and said query. If said relationship was a “context,” then the software would present all objects that share a context relationship with said object. In this case, said motion media that recorded the typing of any email address into said email data object would be found and presented.

Workflow Relationship

The software of this invention can learn from a user's workflow. Of particular value is the software's learning the order that a user performs a certain task or the types of data that a user requests under certain circumstances to enable performance of an operation or for the completion of some task. Workflow can be saved as motion media. Workflow motion media can be used to create Programming Action Objects that model the change saved in said workflow motion media. With knowledge of a workflow the software can present to the user the logical next one or more pieces of data that would likely be required by said user at any step in the user's performance of an operation or in the completion of some task.

Unlimited Relationships

Relationships are potentially as unlimited as the thoughts of users operating any one or more objects.

Placing Verbal Markers in a Video to Mark Video Frames to which User-Generated Content is Added.

A user can draw, type, or speak any word or phrase known to the software and then create a user-defined equivalent of the known word or phrase. For example, a user could speak the word: “marker,” a known word to the software. To the software, a marker is an object that can be placed anywhere in any environment operated by the software, where said marker object can receive an input from any source, and where said marker object can respond to said input by presenting an action, function, event, operation or the equivalent to said software environment or to any object in said software environment.

FIG. 72 illustrates the creation of a verbal marker in an environment.

Step 489: The software checks to see if an object has been selected. If “yes,” the process proceeds to step 490, if “no,” the process ends at step 493.

Step 490: The software checks to see if a spoken input has been received by the software. If “yes,” the process proceeds to step 491, if “no,” the process ends at step 493.

Step 491: The software checks to see if said spoken input is a known word or phrase, a known equivalent of a known word or phrase, or a known phrase that programs a new equivalent for an existing known word or phrase or equivalent of said existing known word or phrase. In the software of this invention, a single character, a word, phrase, sentence, or a document, are all objects. Accordingly, Step 491 could have read: “Is spoken input a known object or a known object that causes the creation of an equivalent for a known object?” An example of a known object could be the word “marker.” An example of a known equivalent could be any object that acts as an equivalent for the word “marker,” like “tab” or the character “M.” An example of a known object that programs an equivalent for a known object would be the equation: “marker equals snow.” The word “equals” is a programming word (object) and the word “snow” is the equivalent being programmed to equal the known word (object) “marker.” If said spoken input is recognized by the software, the process proceeds to step 492, if “no,” the process ends at step 493.

Step 492: The software adds said spoken input to the characteristics of said selected object as an equivalent of said selected object. At this point a verbal marker has been programmed and can be utilized in an environment operated by the software.

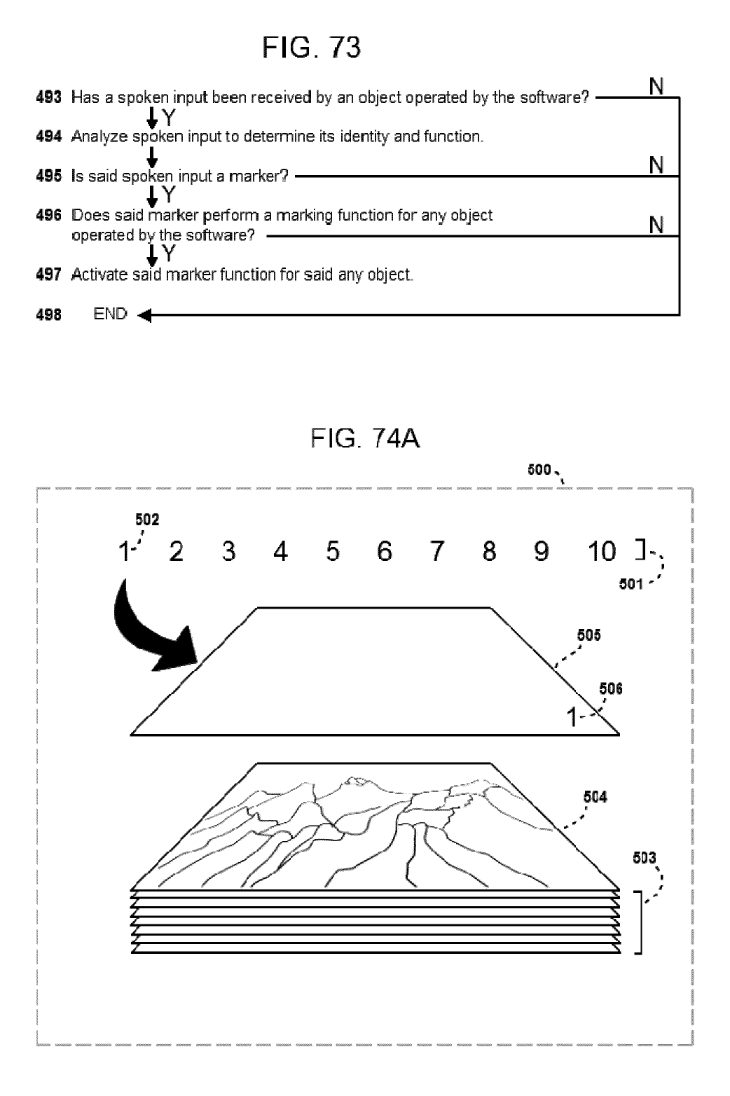

Referring to FIG. 73 this is a flowchart that illustrates the use of a verbal marker.

Step 493: The software checks to see if a spoken input has been received by an object operated by the software. “Operated by the software” means any object that is dependent upon the software for its existence. As a reminder, the environments of the software (including environment media) are themselves objects. If a spoken input has been received by an object of the software the process proceeds to step 494, if not, the process ends at step 498.

Step 494: The software analyzes said received spoken input to determine the characteristics of said spoken input, e.g., is said spoken input recognized by the software, and does said spoken input include an action, function, operation or the like that can be carried out by the software or by any object operated by the software?

Step 495: This is a part of step 494. The software checks to see if said spoken input is a marker. If said spoken input is determined to be a marker by the software, the process proceeds to step 496, if not, the process ends at step 498. [Note: The process described in this flowchart is looking for a marker, however the software could search for any function in this step of the flowchart.]

Step 496: The software checks to see if said marker performs a marking function for any object of the software. This would include any object in any environment media, any object that is part of any assignment to any object operated by the software, and any object that has a relationship to any object operated by the software. If “yes,” the process proceeds to step 497, if not, the process ends at step 498.

Step 497: The software activates said marker function for the object found by the software that contains said spoken marker as part of its characteristics, and/or has a primary or secondary relationship to said spoken marker.

As an example of the operations described in FIGS. 72 and 73, let's say a user is viewing a video. They stop the video on a frame. They create an equivalent for the function “marker.” This can be done by using a spoken object equation as follows: “marker equals name of equivalent.” Let's say that the video has mountains and glaciers in it. Let's say a desired spoken equivalent for the known word “marker” is “snow.” If that were the chosen equivalent for the known word “marker,” a spoken object equation could be: “marker equals snow.” If this equation were written or typed it could read: “marker=snow.”

[Note: an equivalent includes all characteristics of the object for which it is an equivalent. In the case of the equivalent “snow,” the characteristics of the object “snow” would be updated to include the functionality and other characteristics of the known object “marker.” Thus the object “snow” can function as an actual marker. As a software object the word “snow” can communicate to other objects in the software and maintain relationships with other objects in the software.]

Upon recognizing the object equation “marker equals snow,” the software creates “snow” as an equivalent for the function “marker.” Now a user can utilize the object “snow” as a spoken marker. Continuing with the present example, a user stops a video on the frame they wish to mark. The user touches the frame to select it, or designates an area of the image on said frame and touches it to select it. Then the user speaks the name of the marker equivalent “snow.” If the user selects the entire video frame, the software creates an environment media and syncs it to said frame. If a user defines a designated area of said frame, the software creates an environment media and an object that matches the characteristics of said designated area of said frame and syncs said object to said designated area of said frame. [Note: the environment media containing said marker could also be synced to said designated area.] If the user selects the entire said video frame, the software adds the marker “snow” to the characteristics of said environment media synced to said video frame. If the user defines a designated area of said frame, the software adds the marker “snow” to the characteristics of said object that matches the characteristics of said designated area of said frame and is synced to it.

Adding the object “snow” to the characteristics of an environment media and/or to an object in an environment media that is synced to a designated area of a video frame, establishes at least one relationship between the object “snow” and the video frame and/or designated area of said video frame. This is a primary relationship, since said environment media and/or said object in said environment media are synced to said video frame and/or said designated area of said video frame. There is another primary relationship between said object in said environment media and said designated area of said video frame. This is the result of said object in said environment media matching the characteristics of said designated area of said video frame.

The operation of a verbal marker is simple. When a video is streaming, paused or stopped on any frame or being played by any means, a user can speak [or type, write, or otherwise input] the object “snow.” The software recognizes the verbal input “snow” and locates said video to the frame that has a relationship with the marker object “snow.” Said relationship is to the environment media whose characteristics are updated to include the marker “snow” or to the object in said environment media whose characteristics are updated to include the marker “snow.” It should be noted that if said object, in sync with said designated area of said frame, is modified, the appearance of said designated area of said frame is modified accordingly, but this does not affect the operation of the marker “snow.”

Touch Transparency

Touch transparency is the ability to touch through a layer to an object on a layer below or even on a layer above. An example would be having a large letter on a layer in an environment media. Let's say the letter is 500 pixels high by 600 pixels wide. Let's further say that this letter is a “W” with a transparent background. In conventional software the letter's transparent background enables one to see through the background around the “W”, but not touch through it. So if one touches on the transparent area around the “W,” without touching on any part of the “W” itself, they can drag the “W” to a new location. In an environment media, a user can touch through anything that is transparent to something on a layer below. In conventional layout software, if another object existed below the “W,” but was completely inside the perimeter of the transparent bounding rectangle of the “W,” the touch could not activate the object below the “W.” Every attempt to do so would move the “W” and not the object directly below its transparent bounding rectangle. But by enabling the transparent bounding rectangle of the “W” to be touch transparent, one could simply touch what they see below the “W” and access it. This approach is applied to all transparency in environment media. If a user can see an object though a visually transparent layer, they can access it via a touch or equivalent. This approach enables multiple transparent environment media to be layered directly on top of each other where objects on any layer can be easily operated by a hand, pen, or any other touch method.

Changing the Order or Continuity of Video Frames with an Environment Media

Various prior figures and text have disclosed the utilization of one or more objects in an environment media to alter image data on one or more frames of video content. This section discusses the utilization of an environment media to edit the order and continuity of frames in video content. In one embodiment of the invention a user selects a video in any environment and presents a verbal command, e.g., “edit video.” As a result of this command the software builds an environment media and syncs it to said video. There are many delivery mechanisms for video to which an environment media can be synced, including: (1) streaming video from a server, and (2) downloaded video. Whatever the delivery mechanism, the software permits a user to control the playback of any video on any device via an environment media. In one embodiment of this idea, a video is presented on a computing device via a player, which could include, but not be limited to, any of the following players:
QuickTime, from Apple, plays files that end in .mov.
RealNetworks RealMedia plays .rm files.
Microsoft Windows Media can play a few streaming file types: Windows Media Audio (.wma), Windows Media Video (.wmv) and Advanced Streaming Format (.asf).
VideoLaN plays most codecs with no codec packs needed: MPEG-2, DivX, H.264, WebM, WMV and more.

The Adobe Flash player plays .fly files. It can also play .swf animation files. The method is straightforward. A user plays a video till they reach a place where they want to make an edit. Or they may scrub the video to reach a frame they wish to edit. For instance, to scrub a video, a user could touch on the environment media and drag a finger left or right. The speed of the drag is the speed of the scrub. As the drag slows the resolution of the frames increases to the point where individual frames are being presented. This type of control is common in the art. These playing and scrubbing functions are accomplished in an environment media synced to the video being edited.

As part of the editing process, a user can place markers in a video. Markers can be placed in a video by drawing, typing, via a context, via a verbal input, via a programmed operation, via any input from an object synced to image data on a video frame of said video, via any input from an object sharing a relationship with an object synced to image data on a video frame of said video, by a verbal utterance or any equivalent. Markers can be any object including: any text, picture, drawn line, graphic, environment media, a dimension, an action, a process, an operation, a function, a context, and the like. Regarding verbal markers, they can be any verbalization recognized by the software. For purposes of this example, we will use spoken numbers utilized as markers for individual video frames.

One method of placing marker objects in a video is as follows. A user locates a first frame to be edited in a video and labels it “1” and then locates a second frame and labels it “2” and so on. An example of the labeling process is: locate a frame, select it by touching it, or define a designated area of a frame's image data and select it by touching it. Then say: “marker equals one,” or type on said frame: “marker=1,” or draw on said frame: “marker=1”, or any equivalent. Note: in this example all marker inputs, including verbal commands, are accomplished with an environment media synced to a video. The software of this invention receives verbal inputs, analyzes them and responds to said inputs. In this example, as a user verbally marks each video frame with a spoken number, the software displays the spoken number in an environment media object synced to the video frame that is being marked by said number. Note: each marker number in this example is a software object.

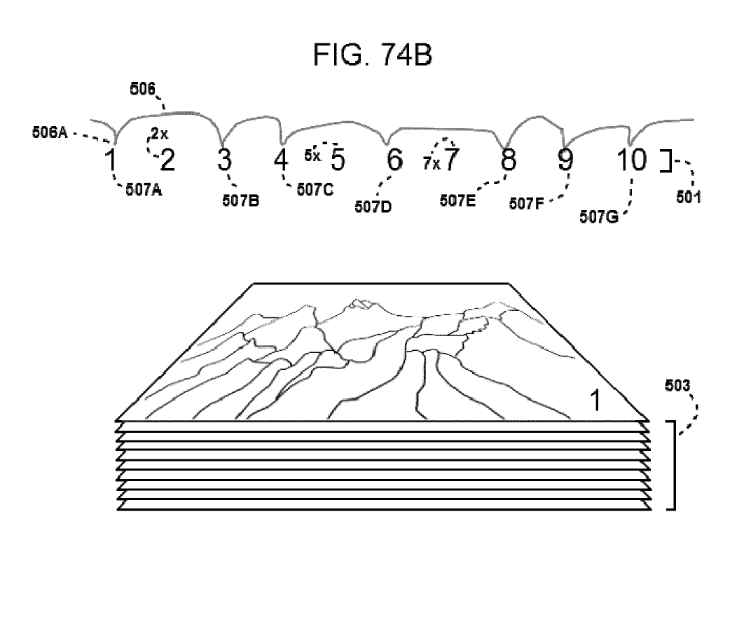

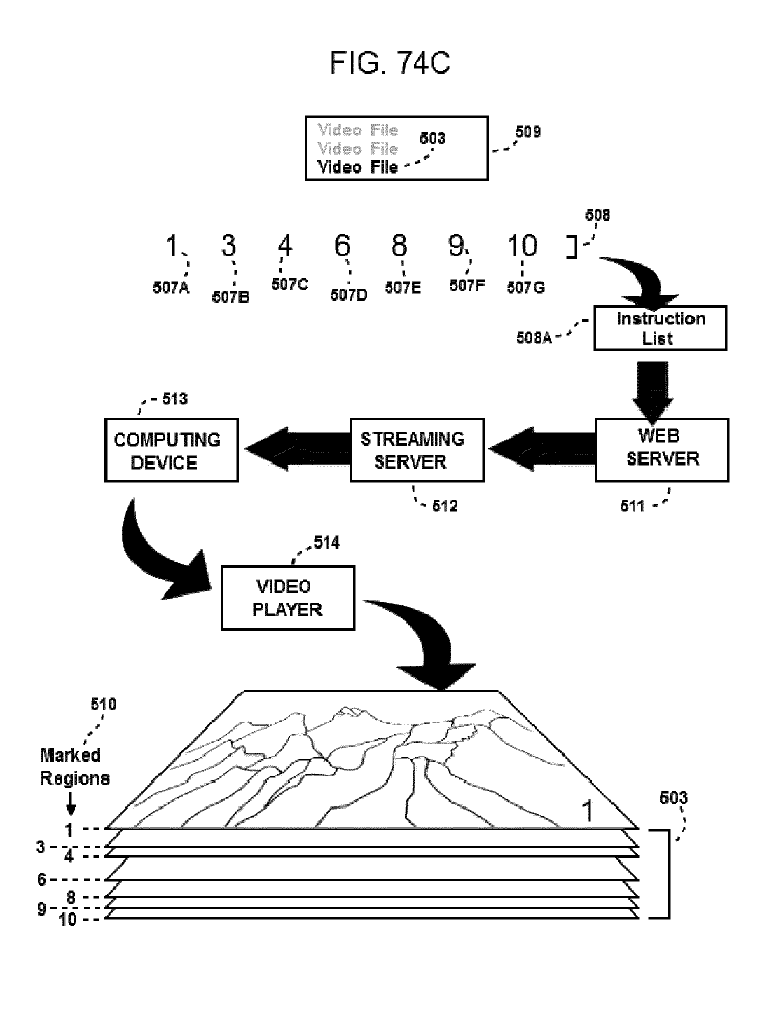

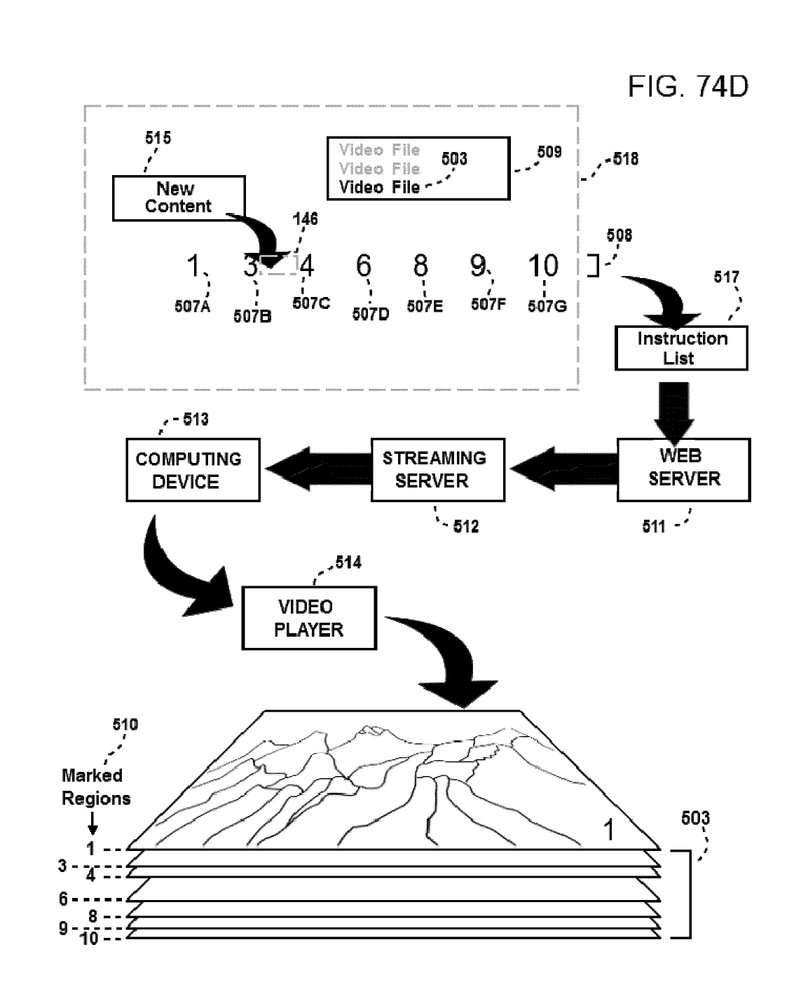

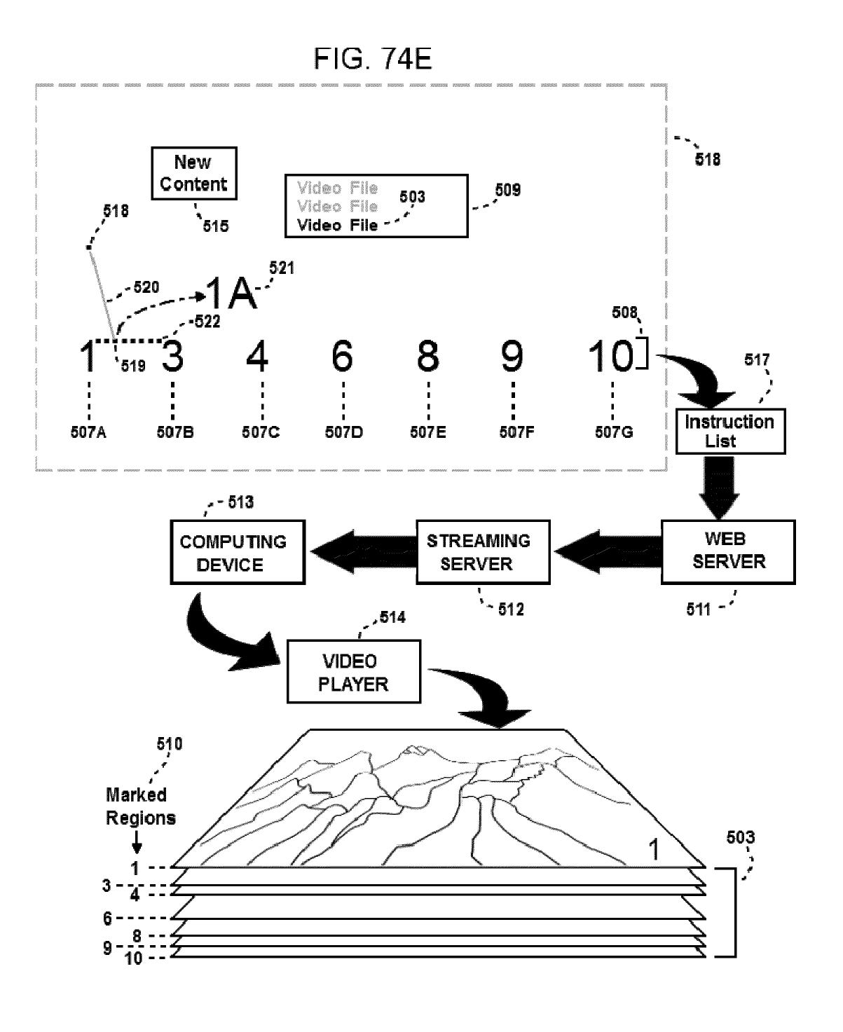

There are many ways to use markers to edit a video. One method is to draw a line. Referring to FIG. 74A, a series of markers 501, is presented in an environment media 500. Each marker is an object that is synced to the video frame that it marks. Using marker 1, 502, as an example, a video frame 504, marked by marker 1, 502, is recreated as an object 505, in an environment media 500. Said object 505, is synced to video frame 504. Further, the software saves the relationship between marker object 1, 502, and the video frame 504, that it marks, environment media object 505, and environment media 500. The software further saves the relationships between all markers 501, and all marked video frames that are recreated in environment media 500. These relationships support communication between markers 501, the recreated video frame objects that are synced to each marked frame and between any input and any marker.

A verbal marker can be used to locate a video to the specific frame marked by said verbal marker. For example, if video 503 is played and a verbal input “1” is spoken into a microphone and said verbal input is received by the software, verbal input “1” would be analyzed by the software to determine if the word “1” is a known word or an equivalent for a known word in the software. In this example, the software would discover that “1” is the equivalent for the known function “marker.” The software searches for a relationship between the object “1” and any object. The software finds a relationship between marker object “1”, 506, and environment media 500 and object 505. Marker object “1” has a primary relationship to object 505 and to environment media 500. The software analyzes the relationships of object 505 and environment media 500. The software discovers that object 505 is synced to frame 504 of video 503. Therefore, object “1”, 506, has a secondary relationship to video frame 504. As a result of the primary relationship between object “1” and object 505 and the secondary relationship between object “1” and video frame 504, the software locates video 503 to frame 504.

Marker objects can be used for other purposes beyond that of serving as auto locators for a video. Marker objects can analyze the characteristics of any object to which a marker has a relationship. Regarding video, marker objects can be used to gather information about the video frames they mark. A marker object can contain information and share the information it contains with other objects. For instance, let's say that an assignment of some data is made to a designated area of video frame 504. Marker “1” would contain knowledge of said assignment. Marker “1” could communicate said knowledge of said assignment to environment media 500, which could build objects in environment media 500 that recreate said assignment and said designated area of video frame 504. The objects in environment media 500 that recreate said assignment and said designated area of video frame 504, can communicate with object marker “1.” Object marker “1” could communicate its own characteristics, and the characteristics of any object with which it has a relationship, to an object in a second environment media. By this method, object marker “1” could share said designated area and said assignment to said designated area of video frame 504, by communicating the characteristics of the objects that recreate said designated area of object 504 and said assignment in environment media 504. The object receiving the communication of said characteristics from object marker “1” (“receiving object”) could communicate said characteristics to a second environment media that contains said receiving object. This would result in said second environment media creating objects that recreate said designated area and said assignment to said designated area in said second environment.

Referring now to FIG. 74A, a marker object 1, 502, has received a query for information about the frame in video 503 that it marks. As a result, the video frame 504, marked by marker 1, 502, is presented in environment media 500. In addition, the environment media object 505, synced to frame 504, is also presented. The presenting of environment media object 505 is valuable for many reasons. First, it enables a user to modify the image of video frame 504, by modifying environment media object 505, which was recreated by the software to match image data on video frame 504. Second, it enables a user to rename or otherwise change the marker 506, for frame 504. Third, it enables a user to assign any new data to frame 504 by assigning data to environment media object 505. Fourth, it enables a motion media to be created from any one or more modifications made to environment media object 505. The list could go on and on.

Referring now to FIG. 74B, a line 506, is drawn to select various markers 501, in order to edit video 503. We call this process digital “stitching.” The software recognizes each drawn point, e.g., 506A, in line 506, that impinge markers, 507A, 507B, 507C, 507D, 507E, 507F, and 507G. Said each drawn point in line 506 defines an edit region of video 503. Each edit region includes the video frames that exist between two stitched markers. For instance, let's say that marker 1, 507A, marks frame 10 in video 503 and that marker 2, 2x, marks frame 300 in video 503. The region of video 503 associated with marker 1, 507A, extends from frame 10 to frame 300. This region equals 290 frames. If the frame rate of video 503 is 30 fps, then the region belonging to marker 1, 507A, equals 9.666 seconds. To edit a video by the drawing of a line, said line is drawn to connect, via stitching, only the markers that represent regions which are desired to be edited together. Unconnected “(unstitched”) regions are then automatically removed from consideration by the software, but they are not deleted from the environment media that contains them. In FIG. 74B the region from marker 2, 2x, to marker 3, 507B, is removed from consideration. Other regions removed from consideration include the region from marker 5, 5x, to marker 6, 507D, and the region from marker 7, 7x, to marker 8, 507E. The result of the stitched line 506, illustrated in FIG. 74B, is shown in FIG. 74C. Here a composite object 508, comprised of each “stitched” (selected) marker region is presented by the software. The composite object 508, is used to edit video 503, which is marked by markers 1, 3, 4, 5, 8, 9, and 10 (507A to 507G respectively). The editing is accomplished without editing video 503. There are various methods to accomplish this. One method is to control the order of the flow of video data to a user's computing device which is playing the video being edited via an environment media. Said computing device can include: any smart phone, pad, laptop, desktop, cloud device or any equivalent. To better describe this method, a quick summary of how a video is currently streamed to a user's computing device, as is common in the art, is presented below.
(a) Via a web browser, a user finds a site that features streaming video.
(b) On a web page of said site said user locates a video file they want to access.
(c) Said user selects an image, link or embedded player on said site that delivers said video file.
(d) The web server hosting said web page requests the selected video file from the streaming server.
(e) The software on the streaming server breaks said video file into pieces and sends them to said users computing device utilizing real-time protocols.
(f) The browser plugin, standalone player or Flash application on said user's computing device decodes and displays the video data as it arrives from the streaming server.
(g) The user's computing device discards the data after being displayed on said user's computer device by said plugin, player or Flash application, or any equivalent.

Referring to item (a) in the list above, said web browser content contains an environment media object created by the software of this invention. Referring to item (b) said web page is presented as an object in said environment media object. Referring to item (c) and to FIG. 74C, said user selects a video file 503, on said environment media object web page 509. Referring to item (d) and to FIG. 74C, composite object 508, sends a list of instructions 508A, to the web server 511, hosting said environment object web page 509. Web server 511, requests the sections of video 503 that match the edit regions defined by composite object 508, from the streaming server 512. Referring to item (e) and again to FIG. 74C, based on said list of instructions from web server 511, streaming server 512, breaks video file 503, into pieces that correspond to the edit regions defined by said composite object 508, and sends them to said user's computing device using real-time protocols, and buffers said edit regions of said video as necessary to maintain a consistent stream of video content. Regarding item (f), sections of video 503 are played by a video player 514. Regarding item (g) the user's computing device discards streamed data after being displayed on said user's computing device by video player 514. However the collection of markers 501, [shown in FIG. 74A] and composite object 508 [shown in FIG. 74C] are not discarded by the software. These elements comprise relationships that are stored by the software for environment media 500, for each environment media object in sync with each video frame marked by said markers in collection 501, for each marker object, 507A to 507G, and for composite object 508.

By the above described method a user can edit any video without editing the original video content. This method enables endless editing of any original video without any destructive editing of said original video. Further at any time in the editing of a video by the method described in FIGS. 74A, 74B, and 74C any data can be added to any portion (e.g., any designated area) of any video frame. Thus the user is not limited in their utilization of original video content. As part of this editing process, original video content can be utilized for a wide variety of purposes, which include but are not limited to: (1) the creation of new user-generated content (like mash ups or composite collections), (2) the utilization of any number of video frames as storage devices to store user-generated or other data, (3) modifying any video frame or any designated area of any video frame to enable interactive objects assigned to any frame or any designated area of any frame to present advertising data or any other desired data, and (4) recreating any image that persists through a series of frames in any video as one or more objects in a standalone environment media, which can be used as standalone content, and so on.

The management of the video editing process via any environment media is performed by the software. The software receives user's instructions, e.g., via a stitched line, via verbal input, gestural means, context means, via a motion media, via a Programming Action Object or the like. The software uses said instructions to locate a video player to the position of a marker, and play the video from said position to the end of said marker's region. The software then locates said video to a next marker position and plays said video from there, and so on. This is performed in a seamless manner such that said video appears to have been edited. But in reality said video hasn't been changed in any way. By this method, and many possible variations of said method, the software of this invention controls the process of playing a video on any device such that said video is edited.

Now a word about the word “layer.” The software syncs an environment media, and/or objects in an environment media, to a video, and/or to frames of said video, and/or to designated areas of frames of said video. Said video is viewed “through” said environment media and/or objects in said environment media. This produces a visual experience, whereby changes to an environment media, and/or changes to said objects in an environment media, synced to any video, modify said video. [Note: an environment media does not have to be positioned over a video frame to match the objects in said environment media to the video frame images from which said objects were derived. The software produces this matching in memory.]

One method to accomplish this is that the software analyzes a first frame of video to determine if any environment media objects are synced to said frame. If the software finds environment media objects synced to said first frame of video, the software copies the frame image data for said first frame and said environment media objects synced to said first frame into memory. The image data of said first frame and said environment media objects synced to said first frame are presented together as said video, e.g., as part of the playback of said video or as a still frame of said video.

When said first video frame is replaced by another frame by any means (e.g, via a playback, scrub, or locate action), the data saved for said first frame is flushed from memory and a second video frame image data and the environment media object(s) synced to said second video frame image data are moved to memory. When said second video frame is replaced by another frame by any means, the data saved for said second frame is flushed from memory and a third video frame image data and the environment media object(s) synced to said second video frame image data are moved to memory, and so on.

Based on frame rates and the speed of video playback, the software caches video frame image data and objects synced to said video frame image data from an environment media, as needed to maintain sync between said video frame image data and said objects in said environment media. By this means the software looks ahead and preloads video frame image content and software objects synced to said video image content as needed. As an alternate or additional process, a certain number of frames and the environment media objects synced to a certain number of frames can be kept in memory after being displayed. This would supply a buffer that could enable the immediate or fast playback of a video in reverse and maintain sync between video image data and objects in an environment media synced to said video image data

Adding Content to an Edited Video Via an Environment Media Referring to FIG. 74D new content 515, has been dragged to impinge the space between marker 3, 507B, and marker 4, 507C, in composite object 508. Note: each space between marker objects 507A, 507B, 507C, 507D, 507E, 507F, and 507G is an object. New content object 515 is moved to impinge object 516. As a result new content 515 is inserted into composite object 508, and new content object 515 is added to the characteristics of composite object 508. [Note: upon the impingement of object 516 with object 515, the software may present a message, e.g., a visual or audible message, requesting a confirmation of the insertion action. Upon receiving said confirmation, the software finalizes said insertion. As an alternate, the impinging of object 516 with object 515 could produce an automatic insertion action, not requiring any confirmation or any equivalent.] As a result of said insertion, the software updates instruction list 517, with new content 515.

In this example, said insertion is occurring in the edit region defined by marker 3, 507B, and marker 4, 507C. Said edit region extends from the point in time marked by marker 3, 507B, and ends at the point in time marked by marker 4, 507C. We will refer to this region as the “marker 3 edit region” or the “edit region of marker 3.” The exact time location of said insertion of new content 515 in the marker 3 edit region can be determined by many methods. In a first method, object 516, represents the maker 3 edit region. The location of the impingement of object 516 by object 515 is converted to a percentage of the total length of object 516, in environment media 518. Said distance is converted to a percentage of the total frames contained in the region marked by marker 3, 507B. For instance, let's say the edit region for marker 3, 507B, equals 10 seconds and the distance between marker 3, 507B, and marker 4, 507C, is 200 pixels, and the impingement of object 516 by new content 515 is 50 pixels from the leftmost edge of object 516. As a result of said impingement, new content 515 is inserted 2.5 seconds after the start of the region for marker 3. Assuming that the frame rate for the video marked by the markers contained in composite object 508 is 30 fps, new content 515, is inserted 75 frames after the start of the region marked by marker 3, 507B. The method just described enables a user to directly manipulate visual objects in an environment media to modify the editing process of video content.

Referring to FIG. 74E, in a second method of determining the exact location of said insertion in the marker 3 edit region a line 520, is drawn from a pixel-size object 518, which has a relationship to new content object 515. For the purposes of this example we shall say that said relationship between object 518 and new content 515 is an assignment, namely, new content 515 is assigned to object 518. Pixel-size object 519 has a specific time location along a length of time, 522, that comprises the edit region of marker 3, 507A. The time location of object 149 can be determined by many methods: (a) selecting a frame within the edit region of marker 3, 507A, and designating said frame to be the location of object 519, (b) an input is made to object 519 that states what its time location is within the edit region of marker 3, (c) an automatic calculation is performed in software to determine a frame in video 503 to which object 519 is synced. There are a wide variety of mathematical calculations that can be used to accomplish method (c). For instance, the number of pixel-size objects between the right most pixel comprising the “1” object, 507A, and the left most pixel comprising the “3” object, 507B, could represent the length 522, of the marker 3 edit region. Let's say that said length equals the end-to-end length of 1000 pixels. Considering the left-most pixel as pixel number 1, let's further say that object 519 is pixel number 400. Let's also say that the length of marker 3 edit region is 300 frames. Therefore, (0.4 times 300 frames)=frame 120. Therefore, object 519 equals the location of frame 120 of video 503. Frame 120 occurs 4 seconds after the point in time marked by marker 3, 507B.

Upon the impingement of object 519 with line 520, object 518 is added to the characteristics of pixel-size object 519 in environment media 518. [Note: upon the impingement of object 519 with line 520, the software may automatically assign object 518 to object 519. As an alternate the software could create a relationship between object 518 and object 519 without enacting an assignment of object 518 to object 519. Said relationship enables object 518 to communicate with object 519. In addition, the software may require an input to verify any action taken by the software as a result of said impingement of object 519 by object 518. In this case, upon receiving said verification input, the software would enact the action is provided for via said verification input.] How is object 515 added to the characteristics of object 519? According to one method, object 518, which can freely communicate with object 515, communicates the content of object 515 to object 519. In this case, the content of object 515 becomes part of the characteristics of object 519. As a result of said communication of said content of object 515 to object 519, the following actions occur:
(a) Object 519 sends a message to composite object 508 to create an instruction to stop the playback of video 503, at the point in time in the edit region of marker 3, 507B, represented by object 519.
(b) Object 519 creates a new marker object “1A,” 521, that equals the position of object 519 in the edit region of marker 3.
(c) Object 519 syncs said new marker object “1A” 521, to the frame in video 503 that represents the frame marked by marker object 1A, 521. In this example, said frame in video 503 is the 120^{th} frame past the frame marked by marker 3, 507B, in video 503.
(d) Object 519 sends a message to composite object 508 to add new marker 1A to the list of markers contained in composite object 508.
(e) Object 519 sends a message to composite object 508 to create an instruction to present new content 515 from the position of marker 1A, when the frame marked by marker 1A, is presented during the playing of video 503.
(f) Object 519 sends a message to composite object 508 to create an instruction to continue the playback of video 503 in the edit region of marker 3 at “X time” after the conclusion of the presenting of new content 515. The determination of “X time” can be according to a default (e.g., 1 frame), or according to a context (since 30 fps is the frame rate for video 503, said 30 fps could act as a context that defines a time, like 1/30^{th} of a second), or “X time” could be determined according to an input which must be received before the commencing of the playback of video 503, or according to any other suitable method common in the art or described herein.

As a result of the communications from object 519, composite object sends an updated instruction list 517, to a web server 511, which sends requests defined by said instruction list 517 to a streaming server 512, which breaks video 503 into sections that comply with said instruction list 517, and sends them to a computing device which utilizes a video player 514 to play video 503 according to the edit regions defined by composite object 138 508.

Thus far this disclosure has been directed towards syncing environment media to existing content. Now this disclosure will be directed towards standalone environment media, which are derived from any of the following: existing content, user operations applied to existing programs and apps operating as installed software on a computing device, or as cloud-based services.

Open Objects in an Environment Media

An “open object” is an object that has generic characteristics, which may include: size, transparency, the ability to communicate, the ability to respond to input, the ability to analyze data, ability to maintain a relationship, the ability to create a relationship, ability to recognize a layer, and the like. An open object generally does not contain an assignment, any unique characteristic not shared by other open objects, saved history, a motion media, a programming action object, an environment media object, or anything that would distinguish one open object from other open objects. Open objects can be programmed via a communication, input, relationship, context, pre-determined software operation or action, a programming action object, or any other cause that can be applied to an object operated by the software.

Programming an Environment Media Via User Operations

As disclosed herein, EM software can be used to modify existing content via EM objects that recreate said existing content in whole or in part in or as environment media. The next section is a discussion of user operations being used to program EM objects. The first part in this section describes the process of employing user actions supported by EM software to program EM objects in an environment media. The second part of this section is a discussion of EM objects that are programmed by a user's operation of any non EM software program, app, or the equivalent, via a method we call “visualization.” The following steps summarize the process of employing user actions in an EM software environment to program EM objects in an environment media
(a) EM software records a user's operations of EM software as a motion media.
(b) EM software converts said motion media into a programming tool, e.g., a programming action object, using a task model analysis, relationship analysis or any other suitable analysis.
(c) Said programming tool is utilized to program the characteristics of objects in an environment media.
(d) Said objects in said environment media can be individually or collectively operated by user input and other input as described herein.
(e) Said objects in said environment media constitute a new type of dynamic content, which is comprised of one or more EM objects whose characteristics are dynamically modifiable, such that said EM objects can become any content. According to one method of sharing said any content, a first EM object in a first environment media delivers one or more messages that are received by a second EM object in a second environment media. Said messages include the characteristics and/or change to said characteristics of said one or more EM objects in said first environment media which comprise a content (e.g., “shared content 1”). Said second EM object utilizes said messages to program itself and communicates said messages to other EM objects in said second environment media to program said other EM objects to recreate “shared content 1” in said second environment media. The EM objects in said first environment media are not copied or sent to said second environment media. “Shared content 1” is transferred from one environment media to another by the sharing of messages between EM objects or between environment media objects.

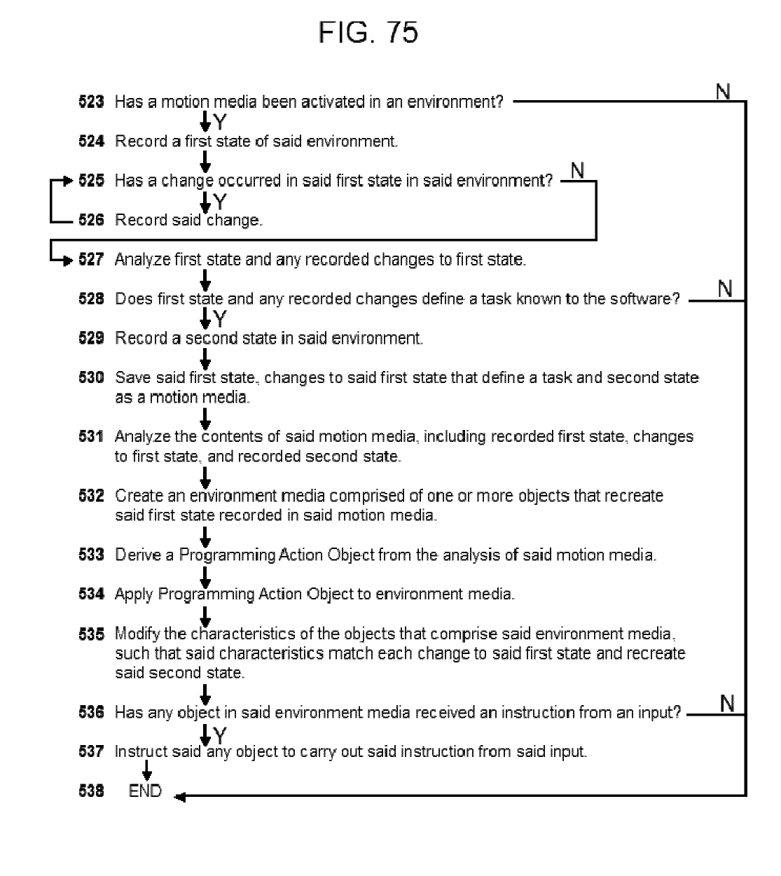

Referring to FIG. 75 this is a flow chart illustrating the utilization of a motion media to program an environment media to recreate a task in an EM software environment.

Step 523: The software checks to confirm that a motion media has been activated in an EM software environment.

Step 524: Said motion media records a first state of said environment. Said first state includes all image data (and any functional data) that comprises said environment.

Step 525: The software checks to see if a change has occurred in said first state recorded by said motion media. If “yes,” the process proceeds to step 526.

Step 526: The software records said change as part of said motion media. Steps 525 and 526 comprise an iterative process. As each new change is found in step 525, said new change is recorded in said motion media in step 156 526. When no new changes are found by the software the process proceeds to step 527. If no changes are found by the software in step 525, the process proceeds directly to step 527.

Step 527: The software analyzes the first state recorded by said motion media. The software further analyzes any change to said first state. This analysis includes an analysis of any change to any relationship associated with any element in said first state. Relationships are important here. An understanding of relationships and changes to relationships helps the software to determine change that defines a task.

Step 528: Based on the analysis in step 157 527, the software determines if said first state defines a task. If not, the software analyzes said change found via the iterative steps 525 and 526. If a task is found, the process proceeds to step 529. If no task can be determined from the analysis in step 527, the process ends at step 538.

[Note: a first state can define a task. For example, a first state could include an ongoing process of some kind, which would likely define a task. A first state in an environment media can be a fully dynamic set of relationships between EM objects and other objects, e.g., other environment media. Thus a first state could define more than one task and include change as a natural occurrence in said first state. Input (e.g., via a user, context, time and other factors) can cause further change to said dynamic set of relationships in said first state. Said further change can be analyzed by the software and used to determine additional tasks, tasks of layered complexity or the equivalent.]

Step 529: The software records the state of said environment directly following the last recorded change to said first state. There are different ways to consider states saved by a motion media. In the flow chart of FIG. 75, all found change to said environment is being considered a change to said first state over time. Another way of considering change to an environment could be that each found change produces a new state which could be recorded by a motion media as a new object. In this case, all change to an environment would be saved as a progression of state objects, rather than as a series of changes to a first state.

Step 530: The software saves said motion media. Said motion media's contents include: said first state of said environment, all found changes to said first state that define a task, a task definition, and said second state. As part of the saving process, said motion media is given an object identifier. This could be a name presented by a user via an input to the software or an automatic number and/or character sequence determined by the software. [Note: If multiple tasks are found, each task and the set of change defining said task are saved as either objects contained within one motion media or as separate motion media.]

Step 531: The software analyzes the contents of said motion media.

Step 532: The software creates an environment media that is comprised of one or more objects that recreate the first state recorded in said motion media. Said environment media could include any number of objects. For example, said environment media could include a separate object that recreates and matches each pixel presented on a device displaying a first state. For example for a smart phone with a 480×320 resolution, there would be 153, 600 pixels. Each of these pixels could be recreated by a separate EM object in an environment media. The decision as to how many objects comprise said environment media can be according to any method disclosed herein or known in the art.

Step 533: The software derives a Programming Action Object from the software's analysis of the states and change of said motion media.

Step 534: The software applies said Programming Action Object to said environment media and/or to the objects that comprise said environment media.

Step 535: There are multiple approaches to modifying objects in an environment media via a Programming Action Object. In a first method, the software modifies the characteristics of each of said object in said environment media according to each change in said motion media created in step 532. In a second method, said Programming Action Object, derives a model of change from said motion media and applies said model of change to said EM objects in said environment media.

Step 536: This step involves the operation of said environment media, programmed by said Programming Action Object in step 535. The software queries said EM objects in said environment media to determine if any EM object has received an input that contains an instruction. If the answer is “yes,” the process proceeds to step 537, if not, the process ends at step 538.

Step 537: The software executes said instruction for said any EM object in said environment media that received said input.

Visualization

This next section contains a discussion of a method whereby EM objects are programmed by a user's operation of any program or app operated on any device running on any operating system, or as a cloud service, or any equivalent. Said method shall be referred to as: “visualization.” According to this method, the software of this invention records one or more states of any program, operated in any computing device or system, and/or changes made to said one or more states (e.g., via user input) as visual image data (and if applicable, functional data). Said image data and associated functional data, if any, shall be referred to as “visualizations.” Visualizations can be analyzed by many means, including: being directly analyzed by the software, recorded as a motion media and then analyzed, subjected to comparative analysis, e.g., being compared to known visualizations in a data base or the equivalent. A visualization can equal a portion of the image data of any visualization, thus multiple visualizations can be derived from a single visualization and analyzed as composite or separate visualizations. At any point after a visualization has been recorded, the software can analyze said visualization to determine its characteristics. Visualization characteristics can include, but are not limited to: color, hue, contrast, shape, transparency, position, the recognition of segments of recorded image data as definable objects, any relationship between segments of recorded image data and other image data segments and/or functional data represented by said image data or associated in any way with said image data. In an exemplary embodiment of the invention, the software compares the results of the analysis of a recorded visualization to image data saved in a data base of known visualizations. Each of said known visualizations in said data base contains or is associated with one or more operations, functions, processes, procedures, methods or the equivalent, (“visualization actions”) that are called forth, enacted or otherwise carried out by said known visualizations. Thus, by comparing a recorded visualization, which was recorded in any environment, including environments not produced by the software of this invention, to known visualizations in a data base, the software of this invention can determine one or more “visualization actions” associated with said recorded visualization. As a result of a successful comparative analysis of any recorded visualization, the software can create a set of data and/or a model of the characteristics and change to said characteristics of said any recorded visualization as a motion media or other software element. A Programming Action Object can be derived from said motion media and utilized to program one or more EM objects to recreate the visualization actions (and/or image data) for any recorded visualization as an environment media.

Regarding said known data base of visualizations, said data base is a collection of image data, where each image data in said data base is associated with one or more “visualization actions” that can be carried out by EM software or by other software. One might think of this database as a sophisticated dictionary of digital images, where each, known visualization in said data base includes one or more “visualization actions” that can be invoked, called forth, presented, activated, carried out (or any equivalent) by said known visualization. Said data base can be generated by many means, including: via programmer input, via analysis of user actions, via reverse modeling, via interpretive analysis, and any other suitable method. By achieving a match of a recorded visualization to a known visualization in said data base, the software can acquire an understanding of how to program EM objects to recreate one or more “visualization actions” associated with said known visualization, matched to said recorded visualization.

The following is an example of user operations which can be utilized to program one or more EM objects such that said one or more EM objects recreate the results of said user operations in software that is not EM software. A user launches a word processor program on a computing device and recalls a text document to said word processor program which is displayed on said computing device in a word processing program environment. Said user changes the indent setting for said document in said word processing program environment. As a result of these user actions, the following is carried out by EM software (also referred to as “the software”).

One, the software records the displayed text document in the word processor program environment as a first recorded visualization.

Two, the software records any change to said first recorded visualization resulting from user input. Many methods can be employed to accomplish this task. In a first method, each said any change to said recorded first visualization is recorded as an additional visualization. The recording of said additional visualization could be via many methods. In one method, the software records an additional visualization each time it detects an input to said computing device. Said input could include: a finger touch, a verbal command, a pen touch, a gesture, a thought emanation, a mouse click or any other input recognizable by a computing system. With this first method, there is no guarantee that each, additional visualization represents a change to said first recorded visualization. Each new input may not cause a change to said first recorded visualization. However, by this method the software would be able to record all additional visualizations that collectively represent all change to said first recorded visualization, even if some of said additional visualizations don't represent change. In a second method, the software compares each, additional visualization to said first recorded visualization. If no change is found, said each, additional visualization is not recorded. If a change is found, an additional visualization is recorded according to various methods, including: (a) as a separate additional visualization, or (b) as a model of change to the data of said recorded first visualization. In the case of method (b), the software can create a motion media where said first recorded visualization is the first state of said motion media and said each change is a modification to said first state of said recorded visualization. In this method, the software analyzes said first recorded visualization and compares it to a second visualization to determine any change to the data of said first recorded visualization in said second visualization. This process is carried out for a third visualization recorded by the software and for a fourth visualization recorded by the software, and so on. It should be noted that in this example all visualization data recorded by the software is image data, unless the software can apply a functionality to a recorded visualization without requiring a comparative analysis to known visualizations in a data base. To accomplish the methods described above, EM software does not need to be aware of the operation of said word processing program, or of the operating system on which said device is operating, or the programming language used to write said word processing program. EM software gathers image data, and applies functionality to said image data, via an analysis of recorded visualizations' characteristics, and/or via comparative analysis to known visualizations in a data base, or any equivalent.

Three, the software performs a comparative analysis of said first recorded visualization, and said additional visualizations, to known visualizations in a data base. As an alternate, the software performs an analysis of said first recorded visualization and any model of change to said first recorded visualization.

Four, the software searches for one or more known visualizations in said data base that match or nearly match said first recorded visualization and said additional visualizations. As an alternate, the software searches for one or more known visualizations in said data base that match or nearly match said first recorded visualization and said models of change to said first recorded visualization. A known visualization in said data base that is matched to a recorded visualization shall be referred to as a “matched visualization.” A matched visualization contains at least one “visualization action.”

Five, the software analyzes each “visualization action” for each, matched visualization in said data base. The software associates each found “visualization action,” contained by a found, known visualization matched to a recorded visualization, to said recorded visualization.

As an example of this process, consider the following. A word processing program has been launched on a device with a display. On said display is an array of word processing tools, including menus, task bars, rulers, and the like, that comprise said word processing program. In addition, a text document consisting of multiple paragraphs is presented in said word processing program on said display. All visual elements that comprise said word processing program on said display, including the arrangement of menus, task bars, rulers and the like, and the presence of said text document in said word processor are recorded by the software as a first recorded visualization. In this example we will refer to this first recorded visualization as, “Word processor state A.” Next a user alters the indent spacing for paragraph 3 in said text document in said processor program on said display of said device. This alteration of the indent spacing for paragraph 3 comprises a change to said “Word processor state A.” Said alteration of the indent spacing shall be referred to as, “Indent alteration A.” As previously discussed, a change to a first recorded visualization can be saved according to many methods. According to a first method, “Indent alteration A” is recorded as an additional visualization. According to a second method, “Indent alteration B” is recorded as a model of change applied to said first recorded visualization “Word processor state A.” Let's assume the software saves “Indent alteration B” as a model of change.

Let's further say that the software of this invention does not understand the operating system, the programming language used to create said word processing program, or the specific software protocol that enables said indent spacing to be altered in said word processing program. This is not a problem. Through comparative analysis, EM software can determine one or more “visualization actions” that are represented, invoked, called forth, or caused to be carried out by said first recorded visualization “Word processor state A” and said model of change “Indent alteration B.” The software compares said first recorded visualization to known visualizations in a data base. In said data base the software finds a matched visualization for said first recorded visualization “Word processor state A,” and another matched visualization for said model of change “Indent alteration A.” Each, known visualization that is part of a matched visualization includes at least one “visualization action.” Through an analysis of the “visualization action” associated with the matched visualization for “Word processor A,” and the “visualization action” associated with the matched visualization for “Indent alteration A,” the software acquires an understanding of how to program EM objects to recreate the “visualization action” associated with “Word processor A” and “Indent alteration A” in an environment media.

[Note: In addition to programing EM objects to recreate the “visualization actions” of said matched visualizations to “Word processor A” and “Indent alteration A,” EM software can program EM objects to recreate the image data of “Word processor state A” and “Indent alteration A.” The recreation of all or part of said image data can be determined by a user input, software programmed input, context, relationship, programming action object and many other elements.]

Six, information gathered from the analysis of image data and from comparative analysis, including the discovery and analysis of “visualization actions” and models of change, are saved as at least one Programming Action Object.

Seven, said at least one Programming Action Object is used to program EM objects, (such as open EM objects) in at least one environment media, such that said EM objects recreate said “visualization actions” of matched visualizations. Further, if desired, said at least one Programming Action Object is used to program EM objects to recreate all or part of said image data of said recorded first EM visualization and any recorded additional visualizations.

In summary, using the above method, a user operates any program, app or equivalent. The software records the state of said any program or app as a first visualization, and any user operation of said program or app as one or more additional visualizations. The software performs comparative analysis to determine one or more “visualization actions” associated with one or more recorded visualizations. The software directly utilizes said analysis to program one or more EM objects to recreate said “visualization actions” and, if desired, the image data of said recorded visualizations. As an alternate, the software utilizes said analysis to create a motion media and/or a programming action object, which is utilized to program one or more EM objects to recreate said “visualization actions” and, if desired, the image data of said recorded visualizations.

Further a user can simply their operation of any app or program by only operating portions of said app and program that said user wishes include in an object recreation of said app and program, and saving their operations as one or more visualizations. As the software analyzes the visualizations that record said user's operations, the software will recreate only the parts of said any app or program that are defined by said user's operations. Thus the processes of an existing app or program can be simplified by a user only operating what they need and recording said operations as visualizations.

Interoperability

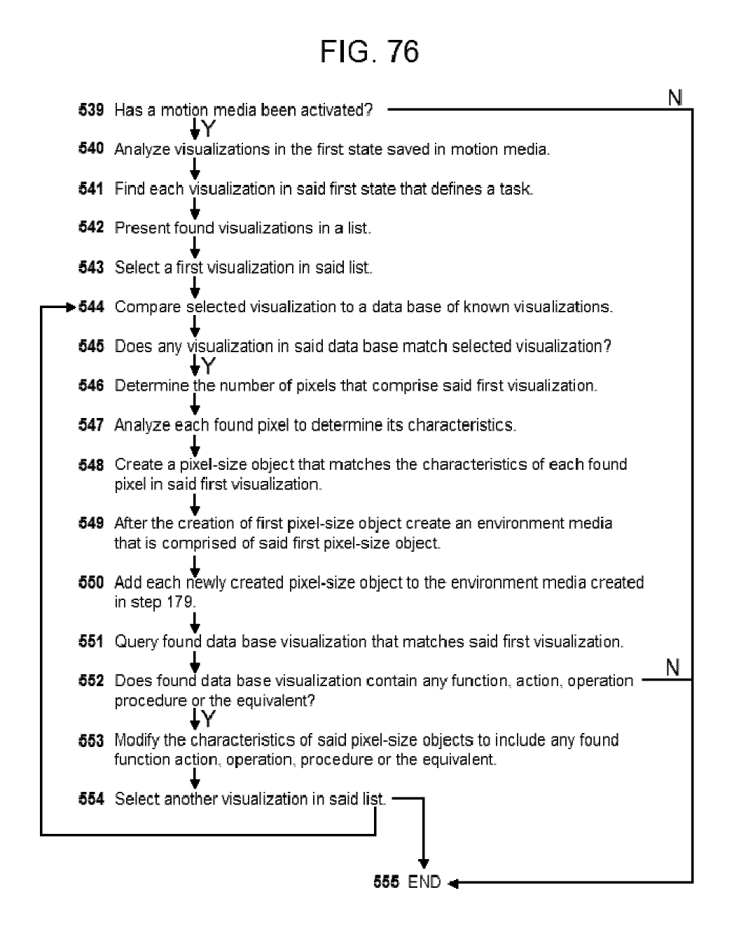

Referring now to FIG. 76, this is a flow chart illustrating the utilization and analysis of one or more visualizations, saved as a motion media, to program objects in an environment media.

Step 539: The software verifies that a motion media has been activated. For the purposes of this example, let's say that a motion media has recorded the state of a word processing program.

Step 540: The software analyzes visualizations in the first state saved in said motion media.

Step 541: The analysis of step 540 is utilized to determine visualizations in said first state that define a task.

Step 542: Each, visualization that is found by this process is saved in memory as a list. Said list could be backed up on a permanent storage device, e.g., to a cloud storage, local storage or any other viable storage medium.

Step 543: The software selects a first visualization in said list.

Step 544: The software compares said first visualization to a data base of known visualizations.

Step 545: The software determines if any visualization in said data base matches selected first visualization in said list.

Step 546: The software determines the number of base elements that comprise said first visualization. Assuming that the program or content (from which said motion media of step 539 was recorded) is presented via a display, the software analyzes each pixel of the visual content of said first visualization. If said program or content were presented via some other display means, e.g., a hologram, 3D projection, the software would analyze each of the smallest elements of said display means, unless this is not practical. In that case, the software would analyze larger elements of said display means. For the purposes of the example of FIG. 76, said motion media has recorded visualizations presented on a display utilizing pixels.

Step 547: The characteristics of each pixel, comprising said first visualization are analyzed by said software. The results are saved to memory.

Step 548: For each pixel analyzed in said first visualization, the software creates one EM object. For example, the software determines the characteristics of said first pixel in said first visualization (“first pixel characteristics”). The software creates a first open object and updates its characteristics to include said first pixel's characteristics. This process is repeated for each pixel found in said first visualization. In the flow chart of FIG. 76 this is accomplished via an iterative process from step 544 to step 554 for each found pixel in said first visualization. [Note: as an alternate method, the software does not need to analyze each pixel of said first visualization to determine any function action, operation, procedure or the equivalent or said first visualization. Groups of pixels, including the entire first visualization of said first state could be analyzed by the software and then matched to a known visualization in a data base.] For maximum accuracy and flexibility, providing for the characteristics of each pixel in a visualization to be recreated by a different pixel-size EM object is valuable.

Step 549: Upon the creation of the first EM object in step 548 an environment media is created by the software. At this point in time, said environment media is comprised of one EM object. As more EM objects are created in step 548 they are added to said environment media. For example, if said first visualization included 8000 pixels, 8000 pixel-size EM objects could be created by the software in step 548. The first of said 8000 pixel-size EM objects would match the characteristics of the first pixel in said first visualization. The second of said 8000 pixel-size EM objects would match the characteristics of the second pixel in said first visualization and so on.

Step 550: As each new EM object is created by the software, it is added to the environment media created in step 549.

Step 551: The software queries the known visualization found in said data base that matches or most closely matches the characteristics of said selected first visualization. Said known visualization shall be referred to as “first matched visualization.”

Step 552: The software determines if said first matched visualization contains any function, action, operation, procedure or the equivalent. If “yes,” the process proceeds to step 553. If “no” the process ends at step 185.

Step 553: The software modifies the characteristics of said pixel-size EM objects created in step 548 to include any function, action, operation, procedure or the equivalent found in said first matched visualization in said data base.

Step 554: The software selects the next found visualization in said list created in step 542 and repeats steps 544 to 554. This is an iterative process that is applied to each visualization in said list. When there are no more visualizations to select and analyze, the process ends at step 555.

The software can record a motion media from the operation of any content or program. All content and programs recreated as EM objects in environment media have full interoperability. All objects in all environment media can communicate with each other.

Using Visualizations to Program EM Objects with Motion Media

Below is an example of a method that utilizes recorded visualizations to program EM objects without motion media. Let's say a user operates an app that records audio and the software for said app is not EM software. EM software can record a first state of said app (“audio first state”), any user operation of said app, and a second state (“audio second state”) as visualizations.

The recording of the operation of said app by the software of this invention can be accomplished by any means known in the art or that is disclosed herein. For example, EM content could be presented in a browser or similar client application as HTML content, or via any other means.

Said audio first state, changes to said audio first state, and said second state shall be referred to as “audio visualizations.” Note: any visualization can be analyzed by software to determine its characteristics. Or any portion of any visualization can be analyzed to determine its characteristics. Further, any visualization or any portion of any visualization can be compared to any known visualization in a data base or its equivalent to determine one or more visualization actions associated with said any visualization or said any portion of any visualization. The software analyzes said audio visualizations and determines if any one or more of said visualizations define one or more tasks. For example, let's say a first visualization is found in said audio first state that initiates a recording function of an audio input, and a second visualization is found in said audio first state that saves a recorded audio input as a sound file. The software searches a data base of known visualizations for visualizations that represent audio functions. The software further searches said data base for a visualization that includes the operation: “record an audio input”—(“task 1”=record an audio input). The software also searches for a visualization in said data base that includes the operation “save a recorded audio input as a sound file type”—(“task 2”=save a recorded input as a sound file type”). The software finds a known visualization in said data base that matches the characteristics of said first visualization. The software finds a second known visualization in said data base that matches the characteristics of said second visualization. The characteristics of first found known visualization in said data base include functionality that enables “task 1” to be carried out. The characteristics of second found known visualization in said data base include functionality that enable “task 2” to be carried out. Said found first and second known visualizations in said data base can communicate their functionality to one or more environment media objects and/or to any environment media object.

The software uses said first and second found known visualizations to modify the characteristics of environment media objects. This modifying of environment media objects can be the updating of existing EM objects in an existing environment media, or part of the process of creating new EM objects.

Regarding the updating of an existing environment media, the software applies the functions “record an audio input” and “save an audio input as a sound file” to the characteristics of existing objects in an existing environment media. As an alternate, said found first known visualization in said data base can communicate its function “record an audio input” to existing objects in an existing environment media. Said found second known visualization in said data base communicates its function “save a recorded input as a sound file type” to said existing objects in said existing environment media.

In summary, even though EM software may not understand the functionality of a software program, EM software can analyze the image data of a software program, and change (caused by any means) to said image data of a software program. EM software can then match recorded visualizations of any software program to known visualizations in a data base that contains functionality for each of said known visualizations. By this means EM software can determine one or more “visualization actions” that said image data of said any software program is illustrating. EM software can then program the characteristics of EM objects with said functionality. The programming of the characteristics of EM objects can take many forms, including but not limited to: adding to the characteristics of an EM object, creating switchable sets of characteristics for an EM object, replacing an EM objects' characteristics with new characteristics, adding a motion media to an EM object, adding a Programming Action Object to an EM object and more. Through the use of visualizations, EM software can recreate the functionality and image data of a wide variety of apps and programs without knowledge of the operating system, protocols, programming language or device used to present said apps and programs. Further the recreated functionality and image data of apps and programs as objects, e.g., in environment media, is fully interoperable.

Referring again to the example of the audio app, and regarding the program from which said first visualization and said second visualization were recorded, EM software does not need to communicate to digital protocols of said audio app or understand the structure or operations of said audio app. The software analyzes one or more recorded visualizations of said audio app. Said visualizations include, but are not limited to: image data, modifications to said image data via user operations of said app, and/or via other factors, e.g., context, assignments, relationships, and more. A key idea here is that through analysis of said recorded visualizations of said audio app, and by comparing said recorded visualizations of said audio app and said analysis of said recorded visualizations of said audio app to known visualizations in a data base, EM software discovers functionality that is represented by said recorded visualizations of said audio app. Thus, though EM software analysis and through comparative analysis (comparing image data of an app or program to known functionality associated with known visualizations), EM software is able to discern functionality that is initiated, controlled, called forth or enacted by said image data, or that is otherwise associated with said image data. EM software utilizes said functionality to program EM objects in an environment media or the equivalent.

In summary there are many advantages to this method. For example, EM software enables a user to activate any app or program and operate said any app or program to program any EM object in any environment media. By this method, a user operates software they already know in order to program environment media and EM objects to recreate said software as interoperable digital objects. Any part of any app or program that is recreated as EM objects has full interoperability with any other part of any app or program that is recreated as EM objects. EM objects can communicate directly to each other, thus EM objects provide interoperability between themselves, between environment media, between EM objects and server-side computing systems, between environment media and server-side computing systems, between EM objects and users and more. Also, a user can create simplified versions of existing programs as environment media by operating only the aspects of said existing programs that said user understands and/or wishes to utilize, and recording said aspects as visualizations. Upon the comparative analysis of said recorded visualizations, only said aspects will be recreated as EM objects in an environment media. Thus a user can simplify any program's functionality simply by how said user operates said program.

[NOTE: it is not necessary to have a second state to successfully analyze and compare recorded visualizations of apps and programs to known visualizations in a data base or its equivalent. A first state may contain all the visualization information needed to successfully determine one or more “visualization actions” with which to program any EM object.]

All environment media has interoperability with other environment media, whether said environment media is synced to content or programs, or whether said environment media exists as a standalone environment. All content that is recreated in whole or in part as one or more EM objects that comprise an environment media can have interoperability with any object in any environment media.

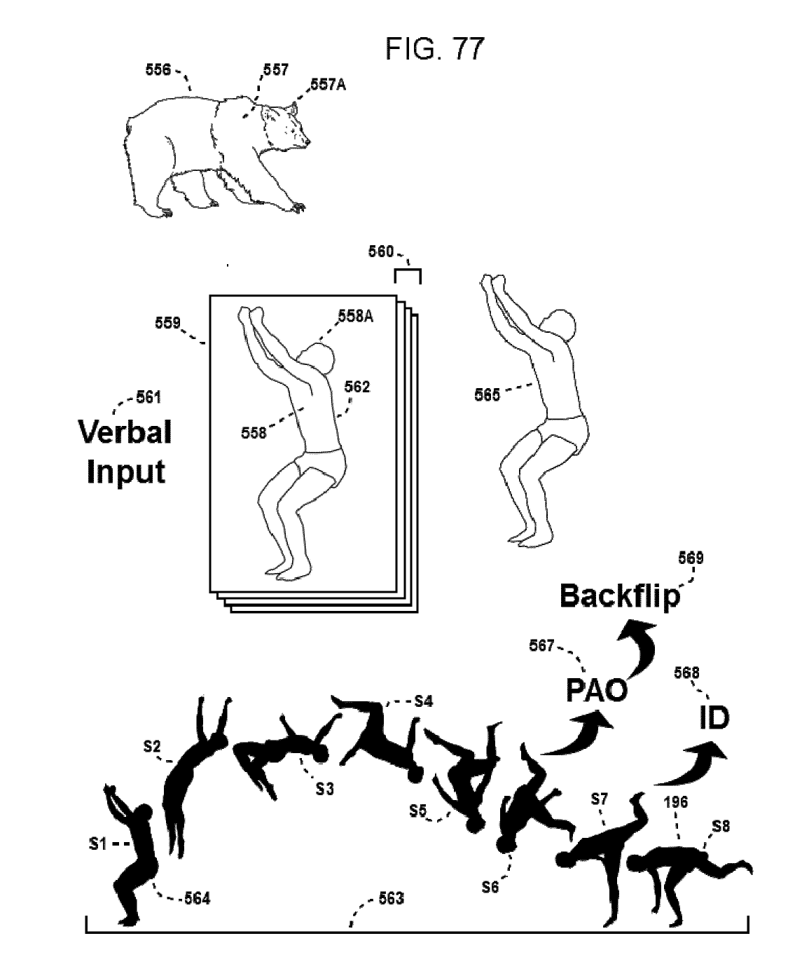

Referring now to FIG. 77, an environment media 556 is comprised of a pixel-based composite object 557 that presents a walking bear 557. For this example, said composite object 557 is comprised of 3000 pixel-size EM objects. Said environment media 556 and composite object 557 are the same shape. Environment media 556 changes its shape to match each change in each pixel-size object in composite object 557 as the bear 557 walks from left to right. Image 558 is on a first frame 559 of a video 560. Video 560 contains a person performing a back flip. A verbal input 561 defines image 558 on frame 559 as a designated area 562. Said designated area 562 contains 5000 pixels. A composite object 565, created by EM software, contains 5000 pixel-size EM objects. Pixel-size EM object 1 of 5000 matches pixel 1 of 5000 in designated image area 562 on frame 559 of video 560. Pixel-size EM object 2 of 5000 matches pixel 2 of 5000 in designated area 562 on frame 559 of video 560 and so on.

EM software analyzes the motion of image 558 as it performs a back flip through 60 frames in video 190. At 30 fps, image 188 takes 2 seconds to complete a flip. A motion media 563 is created from the 60 frames of video 560. State 564 is the first state of motion media 563. The change to each of said 5000 pixels on 60 frames is recorded as change to said first state. Said second state is frame 60, 566, showing the person landing on one foot after a successful flip. The motion media 563 is saved by the software and given an ID 568. The software analyzes the motion (changes to state 1, 564) recorded in said motion media and represents the motion of object 558 as a series of 60 geometric positions for each of the 5000 pixels comprising image 558. The final position of said 5000 pixels matches the position of state 2, 566, in motion media 563. The software saves said series of geometric positions as a Programming Action Object 567. Programming Action Object 567, is assigned to a text object 569, by the software. In this case the object is the word: “Backflip,” which was derived from the analyzed motion of object 558.

Further regarding composite objects, the software of this invention can enable objects of any size to comprise a composite object. All objects that comprise a composite object (“composite object elements”) can operate in sync with each other and with content. In addition, if composite object elements were derived from any content, said composite objects elements can operate in sync with the content from which they were derived.

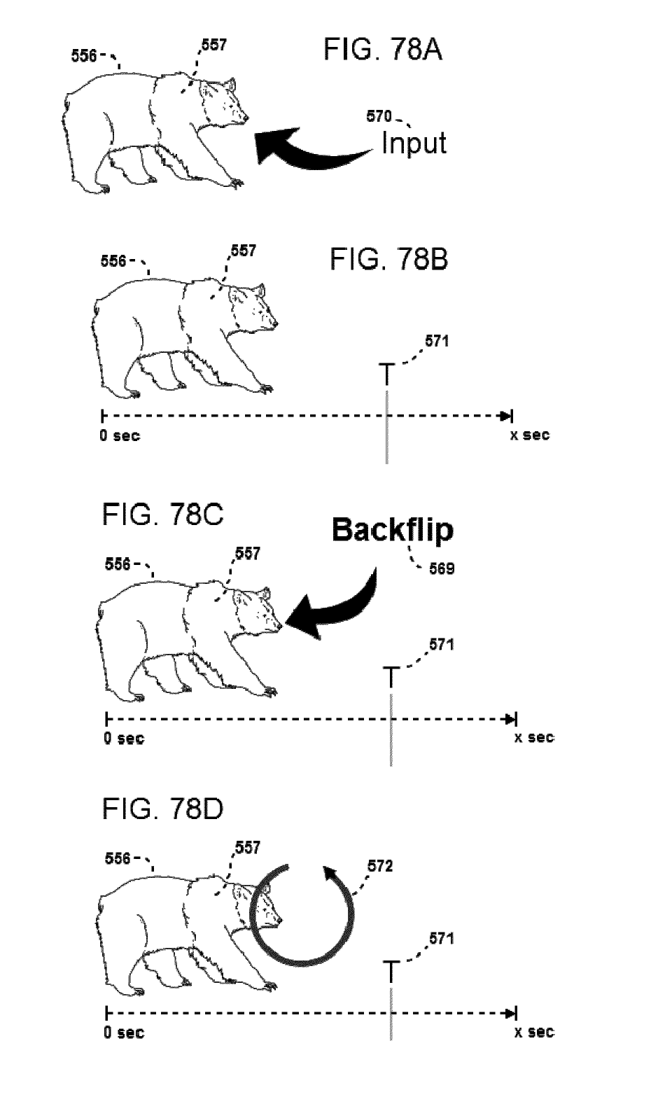

Referring now to FIG. 78A, environment media 556 (the walking bear) receives an input that causes environment media 556 to present changes to the characteristics of each EM object comprising composite object 557 in real time. As a result of input 570, the bear image 557 starts to walk. In FIG. 78B environment media 556 is stopped at a point in time 571. In FIG. 78C backflip object 569 is presented to the composite object 557 in environment media 556. The software applies object 569, (which equals Programming Action Object 567 as shown in FIG. 77) to composite object 557. As a result, the walking bear composite object 187 557 performs a front flip. In FIG. 78D a gesture 572, is applied to composite object 557, to reverse the front flip. As a result the composite bear object 557 performs a backflip.

The operations of FIGS. 77 to 78C are automatic, except for an initial input which presents video 560 of a person performing a black flip to composite object 557 or to one of the pixel-size objects comprising object 557. Part of these automatic operations is the process of modifying a composite EM object comprised of 3000 pixel-size objects with the characteristics of an image containing 5000 pixels. The number of base elements in composite object 557 and the number of based elements in video frame image 558 don't match. The EM software corrects this disparity. For the purposes of the following examples we will consider the base element of a first video frame image 558 and of composite EM object 557 to be a pixel. Further 60 changes to said 5000 pixels (300,000 changes) are to be recreated by composite image 557, which consists of 3000 pixel-size EM objects.

In a first method to correct a base element number disparity, the software creates an additional 2000 pixel-size EM objects and adds them to composite object 557 to increase the total pixel-size EM objects comprising composite object 557 to 5000. The software then matches 1 of 5000 EM objects, comprising composite object 557, to one 1 of 5000 pixels in image 558, and 2 of 5000 EM objects comprising composite object 557 is matched to 2 of 5000 pixels in image 558, and so on. Thus each pixel-size EM object comprising composite object 557 is matched to one pixel in image 558. As part of this matching process, the software analyzes the characteristics of each of said 5000 pixels in Image 558. There are many methods that can be employed to utilize the analysis of said 5000 pixels in Image 558. According to one method, EM object 1 of 5000 is updated to include the characteristics of pixel 1 of 5000 in Image 558. According to this method the software adds characteristics to existing EM objects and then communicates to said EM objects to switch between one set of characteristics and another. The switching between sets of characteristics can be accomplished by many means, including, but not limited to: context means, input means, programming means, relationship means, and assignment means. In this first method the software changes said 5000 EM objects comprising composite object 557 sixty times. Stated another way, the software switches composite object 557 between 60 different sets of 5000 EM objects. As a result 5000 pixel-size EM objects comprising object 557 are changed to match changes in said 5000 pixels comprising image 558 as said 5000 pixels change over 60 frames in video 560.

In a second method of utilizing the analysis of 5000 pixels in image 558, the software replaces the characteristics EM object 1 of 5000 with the characteristics of pixel 1 of 5000 in image 558 and so on until the characteristics of all 5000 EM objects have been replaced with the characteristics of each pixel to which each of said 5000 EM objects matches. Continuing in reference to FIG. 77, causing each pixel-size EM object of composite object 557 to match the characteristics of a corresponding pixel in image 188 would result in object 557 being transformed into image 558. If the matching of base elements between composite object 557 and image 558 is maintained over 60 frames as recorded in motion media 563, composite object 557 would be transformed into image 558 and perform a backflip. Thus the bear object 557 would be turned into the person in image 558 performing a backflip in video 560.

Other factors, like orientation, can be applied to this method. Orientation could be utilized by the software (or a user) to determine which of said 5000 image pixels is “1” and which of 5000 pixel size EM objects is “1.” There are many methods that can be employed to determine which pixel-size EM object comprising composite object 557 is matched to which pixel of image 558.

Referring again to FIG. 77, the orientation of object 557 is landscape and the orientation of image 558 is portrait. Considering orientation as a factor in the alignment of base elements between object 188 and composite object 557, the software could choose pixel 558A, of image 558 as “1,” and pixel 557A, of object 557 as “1.” The choice of object 557A and image pixel 558A as base element “1” could provide a more balanced approach to the arrangement of pixel-size EM objects in composite object 557 and pixels in image 558. Referring again to FIG. 77, in a second method to correct a base element number disparity, the software creates one or more models from motion media 563. The back flip action when converted to a model can be applied to any number of pixel-size EM objects or be applied to a composite object or to an environment media. In this case the disparity between the number of pixels in image 558 and the number of pixel-size objects comprising composite object 557 is not a factor. An example of a model would be converting each modified state, S1, S2, S3, S4, S5, S6, S7 and S8, to a geometric shape, rotation position, a ratio of change between any two successive states, or other approach comparing the relationships between states in motion media 563. This model will be referred to as “model 1.” In the example of FIG. 77, “model 1” which is derived from motion media 563 could be used to program composite object 557. “Model 1” would create changes in the shape of object 557, which match changes in states S1 to S8 of motion media 563, without altering other characteristics of the pixel-size EM objects comprising composite object 557. As a result, object 557 is not transformed into the person performing a flip in video 560. Only a model of the motion of said flip is applied to object 557. As a result, object 557 performs a flip. If a model fashioned from motion media 563 adheres to the orientation of said states, S1 to S8, object 557 will be flipped forward. This can be corrected with a simple input.

Referring to FIG. 78D, a user input 572 has been performed as a circular counter-clockwise gesture arrow which impinges object 557. There is a context here. Since composite object 557 has been modified by “model 1,” as a composite object and not as 3000 separate pixel-size objects, said gesture 202 is automatically applied to composite object 557, which then applies said gesture to the 3000 pixel-size EM objects that comprise composite object 557.

The software of this invention supports communication between any EM object. A key aspect of said communication is the ability of any EM object to communicate any change in its characteristics to any other EM object in any location. Another key aspect of EM objects is their ability to analyze data and share said analysis with any other EM object. This simple to state functionality has the potential to forever change the definition of digital content. For example, with EM objects there is generally no need to send documents, pictures, layouts, diagrams, slide shows, videos and apps from one location to another. First, content is replaced with environment media and/or by EM objects. Environment media is comprised of EM objects that can change their characteristics at any time in response to any input. Consider a document with text, pictures, links, diagrams, layout structure and the like. Said document can be reproduced with a group of EM objects that can be programmed to alter one or more of their characteristics according to any input, context, time interval, relationship, assignment, or any other causal event, action, function, operation or the equivalent. Thus one or more EM objects can effectively recreate any content, or program, or app. What is presented by said one or more EM objects is the result of the characteristics of said EM objects. Therefore, if a document being presented by one or more EM objects is to be shared, there is no need to send the EM objects. Instead, a description of the characteristics of said EM objects and any change to said characteristics of said EM objects can be sent. Four vehicles for permitting the sharing of EM object characteristics and change to said EM object characteristics are: (1) communication between one or more EM objects in a first environment media to one or more EM objects in a second environment media, (2) communication between any two or more environment media, (3) any motion media, and (4) any Programming Action Object.

For example, a digital book could be presented by a single set of EM objects that change their characteristics to present each new page in said book. The EM objects that comprise a first page change their characteristics upon receipt of some input or stimulus to become another page and so on. An example of an input to cause the altering of the characteristics of said EM objects to become a different page in said book could as simple as a gesture of flipping a page in said book. Verbal commands, other gestures, context, time, and many other phenomena can act as inputs to trigger the alteration of the characteristics of one or more EM objects comprising a page in said book.

A video frame or a designated area of a video frame can be presented as a single set of EM objects, which can change their characteristics over time to recreate changing image data on multiple frames of a video.

The operation of an app or program can be presented as a single set of EM objects which are derived from one or more visualizations as described herein. Like the EM objects presenting themselves as different pages in a book or as different image data on multiple frames of a video, EM objects can have their characteristics altered to recreate the functionality, operations, actions, procedures, structures, etc., of any program, app or the equivalent.

Imagine multiple users that have their own set of personal EM objects which can be programmed to present any content, program, app or any equivalent. The altering of the characteristics of a set of EM objects enables said set of EM objects to become a wide variety of different content and functionality. To share said content and functionality, a user need only share the objects' characteristics and change to said characteristics that produce said content and functionality. One way to share this data is by sharing motion media and/or Programming Action Objects (PAOs), which can be used to program one user's EM objects to become the content and functionality that another user wishes to share. Sharing motion media and PAOs is not the only method of sharing the characteristics and change to characteristics of EM objects. The EM objects of one user can directly communicate to the EM objects of another user. There are many methods of controlling this communication so that it does not go on unchecked by a user. One method is to require user permission for one user's EM objects to communicate to another user's EM objects. Another method is to grant permission for one user's EM objects to communicate to another user's EM objects according to defined categories of change or the equivalent.

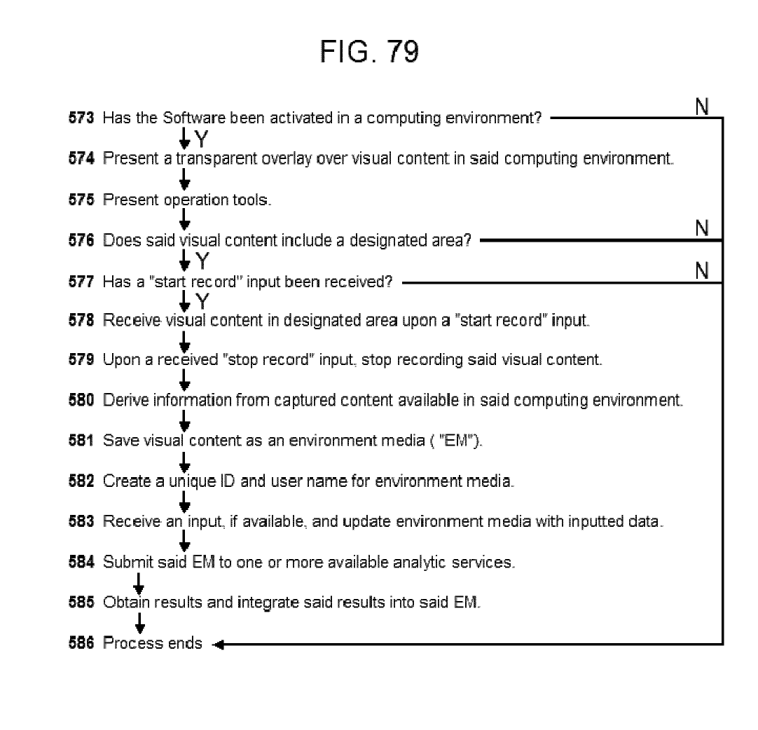

Further regarding EM visualizations, the software of this invention can record image data pertaining to at least one state and/or change to said state of any program as one or more EM visualizations. Referring now to FIG. 79, this is a flowchart describing a method of acquiring data, saving it as an EM visualization, and performing one or more analyses on said acquired data

Step 573: Has the software been activated in computing environment? The software of this invention is executable on a device where said software includes an application that presents shape drawing tools and an overlay window that covers the visual interface of said computing environment. Said overlay window allows a user, context, software process or any other viable condition or operation, to create a designated area of content presented in said computing environment, without affecting the underlying applications in said computing environment. Regarding the recognition of an input, said input could be a gesture, a verbal input, a text input, a context and or the like. Once said input is recognized the software is activated and is able to receive input from the computing environment.

Step 574: The software creates a transparent overlay over visual content in said computing environment. Said transparent overlay can be any size, including the entire display area of said computing environment, all objects managed by a VDACC, or the smallest element of said display area or said VDACC, e.g., a sub-pixel. Said visual content can be any size, including an area not visible on said display area of said computing environment.

Step 575: Present operation tools. As part of the activation of the software, operation tools to be utilized to operate the software are presented. Said operational tools could contain visual representations of functionality (e.g., any image data) or said operational tools could be activated via a context, relationship or via any other suitable means. For example, said tools could enable a user to draw around one or more portions of said visual content, or otherwise define (e.g., via verbal means, dragging means, context means, presenting one or more items to a digital camera input and more) one or more shapes that select all or part of said visual content. As a further example, let's say said visual content is a mixing console, a user may draw around an input fader on an input module of said mixing console, then draw a second input around an equalizer function on said input module, then activate said equalizer so its individual elements appear on the display of said computing environment, then draw additional inputs around one or more of the equalizer's elements (e.g., Q, frequency, type of filter, etc.). Any number of designated areas can be created for said visual content. Further, said visual content could be comprised of displayed image data, for instance, what a user would see when they launch a computer program, e.g., a word processor program, photo program, finance program, etc., before said user recalled a document, picture or spread sheet. Note: If the activation of the software in said computing environment is via an automated process, or its equivalent, there may be no need to visually present operation tools.

Step 576: Does said visual content include a designated area? Any input (e.g., an input via software, context, a user, or any other viable input) can be used to designated an area of content to be captured (recorded) by the software. Said input can be utilized to define a portion of the content presented in said computing environment or the entirety of said content. If said visual content has a designated area, then the boundary shape of said visual content to be captured by the software is defined by said designated area. A designated area can also be determined via a capture command (e.g., a user or software generated input); a capture configuration (a software configure file setup); a timed event; a software program; via a communication from an object, e.g., a motion media, an environment media; via a Programming Action Object and more. A designated area can include all image data of the display of said computing environment, or all objects managed by a VDACC. If no designated area is applied to said content, the process ends at Step 586. If said software has applied a designated area to said visual content, the process proceeds to Step 577.

Step 577: Has a “start record” input been received? A start input can be presented by any means known to the art, including: via verbal means, context means, typing means, drawing means, dragging means, software generated means and any equivalent. Once the software receives a start record input, the software captures the image data within the designated area of said visual content. The software receives (“records”, “captures”) the portion of said visual content within the boundary shape of said designated area. Said visual content can be from a 2D or 3D shape boundary. Said visual content includes dynamic and static data and any equivalent. [Note: said visual content can be called forth to said computing environment as the result of an input from a computer user or via any other cause known to the art, e.g., a context, software generated function, or timed event.]

Step 578: Receive visual content in designated area upon a “start record” input.” Upon receiving a start record command, the software records said visual content within said designated area. The recording of said visual content continues until the software receives a “stop record” command

Step 579: Upon a received “stop record” input, stop recording said visual content. The designated area of said visual content is captured, until an input indicates that the capture is complete. When the software receives a “stop record” input the software ceases the recording of said visual content. As an example only, if said visual content is a video, the software would commence recording the video upon receiving a “start record” input and continue recording the video until a “stop record” input is received. Said recording could continue for any length of time up to and including the full length of said video or longer.

Step 580: Derive information from captured (“recorded”) content available from said computing environment. It should be noted that there are at least three sources of additional information pertaining to said captured visual content, beyond the captured visual content itself: (1) information that said computing environment can supply about said captured visual content, (2) user presented information about said captured visual content, and (3) input from services, e.g., analytical services. Regarding item (1), the computing environment may offer current date and time information, data source information, GPS information, source application information, e.g., containing a UI title and other data associated with said captured visual content. Regarding item (2) a user may input descriptive information, e.g., the name of said captured image data in said designated area, e.g., “it's a dog or it's a yellow flower, etc.” Or a user could supply relationship information, e.g., said captured visual content in said designated area is related to some other content and the user may define the nature of the relationship. Regarding item (3) see Step 584 and 585 below.

Step 581: Save visual content as an environment media (“EM”). The captured visual content is saved as an object, e.g., an Environment Media (“EM”) or as a file. The saving of said visual content can be to a local storage on the device of said computing environment, to a server or to any other storage known to the art. The saving of said visual content would include any information derived from said computing environment. Further, if the software were capable of performing any analysis as part of the capturing of said visual content, the results of said analysis would be saved with said content. An example of said analysis could be the recognition of a geometric shape, or the recognition of a an image in said visual content, or the accounting of the number of pixels in said captured visual content and more. [Note: the applying of analyses to captured visual content can be controlled by a user or via an automated process. Thus a prompt can be issued by the software enabling a user to accept or reject the applying of certain analytic processes to raw captured visual content. If the process is automated, part of the automated process can include a decision list or the equivalent, to determine whether analytic processes are to be applied to raw captured visual content. Such a decision may depend upon available resources, e.g., process speeds, memory, access to networked processing and the like.

Step 582: Create a unique ID and user name for environment media. Regarding the naming of captured visual content, the software can perform many tasks, including any one or more of the following:
The software creates a unique ID for said visual content, e.g., a GUID.
The software creates a text name for said visual data Said text name could be derived from information acquired from said computing environment, from a user, or by any other suitable means. This would be the name that a user employs to refer to a saved environment media.
The software prompts a user for additional characterizing information (annotations), for example a name or classification (“a pretty rock”, “my dog Ruff”, “monarch butterfly”).

Step 583: Receive an input, if available. The software can receive inputs from any viable source, including but not limited to: automated software generated inputs, inputs generated by context, inputs generated by a relationship, and user inputs. The software can receive user inputs in any form, including via verbal means, gestural means, drawing means, dragging means, context means, via a computerize camera recognition system, and the like. User input could include a description of the received visual data. For instance, a user input may define the input, as: “it is a flower,” “it is a rock,” “it is a yellow flower,” “it is a gray specked rock,” etc. Further user input could define the function of said EM, for instance, “it is used to program an object to open like a hinged door.” The software updates said environment media saved in Step 581 with said input of Step 583.

Step 584: Submit said EM to one or more available analytic services. These services can include analytic services previously registered and configured, and/or any collaborating software process or the equivalent, including: geometric analysis, boundary recognition, motion analysis, colorimetric analysis, taxonomic identification, lexical analysis, and the like.

As a part of the analytic process the visual content comprising said EM can be recreated as any number of objects (if said visual content is static) or as any number of object pairs if said visual content is dynamic. Each said object pair would include: an object containing characteristics of the portion of said visual content being recreated by said object, and a motion media saving all change to the characteristics of said object.

Further as part of said analytic services, said EM can be submitted to one or more content matching (pattern recognition) services. The software, for example, communicating to an application server, causes queries to be made to one or more data base servers or to one or more server-side computer systems to initiate one or more collaborating software processes, which can be executed independent of said software. One of these processes can include the attempt to match all or part of said EM to visual data in a data base containing visual information associated with functional data that either defines said visual information, is activated by said visual information or is otherwise associated with said visual information.

Step 585: Obtain results and integrate said results into said EM. The results of said analytic services as provided for in Step 584 are used to either create new objects to comprise said EM [see paragraph 358] or update the characteristics of existing objects comprising said EM. Regarding finding matches for all or part of said EM to visual data in a data base, for each match returned by said services, the software creates new attributes (characteristics) as tagged data (groups of name-value pairs) and adds them to said EM, e.g., updates the characteristics of objects comprising said EM, updates the characteristics of the EM object itself, or updates any motion media belonging to any object pair associated with said EM. In this step, a purely visual piece of data is identified by a returned match from said data base containing visual information associated with functional data. Said match enables the software to create one or more actions, operations, processes, instructions, or any other functional data for said EM and/or for any object (including any motion media) comprising said EM. By this means, any visual data (content) can be recreated as software objects which have one or more actions associated with them, where said actions are not known when the software first receives said visual data By this process, image data can be captured by the software, analyzed, and utilized to create operational objects in an environment media of the software. This process can be carried out by the software without the need to understand the operating system or the program used to present said visual content on a device, beyond what is required to capture the raw visual content from said computing environment.

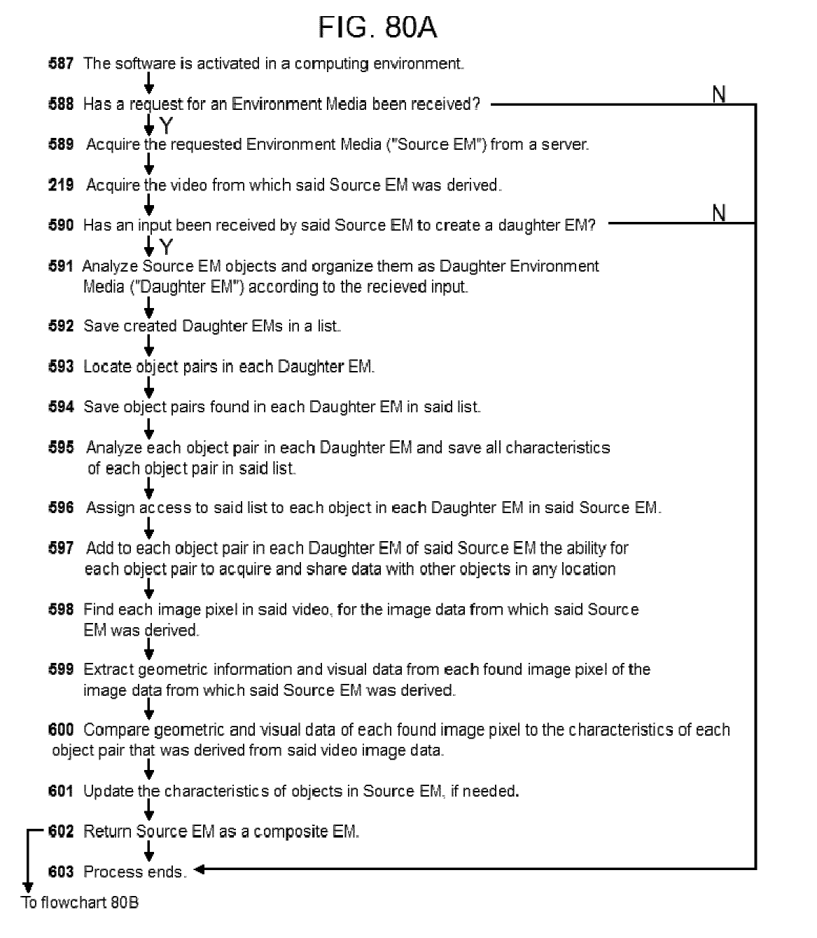

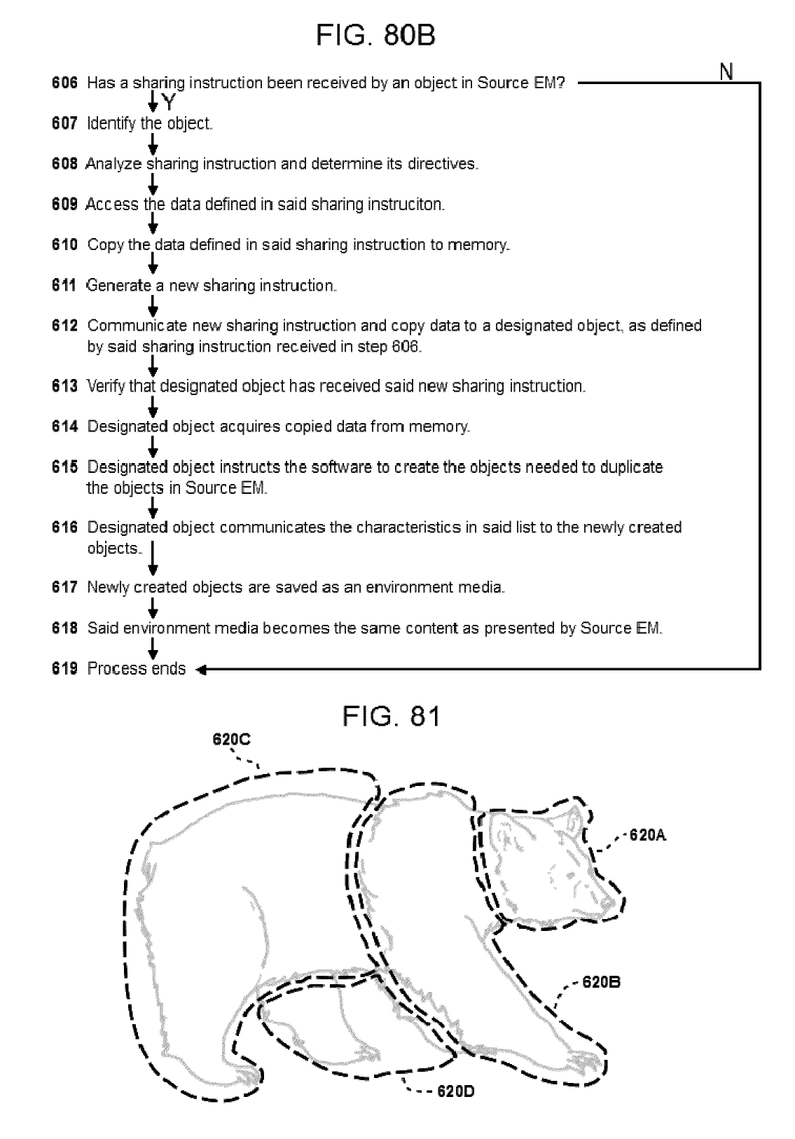

Referring now to FIG. 80A, this is flowchart illustrating a method to create composite objects from an environment media and maintain sync between objects that comprise a composite object.

Step 587: The software is activated in a computing environment.

Step 588: Has a request for an environment media been received? This request could be from any source, including from a user, software, the result of a context, from an object or the like. If “yes,” the process proceeds to step 589, if “no,” the process ends.

Step 589: As a result of the request of step 588, the software acquires the requested environment media from a known registered source. The acquired environment media will be referred to as the “Source EM.” For purposes of this example, let's say that the Source EM is a walking bear, which is comprised of pixel-size objects that were created from an analysis of a video of a walking bear, which shall be referred to as the “Bear Video.” Said Source EM is the result of a previous analysis of said Bear Video and the subsequent creation of pixel-size objects to recreate the characteristics of image pixels that comprise said walking bear in said Bear Video. The first analyzed frame of said Bear Video became “state 1” of said Source EM. This 1^{st} frame shall be referred to as simply “1^{st} frame.” Each pixel-size object in said Source EM recreates one pixel in the image of said walking bear on said 1^{st} frame. A motion media paired to each said pixel-size object manages change to each pixel-size object to which it is paired. The number of pixel-size objects that comprise said Source EM is known to said Source EM Finally, said Source EM could have two generalized functions: (1) to modify an existing content, or (2) to exist as a standalone media. For the purposes of this example, let's say that the purpose of said Source EM is to modify image data in said Bear Video.

Step 590: Has an input been received by the Source EM to create a daughter EM? If yes, the process continues to step 591, if no, then the process ends. [Note: All objects in an environment media, including the environment media object itself, can directly receive inputs, analyze them and act on them.]

Step 591: The software analyzes the Source EM and divides it into one or more composite objects according to the received input of Step 590. The object pairs that comprise said Source EM are located and organized as separate composite objects, and saved as Daughter EMs to said Source EM. Thus the original Source EM becomes the “Parent EM.” The software or the Source EM object itself locates all object pairs that are now allocated to each Daughter EM composite object. There are many methods that can be employed to direct the reconstruction of the Source EM to contain one or more composite objects.

Overall Consideration:

The most accurate way to create the Source EM from a piece of content or as a standalone environment media is to create one object to match each of the smallest elements of a display environment. In the case where the EM recreates all or part of a piece of content presented on a device (e.g., “device 1”), the smallest element of said display environment would be the size of a pixel on the display of device 1. In the case where said Source EM is a standalone environment, not matching any content, the size of each object comprising said Source EM could be according to a default value, e.g., a certain dot and pitch for a 1080P display. Considering this example where said Source EM contains pixel-size objects that have recreated the content of a walking bear, each pixel in the image of the bear on said 1st frame would have been recreated as an object in said Source EM. This could be a hundred thousand objects or more. Further, each of these 100K objects would have a second object, a motion media object, paired to it. An object and the motion media object paired to it shall be referred to as an “object pair.” The motion media records any change to the characteristics of the object to which it is paired. So if there are 100K objects making up the bear image in said Source EM, there would be 100K motion media, one for each of the 100K objects making up the bear image. Once a group of object pairs has been created, such as the object pairs that comprise said Source EM, the software can reorganize them into composite objects. The Source EM object or the software directing the Source EM object can apply many methods to the reorganization of the objects that comprise said Source EM. For the purposes of the examples below, the Source EM object will be the object doing the reorganization. Said reorganization could performed by the software or any object external to said Source EM or any computer to which said Source EM, or any of the objects comprising said Source EM, can communicate.

Method 1:

Source EM object receives an input. Said input could be from any source, including, external software, another EM object, an object in another EM object, an object in said Source EM object or a user input or from any other source. Let's say the input is from a user. User inputs can theoretically take an infinite variety of forms. In this example, the user input is as follows. A user “plays” (“activates”) said Source EM to present a first state of said Source EM. In this example the first state (“state 1”) is the first position of a walking bear in said Bear Video. So a user providing the input can see the image of a bear via a display of some kind, e.g., screen, hologram, virtual 3D, heads up display, Google Glass, and more. What appears to be a picture of a bear is actually the Source EM, comprised of a number of pixel-size objects, each paired to a motion media object (“object pairs”). Let's say said walking bear in said Source EM is comprised of 100K object pairs. Said user input could define the reorganization of said object pairs comprising said Source EM. As one example of a user input, now referring to FIG. 81, a user draws on said bear image to define a series of designated areas. [Note: the user drawn designations are shown as dashed lines which define areas larger than the actual bear, so a viewer can see both the gray outline of the bear and user drawn designated areas]. User input 620A defines the head of the bear; user input 620B defines the upper body of the bear and the right forearm; user input 620C defines the back and back end of the bear and the right back leg; user input 620D defines the left forearm and back left leg of the bear. [Note, any number of areas of the bear could be defined as designated areas by any number of user drawn inputs.] The Source EM object receives said user inputs and analyzes said inputs to determine that the number of image pixels of said bear image that lie within the boundary of each drawn user input. If the drawn boundary contains a portion of the image data that has persistent visibility, this is a precise calculation for the software. The software simply analyzes the shape of the user drawn input, queries the display driver to discover the number and characteristics (e.g., dot and pitch, etc.) of the pixels on the display where the user input in presented. Then it is a simple calculation to determine how many image pixels reside within each user drawn designated area. This number can be applied to the number and location of the objects that are recreating said image data of said walking bear in said Source EM. Then, each group of objects that are recreating said image data of said walking bear within each designated area are designated as and saved as a composite object (e.g., “composite object 620”, “composite object 620B,” “composite object 620C” and “composite object 620D” in this example) within said Source EM. Each composite object 620A to 620D is an Environment Media contained with said Source EM.

Dynamic Visibility

Dynamic Visibility is utilized to manage objects in environment media under various circumstances,

including the following: (a) there are more objects than are needed to create image data at a certain point in time, (b) certain parts of an image data are obscured by some other image data, thus the objects creating the obscured image data are not needed for the presenting of said image data at a certain point in time, and (c) the lighting of the image data created by certain objects is too dim such that said image data is no longer visible, thus the objects creating said image data are not needed at a certain point in time. As an example of (a), let's say the walking bear in our example, turns and walks directly towards the viewer. The number of objects required to create the right arm and right paw of the walking bear when viewed from the side may be many times more than the number of objects required to create the bear's arm and paw when viewing it front the end of the paw. In this case, the pixels not required to create this view of the bear's arm and paw are made invisible or are hidden. As the view of the bear's right arm and paw changes and more of the side of the bear's arm and paw become visible, more of the invisible objects making up this portion of the bear image become visible. His behavior is an example of Dynamic Visibility.

As another example, in the case of the left forearm and back left leg of the bear, defined by drawn user input B4, the software cannot use a set image pixel count of these parts of the bear, because for each frame where the bear walks, the amount of image data presented by the left forearm and left back leg change, since different portions of the left bear forearm and back left leg of the bear become visible as the bear walks. Thus the total number of objects required to create the said left forearm and left back leg are constantly changing. As a result, for each walking motion of the bear image, some of the objects creating said left forearm and left back leg are made invisible and others become invisible. This same approach can be used for any object comprising the bear image when said any object may become hidden. For instance, the bear might place a right paw behind a portion of a rock as it walks. During that time period the objects comprising part of the right paw are hidden. All EM objects and objects that comprise EM objects and the software itself can manage dynamic visibility as part of the characteristics of any object of the software.

Method 2:

A Programming Action Object is applied to an environment media object. Said Programming Action Object (“PAO”) includes a model of regions that can be applied to environment media object, e.g., said Source EM and thus to any object that comprises said Source EM. In the case of the walking bear, the model of said PAO, being applied to said Source EM, causes the objects comprising said walking bear to be organized into individual regions, which exist as separate environment media within said Source EM. We call environment media contained within an environment media “Daughter Environment media” or “Daughter EM.” The environment media containing said daughter environment media is referred to as a “Parent EM.”

Method 3:

An environment media receives a communication from another object or another environment media, which causes said the environment media receiving said communication to create one or more daughter environment media contained within a parent environment media.

Continuing with FIG. 80A

NOTE: Step 591 includes the steps of 592, 593, 594 and 595.

Step 592: Save all created Daughter EMs in a list. The number of Daughter EMs is determined by the input received in step 590. In the example of FIG. 81, there are four Daughter EMs designated by user input.

Step 593: Locate object pairs in each Daughter EM. This is performed as part of the analysis of step 221. Each object and the motion media paired to it that comprise each Daughter EM are found.

Step 594: Save all object pairs comprising each Daughter EM in a list. The list of Daughter EMs is updated with the list of object pairs that belong to each Daughter EM composite object. In this example, each object in a Daughter EM recreates part of the designated area of said 1^{st} frame of said Bear Video. For example, Daughter EM 613A (see FIG. 81) is a composite group of objects that recreate the head of the walking bear image on the 1^{st} frame of said Bear Video. The objects in Daughter EM 613A (see FIG. 81) recreate the right shoulder and forearm of the walking bear image in the 1^{st} frame of said Bear Video and so on.

Step 595: Analyze each object pair in each Daughter EM and save all characteristics of each object pair in said list. As a quick review: the Source EM is comprised of pixel-size objects that recreate the image pixels of a walking bear moving through many frames of said Bear Video. Each of said pixel-size objects recreate one of the image pixels of said walking bear in said Bear Video. Further, each of said pixel-size objects is paired to a motion media object, which manages change to said each of said pixel-size objects. Each motion media manages changes to the characteristics of the pixel-sized object to which it is paired. Said changes enable the pixel-size object paired to said motion media object to reproduce changes in the image pixel it is matching in said Bear Video. The analysis of each object pair includes a discovery of each change to each characteristic of each pixel-size object that comprises each Daughter EM object.

Step 596: Each object in said Source EM (now organized as four composite environment media objects: 620A, 620B, 620C and 620D in our example), is given the ability to access said list of paired objects and all characteristics of said paired objects, including all change recorded in each motion media that is part of each object pair, and their organization into four Daughter EMs. As a result, each object, including each motion media object, is capable of accessing and utilizing any information saved in said list.

Step 597: Add to each object in each object pair, contained in each Daughter EM, the ability for each object to acquire and share data with other objects both in said Source EM (the Parent EM) and with any object in any other environment media in any location, or with any environment media object in any location. This ability to acquire and share data is also given to each motion media object. This ability to acquire and share data is a key element in enabling objects of the software of this invention to directly communicate with each other.

Step 598: Find each image pixel in said video, for the image data from which said Source EM was derived. This is the first of several checks. This is the first of three steps that can serve as an error check for the sync between said Source EM and said Bear Video. If the Bear Video has been changed for any reason, this step and the following two steps will serve to re-sync said Source EM with said Bear Video. [Note: It should be noted that steps 598, 599, 600 and 601 may not change anything in said Source EM. In fact, said source EM, being previously created to match each image pixel of said 1^{st} frame and each change to each image pixel of said walking bear in subsequent frames of said Bear Video, may need no modifications

A key idea here is that the objects in said Source EM are not duplicated again and again in order to match changes in each frame of said Bear Video from which said Source EM was derived. Instead, the characteristics of said objects in said Source EM are modified to enable said objects to present motion that matches the area of said Bear Video from which said EM was derived. As previously explained, the modification of the characteristics of said objects is managed by a motion media object paired to each of said objects.

Step 599: Extract geometric information and visual data from each found image pixel of the image data from which said Source EM was derived.

Step 600: Compare geometric and visual data of each found image pixel to the characteristics of each object pair that was derived from said video image data

Step 601: If any differences between said Bear Video and said Source EM are found, the objects with discrepancies are modified to match the image pixels of said Bear Video. For example, if a first object that recreates a first pixel in 1^{st} frame of bear video is found to contain a discrepancy, it is updated to match the location and physical characteristics said first image pixel in 1^{st} frame. Further, for each change to said first image pixel in subsequent video frames, the motion media paired to said first object is updated with the change in location and any change in image characteristics. If no discrepancy is found, no change is made to any object in said Source EM. By the operations contained steps 598, 599, and 600, said Source EM is enabled to modify the walking bear in said Bear Video with perfect sync. [Note: example of FIG. 80A illustrates the use of an environment media to modify an existing content. Once an environment is created and its objects accurately recreate image data and changes to said image data in any content, the sync between said environment media and said any content should remain. If, for some reason, the environment media or the content from which said environment media is derived has changed, e.g., via data corruption, interruption in communication, or for any other reason the process just described can reestablish sync between said environment media and the content from which it was derived.]

Step 602: Return the Source EM as a composite EM. It should be noted that all objects that comprise an environment media continue to comprise that environment media, even though the environment media is reorganized as a Parent Environment Media to contain one or more composite objects as Daughter Environment Media. This step proceeds to step 606 of FIG. 80B.

Step 603: The process ends.

Regarding the communication between objects, all objects of the software of this invention are capable of directly communicating to each other. This can exist as an inherent characteristic of an object or as a modification to the characteristics of any object of this software via any communication or any other suitable input. Referring now to FIG. 80B, this is a flowchart that follows from the flowchart of FIG. 80A.

Step 606: Has a sharing instruction been received by an object? As a reminder, a sharing instruction is an instruction, presented to an object, which includes a request to share said instruction with one or more other objects, computers, or any other digital entity that can receive an instruction. Any object in any environment media can receive one or more sharing instructions. Said any object can acquire data from any other object, including any environment media object or any number of objects that comprise any environment media or from any computer capable of communicating with said object and the like. If a sharing instruction has been received by an object in Source EM, the process proceeds to step 607, if not, the process ends at step 242.

Step 607: Identify the object. Any object can receive a sharing instruction, including an environment media, any object that comprises an environment media or any standalone object. In addition, a server-side computer can receive a sharing instruction. For the purposes of this example, let's say that the object receiving said sharing instruction is an object in Source EM (“Object 1”)

Step 608: Object 1 analyzes said sharing instruction. This analysis determines all elements and aspects of the sharing instruction, including: the characteristics of the sharing instruction, the task, if any, of said sharing instruction, and to which objects and/or entities said sharing instruction is to be shared.

Step 609/610: Object 1 accesses the data that is to be shared and copies it into memory. This data could be anything accessible by Object 1. For instance, it could one or more characteristics of any number of objects that comprise an environment media, like Source EM. It could be one or more characteristics of any number of objects that comprise one of the Daughter EM objects of Source EM or of any other environment media; it could be any data or any part of any data stored on any database server to which Object 1 can communicate; it could be any information contained in any server-side computer to which Object 1 can communicate and so on. Let's say for the purposes of an example of the method described in FIG. 80B that said sharing instruction of Step 606 designates all of the characteristics of all objects that comprise Source EM to be shared with another object in another location belonging to a user, other than the user operating said Source EM. In this case, Object 1 would access said list of Step 596 in FIG. 80A and copy all contents of said list to memory.

Step 611: Object 1 generates a new sharing instruction. This new sharing instruction includes the task, or the equivalent, contained in the sharing instruction received by Object 1 in Step 606. In this example, the sharing instruction is to copy all contents of said list of Step 596 and send them to an object (“Object 2”) belonging to another user. The task is for Object 2 to instruct the software of said another user to create the same number of object pairs as contained in Source EM and assign to them the characteristics saved in said list of Step 596.

Step 612: Object 1 sends a sharing instruction to Object 2.

Step 613: Object 1 verifies that Object 2 has received its sharing instruction.

Step 614: Object 2 acquires the contents of said list from said memory. As an alternate operation, Object 2 could instruct the software to acquire the content of said list from said memory.

Step 615: Object 2 creates all of the needed objects to duplicate the object pairs of Source EM.

Step 616: Object 2 communicates the characteristics, acquired from said list, to the newly created objects, created in Step 245.

Step 617: Said newly created objects are returned as an environment media (“EM 2”).

Step 618: EM2 becomes the same content as presented by Source EM. Thus by communicating the number of object pairs and their characteristics to another object in another environment of the software of this invention, said objects and their characteristics are created and saved as a new environment media which becomes the same content presented by Source EM. For example, if Source EM modified a video of a walking bear, EM 2 modifies the same video in the same way. If the environment media created in FIG. 80B is for the purpose of modifying an existing content, then one more step is needed. The newly created environment media (EM 2 in the example above) activates the video to which the object pairs of Source EM are synced with, and then syncs the newly created object pairs in EM 2 with the same video.

Step 619: With the successful communication of the sharing instruction of Object 1 to Object 2 and the completion of the programming of objects with the characteristics of said list, the process ends.

Environment Media Construction

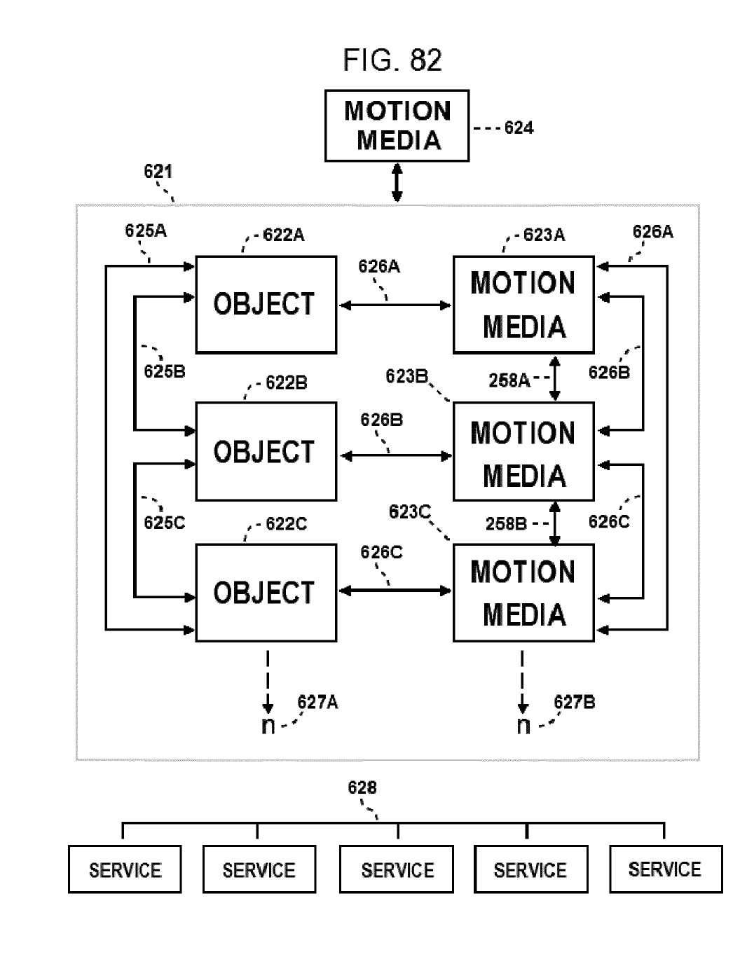

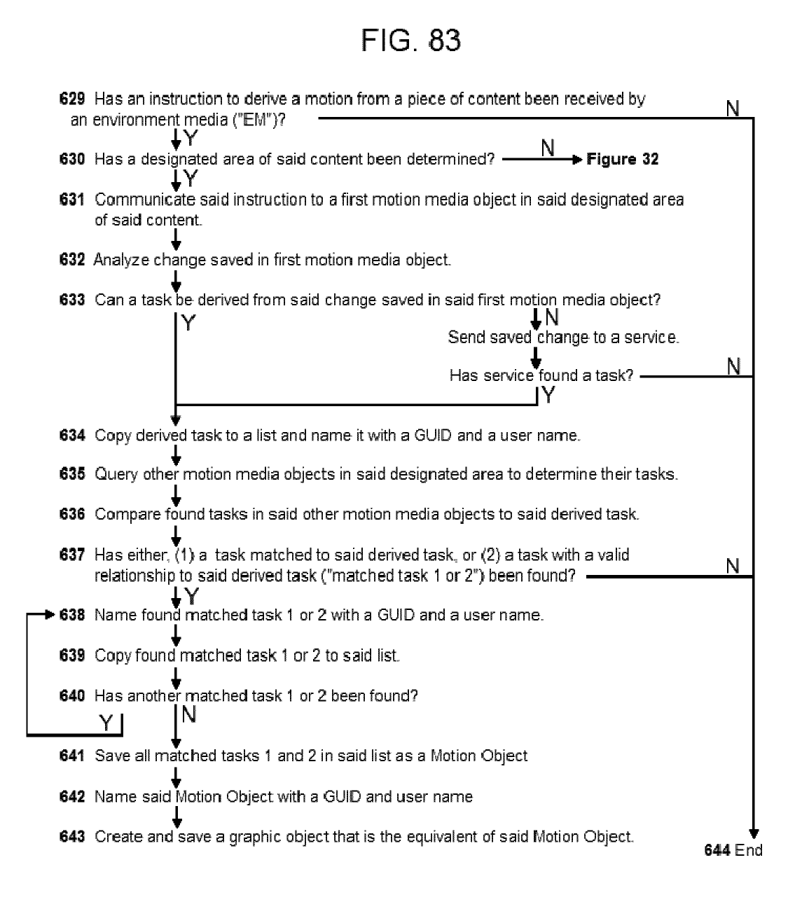

Each object in an environment media is paired with a motion media object. Further, an environment media object is paired with its own motion media object. Referring to FIG. 82, this is a diagram of the structure of an Environment Media and the relationships and functions of the objects comprising an environment media. Environment media 621 contains objects 622A, 622B, and 622C on to object “n” 627A. Each of these objects has a motion media paired to it. Object 622A is paired with motion media 623A. Object 622B is paired with motion media object 623B and so on. Further, environment media 621, is paired with its own motion media object, 624.

Each motion media, e.g., 623A, performs multiple functions:

A. A Motion Media Saves Change to the Object to which it is Paired.

Each motion media object saves all changes (“change”) to the object to which it is paired. For example, motion media 623A saves change to object 622A, motion media 623B, saves change to object 622B, and so on. Said change includes any modification, alteration, variation, transformation, motion, or any other change to the object to which a motion media is paired.

B. A Motion Media Analyzes the Change that it has Saved and Attempts to Derive One or More Tasks from Said Change.

A motion media analyzes the changes to the characteristics of the object to which it is paired and attempts to match one or more tasks to one or more said changes. Thus the total number of changes to the characteristics of an object may define more than one task. As a part of this process, a motion media may communicate with one or more services to request said services to perform analytic functions, e.g., comparative analysis, associative analysis, geometric analysis and any other analytic function or the equivalent. The communication of any motion media object, e.g., 623A to “n”, 627B, to any service 628, can be a direct communication from said any motion media. As an alternate said any motion media, e.g., 623A to “n”, 627B, could communicate to the environment media that contains it, e.g., 621, and then the environment media 621 that contains it could communicate to any service 628. In this latter case, either said environment media 621 or said any service 628 would communicate back to said any motion media, e.g., 623A to “n”, 627B.

C. A Motion Media Co-Communicates with Other Motion Media in the Environment Media that Contains Said Motion Media.

For example, in FIG. 29 82, motion media 253A 623A, communicates directly with motion media 253B 623B, 253C 623C, and to any number of other motion media “n”, 257B 627B, which are all part of environment media 251 621. Communication can be direct, e.g., via 256A 626A, 256B 626B, 256C 626C and so on, or communication can be indirect, e.g., motion media 253A 623A communicates to environment media 251 621, which communicates to motion media 253B 623B and so on, or motion media 253A 623A communicates to motion media 253B 623B, which communicates to motion media 253C 623C and so on, e.g., via 258A 628A, 258B 628B and so on. Said communication can be in the form of queries, demands, requests or any other type of communication. A key element of this communication is to compare the tasks of one motion media with another. For example, motion media 623A could query motion media 623B to cause motion media 623B to send motion media 623A any task derived by motion media 623B from the analysis of change to object 622B—the object to which motion media 623B is paired.

There are Many Factors that can Affect a Motion Media Object's Choice of which Motion Media it should Communicate to and which Motion Media it should Send Queries to.

For the purposes of illustration only, let's say that the object pair consisting of object 622A and 623A is among other object pairs that are creating the image of a yellow flower pedal. Let's say that motion media 623A, has derived a task from an analysis of change to object 622A, which is: “changing the color yellow to the color blue,” (“Task 1”). One way to discover other motion media objects that contain this same task would be for motion media 623A to request the tasks of all motion media objects in environment media 621, and through comparative analysis or any other suitable analysis find all tasks that match or closely match Task 1. If there were, let's say 500,000 object pairs in environment media 621, all object pairs would be analyzed. Another approach would be for motion media 623A to define a boundary for the part of the image that contains object 622A, and conduct a task search first among the objects that are within said boundary. As a reminder, object 622A and its motion media 623A is part of a collection of objects that is creating the image of a yellow flower pedal. The perimeter of yellow flower pedal (“Boundary 1”) is discovered by motion media 623A or by a service employed by motion media 623A. As a result of the defining of Boundary 1, motion media 623A confines its initial search to the motion media that are paired to objects that lie within Boundary 1. Once matches to Task 1 are found there, the search could be expanded to include motion media paired to objects adjacent to the perimeter of Boundary 1. If no matches to Task 1 are found among these objects, the search could be ended.

What if the task is more complex, like the blinking of an eye? For the purposes of illustration only, let's say there are 100 objects that comprise a blinking eye motion (“Blink objects”). The change to the characteristics of each of said Blink objects would not be exactly the same. However, all change to said Blink objects would comprise a definable motion, in this case, the blinking of an eye. Thus some of the objects making up the blinking eye motion comprise the pupil, other objects comprise the iris, other objects comprise the eye lid, and other objects comprise the eye lashes and so on. The change to the characteristics of just one of these objects comprises a portion of the blinking eye motion. Accordingly, an analysis of any one motion media comprising a part of said blinking eye motion will not likely reveal the full blinking eye motion. For example, during the blinking eye motion, “object 1^{a}” that comprises part of said eye lid will move downward from a starting point, (“state 1” of object 1.) and then back up to a new position (“end state” of object 1^{a}). Whereas during the same blinking eye motion, “object 1ⁿ” that comprises part of said pupil may move very little, but will change its characteristics to become progressively hidden by the objects comprising said eye lid. However, even though the changes to the characteristics of object 1^{a} are quite different from the changes to object both objects are part of the same motion.

In the case of complex motion, a motion media may employ any number of services 628, for the purpose of analyzing image data or other data to derive recognized data. For instance, one or more services could analyze a person's face to determine regions that define the eyes, nose, mouth and other sections of said face. The boundaries and other characteristics of recognized regions or the equivalent can be communicated to a motion media. This information can determine the motion media to which requests are made for tasks. In the case of the blinking eye example, if motion media 623A were searching for other motion media that contain tasks that are part of a blinking eye motion, queries would be sent objects within the boundary of a recognized eye.

D. A Motion Media Analyzes the Tasks Received from Other Motion Media and Compares Said Tasks to the Tasks of the Motion Media Performing the Analysis.

For example, motion media 623A, after receiving tasks from motion media 623B, analyzes said tasks of 623B and compares said tasks of 623B to the tasks of 623B. The comparative analysis or any other analysis of received tasks by motion media 623A, may be performed in whole or in part by one or more services, 628.

E. A Motion Media Searches for a Match or Near Match Between Tasks Received from Other Motion Media and its Own Tasks.

For instance, motion media 623A searches for a match or near match of any task received from motion media 623B to any task of 623A. If a match of tasks is found between any two motion media, said task is saved, e.g., in a list or the equivalent. This existence of a common task establishes a relationship between said any two motion media. For example, if a received task from motion media 623B matches a task of motion media 623A, this establishes a relationship of a common task between motion media 623A and 623B. This also establishes a relationship between objects 622A and 622B, which are controlled by motion media 623A and 623B respectively. [Note: A common task could be a same or a similar change to any one or more characteristics or a same or similar change to any relationship.]

F. A Motion Media, with or without the Aid of One or More Services 628, Derives a Transformation from a Set of Similar or Same Tasks.

A transformation could be the flapping of a butterfly's wings without the image data of the butterfly. In the above example, a transformation would be the blinking of an eye without the image data of the eye and its various visual components, e.g., lashes, lid, iris, pupil, etc. A blinking eye transformation would include all elements of the motion of an eye blink without the eye image data from which said blinking eye motion was derived.

G. A Motion Media Communicates a Found Set of Similar or Same Tasks to an Environment Media.

For example, environment media 621 receives a list of object pairs that include Task 1: changing the color yellow to blue. As a result, environment media 621, repurposes or otherwise designates all object pairs that comprise said found set of similar or same tasks as a daughter environment media. As a result, environment media 251 becomes a parent environment media.

H. Said Set of Similar or Same Tasks is Saved as a Motion Object.

The environment media receiving a communication from a motion media that includes a set of similar or same tasks, (“Task Set”), saves said Task Set as a list or the equivalent and then saves said list as a motion object, like a Programming Action Object. Said Programming Action Object can be used to apply the motion defined by said Task Set to other objects.

H. Any Motion Media, Contained by an Environment Media can Communicate to the Motion Media (“EM Motion Media”) Paired to the Environment Media that Contains Said any Motion Media.

For example, any motion media, e.g., 623A to 627B, contained in environment media 621 could communicate to motion media 624.

I. The Motion Media Object Paired to an Environment Media Object Manages all Change to all Objects that Comprise Said Environment Media.

Referring again to FIG. 82, motion media object 624 performs any or all motion media operations, as described herein, for the environment media object to which it is paired. The motion media 624, paired to an environment media, 621, is the housekeeper for all objects that comprise the environment media 621. A motion media paired to an environment media can perform many functions, including but not limited to: (1) updating its characteristics at any time, (2) receiving any input, (3) acting on and/or responding to any input, (4) communicating any one or more characteristics of any object that comprises the environment media to which it is paired, (5) communicating to any object in any environment media, (6) communicating to any service, (7) reconfiguring any number of object pairs as a daughter environment media. With regards to the example of a blinking eye motion. Once motion media 623A has found the other motion media that share a common task (the motion of blinking an eye), motion media 624 receives a communication from motion media 623A. Said communication from object 624A includes all found common tasks and any other information related to said common tasks. This information would include a list, or the equivalent, of the object pairs that include said found common tasks. Object 624 takes all object pairs on said list and creates a daughter environment media and updates the characteristics of itself and environment media 621 to which it is paired. As part of this process, object 624 redefines environment media 621 as a parent environment media.

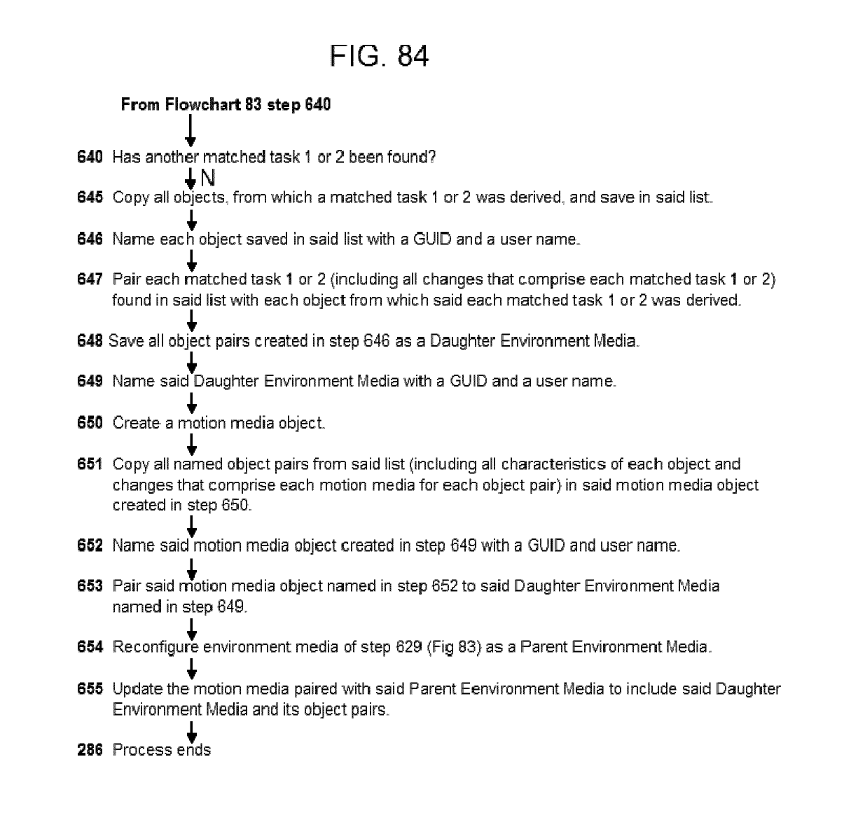

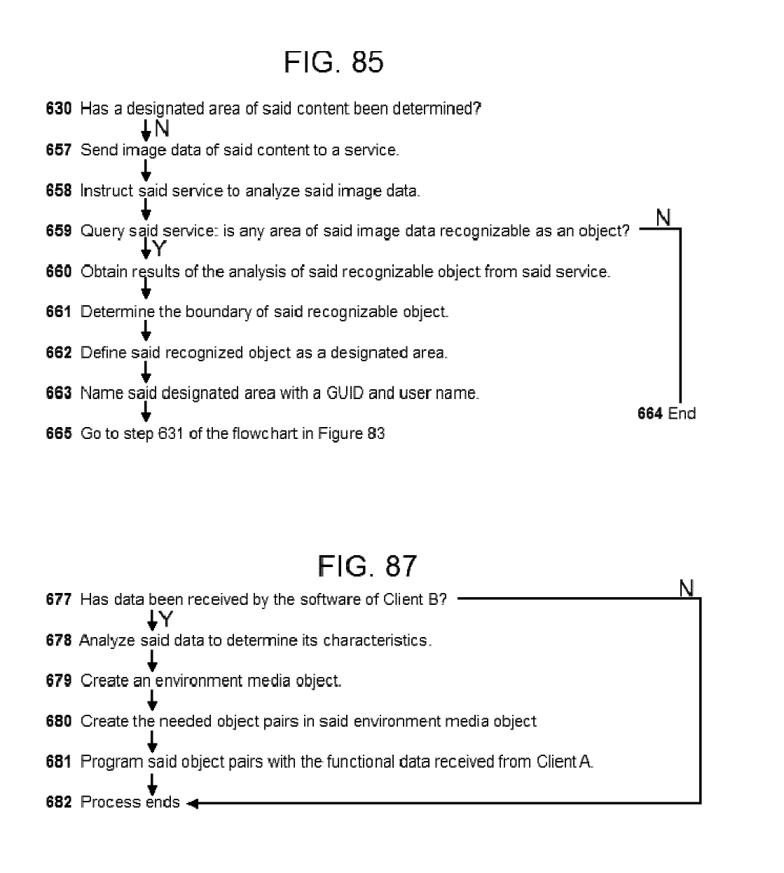

Referring now to FIG. 83, this is a flowchart illustrating the process of a motion media discovering a collection of objects that share a common task.

Step 629: Has an instruction to derive a motion from a piece of content been received by an environment media object? Inputs can be received and processed by any object of the software. This includes, but is not limited to, any environment media object, any object comprising any environment media object and any motion media object paired to any object comprising any environment media object. If the answer is “yes,” the process proceeds to step 630, if “no,” the process ends at step 643.

Step 630: Has a designated area of said content been determined? There are many ways to designate an area of any content. A user input could designate an area of content by drawing or gesturing or verbally describing an image or section of an image or by describing a process, motion, action or the like. Other methods include: context, software determination, applying a programming action object, other verbal means and more. A designated area of content could be the entire content or it could be any section, segment or the like of the content. If the answer is “yes,” the process proceeds to step 631. If, “no,” the process proceeds to a service, shown in FIG. 85. If this service is successful in determining a designated area of said content, the flowchart proceeds to step 261 631.

Step 631: The environment media object that received an instruction in step 629 communicates said instruction to a first motion media in said designation area of said content. As previously described, an environment media consists of object pairs: an object that creates part of a piece of content or the equivalent, and a motion media, paired to said object. Said motion media saves all change that occurs to the object to which it is paired. In this step said environment media sends the instruction received in step 629 to a first motion media paired to an object that creates part of said content in said designated area. All objects in an environment media are capable of communicating with each other which includes the ability to send and receive data and to analyze the data they receive.

Step 632: Either the software, said first motion media or said environment media (collectively referred to as “EM object 1”) analyzes the change saved by said first motion media. As a reminder, this change is the change to the object paired to said first motion media.

Step 633: Said EM object 1 attempts to derive a task from said change saved in said first motion media. If at least one task can be derived, the process proceeds to step 634. If not, the change saved in said first motion media is sent to a service, for example, 628 as shown in FIG. 82.

Motion Media Operations

A motion media is an integral part of the capturing of image data in a computing environment where the motion media chronicles all change to the image data that is captured. The motion media could preserve change according to the smallest visual element of the display medium, e.g., a pixel or even a sub-pixel. Or the motion media could preserve change according to larger image structures which can be formed according to some criteria. One criterion could be according to object recognition, namely, any image, motion or audio data that a motion media recognizes can become a recognized structure and the motion media then records change to that recognized structure. Another criterion could be according to a relationship. If a section of image data is not strictly recognized, but can be defined as an area that has a relationship to another visual area or to a recognized visual structure, each such area can be dealt with as a visual structure.

(a) A motion media first records all change to “state 1,” the first condition of a computing environment or visual image data presented in a computing environment on any device or the equivalent.

(b) The motion media analyzes what it has recorded and attempts to define any number of changes as a task. The motion media asks: “does a certain number of changes define a task?” Then it asks: “are all of the recorded changes necessary to perform this task?” The motion media culls through the recorded data and removes anything that is not required to perform a certain task. These processes can be accomplished by a variety of methods. In one method the motion media performs a comparative analysis of various changes to a data base of known tasks and tries to find a match. If it finds a match, the motion media consolidates the change data, throwing out any change that is not needed to accomplish the matched task and then saves the changes as a task object, also referred to as a “motion object.” The task object is named with a GUID or the equivalent, plus a familiar name that a user can recognize and utilize. For example, the familiar name of the object could simply be the task that it performs, like “record an audio input,” or “move a line of text to the right to perform an indent” or “flapping motion of an eagle's wings” and so on.

(c) User input can be received by any motion media. For instance, a user may submit a task definition to a motion media, directing it to organize its recorded change as a particular task. In this case the operation of the motion media would not be to discover a task, but to validate a number of recorded changes as defining a certain task supplied to the motion media by a user input. With no input, a motion media could return any number of found tasks based upon the change that it has recorded and subsequently analyzed. If a task cannot be found, the raw recorded change data is archived for later analysis.

(d) A motion media takes the data that it has organized according to tasks and puts this data into data packets or the equivalent, each defined by a task. Further examples of tasks would include: putting a page number at the bottom of a page, indenting a paragraph's first line of text, etc.

If a motion media cannot successfully derive a task from the change it has recorded for the object to which it is paired, the motion media communicates its change to another object and/or to a service. A service could be running server-side or running locally on a client's computer. Further, said service could be a protocol that utilizes local processors, e.g., in a user's devices (smart phone, pads, 2-in-one devices and the like) and utilizes processors in physical analog objects, e.g., processors that support the internet of things. Said protocol could be supported by Open CL or the like. For example, Open CL could be used to enable tasks to be farmed out to collective of processors (e.g., a room or a house full of processors that support the internet of things), to perform tasks for the software generation of content via collections of objects and functional data associated with those objects.

We will refer to this collective of processors as an “analytic farm.” An analytic farm could work like this: (1) the software, an environment media object, a motion media object or any other object identifies all of the processors that a user has access to, (2) the software, an environment media object, a motion media object or other object farms out tasks or portions of tasks to said analytic farm, (3) the analytic farm returns solutions to various tasks over time to said software, environment media object or any other object.

Further regarding the utilization of a service, said service can receive one or more of the task related lists of a motion media. The service analyzes each of the received motion media task packets and attempts to figure out what they mean. If a service figures out the meaning of a task, it produces one or more models of that task. There are two different basic types of models: (1) a literal model, and (2) a generalized model. For example, if a literal model of a dog doing a backflip was applied it to an environment media creating a walking bear, the bear would turn into a dog and perform a backflip. If a generalized model of a dog doing a backflip was applied it to an environment media creating a walking bear, the bear would remain a bear and perform a backflip as a bear. The generalized model is the motion of the backflip, and the literal model is the object performing the motion of a backflip.

Further Regarding User Input and Motion Media

In the software of this invention motion is described as a series of change to the characteristics of one or more objects. Said objects could comprise an environment media or exist as an independent collection of objects. As previously described, in one construction of an environment media, each object comprising said environment media is paired with a motion media object that records change to the object to which it is paired, plus said environment media is paired with its own motion media that contains all change to all objects within said environment media. In another construction of an environment media, said objects comprising said environment media are not paired with a motion media object. Instead, one motion media object paired to said environment media records and manages and change to all objects that comprise said environment media. In either construction of an environment media, video is no longer defined by frames. Video is simply the result of changes over time to characteristics of objects and the relationships between objects. This approach decouples the motion of the software of this invention from MPEG and other formats. Also it defines a new baseline from which to process motion.

Below are three sources of input that are all quite significant to the software:

(1) User Designated Content.

A user says: “I like that, I want that.” The user knows something about an image or content. As a result, the user draws around some image or other content, or otherwise designates all or part of an image or content. As a result of a user input the software captures raw bits of user designated content data.

(2) User Accessorized Content.

The user says: “I want to connect other sources of information with this designated content or with this object.” Thus a user wants to accessorize designated content or objects with the user's knowledge. For instance, a user may say: “It's called a moth, its genus is this, its species is this,” and so on. By this means, a user can add information to any designated content or to any object created by the software.

(3) User Requested Motion.

The user can conceptualize motion and ask for it, but it may be more of an intangible thing. For instance, a user could say: “give me something that represents the motion of this butterfly in this video content.” Through a computational method, the software makes elements that are somewhat intangible very tangible. The recognition of a verbal user request can be handled by any suitable service. Further a visual representation of a user request can be handled by the software or in concert with a service. For example, as a result of a user request for motion, a wireframe or an avatar could be produced that shows the basic motion being requested. Thus the motion becomes something tangible to the user, rather than remaining a concept only. [Note: however motion is presented to a user by the software said motion exists as an object in the software and can be utilized by a user to program other objects and existing content.] [Note: A key power of this idea is that the objects and services of the software have a logic where they can talk to themselves and perform tasks without user intervention. The objects and services have a logistical intelligence where they can analyze data and go through their own steps of discovery.]

Step 634: EM Object 1 copies said derived task to a list and names said derived task with a GUID and a user name or the equivalent. At this point, a task has been derived from the change of said first motion media in said environment media. Said derived task is saved as a motion object, or any equivalent, in a list. [Note: The user name could be derived from the task and thus enable a user to both understand it request it by name.]

Step 635: Query other motion media objects and said designated area to determine their tasks. EM Object 1 sends a request to each motion media object in said designated area. The query is a request to send any task that any motion media in said designated area has derived from the change to its object pair. As a result of said query, first motion media, or EM Object 1, receives tasks from each motion media that was queried in Step 265.

Step 636: EM Object 1 performs comparative analyses of tasks received from said other motion media objects to said derived task of said first motion media. The comparative analyses are directed towards finding matches or near matches or relationship matches between said derived task of said first motion media and the received tasks from said other motion media objects.

Step 637: Has a matched task or a task with a valid relationship to said derived task (“matched task 1 or 2”) been found? As previously described, a designated area could include a collection of tasks which do not have an exact match of characteristics and/or functional data to each other. But, said collection of tasks can constitute a complex motion, like the blinking of an eye or the flapping of a butterfly's wings. Further, said complex motion can be defined as functional data, which does not include the image data or objects creating said image data One could think of said functional data as a collection of motion media tasks and relationships, without the content and/or objects from which said tasks and relationships were derived. Regarding a “valid relationship,” there are many ways to define a valid relationship. According to one approach, any motion media object within a defined boundary of a designated area could be considered to have a valid relationship to at least one other object within said defined boundary. In addition, any motion media containing a task that enables, modifies, actuates, operates, calls forth, or in any other way affects or is functionally related to the task of any motion media within said defined boundary, would have a valid relationship to said any motion media within said defined boundary. In the case of the blinking eye example, if motion media, (for example 623A of FIG. 82) were searching for other motion media that contain tasks that are part of a blinking eye motion, queries would be sent to motion media objects within the boundary of a recognized eye performing said blinking motion. Most, if not all, found tasks from said motion media objects within the boundary of said recognized eye would likely have a valid relationship to at least one other task, and possibly to all tasks, within said boundary. [Note: An exception to this could be the case where a motion media within said boundary of said recognized eye contained tasks that were not related in any way the enactment of a blinking eye motion.]

Step 638: Name found matched motion with a GUID and a user name. Object 1 or its equivalent supplies a name for each found matched motion. The name can contain any number of parts, for example: (1) a GUID, and (2) a user name. A user name can be computer or object generated with or without user input. One way to accomplish this would be for Object 1 to derive a name from the function of a matched task or from the recognition of an object or object boundary.

Step 639: Copy found matched task 1 or 2 to said list. The found matched task or found task with a valid relationship to said derived task of step 633 is saved to said list.

Step 640: Steps 638, 639 and 640 are an iterative process. Said found tasks are searched for another matched task 1 or 2. If a matched task 1 or 2 is found, the process proceeds to step 638. If no additional matched task 1 or 2 is found, the process proceeds to step 641.

Step 641: Save all matched tasks 1 and 2 in said list as a motion object, e.g., a Programming Action Object. This saving process is not limited to a Programming Action Object. The list of all matched tasks 1 and 2 should contain all necessary change and relationships to accurately reproduce the motion of all objects within said designated area determined in Step 630. For example, if the complex motion were the flapping of a butterfly's wings, said motion object, e.g., Programming Action Object, could be applied by a user to any content to modify said content with said motion object. An example of this would be applying said motion object to a digital painting, whereby the digital painting is presented as the motion of a flapping set of butterfly wings.

Step 642: The Motion Object is saved, e.g., with a GUID and a user name as previously described herein or any other naming scheme.

Step 643: Create and save a graphic object that is the equivalent of said Motion Object. As part of the process of naming and saving a Motion Object, the software creates and saves a graphic object that is the equivalent of said Motion Object. The creation of said graphic object could be according to a user input, a context, a software process or any other appropriate method. The purpose of creating a graphic object as an equivalent for a Motion Object is simply because a motion object cannot be seen by a user. It can only be “seen” by software. Thus, for a user to apply a Motion Object to any content or object or environment or any equivalent or any other item, a user needs to be able to see and manipulate a Motion Object. Since a Motion Object is a software object that applies a motion, a user needs a visual representation to apply a Motion Object to some target.

Step 644: The process describing the creation of a Motion Object ends at step 644.

Now referring to FIG. 84, this is a continuation from Step 640 in the flowchart of FIG. 84. FIG. 84's flowchart illustrates the creation of a daughter environment media.

Step 645: Copy all objects from which a matched task 1 or 2 was derived and save in said list. Each motion media that was queried by said first motion media of FIG. 83 is paired to an object. In this step each object that is paired to each motion media that contains a matched task 1 or 2 is found, copied and saved in said list of Step 634 FIG. 83.

Step 646: Name each object saved in said list with a GUID and a user name. Any naming scheme can be used. A GUID and a user name is a good choice, because the user name provides a context for the GUID to better ensure its uniqueness. As a further aspect of a naming process, a third element could be added to the name of any object. This element could be a descriptor derived from the recognized object or boundary of a complex motion being recreated as functional data by a Motion Object.

Step 647: Pair each matched task 1 or 2 found in said list with each object from which said each matched task 1 or 2 was derived. [Note: as previously described, each object that comprises an environment media is paired with a motion media object that records and manages change to the object it is paired to. In this step each matched task 1 or 2 is paired to the object from which said matched task 1 or 2 was derived. Further, once paired, each matched task 1 or 2 is defined as a motion media. Said motion media and the object to which it is paired can be given the same name or each paired object is named individually with a unique ID. By naming each object individually there will be little need for a serialization process to enable the sharing of said object pairs, inasmuch as the paired objects and their relationships to each other have been uniquely identified. To summarize, in Step 647 each task 1 or 2 is paired to the object from which it was derived. Further, each said task 1 or 2 is defined as a motion media.

Step 648: Save all object pairs assembled in Step 646 as a daughter environment media. An environment media is created that is comprised of the object pairs saved in said list.

Step 649: Name said daughter environment media with a GUID and a user name. Any naming scheme can be used that uniquely identifies said daughter environment media.

Step 650: Create a motion media object. The software, said environment media, said daughter environment media or any object comprising either said environment media or said daughter environment media creates a new motion media object or repurposes an existing motion media object.

Step 651: In this step all of the changes contained in each motion media of each object pair in said list are saved in said motion media object created in Step 650. In other words, the motion media paired with said daughter environment media receives information regarding the object pairs that comprise said daughter environment media. This includes the characteristics of all objects and the change saved in each motion media saved to each object. In this case, the “change” is all matched tasks 1 or 2 from said list that were paired with each object from which they were derived.

Step 652: Name said motion media object created in Step 649 with a GUID and user name. To enable the accurate and efficient sharing of information in said motion media it is given a unique ID or set of IDs as described herein or as known in the art.

Step 653: pair the motion media object created in Step 650 to said daughter environment media. [Note: in the creation of an environment media, each environment media is paired with a motion media. Thus when a daughter environment media is created, a motion media is also created with contains all of the information pertaining to each of the objects that comprise said daughter environment media.]

Step 654: Change the configuration of said environment media of Step 629 to a Parent Environment Media.

Step 655: Update the motion media paired with said Parent Environment Media to include said Daughter Environment Media and its object pairs.

Alternate Step: in the flowchart of FIG. 31, all of the object pairs (“matched pairs”) that contained a matched task 1 or 2 were copied and organized as a Daughter Environment Media. At that point in time the data comprising said Daughter Environment Media existed is two places: (1) in the Parent Environment Media of step 654, and (2) in said Daughter Environment Media of Step 648. As an alternate approach, instead of copying the matched pairs, the matched pairs could be moved to said list and then used to comprise said Daughter Environment Media. In this case, there would be one set of data comprising said Daughter Environment Media. The disadvantage of this approach is that the original object pairs may contain more information than just said matched task 1 and 2, thus moving only this data would leave other data behind. The solution would be to either purge that remaining data, or move the remaining data to the newly created Daughter Environment Media as additional characteristics and change to the object pairs comprising said Daughter Environment Media.

Step 656: Once said Daughter Environment Media and the motion media paired to said Daughter Environment Media are created, the process ends at Step 656.

Referring now to FIG. 85, this is a flowchart illustrating an example of a service being employed to determine a boundary for a recognized area. This flowchart starts from Step 630 of FIG. 83.

Step 630: Has a designated area of said content been determined? If no designated of a content can be determined the environment media receiving an instruction to derive a motion from said content can send said content to a service for analysis.

Step 657: Send image data of said content to a service. Said environment media of Step 260 630 communicates with a service, e.g., 628 of FIG. 82, sends said image data to said service.

Step 658: Said environment media instructs said service to analyze said image data. The instruction from said environment media could include any user input, e.g., a user determination as to what said image data is, i.e., a flower, a dog, a wing, an eye and so on.

Step 659: Said environment media further instructs said service to find any area of said image data that is recognizable. If the service is successful in determining a recognizable area of said image data, the process proceeds to step 660. If not, the process ends at Step 664.

Step 660: Said environment media requests the results of the analysis of said service

Step 661: Said service, the software or any object of the software, for instance, said environment media, determines the boundary of the recognizable object discovered by said service. Said boundary is determined by means known to the art.

Step 662: The software or any object of the software, for instance, said environment media, defines object as a designated area.

Step 663: Name said designated area with a GUID and user name.

Step 665: Go to step 631 in the flowchart of FIG. 83.

Summary Regarding the Utilization of Environment Media, Object Pairs, and Motion Media

A key problem with formats is that file formats are not easily compatible with each other and with many programs; further, file formats are generally limited to printing, viewing or touching a link to go somewhere. Among other things, the software of this invention can be used by people (who have no programming abilities), to discover functional data associated with any image data recorded by the software, and to utilize that data as a programming tool. The software builds objects that reproduce the functionality associated with data, as operational objects in an environment media or in other object-based environments. For example, using the software of this invention, a user can take: (a) the motion of a moth's wings and, (2) the raster image of some object and, (c) modify said digital image with said motion. The software derives motion from changes to image data (and other data like audio data) and can save said changes as motion objects. Said motion objects can be used to program (modify) other objects, content and/or data. As part of this and other processes, motion media can be used to present functional data and relationships, without the objects from which said functional data and relationships were derived. Accordingly, using the functional data and relationships of various motion media, one or more Motion Objects can be created. Said Motion Objects can be used to program other objects. By the means described herein, the software can derive motion from visual data recorded from user operations and deliver motion to the user as a tool. For instance, if a user recorded their eye movements, via a camera input to a digital system, the software could model the eye movements and decouple said movements from the eye and present the motion of the eye movements as a tool. This tool could be a Motion Object, e.g., a Programming Action Object, which can be applied to any content to which a user wishes to program with said motion of the eye movements.

Summary of Motion Media Functionality

Generally, what operations do motion media perform?
(a) A motion media can directly communicate with any object, content, data or the equivalent.
(b) A motion media records and/or tracks change to any object, content, data or the equivalent.
(c) A motion media analyzes change to any object, data, content or the equivalent, and derives tasks from said change.
(d) A motion media searches for and saves relationships between objects. A motion media performs interrogations of any individual object, object pair or any motion media as part of any object pair. A key purpose of said interrogation is to determine if any relationship exists between interrogated objects or between an interrogated object and the motion media interrogating said object. Looking more closely, a motion media performs comparative analyses to determine if any task of any interrogated object matches, or nearly matches, or has a valid relationship to any task of said interrogating motion media or of any other object.
(e) A motion media can separate a task (e.g., a motion) from the object from which said task was derived and save said task as an object, e.g., as a Programming Action Object. For example, the motion of the flapping of a butterfly's wings can be separated from the image data of the flapping butterfly. The motion can be saved as an object. This enables a user to have objects that consist of just the functional data of an object or collection of objects. Said objects are generally referred to as Motion Objects, which include Programming Action Objects. These motion objects can be used to program other objects or collections of objects, like environment media or used to modify content. As an example, a user could take a motion object that contains functional data that equals the flapping motion of a butterfly and use this object to program an environment media, which is creating a document, to make said document flap like a butterfly.

Further Benefits of Environment Media, Motion Media and Motion Objects.

Benefit 1: Interoperability of Content.

The software enables user centralized control. Users can employ motion objects, or their equivalent, to easily modify any piece of content or object displayed on any device, running any operating system, running any piece of software.

Benefit 2: Immediate User Accessibility to any Part of any Content.

With content represented as objects that can communicate to each other and receive and respond to user input, users have the freedom to access any part of any content at any point in time and manipulate it.

Benefit 3: User Programmability of Objects.

Users can make requests and/or send instructions to objects that are relatively simple and very humanistic. Objects can receive said requests and/or instructions and communicate between themselves to create complex operations. As part of this process, objects can read eye movement, heart-beat, voice inflection, and other bodily vitals, and utilize this information to enhance the process of analyzing user input, e.g., the meaning and intent of a user's words and other input. As a result, a user can explain things to an object more like they were talking to a person. Also, they can enhance their communication by employing physical analog objects, e.g., holding up a picture in front of a digital camera input to a digital recognition system. The basic paradigm here is that a user talks to objects in a language familiar to the user, and the objects communicate between themselves in their own language to accomplish complex operations for the user.

Benefit 4: Interoperability of Software Programs.

A user operates software they already know. The software of this invention records the user's operation of a program or its equivalent and captures a first state of visual image data and changes to the visual image data in the environment that the user is operating. The software creates one or more motion media that capture change that occurs in the environment being operated by said user. Either through its own implemented capabilities or of those available through configured remote systems (cloud-based or other similar server-based computational services), the software performs a comparative analysis of the image data and change to the image data that the software records. Using the results of said comparative analysis, the software derives functional data from said change to said image data. The software applies said functional data to objects, which recreate the functionality of the software operated by a user. By this means the functionality of software programs as operated by a user is recreated by objects of the software which are globally interoperable.

Benefit 4 is about users having interoperability of software. For example, a user operates a word program and the software, operating in a computing environment, records everything the user operates in the word program, e.g., the user sets the margins, page numbers, page size and makes rulers visible onscreen. The software of this invention records these user actions as image data, not knowing anything about the operating system, or the software enabling the word program. The software records the image data as raster image data, or its equivalent in a holographic environment, or the equivalent in any other computer environment. The software is agnostic to operating systems, programming software, device protocols, and the equivalent. Once the software has recorded image data, the software presents the recorded image data to a data base that contains at least two elements: (1) visual data and, (2) functional data associated with each visual data. Thus each visual data entry has associated with it in said data base one or more functional data that are called forth, enacted or otherwise produced by a visual presentation, e.g., a change in the visual image presented in a computing environment.

Continuing with the above example, one possible result of the recording and comparative analysis of image data from a user's operations of a word program is the following. The software returns a set of functional data and object characteristics which are used to program a set of objects as an environment media. The objects comprising said environment media would look like text, page space, and other visual characteristics of said word program, but there is no word program, per se. The operations of said word processor program by said user is recreated by the software as software objects that comprise an environment media. In other words, the software discovers the functional data associated with the image data it records, and builds objects that reproduce the functionality associated with the recorded image data as objects in an environment media or other object-based environment.

Sharing Data Between Objects

Two applications can communicate in a peer-to-peer fashion without any server in between. Or a backend server—a remote server—could receive messages from one user and send them to another user. Let's say Client A wants to share an environment media content with Client B. The software server on the backend would receive some data from Client A, the data would go to the application server of the software and then get forwarded on to Client B.

Referring to FIG. 33, this is a flowchart illustrating a method whereby the data of one user, “Client A,” is sent to another user “Client B” to program the objects that comprise Client B's environment media. Let's say that Client A wants to send some functional to Client B to program Client B's objects, such that they become Client A's content. As an example only, the motion media paired to the environment media, EM 1A, could separate all of the functional data from the objects comprising EM 1A. Then the motion media paired to EM 1A posts what is to be shared to memory. This communication between a pair of clients mediated by a server is common in the art. Generally, a backend server acts as a broker to facilitate a connection to each client so they can talk directly to each other. As an alternate, said backend server acts as a kind of telephone switch that receives communications from one client and then forwards the communications on to another client.

Regarding Memory.

The data from a client's environment media can be saved locally or server-side. If Client A's environment media is saved locally, the data to be shared by Client A is transferred to memory, e.g., in an application HEAP or its equivalent. If Client A's environment media is saved server-side, the memory is in an application server of the software. As is common in the art, a browser can give memory to an application that runs in the browser. The memory to which Client A copies, moves or otherwise transfers data could be on an application server or its equivalent. When data is in memory, it has the address of a data structure. If it is referencing something else, it will have some computer memory address. When data is being serialized, it replaces dynamic memory addresses with something that is a more durable. For instance, if an object didn't have a name, it is given a name. If all objects are named, then no memory pointers are needed. As previously described herein, a motion media, can name each piece of data, e.g., each functional data, object, object pair, motion media, environment media, and the relationships between objects, and any other data required to reproduce any content created by any environment media or its equivalent, with one or more unique IDs. As a result, the serializing of the data to be transferred to any device or server can be written out the way they occur. For instance, an object of this software for Client 1 could contact (via peer-to-peer or via an application server), an object of Client 2 and send notice of functional data, or other data, that is to be sent. Then the object sends the data

The software of this invention includes a data structure (an example of which is presented in FIGS. 29, 30, 31 and 32) that enables objects of the software to write data straight out to other objects. Said data doesn't need special preparation, inasmuch as motion media can provide needed data preparation for sharing data.

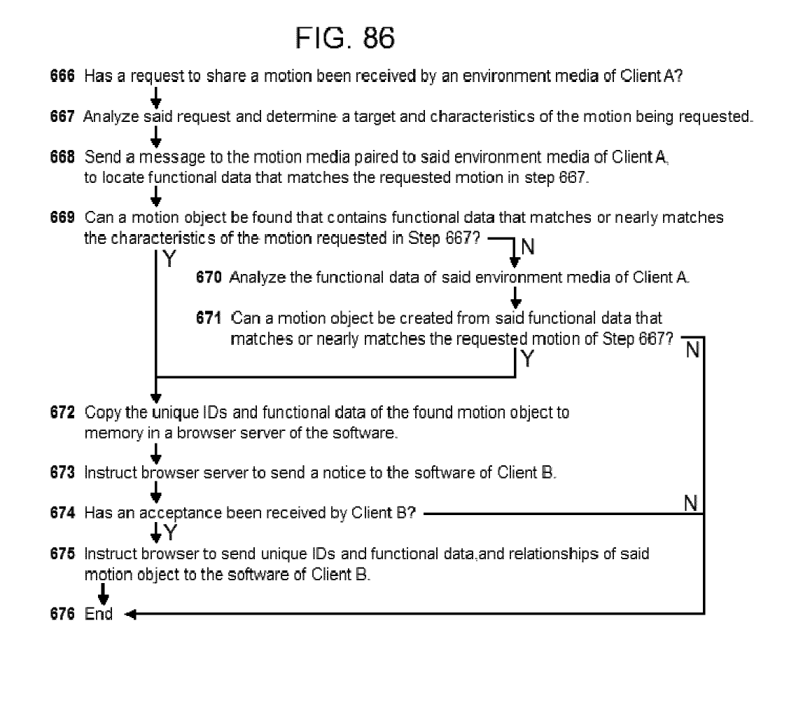

In the example of FIG. 86, functional data is being shared between Client A and Client B. Said functional data can include, but is not limited to: one or more changes to one or more object's characteristics, transformations that modify an existing piece of content, one or more relationships, one or more changes to one or more relationships, the characteristics and change to said characteristics of objects that create a standalone piece of content, e.g., as an environment media, any associated transaction, and any equivalent. [Note: If a user is sharing transformations to be applied to existing content, part of the sharing process would be to stream the original content from where it is archived, but not to copy it or edit it.]

Step 666: Has a request to share a motion been received by an environment media of Client A? Said request could come from any source, including a sharing instruction from a user, initiated by a context, a programmed software operation, a time initiated action or any equivalent.

Step 667: Analyze said request to determine a target and characteristics of the motion being requested. In the case of the example of FIG. 86, Client A is sharing data with Client B. Thus Client B is the target in Step 667. Other targets could include, but are not limited to: servers, server-side computers, any object, or the equivalent. The analysis of Step 667 can be carried out by said environment media, the software, a server-side computer, an analytic farm or any equivalent or combination of these elementslkjo.mn.

Step 668: Send a message to the motion media paired to said environment media of Client A to locate functional data that matches the requested motion in Step 667. The software sends a message to the motion media paired to the environment media receiving said request in Step 666. As previously described, each environment media object can have a motion media paired to it. This is like a master motion media that manages all objects that comprise an environment media, including each motion media paired to each object in said environment media. [Note: said message of Step 668 could be sent to any object of said environment media receiving said request in Step 666 or to the software. Whatever object receives said message can communicate with all needed objects and carry out or manage all needed analysis and associated operations.]

Step 669: Can a motion object be found that contains functional data that matches or nearly matches the characteristics of the motion requested in Step 667. A search is conducted to find a motion object that matches the motion of the request of Step 666. If said motion object is found, the process proceeds to Step 300. If said motion object is found, the process proceeds to step 672.

Step 670: The analysis of Step 667 returns one or more sets of criteria, pertaining to the functional data being requested. Said information can include any definition, function or other defining characteristic of said requested motion. The software of Client A searches for functional data in said environment media that matches or nearly matches the characteristics of the requested motion in Step 296.

Step 671: If a match is found, the software creates a motion object by any method described herein. The process proceeds to Step 672. If no motion object that matches or nearly matches the motion requested in Step 296, the process ends at Step 676.

Step 672: The software copies the unique IDs and functional data, in the found motion object or in the motion object created in Step 301 671, to application memory. [Note: If the sharing of data between Client A and Client B is accomplished via a peer-to-peer process, the software would copy the unique IDs and functional data to local memory.]

Step 673: The software messages the application server to notify the software of Client B.

Step 674: Has an acceptance been received by Client B? The software checks to see if a response of acceptance has been received from the software of Client B.

Step 675: The software instructs the application server to send the unique IDs and functional data, relationships, and any other needed characteristics, if any, of said motion object to the software of Client B.

Step 676: The process ends at Step 676.

Now referring to FIG. 87, this is a flowchart illustrating the receipt of said motion object by Client B from Client A and the subsequent programming of objects in an environment media of Client B.

Step 677: Has data been received by the software of Client B? If the software of Client B confirms receipt of data the process proceeds to Step 678. If not, the process ends at Step 682.

Step 678: The software of Client B analyzes received data to determine its characteristics.

Step 679: The software of Client B creates an environment media object. As an alternate, the software of Client B utilizes a currently active environment media or recalls an existing environment media from any source.

Step 680: The software for Client B creates the needed object pairs in said environment media object. If said environment media object is created, then the objects necessary to create said functional data and relationships sent by Client A, are created as part of said environment media. If said environment media is recalled or a currently active environment media is utilized, the number of objects currently comprising said environment media are increased or decreased as needed to provide the needed number of objects to recreate the functional data and relationships received from Client A.

Step 681: The software programs the objects pairs in Client B's environment media with the data received from Client A. In other words, the functional data, relationship data, and any other data, received from Client A by Client B, are utilized to program each object in Client B's newly created or recalled or modified currently active environment media. By this process the functional data and relationships of objects in Client B's environment media are programmed to match functional data and relationships sent to Client B by Client A. By this process, said functional data and relationships, including any other needed data, like object characteristics, are sent by Client A, received by Client B, and used to program objects in Client B's software environment.

Content Designation and Environment Media Content Sharing

A user (“User 1”) requests an EM content which is presented in a visual environment. The user creates a designated area by any suitable means, which include: touching, drawing, lassoing, gesturing, verbal utterance, context, or otherwise designating all or part of the objects that comprise an EM. The user inputs an instruction to one of the objects comprising the collection of objects in said user designated area. The user doesn't think about the designated area as a collection of objects. They think about it as a piece of content, maybe it's an eye of an eagle or a dog or a flower pedal.

One of the objects that comprise the designated area communicates with other objects in the designated area to determine if they all share the same task. If objects outside the designated area are found that share the same task, they are added to the designated area. If objects inside the designated are found that do not share the same task, they are removed from the designated area. The designated area is redefined as an Environment Media or as a named collection of objects (“Collection 1”).

The software supplies a unique identifier for each object pair in Collection 1. Said unique identifier can contain any data set. For example, it could contain two parts: (1) an ID tag that is derived from the task of said named collection of objects, and (2) a GUID. [Note: each object pair, including all functional data saved in each motion media paired to each object comprising Collection 1, and any relationship between any object or motion media comprising Collection 1 shall be referred to as: “Collection 1 Functional Data.”

Collection 1 is presented to said user.

Now a user wants to share the designated area as a piece of content.

The user inputs a sharing instruction to one of the objects in the designated area. In this example the designated area is Collection 1. The objects and/or object pairs comprising Collection 1 shall be referred to as “Collection Objects.” Let's say the sharing instruction is to share Collection 1 with a friend. The name of the friend, their digital address or any equivalent identifier defines said friend (“User 2”) to the software, and is part of the sharing instruction. Other data that could be included in said sharing instruction might include: a time for the sharing instruction to be sent, a message to be included with the sharing instruction, any other data, e.g., another named collection of objects or any other content, could also be included.

The object in Collection 1 receiving said instruction (“Collection object 1”) communicates with the server of this software and sends the characteristics of Collection 1 (“Collection 1 Functional Data”) to a web server. [Note: Collection 1 Functional Data could also be sent to an application server. If this is the case, the objects comprising Collection 1 Functional Data on the application server can directly communicate with the objects in Collection 1 Functional Data on the web server to ensure that said Collection 1 Functional Data remains the same data in both locations. [Note: the objects comprising Collection 1 (“collection objects 2 to n”) communicate with Collection Object 1 as needed. Any object in Collection 1 can receive an input and communicate to any other object in Collection 1, to any server, computer, to any environment media, and to any other object in any environment of this software.]

Said Collection 1 Functional Data consists of sets of data—at least one set for each object pair that comprises Collection 1. Said Collection 1 Functional Data would include the characteristics of each object (“state 1” of said object) comprising Collection 1, plus data saved in the motion media paired to said each object comprising Collection 1. Said data includes change to the object to which each motion media is paired, the definition of one or more tasks derived from said change, and could also include any relationship between any collection object and another other object recognized by the software of this invention. Note: the object and the motion media object paired to it are not sent to User 2, instead the characteristics and functional data are sent.]

The web server sends a notice to User 2 that Collection 1 is being sent to User 2 from User 1. [Note: the object pairs comprising Collection 1 are not sent to User 2. Instead, the Collection 1 Functional Data is sent.]

One of many actions can occur next, including: (1) a web server or an application server sends the Collection 1 Functional Data to User 2, (2) User 2's software sends a query to said web server or application server to send Collection 1 Functional Data to the software of User 2., (3) User 2 responds to said notice to User 2 which starts the downloading of Collection 1 Functional Data to User 2's software environment, or the equivalent.

Said Collection 1 Functional Data is received by User 2's software and User 2's software utilizes Collection 1 Functional Data to either: (1) change the characteristics and functional data of existing objects to match the function data of said Collection 1 Functional Data, or (2) create an environment media or the equivalent, and an object pair for each set of functional data received. Said each received set of functional data is utilized to program each existing or created object pair in User 2's environment media.

[Note: the characteristics of said object in each object pair may be very simple. Said object may be like a piece of glass or as an empty cell with no functionality. The functionality, including “State 1” is provided for said object by the motion media object paired to it. Thus the sets of functional data in said Collection 1 Functional Data include functional data (including “state 1”) to be used to program each object pair in an environment of the software of this invention.]

[Note: the functional data for each object as provided by each motion media comprising said Collection 1 Functional Data including timing information. Said timing information determines when each change shall occur to the object being programmed by said functional data]

In summary: the functional data is what is being sent to User 2 and User 2's software is instructed as to how many objects to create and then is instructed to apply each set of data to each created object to program it to match the object pair in User 1's Collection 1 content. Said Collection 1 Functional Data is sent to User 2 in lists of characteristics (lists of functional data) per object as it exists in User 1's Collection 1 environment media.

Once this Collection 1 Functional Data is received User 2's software could save said Collection 1 Functional Data in any suitable storage or to a server or save it locally on User 2's device. Further, if User 2 current has an active environment media which is a work in progress, User 2 may not wish to or be able to reprogram their object pairs that comprise their current active environment media. In this case, a new environment could be created by User 2's software and this new environment media would receive said Collection 1 Functional Data and be programmed as described above.

The idea here is that a user is not creating copied content. Instead the user's software is creating instruction sets as functional data that is being shared. If one looked at a data base of this content, it wouldn't look like a .pdf, .mov, .png, etc. Instead there would be a number of lists comprised of functional data that changes over time for “X” number of objects, plus one or more relationships between said “X” number of objects. Plus an ID, and/or a reference to an owner of the data, and/or a reference to a description of the data, e.g., a flower pedal, a leaf, a flapping motion of an eagle's wing, etc.

What is being shared is a list of functional data in a form, not file formats. The form is: (a) a description of an object, and (b) the functional data which includes “state 1” of said object. The list of functional data consists of sets of data that are used to program object pairs. Each object pair being programmed by said functional data consists of an object and a motion media object that manages change to the object to which it is paired. So the functional data for an object pair includes: (a) a first state (“state 1”) a first condition of an object, (b) all change to said object or change that is categorized according to one or more tasks, (c) one or more relationships between said object and other objects.

One user sends functional data that describes a piece of content, e.g., an environment media, a portion of an environment media, or a collection of objects, a portion of the functional data comprising any number of objects, or the like.

[Note: all data has some format. But formats tend to be a barrier to usage. The data of this invention has a format but it allows interoperability rather than prevents it.

Syncing an Environment Media in a Browser to a Video on a Device

Condition 1: an environment media and video player operate in an application browser server. Said environment media is being used to modify a designated area of a video being displayed on a device.
i. Said environment media contains object pairs which have reproduced the image pixels of video image data in a designated area.
ii. Said application browser contains a video player.
iii. A plugin player to the browser performs the playback of said video.
iv. Said player communicates with said application browser. Said player controls the rate of video playback.
v. Said application browser can induce continuous refresh of display sub-regions within its UI area, up to the refresh rate of pixels on the display of said device.
vi. At set time intervals, e.g., every 30^{th} of a second, said application browser is registered for a synchronization trigger from said plugin. Each synchronization trigger causes the browser to refresh said display sub-region said device.
vii. Said application browser communicates with said environment media in said application browser and provides synchronization triggers to said environment media.
viii. Said environment media syncs to said synchronization triggers and presents change to the characteristics of the objects comprising said environment media in sync to the playback of said video.
ix. Said video player prepares its buffer and delivers it to said application browser.
x. Said application browser delivers the final prepared image to said environment media.
xi. Said environment media modifies the video player buffer.
xii. Said environment media delivers its modified image data back to said application browser.
xiii. Said application browser renders said modified image data to said display of said device.

Condition 2: A video is being played locally on a device via a player installed on said device; an environment media, operating in an application browser, is modifying said video being displayed on said device.
i. Said video plays back from a file via a video player on said device.
ii. Said player sets up a trigger as to how fast said player is going to invalidate images.
iii. There is a cooperation between said player and said browser as to which element generates pixel image data. [Note: As is common in the art, often the only element that draws to the screen of said device is the browser.]
iv. The application browser draws to said screen display or its equivalent.
v. The application browser requests video content from said video player
vi. Said video player draws to an area of memory and notifies said application browser when the drawing to said memory is completed.
vii. Said application browser delivers the final prepared image to said environment media.
viii. Said environment media modifies the video player buffer.
ix. Said environment media delivers its modified image data back to said application browser.
x. Said application browser renders said modified image data from memory to said display of said device.

Further Regarding the Communication Between Objects Comprising an Environment Media.

As described herein, objects which comprise an environment media and/or are associated with an environment media, (including any object pair [e.g., one object paired to a motion media object managing change to said one object], the motion media paired to an environment media and managing change to the objects that comprise that environment media, “master motion media,” and including an environment media itself), can communicate between themselves and to and from external input, e.g., user input. This communication can be accomplished via three general means: (1) where each object is capable of sending and receiving data directly to and from any other object associated with an environment media, and (2) a software protocol or the equivalent instructs objects to communicate to each other as needed, and (3) a hybrid of (1) and (2), where some objects are autonomous units and other objects are dependent upon a software application for their communication. In the case of (1) above, each object would contain the ability to process data individually, thus acting as an independent processing unit or the equivalent. This independence could be supported by a multi-threaded computing architecture or by any other suitable means. In the case of (2) above, a software application would direct the communication between objects as needed. Many different specific communication operations are possible with the three above listed general architectures.

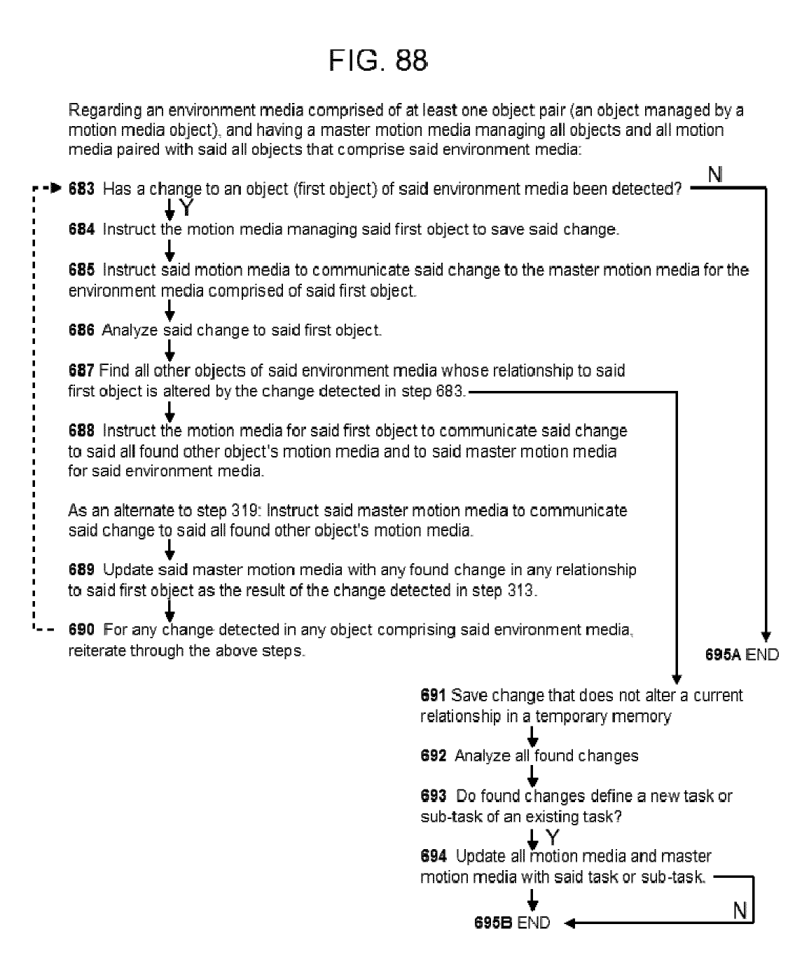

FIG. 88 is a flow chart illustrating one possible set of communication operations. An environment media is comprised of at least one object pair. Said object pair consists of a first object, which is managed by a motion media object that records, analyzes and communicates change to said first object object, including change to relationships between said first object and other objects. Said environment media is paired with a master motion media that records, analyzes and communicates change to the object pairs that comprise said environment media. The communication as illustrated in FIG. 88 is dependent upon a software application instructing objects as to how and when to what objects they shall communicate. It should be noted that the operations described in FIG. 88 could also be carried out by each object acting as an independent processing unit or by a hybrid of independent processor objects and objects instructed by a software application.

Step 683: Has a change to an object (“first object”) of said environment media been detected? Has the software detected a change in the characteristic or relationship of a first object of an environment media?

Step 684: The software instructs the motion media managing said first object to save said change. If said first object and its paired motion media were independent processing units, then said first object could instruct said motion media paired to said first object to save said change. Or said motion media, paired to said first object, could instruct itself to save said change. Or said environment media could instruct said motion media object paired to said first object to save said change and so on.

Step 685: The motion media paired to said first object is instructed to communicate said change to the master motion media for said environment media comprised of said first object. Note: there may be, and likely are, many object pairs comprising said environment media.

Step 686: The motion media paired to said first object and/or the master motion media paired to said environment media analyzes said change to said first object.

Step 687: All other objects comprising said environment media whose relationship to said first object has been altered by said change detected in Step 683 are found. The finding of said all other objects could be carried out by a software application or by the independent processing of said master motion media or by any motion media paired to any object which comprises said environment media, or by any object paired to any motion media and which comprises part of said environment media.

Step 688: The motion media paired to said first object communicates said change to the motion media paired to each found object that has a relationship to said first object, and which has been altered by said change of Step 683. Further, said change is communicated to said master motion media which is paired to said environment media. As described in Step 687, this communication and any additional communication described in FIG. 88, could be carried out via one or more instructions from a software application and/or via instructions created by an object, e.g., a motion media, an object paired to a motion media, said environment media operating as an autonomous processing unit. As an alternate, if said master motion media found said other object as described in Step 687, said master motion media could communicate to each found object's motion media.

Step 689: Depending upon how Step 687 is carried out, the master motion media may need to be updated or may not.

Step 320 690: The previous steps 683 to 689 are repeated for each change detected in any object in said environment media.

Step 687: Objects that are not altered by the change detected in step 683 are also saved to a temporary memory.

Step 692: All changes saved to said temporary memory are analyzed.

Step 693: All changes saved in step 692 are analyzed to determine if these changes define a new task or sub-task or an existing task.

Step 694: If a collection of the changes saved in step 693 define a task or sub-task of an existing task, all motion media for said environment media of step 683 and the master motion media for said environment media of step 693 are updated with a new task or sub-task. If there are not enough changes saved to define a task this process ends.

By the methods described herein, EM elements redefine content, functionality and the sharing of said content and functionality. One user's content, recreated as EM elements (“EM content”) is capable of communicating to another user's EM content. Any program or app that has been recreated by EM elements (“EM program”) can communicate to any EM program of any other user. Any aspect of any “EM content” or “EM program” can be altered according to categories of change, which leaves other parts of said “EM content” or “EM program” unaffected. Functionality can be programmed to exhibit very complex behavior, executed in ways that could never be controlled live by a user, but that are easy to program via EM elements, motion media and Programming Action Objects. As described herein, the programming of said “EM content” and “EM programs” can be accomplished by a user's operation of programs, apps and content. Finally, all EM elements, including environment media, objects that comprise environment media, and server-side computing systems are interoperable. Thus in the environments created by the software of this invention all “EM content” and “EM programs” are interoperable.

The foregoing description of the preferred embodiments of the invention has been presented for purposes of illustration and description. It is not intended to be exhaustive or to limit the invention to the precise form disclosed, and many modifications, and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. Although the specific embodiments of the invention have been described and illustrated, it is intended that the scope of the invention be defined by the claims appended hereto and their equivalents.

What is claimed is:

1. A method of programming an object, said method comprising:
recording at least one visualization;
performing at least one comparative analysis using said at least one visualization;
determining at least one visualization action for said at least one visualization; and
programming at least one object with said at least one visualization action.

2. The method of claim 1 wherein said at least one visualization contains at one additional visualization.

3. The method of claim 1 wherein said programming of said at least one object is accomplished with a Programming Action Object.

4. The method of claim 1 wherein said programming of said at least one object is accomplished with a motion media.

5. The method of claim 1 wherein said programming of said at least one object is accomplished via EM software.

6. A method of programming an object, said method comprising:
operating software in a computing system;
recording at least one operation as a visualization;
performing at least one of the following:
a) analyzing said visualization to determine at least one functionality associated with said visualization; and
b) analyzing the image data of said visualization to determine at least one image characteristic of said visualization; and
utilizing at least one of the following to program an object:
a) at least one functionality associated with said visualization and
b) at least one image characteristic of said visualization.

7. The method of claim 6 wherein said software is a software app.

8. The method of claim 6 wherein said software is a software program.

9. The method of claim 6 wherein said software is a cloud service.

10. A method of modifying content, said method comprising:
presenting at least one content to a computing system;
recognizing an input that triggers the activation of an object-based software;
presenting said object-based software in a browser application;
syncing said object-based software to said content;
designating an area of said content; and
recreating the characteristics of said area of said content as objects in said browser application.
